(19) United States
(12) Patent Application Publication
(10) Pub. No.: US 2011/0205178 A1
(43) Pub. Date: Aug. 25, 2011

(54) ELECTRONIC DEVICE HAVING TWO DISPLAY DEVICES, METHOD OF CONTROLLING THE SAME, AND RECORDING MEDIUM

(76) Inventors: Toshihiko Yoshida, Osaka (JP); Masakazu Kawahara, Osaka (JP); Yukihiro Kubo, Osaka (JP); Osamu Uratani, Osaka (JP)

(21) Appl. No.: 13/126,438

(22) PCT Filed: Oct. 27, 2009
(86) PCT No.: PCT/JP2009/068425

§ 371 Date: Apr. 27, 2011

(30) Foreign Application Priority Data
Oct. 28, 2008 (JP) 2008-277131
Oct. 31, 2008 (JP) 2008-281840
Mar. 3, 2009 (JP) 2009-049290
Mar. 9, 2009 (JP) 2009-055112
Mar. 9, 2009 (JP) 2009-055254

(51) Int. Cl. G06F 3/041

(52) U.S. Cl. 345/173

(57) ABSTRACT

An electronic device can operate in two operation modes of a “mouse mode” and a “tablet mode”. In the mouse mode, a program is executed in response to an input to a liquid crystal panel implemented by a display-integrated tablet. An operation screen of the program created as a result of execution of the program is displayed on a main screen. In the tablet mode, a program is executed in response to an input to the liquid crystal panel. An operation screen of the program generated as a result of execution of the program is displayed on the liquid crystal panel. In a sub application “book”, information on history of electronic books that have been selected so far for viewing on a book viewer is stored and a soft key indicative of each electronic book is displayed on the liquid crystal panel in the order in accordance with the history information.

### TECHNICAL FIELD

The present invention relates to an electronic device and particularly to an electronic device having two display devices, a method of controlling the same, and a recording medium.

### BACKGROUND ART

Currently, such electronic devices as a personal computer and a mobile information terminal have widely been used. In addition, electronic devices having two display devices have recently increasingly been used.

For example, a mobile information terminal disclosed in Japanese Patent Laying-Open No. 2000-172395 (Document 1) has two screens so that a content is displayed on one screen of the two screens. In addition, this mobile information terminal causes the other screen to display a menu bar or a slide bar of contents.

Japanese Patent Laying-Open No. 2001-306291 (Document 2) discloses an information processing apparatus including a main display device and an auxiliary display device. In normal operation, this information processing apparatus causes the main display device to display both of a content and additional information on the content. When full-screen display of a content is provided, the information processing apparatus causes a sub screen to display the additional information.

An electronic instrument disclosed in Japanese Patent Laying-Open No. 2003-202948 (Document 3) has a main display portion and an auxiliary display portion and causes the auxiliary display portion to display a communication connection status of the electronic instrument.

An electronic instrument disclosed in Japanese Patent Laying-Open No. 2003-216297 (Document 4) also has a main display portion and an auxiliary display portion, similarly to the electronic instrument described in Patent Document 3. This electronic instrument causes the auxiliary display portion to display information on a state of the electronic instrument based on combination of a character message, a symbol, and a display color and/or a blinking indication on the auxiliary display portion.

An information processing apparatus disclosed in Japanese Patent Laying-Open No. 2004-5105 (Document 5) includes a main display, a controller for the main display, a display-integrated pointing device, and a controller dedicated for the pointing device. This information processing apparatus can make system setting of BIOS (Basic Input/Output System) by using the pointing device before launch of an OS (Operating System).

Japanese Patent Laying-Open No. 2004-5212 (Document 6) also discloses an information processing apparatus including a main display, a controller for the main display, a display-integrated pointing device, and a controller dedicated for the pointing device, similarly to the information processing apparatus described in Patent Document 5. In order to prevent an erroneous operation, when a display screen of the pointing device is switched, the information processing apparatus disclosed in Patent Document 6 causes the main display to show the display screen of the pointing device.

### PRIOR ART DOCUMENTS

### Patent Documents

Patent Document 1: Japanese Patent Laying-Open No. 2000-172395
Patent Document 2: Japanese Patent Laying-Open No. 2001-306291
Patent Document 3: Japanese Patent Laying-Open No. 2003-202948
Patent Document 4: Japanese Patent Laying-Open No. 2003-216297
Patent Document 5: Japanese Patent Laying-Open No. 2004-5105
Patent Document 6: Japanese Patent Laying-Open No. 2004-5212

### SUMMARY OF THE INVENTION

### Problems to be Solved by the Invention

In the electronic device as described above, a user can use a sub display similarly to a touch pad included in many conventional notebook personal computers. Namely, in such an electronic device, an input to the sub display is processed as information for moving a position of a cursor displayed on a main display or for providing an instruction to an application by clicking, dragging or the like.

Meanwhile, in a mobile information terminal, recently, an operation screen of an application can be displayed on a sub display and the application can be operated by providing an input to the sub display. Namely, an input to the sub display is processed as an input to the operation screen of the application displayed on the sub display.

In the conventional mobile information terminal, how to control an electronic device at the time of making switching of a method of processing an input to the sub display between the two processing methods above has not been considered in detail.

Therefore, the electronic device simply making use of the conventional technique may suffer poor operability at the time of switching between the processing methods.

The present invention was made in view of such circumstances, and an object thereof is to improve operability of an electronic device including two display devices.

### Means for Solving the Problems

An electronic device according to the present invention includes a first display portion, a second display portion, a storage portion, and a control unit for controlling a manner of display on the first and second display portions, the second display portion is a display-integrated tablet capable of accepting an external input, and the control unit is capable of operating in a first mode causing the first display portion to display a screen created in processing performed in accordance with the input to the tablet and in a second mode causing the second display portion to display a screen created in processing performed in accordance with the input to the tablet, causes the storage portion to store operation information which is information specifying a content of an operation in the second mode when an operation mode is switched from the second mode to the first mode, and causes the second display portion to display information in accordance with the operation information stored in the storage portion when the operation mode is switched from the first mode to the second mode.

A method of controlling an electronic device according to the present invention is a method of controlling an electronic device including a first display portion, a second display portion implemented by a display-integrated tablet capable of accepting an external input, a storage portion, and a control unit for controlling a manner of display on the first and second display portions, and the method includes the steps of operating in a first mode causing the first display portion to display a screen created in processing performed in accordance with the input to the tablet, operating in a second mode causing the second display portion to display a screen created in processing performed in accordance with the input to the tablet, storing in the storage portion, operation information which is information specifying a content of an operation in the second mode when an operation mode is switched from the second mode to the first mode, and displaying on the second display portion, information in accordance with the operation information stored in the storage portion when the operation mode is switched from the first mode to the second mode.

A recording medium according to the present invention is a recording medium recording a control program executed in an electronic device including a first display portion, a second display portion implemented by a display-integrated tablet capable of accepting an external input, a storage portion, and a control unit for controlling a manner of display on the first and second display portions, and the control program causes the electronic device to perform the steps of operating in a first mode causing the first display portion to display a screen created in processing performed in accordance with the input to the tablet, operating in a second mode causing the second display portion to display a screen created in processing performed in accordance with the input to the tablet, storing in the storage portion, operation information which is information specifying a content of an operation in the second mode when an operation mode is switched from the second mode to the first mode, and displaying on the second display portion, information in accordance with the operation information stored in the storage portion when the operation mode is switched from the first mode to the second mode.

### Effects of the Invention

According to the present invention, the electronic device which includes the first and second display portions, the second display portion representing one of them being a display-integrated tablet capable of accepting an external input, can operate in two operation modes, that is, in the first mode causing the first display portion to display the screen created in the processing performed in accordance with the input to the tablet and in the second mode causing the second display portion to display the screen created in the processing performed in accordance with the input to the tablet. In addition, in the electronic device, in switching the operation mode from the second mode to the first mode, the operation information which is the information specifying the content of the operation in the second mode is stored in the storage portion. When the operation mode is switched from the first mode to the second mode, the information in accordance with the operation information stored in the storage portion is displayed on the second display portion.

Thus, the user can use the electronic device including two display devices (first and second display portions) in both of the first mode and the second mode, and when the operation mode is changed from one mode to the other mode of these modes, the user can view display based on the information specifying the content of the operation in the other mode on the second display portion.

Therefore, when the operation mode is switched in the electronic device between a plurality of modes different in a manner of use of the two display devices, with regard to a mode set as a result of switching, contents of an operation that has been performed so far in the resultant mode can be reflected on second display means and thus operability of the electronic device including the two display devices can be improved.

### BRIEF DESCRIPTION OF THE DRAWINGS

FIG. 1 is a schematic diagram showing appearance of an electronic device.

FIG. 2 is a block diagram showing a hardware configuration of the electronic device.

FIG. 3 shows a configuration of a liquid crystal panel and peripheral circuits of the liquid crystal panel.

FIG. 4 is a cross-sectional view of the liquid crystal panel and a backlight.

FIG. 5 shows a timing chart in operating a photosensor circuit.

FIG. 6 is a cross-sectional view showing how a photodiode receives light from a backlight in scanning.

FIG. 7 shows a schematic configuration of a command.

FIG. 8 illustrates a command of type “000”.

FIG. 9 illustrates a command of type “001”.

FIG. 10 illustrates a command of type “010”.

FIG. 11 illustrates a command of type “011”.

FIG. 12 illustrates a command of type “100”.

FIG. 13 illustrates a command of type “101”.

FIG. 14 shows a schematic configuration of response data.

FIG. 15 shows an image (a scan image) obtained by scanning a finger.

FIG. 16 is a circuit diagram of a photosensor built-in liquid crystal panel different from that shown in FIG. 3.

FIG. 17 is a cross-sectional view showing how the photodiode receives external light in scanning.

FIG. 18 is a block diagram showing a hardware configuration of a variation of the electronic device.

FIG. 19 is a schematic diagram showing appearance of Variation 3 of the electronic device.

FIG. 20 is a block diagram showing a hardware configuration of the electronic device in FIG. 19.

FIG. 21 is a diagram showing in a block diagram form, a functional configuration of the electronic device.

FIG. 22 is a diagram for illustrating a screen displayed on the electronic device in each of a mouse mode and a tablet mode.

FIG. 23 is a diagram showing a specific example of a mouse screen.

FIG. 24 is a diagram showing a specific example of a home menu screen.

FIG. 25 is a diagram of transition of a screen displayed on the liquid crystal panel in the tablet mode.

FIG. 26 is a diagram for illustrating an operation of the electronic device in switching between the mouse mode and the tablet mode.

FIG. 27 is a diagram schematically showing an operation mode at the time of normal launch.

FIG. 28 is a diagram schematically showing an operation mode at the time of return.

FIG. 29 is a diagram for illustrating an operation of the electronic device in the tablet mode.

FIG. 30 is a diagram showing one example of a character input screen.

FIG. 31 is a first diagram for illustrating an operation of the electronic device when a handwriting character input pad is used.

FIG. 32 is a second diagram for illustrating an operation of the electronic device when the handwriting character input pad is used.

FIG. 33 is a diagram for illustrating an operation of the electronic device when a text box is full.

FIG. 34 is a diagram showing one example of an illustration input screen.

FIG. 35 is a diagram showing one example of a calculator screen.

FIG. 36 is a diagram showing one example of an Internet screen.

FIG. 37 is a diagram showing one example of the Internet screen including a scroll bar.

FIG. 38 is a diagram showing one example of a dictionary selection screen.

FIG. 39 is a diagram showing one example of the dictionary selection screen including a scroll bar.

FIG. 40 is a diagram showing in a flowchart form, a flow of processing performed by the electronic device.

FIG. 41 is a diagram showing in a flowchart form, a flow of processing in a mouse mode operation.

FIG. 42 is a diagram showing in a flowchart form, a flow of processing in a tablet mode operation.

FIG. 43 is a diagram showing in a flowchart form, a flow of processing in a mode switching (from the mouse mode to the tablet mode) operation.

FIG. 44 is a diagram showing in a flowchart form, a flow of first processing in a mode switching (from the tablet mode to the mouse mode) operation.

FIG. 45 is a diagram for illustrating a state of the electronic device where a sub application “book” is being executed.

FIG. 46 is a diagram showing a variation of the block diagram in FIG. 21.

FIG. 47 is a diagram for illustrating a state of the electronic device where the sub application “book” is being executed.

FIG. 48 is a first diagram for illustrating an operation of the electronic device when the handwriting character input pad is used in Variation 4 of the present embodiment.

FIG. 49 is a second diagram for illustrating an operation of the electronic device when the handwriting character input pad is used in Variation 4 of the present embodiment.

FIG. 50 is a diagram for illustrating an operation of the electronic device when the text box is full in Variation 4 of the present embodiment.

FIG. 51 is a diagram showing in a flowchart form, a flow of processing performed by the electronic device in Variation 5 of the present embodiment.

FIG. 52 is a diagram schematically showing an operation mode at the time of normal launch in Variation 6 of the present embodiment.

FIG. 53 is a diagram schematically showing an operation mode at the time of return in Variation 6 of the present embodiment.

FIG. 54 is a diagram for illustrating change in cursor display control according to Variation 7 of the present embodiment.

FIG. 55 is a diagram for illustrating change in cursor display control according to Variation 7 of the present embodiment.

FIG. 56 is a diagram showing in a flowchart form, a flow of processing performed by the electronic device in Variation 8 of the present invention.

FIG. 57 is a diagram showing in a flowchart form, a flow of processing in a mouse mode operation in Variation 8 of the present invention.

FIG. 58 is a diagram showing in a flowchart form, a flow of processing in a tablet mode operation in Variation 8 of the present invention.

FIG. 59 is a diagram showing in a flowchart form, a flow of processing in a mode switching (from the mouse mode to the tablet mode) operation in Variation 8 of the present invention.

FIG. 60 is a diagram showing in a flowchart form, a flow of processing in a mode switching (from the tablet mode to the mouse mode) operation in Variation 8 of the present invention.

FIG. 61 is a diagram showing in a flowchart form, a flow of processing for changing a form of display of a cursor in Variation 8 of the present invention.

FIG. 62 is a diagram showing in a flowchart form, a flow of processing for recovering a form of display of a cursor in Variation 8 of the present invention.

FIG. 63 is a diagram showing in a flowchart form, a flow of processing in making a cursor invisible in Variation 8 of the present invention.

FIG. 64 is a diagram showing in a flowchart form, a flow of processing for again displaying a cursor in Variation 8 of the present invention.

FIG. 65 is a diagram showing in a flowchart form, a flow of processing in moving a cursor in transition from the mouse mode to the tablet mode in Variation 8 of the present invention.

FIG. 66 is a diagram showing in a flowchart form, a flow of processing in moving a cursor in transition from the tablet mode to the mouse mode in Variation 8 of the present invention.

FIG. 67 is a diagram for illustrating change in cursor display control in Variation 9 of the present invention.

FIG. 68 is a diagram showing in a flowchart form, a flow of processing in a mode switching (from the mouse mode to the tablet mode) operation in Variation 9 of the present invention.

FIG. 69 is a diagram showing in a flowchart form, a flow of processing in a mode switching (from the tablet mode to the mouse mode) operation in Variation 9 of the present invention.

FIG. 70 is a diagram showing appearance of an electronic device in Variation 10 of the present invention.

FIG. 71 is a block diagram showing a hardware configuration of the electronic device in Variation 10 of the present invention.

FIG. 72 is a diagram for illustrating change in cursor display control in Variation 10 of the present invention.

FIG. 73 is a diagram showing in a flowchart form, a flow of processing in a mouse mode operation in Variation 10 of the present invention.

FIG. 74 is a diagram showing in a flowchart form, a flow of processing in a tablet mode operation in Variation 10 of the present invention.

FIG. 75 is a diagram showing in a flowchart form, a flow of processing in a mode switching (from the mouse mode to the tablet mode) operation in Variation 10 of the present invention.

FIG. 76 is a diagram showing in a flowchart form, a flow of processing in a mode switching (from the tablet mode to the mouse mode) operation in Variation 10 of the present invention.

FIG. 77 is a diagram for illustrating a variation of a command of type “000” in FIG. 8.

FIG. 78 is a flowchart of sub screen control processing performed by a CPU in the first unit in FIG. 2.

FIG. 79 is a flowchart of sub screen control processing performed by a signal processing unit in the second unit in FIG. 2.

FIG. 80 is a flowchart of sub side control processing performed by the signal processing unit in the second unit in FIG. 2.

FIG. 81A is a diagram showing one example of a display screen on the liquid crystal panel of the first unit in FIG. 2.

FIG. 81B is a diagram showing one example of a display screen on the liquid crystal panel of the second unit in FIG. 2.

FIG. 82A is a diagram for illustrating change in the display screen in FIG. 81B.

FIG. 82B is a diagram for illustrating change in the display screen in FIG. 81B.

FIG. 82C is a diagram for illustrating change in the display screen in FIG. 81B.

FIG. 83A is a diagram showing another example of the display screen on the liquid crystal panel of the first unit in FIG. 2.

FIG. 83B is a diagram showing another example of the display screen on the liquid crystal panel of the second unit in FIG. 2.

FIG. 84 is a flowchart of a variation of the sub screen control processing in FIG. 78.

FIG. 85 is a diagram showing a variation of the flowchart of the sub side control processing in FIG. 79.

FIG. 86 is a diagram showing appearance of an information processing system implemented by the electronic device representing one embodiment of the present invention and one example of an information processing terminal.

FIG. 87 is a diagram for illustrating change in a manner of display of a content on a first display panel of an electronic device in Variation 15 of the present invention.

FIG. 88 is a cross-sectional view showing a configuration in which a photodiode receives external light in scanning.

FIG. 89 is a block diagram showing a hardware configuration of a variation of the electronic device.

FIG. 90 is a block diagram showing a functional configuration of the electronic device according to the present embodiment.

FIG. 91 is a flowchart showing a processing procedure in content display processing in the electronic device according to the present embodiment.

FIG. 92 is a block diagram showing a functional configuration of an electronic device having a first additional function.

FIG. 93 is a conceptual diagram showing transition of a screen of the electronic device having the first additional function.

FIG. 94 is a conceptual diagram showing a processing procedure in content display processing in the electronic device having the first additional function.

FIG. 95 is a block diagram showing a functional configuration of an electronic device having a second additional function.

FIG. 96A is a conceptual diagram showing transition of a screen of the electronic device having the second additional function.

FIG. 96B is a conceptual diagram showing transition of a screen of the electronic device having the second additional function.

FIG. 96C is a conceptual diagram showing transition of a screen of the electronic device having the second additional function.

FIG. 97 is a conceptual diagram showing a processing procedure in content display processing in the electronic device having the second additional function.

FIG. 98 is a block diagram showing a functional configuration of an electronic device having a third additional function.

FIG. 99A is a conceptual diagram showing transition of a screen of the electronic device having the third additional function.

FIG. 99B is a conceptual diagram showing transition of a screen of the electronic device having the third additional function.

FIG. 99C is a conceptual diagram showing transition of a screen of the electronic device having the third additional function.

FIG. 100 is a conceptual diagram showing a processing procedure in content display processing in the electronic device having the third additional function.

### MODES FOR CARRYING OUT THE INVENTION

An embodiment of the present invention will be described hereinafter with reference to the drawings. In the description below, the same elements have the same reference characters allotted. Their label and function are also identical. Therefore, detailed description thereof will not be repeated.

<Appearance of Electronic Device>

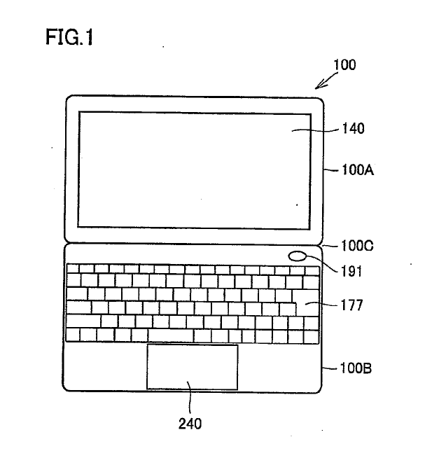

FIG. 1 shows appearance of an electronic device 100 of the present embodiment. Referring to FIG. 1, electronic device 100 includes a first casing 100A and a second casing 100B.

First casing 100A and second casing 100B are foldably connected to each other via a hinge 100C. First casing 100A includes a photosensor built-in liquid crystal panel 140. Second casing 100B includes a photosensor built-in liquid crystal panel 240. As such, electronic device 100 includes the two photosensor built-in liquid crystal panels.

Electronic device 100 is configured as a mobile device having a display function, such as a PDA (Personal Digital Assistant), a notebook type personal computer, a mobile phone, or an electronic dictionary.

<As to Hardware Configuration>

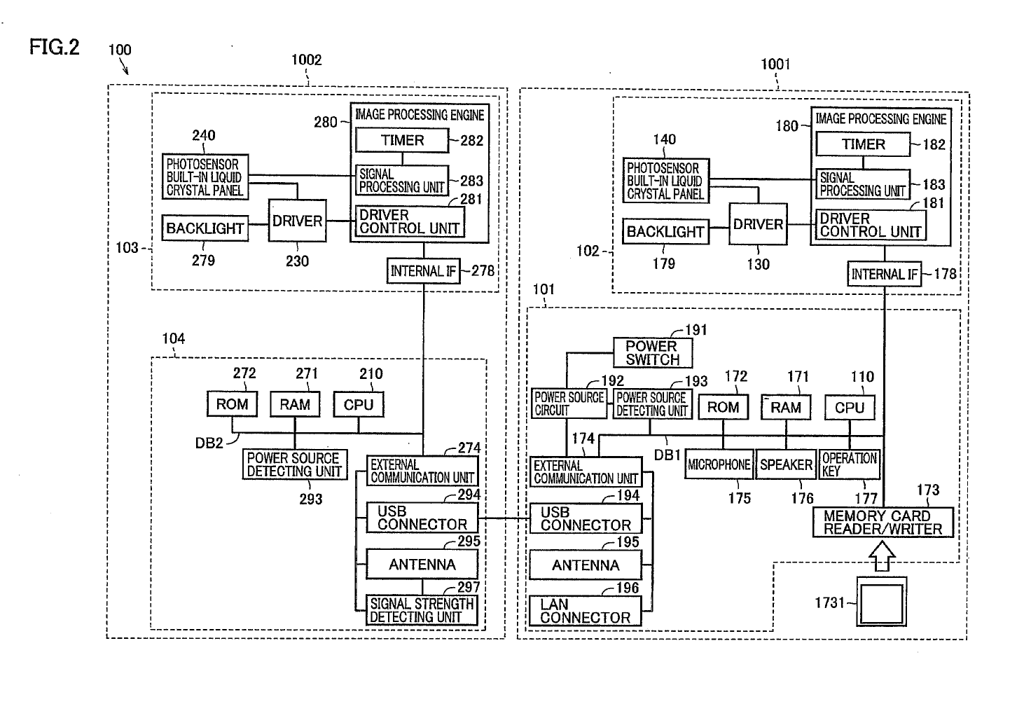

Next, referring to FIG. 2, one embodiment of a specific configuration of electronic device 100 will be described. FIG. 2 is a block diagram showing a hardware configuration of electronic device 100.

Electronic device 100 includes a first unit 1001 and a second unit 1002. Second unit 1002 is connected to first unit 1001 so that it is detachable from electronic device 100. First unit 1001 includes a main device 101 and a display device 102. Second unit 1002 includes a display device 103 and a main device 104.

First casing 100A contains display device 102 therein. Second casing 100B contains main device 101 therein. Second casing 100B also contains second unit 1002 therein.

(As to First Unit)

Main device 101 includes a CPU (Central Processing Unit) 110, a RAM (Random Access Memory) 171, a ROM (Read-Only Memory) 172, a memory card reader/writer 173, an external communication unit 174, a microphone 175, a speaker 176, an operation key 177, a power switch 191, a power source circuit 192, a power source detecting unit 193, a USB (Universal Serial Bus) connector 194, an antenna 195, and a LAN (Local Area Network) connector 196. These components (110, 171-177, 193) are connected to one another via a data bus DB1. To memory card reader/writer 173, a memory card 1731 is inserted.

CPU 110 executes a program. Operation key 177 receives an instruction input from a user of electronic device 100. RAM 171 stores therein data generated by execution of a program by CPU 110 or input data provided via operation key 177, in a volatile manner. ROM 172 stores data therein in a nonvolatile manner. ROM 172 is a ROM in and from which data can be written and deleted, such as an EPROM (Erasable Programmable Read-Only Memory) or a flash memory.

External communication unit 174 communicates with another electronic device. Specifically, external communication unit 174 communicates with for example second unit 1002 via USB connector 194. Further, external communication unit 174 wirelessly communicates with for example second unit 1002 via antenna 195. Further, external communication unit 174 communicates with other electronic devices via LAN connector 196 in a wired manner.

Main device 101 may communicate with other electronic devices through wireless communication other than Bluetooth®. For example, external communication unit 174 may wirelessly communicate with another electronic device connected to the LAN, via a wireless LAN antenna not shown in the figure. Alternatively, external communication unit 174 may wirelessly communicate with another electronic device via an infrared port not shown in the figure.

Power switch 191 is a switch for launching electronic device 100.

When power switch 191 is turned on, power source circuit 192 supplies power via power source detecting unit 193 to the components and display device 102 each of which is connected to data bus DB1. Further, when power switch 191 is turned on, power source circuit 192 supplies power to external communication unit 174 not via power source detecting unit 193.

Power source detecting unit 193 detects an output from power source circuit 192. Further, power source detecting unit 193 sends information concerned with the detected output (for example, a voltage value or a current value) to CPU 110.

USB connector 194 is used to connect first unit 1001 to second unit 1002. It should be noted that main device 101 may include another USB connector in addition to USB connector 194.

First unit 1001 transmits data to second unit 1002 via USB connector 194. Further, first unit 1001 receives data from second unit 1002 via USB connector 194. Furthermore, first unit 1001 supplies power to second unit 1002 via USB connector 194.

Antenna 195 is used for communication between first unit 1001 and other communication devices (for example, second unit 1002) in compliance with the Bluetooth® standard. LAN connector 196 is used to connect electronic device 100 to the LAN.

Display device 102 includes a driver 130, photosensor built-in liquid crystal panel 140 (hereinafter, referred to as liquid crystal panel 140), an internal IF 178, a backlight 179, and an image processing engine 180.

Driver 130 is a driving circuit for driving liquid crystal panel 140 and backlight 179. Various driving circuits in driver 130 will be described later.

Liquid crystal panel 140 is a device including a function of a liquid crystal display and a function of a photosensor. In other words, liquid crystal panel 140 is capable of displaying an image using liquid crystal and sensing using a photosensor. Details of liquid crystal panel 140 will be described later.

Internal IF (Interface) 178 interfaces exchanges of data between main device 101 and display device 102.

Backlight 179 is a light source provided at the back surface of liquid crystal panel 140. Backlight 179 emits uniform light to the back surface. Image processing engine 180 controls operations of liquid crystal panel 140 via driver 130. This control is performed based on various types of data sent from main device 101 via internal IF 178. The various types of data include below-described commands. Further, image processing engine 180 processes data output from liquid crystal panel 140, and sends the processed data to main device 101 via internal IF 178. Further, image processing engine 180 includes a driver control unit 181, a timer 182, and a signal processing unit 183.

Driver control unit 181 sends a control signal to driver 130 to control operations of driver 130. Further, driver control unit 181 analyzes a command sent from main device 101. Further, driver control unit 181 sends to driver 130 a control signal that is based on a result of the analysis. Details of the operations of driver 130 will be described later.

Timer 182 generates time information and sends the time information to signal processing unit 183.

Signal processing unit 183 receives data output from the photosensor. The data thus output from the photosensor is analog data, and therefore signal processing unit 183 first converts the analog data into digital data. Then, signal processing unit 183 subjects the digital data to data processing corresponding to the content of a command sent from main device 101. Then, signal processing unit 183 sends to main device 101 data including the data (hereinafter, referred to as response data) having been subjected to the data processing and the time information obtained from timer 182. Further, signal processing unit 183 includes a RAM (not shown) capable of sequentially storing therein a plurality of pieces of scan data described below.

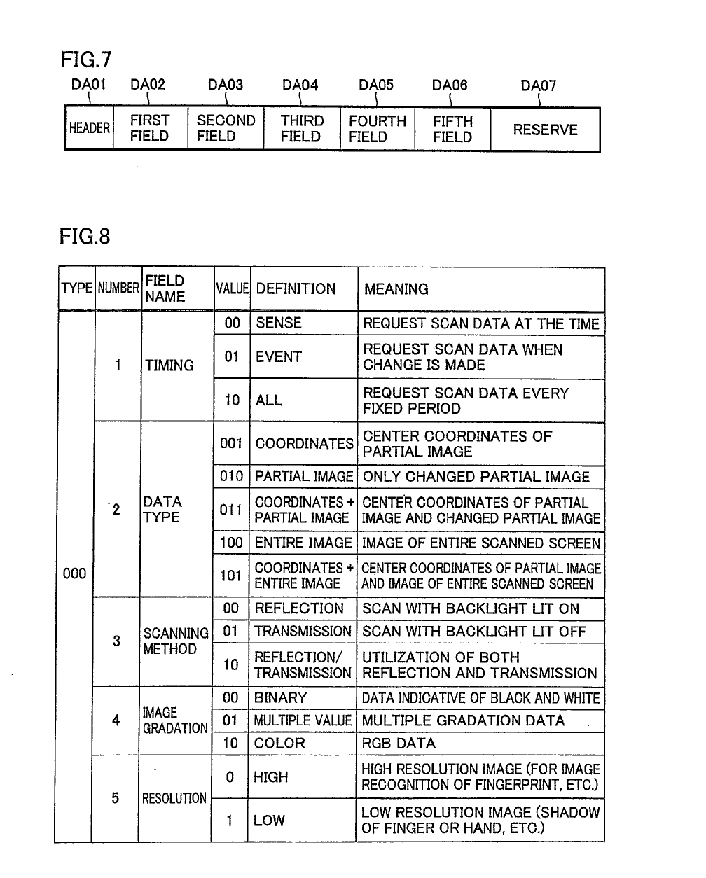

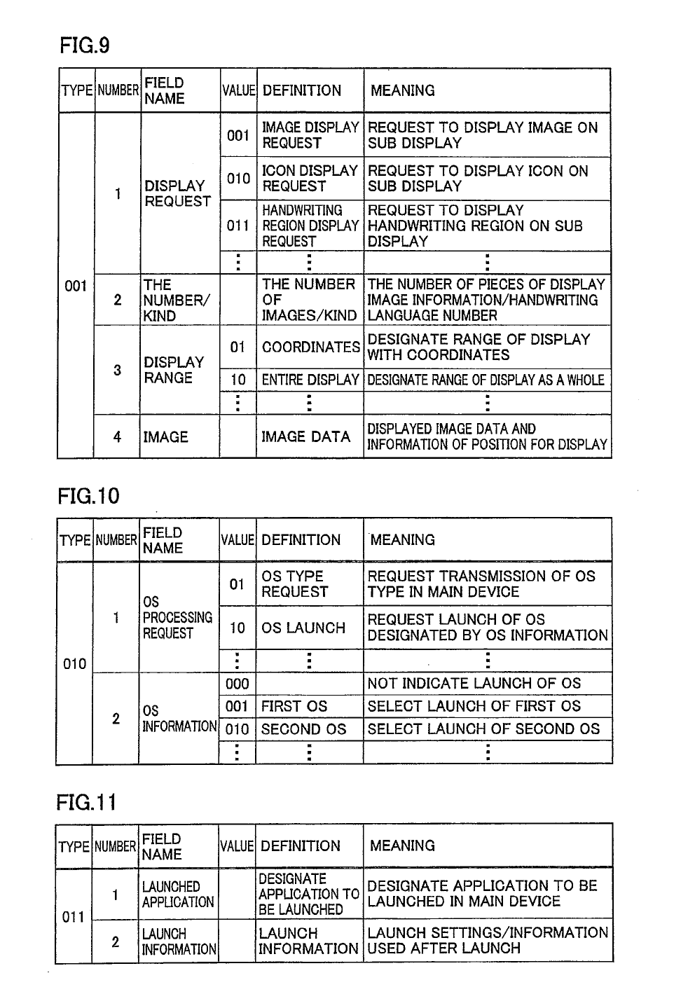

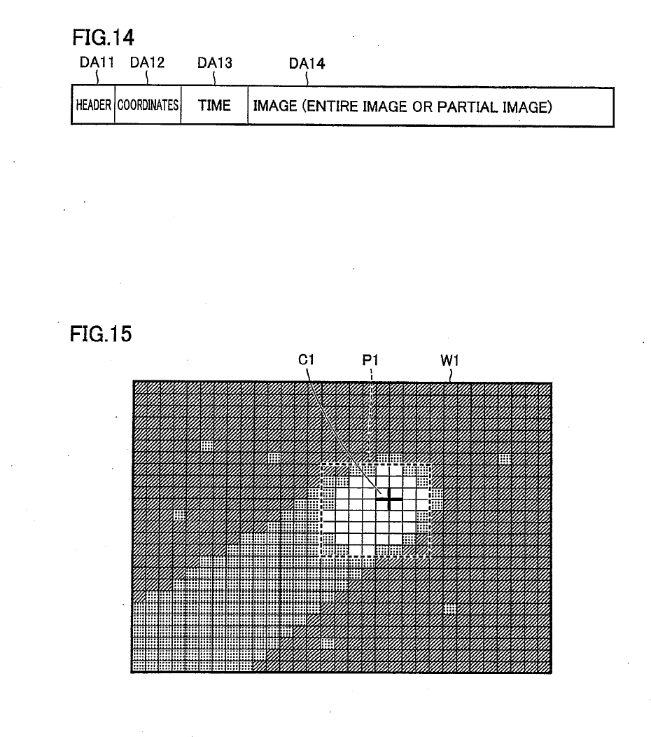

The commands include a sensing command for instructing the photosensor to perform sensing. Details of the sensing command and the response data will be described later (FIG. 7, FIG. 8, and FIG. 14).

It should be noted that timer 182 does not need to be necessarily provided in image processing engine 180. For example, timer 182 may be provided outside image processing engine 180 in display device 102. Alternatively, timer 182 may be provided in main device 101. Further, microphone 175 and speaker 176 do not need to be always provided in electronic device 100. In some embodiments of electronic device 100, one or both of microphone 175 and speaker 176 may not be provided.

Here, display device 102 includes a system LCD. The system LCD is a device obtained by forming peripheral devices of liquid crystal panel 140 in one piece on a glass substrate of liquid crystal panel 140. In the present embodiment, driver 130 (excluding a circuit for driving backlight 179), internal IF 178, and image processing engine 180 are formed in one piece on the glass substrate of liquid crystal panel 140. It should be noted that display device 102 does not need to be configured to use the system LCD, and driver 130 (excluding the circuit for driving backlight 179), internal IF 178, and image processing engine 180 may be provided on a substrate other than the glass substrate.

(As to Second Unit)

Second unit 1002 is supplied with power from first unit 1001. Specifically, by connecting a below-described USB connector 294 to USB connector 194 of first unit 1001, second unit 1002 is supplied with power from power source circuit 192 of first unit 1001.

Main device 104 includes a CPU 210, a RAM 271, a ROM 272, an external communication unit 274, a power source detecting unit 293, USB connector 294, an antenna 295, and a signal strength detecting unit 297. The components (210, 271, 272, 274, 293) are connected to one another via a data bus DB2.

CPU 210 executes a program. RAM 271 stores therein data generated by execution of the program by CPU 210, in a volatile manner. ROM 272 stores data therein in a nonvolatile manner. Further, ROM 272 is a ROM in and from which data can be written and deleted, such as an EPROM (Erasable Programmable Read-Only Memory) or a flash memory.

External communication unit 274 communicates with another electronic device. Specifically, external communication unit 274 communicates with for example first unit 1001 via USB connector 294. Further, external communication unit 274 communicates with for example first unit 1001 via antenna 295.

It should be noted that main device 104 may communicate with another electronic device (for example, first unit 1001) through wireless communication other than Bluetooth®. For example, external communication unit 274 may wirelessly communicate with another electronic device via an infrared port not shown in the figure.

Signal strength detecting unit 297 detects the strength of a signal received via antenna 295. Further, signal strength detecting unit 297 informs external communication unit 274 of the strength thus detected.

USB connector 294 is used to connect second unit 1002 to first unit 1001.

Second unit 1002 transmits data to first unit 1001 via USB connector 294. Further, second unit 1002 receives data from first unit 1001 via USB connector 294. Furthermore, second unit 1002 is supplied with power from first unit 1001 via USB connector 294 as described above. It should be noted that second unit 1002 stores, in a battery not shown in the figure, the power thus supplied from first unit 1001.

Antenna 295 is used for communication between second unit 1002 and for example first unit 1001, in compliance with the Bluetooth® standard.

Power source detecting unit 293 detects the power supplied via USB connector 294. Further, power source detecting unit 293 sends information concerned with the detected power, to CPU 210.

Further, main device 104 may have a function of infrared communication.

Display device 103 includes a driver 230, photosensor built-in liquid crystal panel 240 (hereinafter, referred to as “liquid crystal panel 240”), an internal IF 278, a backlight 279, and an image processing engine 280. Image processing engine 280 includes a driver control unit 281, a timer 282, and a signal processing unit 283.

Display device 103 has a configuration similar to that of display device 102. Namely, driver 230, liquid crystal panel 240, internal IF 278, backlight 279, and image processing engine 280 respectively have the same configurations as those of driver 130, liquid crystal panel 140, internal IF 178, backlight 179, and image processing engine 180 of display device 102. Driver control unit 281, timer 282, and signal processing unit 283 respectively have the same configurations as those of driver control unit 181, timer 182, and signal processing unit 183 of display device 102. Hence, explanation is not repeated for each functional block in display device 103.

Meanwhile, the processes in electronic device 100 are implemented by hardware and software executed by CPU 110. Such software may be stored in ROM 172 in advance. Alternatively, the software may be stored in memory card 1731 or another storage medium and may be distributed as a program product. Alternatively, the software may be provided as a downloadable program product by an information providing business entity connected to what is called the Internet. Such software is read from the storage medium by memory card reader/writer 173 or another reader, or is downloaded via communication unit 174 or a communication IF (not shown), and is then temporarily stored in ROM 172. The software is read from ROM 172 by CPU 110, and is then stored in RAM 171 in the form of an executable program. CPU 110 executes the program.

Each component constituting main device 101 of electronic device 100 shown in FIG. 2 is a general one. Hence, it can be said that an essential part of the present invention lies in the software stored in RAM 171, ROM 172, memory card 1731, and other storage media, or the software downloadable via the network. It should be noted that the operations of the hardware of main device 101 of electronic device 100 are well known and are not described repeatedly in detail.

It should also be noted that the storage medium is not limited to a memory card, but may be a medium storing a program in a fixed manner such as a CD-ROM, an FD (Flexible Disk), a hard disc, a magnetic tape, a cassette tape, an optical disk (MO (Magnetic Optical Disc)/MD (Mini Disc)/DVD (Digital Versatile Disc)), an IC (Integrated Circuit) card (excluding a memory card), an optical card, and a semiconductor memory such as a mask ROM, an EPROM, an EEPROM (Electronically Erasable Programmable Read-Only Memory), and a flash ROM.

The program herein includes not only a program directly executable by the CPU, but also a program in the form of a source program, a compressed program, an encrypted program, and the like.

<As to Configuration and Driving of Photosensor Built-in Liquid Crystal Panel>

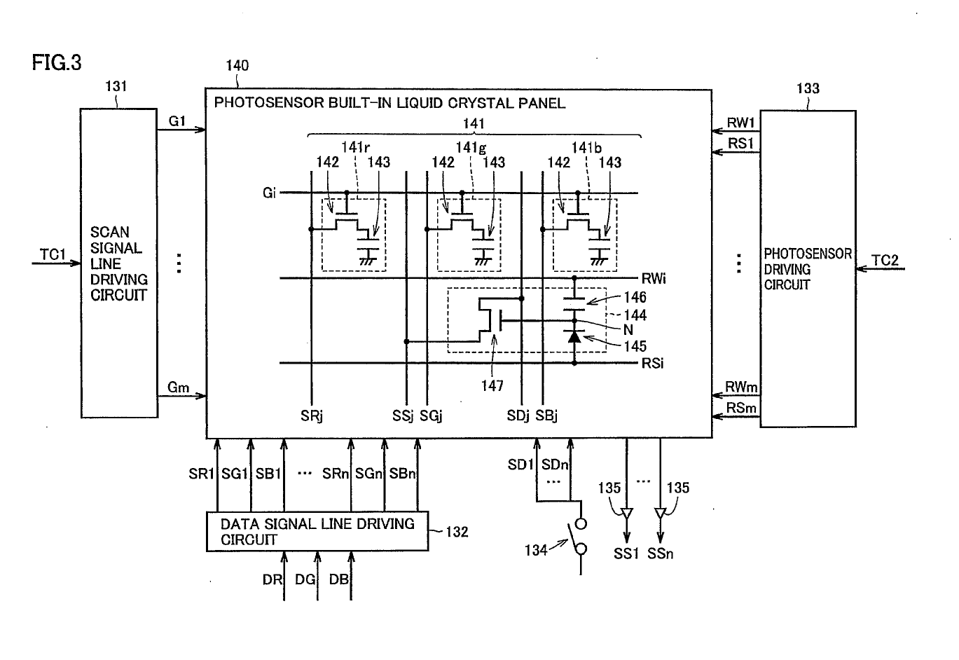

The following describes the configuration of liquid crystal panel 140 and configurations of circuits around liquid crystal panel 140. FIG. 3 shows the configuration of liquid crystal panel 140 and the circuits around liquid crystal panel 140.

Referring to FIG. 3, liquid crystal panel 140 includes a pixel circuit 141, a photo sensor circuit 144, scanning signal lines Gi, data signal lines SRj, data signal lines SGj, data signal lines SBj, sensor signal lines SSj, sensor signal lines SDj, read signal lines RWi, and reset signal lines RSi. It should be noted that i represents a natural number satisfying 1≦i≦m whereas j represents a natural number satisfying 1≦j≦n.

Further, driver 130 of display device 102 shown in FIG. 2 includes a scan signal line driving circuit 131, a data signal line driving circuit 132, a photo sensor driving circuit 133, a switch 134, and amplifiers 135, all of which are the circuits around liquid crystal panel 140.

Scan signal line driving circuit 131 receives a control signal TC1 from driver control unit 181 shown in FIG. 2. Based on control signal TC1, scan signal line driving circuit 131 applies a predetermined voltage to the scanning signal lines (G1-Gm) one after another in an order from scanning signal line G1. More specifically, scan signal line driving circuit 131 sequentially selects one of the scanning signal lines (G1-Gm) every unit time, and applies to the selected scanning signal line a voltage (hereinafter, referred to as a high-level voltage) sufficient to turn on the gate of a TFT (Thin Film Transistor) 142 which will be described later. It should be noted that the scanning signal lines not selected are not fed with the high-level voltage but remains fed with a low-level voltage.

Data signal line driving circuit 132 receives image data (DR, DG, DB) from driver control unit 181 shown in FIG. 2. Then, data signal line driving circuit 132 sequentially applies a voltage corresponding to image data for one row to each of 3n data signal lines (SR1-SRn, SG1-SGn, SB1-SBn) every unit time described above.

It should be noted that, in the description herein, a driving method called line sequential method is employed, however, the driving method is not limited to this.

Each of pixel circuits 141 is a circuit for setting a luminance (transmittance) of one pixel. Further, m×n pixel circuits 141 are arranged in matrix. More specifically, m pixel circuits 141 are arranged in the vertical direction of FIG. 3 and n pixel circuits 141 are arranged in the horizontal direction.

Each of pixel circuits 141 is constituted of an R sub pixel circuit 141r, a G sub pixel circuit 141g, and a B sub pixel circuit 141b. Each of the three circuits (141r, 141g, 141b) includes TFT 142, an electrode pair 143 made up of a pixel electrode and a counter electrode, and a capacitor not shown in the figure.

In display device 102, a polycrystalline silicon thin film transistor (p-Si TFT) is used as TFT 142 because the polycrystalline silicon thin film transistor allows for realization of a CMOS (Complementary Metal Oxide Semiconductor) with an n-type transistor and a p-type transistor and the polycrystalline silicon thin film transistor allows carriers (electrons or holes) to move several hundred times faster than in an amorphous silicon thin film transistor (a-Si TFT). It is assumed herein that TFT 142 is a field effect transistor with an n-type channel, however, TFT 142 may be a field effect transistor with a p-type channel.

TFT 142 in R sub pixel circuit 141r has a source connected to data signal line SRj. Further, TFT 142 has a gate connected to scanning signal line Gi. Furthermore, TFT 142 has a drain connected to the pixel electrode of electrode pair 143. Between the pixel electrode and the counter electrode, liquid crystal is provided. It should be noted that each of G sub pixel circuit 141g and B sub pixel circuit 141b has the same configuration as that of R sub pixel circuit 141r except that TFT 142 of each of them has a source connected to a different data signal line. Hence, explanation is not repeated for these two circuits (141g, 141b).

Now, how luminance is set in pixel circuit 141 will be described. First, the above-described high-level voltage is applied to scanning signal line Gi. The application of the high-level voltage turns on the gate of TFT 142. While the gate of TFT 142 is on, designated voltages (voltages corresponding to image data for one pixel) are respectively applied to the data signal lines (SRj, SGj, SBj). In this way, a voltage based on the designated voltages is applied to the pixel electrode. This results in a potential difference between the pixel electrode and the counter electrode. Based on the potential difference, the liquid crystal responds to set the luminance of the pixel to a predetermined luminance. The potential difference is maintained until scanning signal line Gi is selected in a next frame period by the capacitor (auxiliary capacitor) not shown in the figure.

Photosensor driving circuit 133 receives a control signal TC2 from driver control unit 181 shown in FIG. 2.

Based on control signal TC2, photo sensor driving circuit 133 sequentially selects one signal line of the reset signal lines (RS1-RSm) every unit time, and applies to the selected signal line a voltage VDDR that has a level higher than that of a usual one, at a predetermined timing. It should be noted that reset signal lines not selected remain fed with a voltage VSSR lower than the voltage applied to the selected reset signal line. For example, voltage VDDR may be set to 0 V whereas voltage VSSR may be set to −5 V.

In addition, based on control signal TC2, photosensor driving circuit 133 sequentially selects one signal line of the read signal lines (RW1-RWm) every unit time, and applies to the selected signal line a voltage VDD that has a level higher than that of a usual one, at a predetermined timing. It should be noted that read signal lines not selected remain fed with voltage VSSR described above. The value of VDD may be set, for example, to 8 V.

The timing at which voltage VDDR is applied and the timing at which voltage VDD is applied will be described later.

Photosensor circuit 144 includes a photodiode 145, a capacitor 146, and a TFT 147. In the description below, it is assumed that TFT 147 is a field effect transistor with an n-type channel, however, TFT 147 may be a field effect transistor with a p-type channel.

Photodiode 145 has an anode connected to reset signal line RSi. Photodiode 145 has a cathode connected to one electrode of capacitor 146. The other electrode of capacitor 146 is connected to read signal line RWi. In the description below, a connection point of photodiode 145 and capacitor 146 is referred to as node N.

TFT 147 has a gate connected to node N. TFT 147 has a drain connected to sensor signal line SDj. TFT 147 has a source connected to sensor signal line SSj. Details of sensing using photosensor circuit 144 will be described later.

Switch 134 is provided for switching as to whether to apply a predetermined voltage to each of the sensor signal lines (SD1-SDn) or not to apply the predetermined voltage thereto. The switching operation of switch 134 is caused by photosensor driving circuit 133. The voltage applied to each of the sensor signal lines (SD1-SDn) when switch 134 is brought into a conductive state will be described later.

Amplifiers 135 amplify respective voltages output from the sensor signal lines (SS1-SSn). Each of the voltages thus amplified is sent to signal processing unit 183 shown in FIG. 2.

It should be noted that image processing engine 180 controls the timing at which an image is displayed on liquid crystal panel 140 using pixel circuit 141 and the timing at which sensing is performed using photo sensor circuit 144.

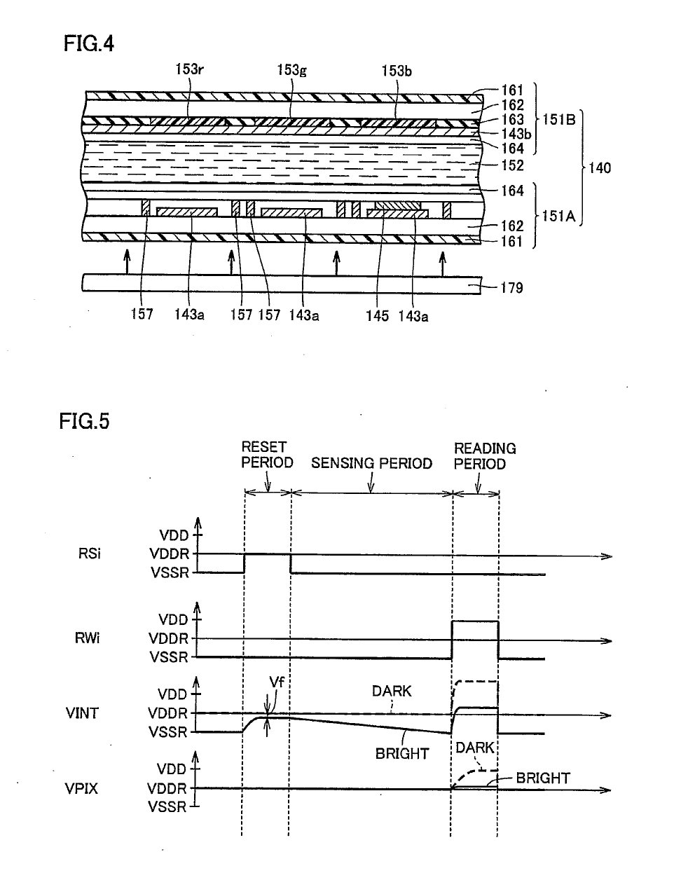

FIG. 4 is a cross-sectional view of liquid crystal panel 140 and backlight 179. Referring to FIG. 4, liquid crystal panel 140 includes an active matrix substrate 151A, a counter substrate 151B, and a liquid crystal layer 152. Counter substrate 151B is provided opposite to active matrix substrate 151A. Liquid crystal layer 152 is interposed between active matrix substrate 151A and counter substrate 151B. Backlight 179 is provided on a side opposite to liquid crystal layer 152 so as to face active matrix substrate 151A.

Active matrix substrate 151A includes a polarizing filter 161, a glass substrate 162, pixel electrodes 143a constituting electrode pairs 143, photodiode 145, data signal lines 157, and an alignment film 164. Although not shown in FIG. 4, active matrix substrate 151A further includes capacitor 146, TFTs 147, TFTs 142, and scanning signal lines Gi, each of which is shown in FIG. 3.

In active matrix substrate 151A, polarizing filter 161, glass substrate 162, pixel electrodes 143a, and alignment film 164 are arranged in this order from the backlight 179 side thereof. Photodiode 145 and data signal lines 157 are formed on the liquid crystal layer 152 side of glass substrate 162.

Counter substrate 151B includes polarizing filter 161, glass substrate 162, a light shielding film 163, color filters (153r, 153g, 153b), counter electrode 143b constituting electrode pairs 143, and alignment film 164.

In counter substrate 151B, alignment film 164, counter electrode 143b, the color filters (153r, 153g, 153b), glass substrate 162, and polarizing filter 161 are arranged in this order from the liquid crystal layer 152 side thereof. Light shielding film 163 is formed in the same layer where the color filters (153r, 153g, 153b) are provided.

Color filter 153r is a filter allowing light in a wavelength of red to pass therethrough. Color filter 153g is a filter allowing light in a wavelength of green to pass therethrough. Color filter 153b is a filter allowing light in a wavelength of blue to pass therethrough. Here, photodiode 145 is provided at a position opposite to color filter 153b.

Liquid crystal panel 140 displays an image by shielding and passing the external light and light emitted from a light source such as backlight 179. Specifically, by applying a voltage between each pixel electrode 143a and each counter electrode 143b, orientations of liquid crystal molecules in liquid crystal layer 152 are changed in liquid crystal panel 140, thereby blocking or passing the light. However, the light cannot completely be blocked only by the liquid crystal, and therefore polarizing filter 161 is provided to allow only light having a specific polarization direction to pass therethrough.

It should be noted that the position of photodiode 145 is not limited to the position described above and photodiode 145 may be provided at a position opposite to color filter 153r or a position opposite to color filter 153g.

Here, operations of photosensor circuit 144 will be described. FIG. 5 shows a timing chart in operating photosensor circuit 144. In FIG. 5, a voltage VINT is a potential at node N in photosensor circuit 144. A voltage VPIX is an output voltage of each sensor signal line SSj shown in FIG. 3 before being amplified by amplifier 135.

The following individually describes a reset period for resetting photosensor circuit 144, a sensing period for sensing light using photosensor circuit 144, and a reading period for reading a result of the sensing.

First explained is the reset period. In the reset period, the voltage applied to reset signal line RSi is momentarily switched from the low level (voltage VSSR) to the high level (voltage VDDR). Meanwhile, the voltage applied to read signal line RWi remains at the low level (voltage VSSR). By applying the high-level voltage to reset signal line RSi in this way, a current starts to flow in the forward direction of photodiode 145 (from the anode side to the cathode side). Accordingly, voltage VINT, which is the potential of node N, has a value found by a below-described formula (I). It should be noted that in formula (I), an amount of decrease in voltage in the forward direction of photodiode 145 is denoted as Vf.

VINT=VSSR+|VDDR−VSSR|−Vf (1)

Hence, the potential of node N has a value smaller than voltage VDDR by Vf as shown in FIG. 5.

Here, voltage VINT is not higher than the threshold of turning on the gate of TFT 147, and therefore no output is provided from sensor signal line SSj. Hence, voltage VPIX is not changed. Further, there is a difference between the electrodes of capacitor 146 by voltage VINT described above. Accordingly, charges corresponding to the difference are stored in capacitor 146.

Explained next is the sensing period. In the sensing period following the reset period, the voltage applied to reset signal line RSi is momentarily switched from the high level (voltage VDDR) to the low level (voltage VSSR). Meanwhile, the voltage applied to read signal line RWi remains at the low level (voltage VSSR).

By changing the voltage applied to reset signal line RSi to the low level as such, the potential of node N is higher than the voltage of reset signal line RSi and the voltage of read signal line RWi. Hence, in photodiode 145, the voltage on the cathode side is higher than the voltage on the anode side. Namely, photodiode 145 is in a reverse-biased state. When photodiode 145 receives light from the light source in such a reverse-biased state, a current starts to flow from the cathode side of photodiode 145 to the anode side thereof. As a result, as shown in FIG. 5, the potential of node N (i.e., voltage VINT) is decreased with lapse of time.

Since voltage VINT keeps decreasing as such, the gate of TFT 147 is not turned on. Hence, there is no output from sensor signal line SSj. Accordingly, voltage VPIX is not changed.

Explained next is the reading period. In the reading period following the sensing period, the voltage applied to reset signal line RSi is maintained at the low level (voltage VSSR). Meanwhile, the voltage applied to read signal line RWi is momentarily switched from the low level (voltage VSSR) to the high level (voltage VDD). Here, voltage VDD has a value higher than that of voltage VDDR.

By momentarily applying the high-level voltage to read signal line RWi in this way, the potential of node N is raised through capacitor 146 as shown in FIG. 5. Magnitude of rise of the potential of node N corresponds to the voltage applied to read signal line RWi. Here, the potential of node N (i.e., voltage VINT) is raised to be equal to or higher than the threshold of turning on the gate of TFT 147, whereby the gate of TFT 147 is turned on.

Here, if a fixed voltage is applied in advance to sensor signal line SDj (see FIG. 3) connected to the drain side of TFT 147, a voltage corresponding to the potential of node N is output from sensor signal line SSj connected to the source side of TFT 147 as shown in a graph of VPIX in FIG. 5.

Here, when an amount of light received by photodiode 145 (hereinafter, referred to as amount of received light) is small, the slope of the straight line shown in the graph of VINT in FIG. 5 is gentle. As a result, voltage VPIX is higher than that when the amount of received light is large. As such, photosensor circuit 144 varies the value of the voltage to be output to sensor signal line SSj, in accordance with the amount of light received by photodiode 145.

The description above deals with the operations of photosensor circuit 144 of the m×n photosensor circuits. In the description below, operations of the photosensor circuits in liquid crystal panel 140 will be described.

First, photosensor driving circuit 133 applies a predetermined voltage to all the n sensor signal lines (SD1-SDn). Then, photosensor driving circuit 133 applies to reset signal line RS1 voltage VDDR having a level higher than that of a usual one. Other reset signal lines (RS2-RSm) and read signal lines (RW1-RWm) remain fed with the low-level voltage. In this way, n photosensor circuits in the first row in FIG. 3 enter the above-described reset period. Thereafter, the n photosensor circuits in the first row enter the sensing period. Then, the n photosensor circuits in the first row enter the reading period.

It should be noted that the timing of applying the predetermined voltage to all the n sensor signal lines (SD1-SDn) is not limited to the above-described timing, and may be any timing at least before the reading period.

When the reading period of the n photosensor circuits in the first row ends, photosensor driving circuit 133 applies to reset signal line RS2 voltage VDDR having a level higher than a usual one. In other words, n photosensor circuits in the second row enter the reset period. When the reset period thereof ends, the n photosensor circuits in the second row enter the sensing period and then enter the reading period.

Thereafter, the above-described processes are performed onto n photosensor circuits in the third row, n photosensor circuits in the fourth row, . . . , and n photosensor circuits in the mth row, in this order. As a result, from the sensor signal lines (SS1-SSn), a sensing result for the first row, a sensing result for the second row, . . . , and a sensing result for the mth row are output in this order.

As such, in display device 102, sensing is performed for each row as described above, and a sensing result for each row is output from liquid crystal panel 140. Hence, in the description below, the data concerned with the voltages for m rows in total from the first row to the mth row output from liquid crystal panel 140 and having been subjected to the above-described data processing by signal processing unit 183 is referred to as “scan data”. In other words, the scan data refers to image data obtained by scanning a scan target object (for example, the user's finger). Further, an image displayed based on the scan data is referred to as “scan image”. Furthermore, in the description below, the sensing is referred to as “scan (scanning)”.

Further, the configuration in which the m×n photosensor circuits are all used for scanning has been exemplified in the above, however, the present invention is not limited to this. A configuration may be employed in which a partial region of the surface of liquid crystal panel 140 is scanned using photosensor circuits selected in advance.

In the description below, it is assumed that electronic device 100 can adopt either of the configurations. The configurations can be changed over in accordance with a command that is based on an input or the like provided via operation key 177 and sent from main device 101. In the case where a partial region of the surface of liquid crystal panel 140 is to be scanned, image processing engine 180 sets a region to be scanned. The region to be scanned may be set and designated by the user via operation key 177.

In the case where the partial region of the surface of liquid crystal panel 140 is to be scanned, the following manners of utilization thereof are available in displaying an image. The first one is to display an image in a region in the surface other than the partial region above (hereinafter, referred to as scan region). The second one is to display no image in the region of the surface other than the scan region. Adoption of the manners depends on a command sent from main device 101 to image processing engine 180.

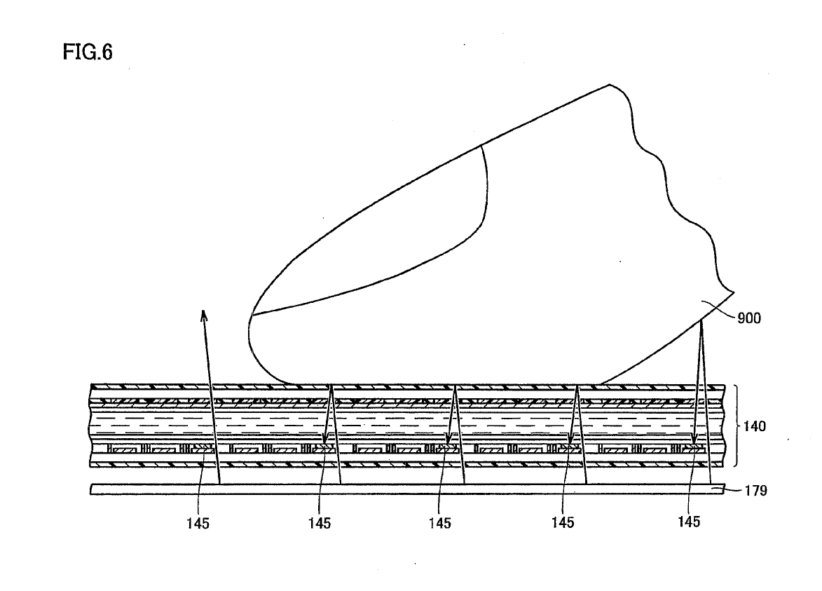

FIG. 6 is a cross-sectional view of liquid crystal panel 140 and backlight 179, showing how photodiode 145 receives light from backlight 179 in scanning.

Referring to FIG. 6, when the user's finger 900 contacts the surface of liquid crystal panel 140, a part of light emitted from backlight 179 is reflected by the user's finger 900 (substantially flat surface) at the contacted region. The light thus reflected is received by photodiode 145.

Further, even in a region not contacted by finger 900, a part of the light emitted from backlight 179 is reflected by the user's finger 900. In this case as well, photodiode 145 receives the light thus reflected. However, since finger 900 does not contact the surface of liquid crystal panel 140 in the region, an amount of the light received by photodiode 145 is smaller than that in the region contacted by finger 900. It should be noted that most of light emitted from backlight 179 but failing to reach the user's finger 900 cannot be received by photodiode 145.

Here, by lighting on backlight 179 at least during the sensing period, photosensor circuit 144 can output a voltage corresponding to the amount of light reflected by the user's finger 900, from sensor signal line SSj. As such, by controlling backlight 179 to light on and light off, the voltage output from each of the sensor signal lines (SS1 to SSn) is varied in liquid crystal panel 140 in accordance with the position in contact with finger 900, a range in contact with finger 900 (determined by pressing force of finger 900), a direction of finger 900 relative to the surface of liquid crystal panel 140, and the like.

In this way, display device 102 is capable of scanning an image (hereinafter, also referred to as reflection image) obtained by reflection of the light by finger 900.

It should be noted that an exemplary scan target object other than finger 900 is a stylus or the like.

It should also be noted that, in the present embodiment, the liquid crystal panel is illustrated as an exemplary display device of electronic device 100, however, other panels such as an organic EL (Electro-Luminescence) panel may be used instead of the liquid crystal panel.

<As to Data>

The following describes commands exchanged between first unit 1001 and second unit 1002, and commands exchanged between main device 101 and display device 102 in first unit 1001.

FIG. 7 shows a schematic configuration of a command. Referring to FIG. 7, the command includes a header DA01, a first field DA02, a second field DA03, a third field DA04, a fourth field DA05, a fifth field DA06, and a reserve data region DA07.

FIG. 8 illustrates a command of type “000” (i.e., sensing command). CPU 110 transmits the command of type “000” (hereinafter, referred to as “first command”) from main device 101 of first unit 1001 to second unit 1002. Alternatively, CPU 110 transmits the first command from main device 101 to display device 102. The description below shows an exemplary case where CPU 110 transmits the first command from main device 101 of first unit 1001 to second unit 1002.

CPU 110 writes, in header DA01, the type (“000”) of the command, a destination of transmission of the command, and the like. CPU 110 writes, in first field DA02, a value of timing corresponding to a number “1”. CPU 110 writes, in second field DA03, a value of a data type corresponding to a number “2”. CPU 110 writes, in third field DA04, a value of a scanning method corresponding to a number “3”. CPU 110 writes, in fourth field DA05, a value of image gradation corresponding to a number “4”. CPU 110 writes, in fifth field DA06, a value of resolution corresponding to a number “5”.

A first command having first field DA02 set to “00” requests image processing engine 280 to transmit scan data obtained at the moment. Specifically, the sensing first command requests transmission of scan data obtained by scanning using the photosensor circuits of liquid crystal panel 240 after image processing engine 280 receives the first command. A first command having first field DA02 set to “01” requests transmission of scan data obtained when there is a change in scan result. A first command having first field DA02 set to “10” requests transmission of scan data every fixed period.

A first command having second field DA03 set to “001” requests transmission of coordinate values of the center coordinates of a partial image. A first command having second field DA03 set to “010” requests transmission only of a partial image changed in scan result. It should be noted that change in scan result refers to difference between the previous scan result and the current scan result. A first command having second field DA03 set to “100” requests transmission of an entire image.

The “entire image” herein refers to an image generated by image processing engine 280 based on the output voltage of each photosensor circuit in scanning with the m×n photosensor circuits. On the other hand, the “partial image” herein refers to a portion of the entire image. Regarding the partial image, a reason for requesting the transmission of only the partial image changed in scan result will be described later.

Further, the coordinate values and the partial image or the entire image may simultaneously be requested. Furthermore, in the case where the partial region of the surface of liquid crystal panel 240 is scanned, the entire image is an image corresponding to the scanned region.

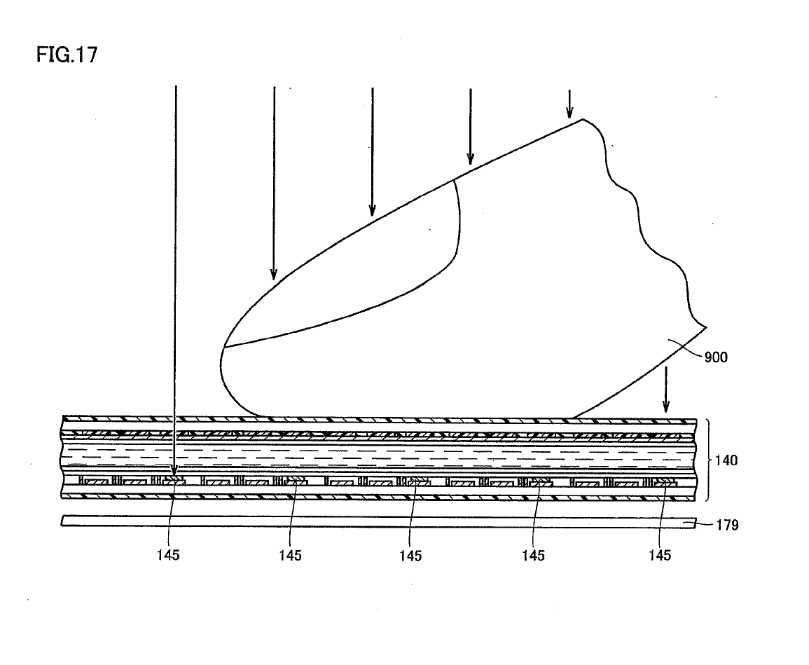

A sensing first command having third field DA04 set to “00” requests scan with backlight 279 lit on. On the other hand, a first command having third field DA04 set to “01” requests to scan with backlight 279 lit off. A configuration of scanning with backlight 279 lit off will be described later (FIG. 17). A first command having third field DA04 set to “10” requests scanning with both reflection and transmission of light. Scanning with both reflection and transmission of light refers to scanning of a scan target object by switching between the method of scanning with backlight 279 lit on and the method of scanning with the backlight lit off.

A first command having fourth field DA05 set to “00” requests binary image data of black or white. A first command having fourth field DA05 set to “01” requests image data of multiple gradation. A first command having fourth field DA05 set to “10” requests image data of RGB colors.

A first command having fifth field DA06 set to “0” requests image data having a high resolution. A first command having fifth field DA06 set to “1” requests image data having a low resolution.

Also described in the first command in addition to the data shown in FIG. 8 are designation of a region to be scanned (region of pixels in which photosensor circuits 144 are to be driven), a timing of scanning, a timing of lighting on backlight 179, and the like.

Image processing engine 280 analyzes the content of the first command, and returns to main device 101 data generated in accordance with a result of the analysis (i.e., response data).

FIG. 9 illustrates a command of type “001” (hereinafter, referred to as “second command”). CPU 110 sends the second command from main device 101 of first unit 1001 to second unit 1002.

CPU 110 writes, in header DA01, the type (“001”) of the command, a destination of transmission of the command, and the like. CPU 110 writes, in first field DA02, a value of display request corresponding to a number “1”. CPU 110 writes, in second field DA03, information regarding the number/kind and corresponding to a number “2”. CPU 110 writes, in third field DA04, a value of a range of display corresponding to a number “3”. CPU 110 writes, in fourth field DA05, information regarding image data and corresponding to a number “4”.

A second command having first field DA02 set to “001” requests image processing engine 280 to display an image on liquid crystal panel 240 (sub screen). A second command having first field DA02 set to “010” requests image processing engine 280 to display an icon on liquid crystal panel 240. A second command having first field DA02 set to “011” requests image processing engine 280 to display a handwriting region on liquid crystal panel 240.

Stored in second field DA03 is the number of images to be displayed on liquid crystal panel 240, and a number designating a kind of language used in handwriting. Image processing engine 280 performs processing in accordance with the number of the images or the kind of language.

A second command having third field DA04 set to “01” requests image processing engine 280 to designate the range of display in liquid crystal panel 240 using coordinates. A second command having third field DA04 set to “10” requests image processing engine 280 to set the entire display region as the range of display in liquid crystal panel 240.

Stored in fourth field DA05 are image data to be displayed on liquid crystal panel 240 and information on a position where the image data is to be displayed. Image processing engine 280 performs processing to display the image data at a position specified by the position information.

FIG. 10 illustrates a command of type “010” (hereinafter, referred to as “third command”). CPU 110 sends the third command from main device 101 of first unit 1001 to second unit 1002. Alternatively, CPU 210 sends the third command from main device 104 of second unit 1002 to first unit 1001.

CPU 110 or 210 writes, in header DA01, a type (“010”) of the command, a destination of the transmission of the command, and the like. CPU 110 or 210 writes, in first field DA02, a value of OS (Operating System) processing request corresponding to a number “1”. CPU 110 or 210 writes, in second field DA03, a value of OS information corresponding to a number “2”.

A third command having first field DA02 set to “01” or “10” is transmitted from second unit 1002 to first unit 1001.

The third command having first field DA02 set to “01” requests first unit 1001 to transmit information indicating a type of an OS employed in first unit 1001 (main device). The third command having first field DA02 set to “10” requests first unit 1001 to launch the OS designated by the OS information.

A third command having second field DA03 set to “000”, “001”, or “010” is transmitted from second unit 1002 to first unit 1001.

The third command having second field DA03 set to “000” does not request first unit 1001 to launch an OS. The third command having second field DA03 set to “001” indicates that second unit 1002 has selected to launch a first OS. The third command having second field DA03 set to “010” indicates that second unit 1002 has selected to launch a second OS.

FIG. 11 illustrates a command of type “011” (hereinafter, referred to as “fourth command”). CPU 210 sends the fourth command from main device 104 of second unit 1002 to first unit 1001.

CPU 210 writes, in header DA01, the type of the command (“011”), a destination of the transmission of the command, and the like. CPU 210 writes, in first field DA02, information regarding an application to be launched and corresponding to a number “1”. CPU 210 writes, in second field DA03, launch information corresponding to a number “2”.

Stored in first field DA02 is information designating the application to be launched in first unit 1001. Stored in second field DA03 are information used in launch setting and information used after the launch thereof.

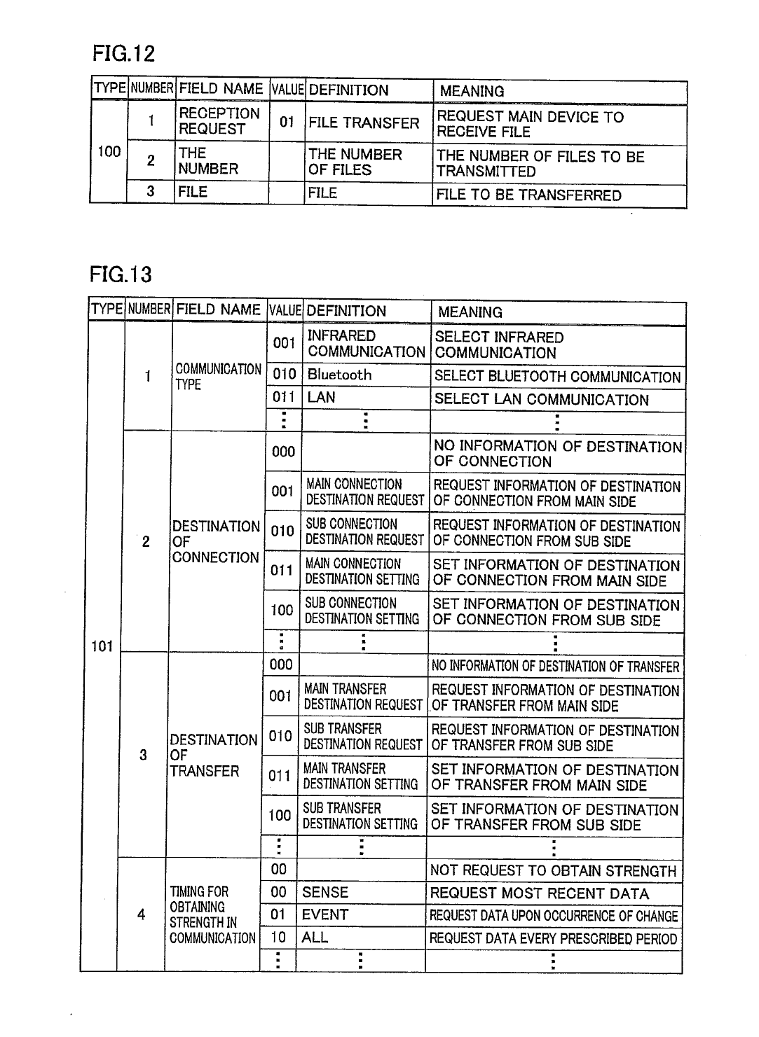

FIG. 12 illustrates a command of type “100” (hereinafter, referred to as “fifth command”). CPU 210 sends the fifth command from main device 104 of second unit 1002 to first unit 1001.

CPU 210 writes, in header DA01, the type of the command (“100”), a destination of transmission of the command, and the like. CPU 210 writes, in first field DA02, information regarding a reception request and corresponding to a number “1”. CPU 210 writes, in second field DA03, information regarding the number and corresponding to a number “2”. CPU 210 writes, in third field DA04, information regarding files and corresponding to a number “3”.

A fifth command having first field DA02 set to “01” requests first unit 1001 to receive a file. Stored in second field DA03 is the number of files to be transmitted by second unit 1002 to first unit 1001. Stored in third field DA04 are the files to be transmitted by second unit 1002 to first unit 1001.

FIG. 13 illustrates a command of type “101” (hereinafter, referred to as “sixth command”). CPU 110 sends the sixth command from main device 101 of first unit 1001 to second unit 1002. Alternatively, CPU 210 sends the sixth command from main device 104 of second unit 1002 to first unit 1001. CPU 110 or 210 writes, in header DA01, the type of the command (“101”), a destination of transmission of the command, and the like. CPU 110 or 210 writes, in first field DA02, a value of a communication type corresponding to a number “1”. CPU 110 or 210 writes, in second field DA03, a value of a destination of connection corresponding to a number “2”. CPU 110 or 210 writes, in third field DA04, a value of a destination of transfer corresponding to a number “3”. CPU 110 or 210 writes, in fourth field DA05, a value of a timing to obtain strength of a signal corresponding to a number “4”.

A sixth command having first field DA02 set to “001” requests a device of its counterpart to establish infrared communication therewith. A sixth command having first field DA02 set to “010” requests the device of its counterpart to establish wireless communication therewith using Bluetooth®. A sixth command having first field DA02 set to “011” requests the device of its counterpart to establish communication therewith using a LAN.

A sixth command having second field DA03 set to “000” indicates that it has no information designating the destination of connection in the communication.

A sixth command having second field DA03 set to “001” is transmitted by first unit 1001 to a device connected to first unit 1001. Such a sixth command requests transmission of information regarding the device to which first unit 1001 is connected.

A sixth command having second field DA03 set to “010” is transmitted by second unit 1002 to first unit 1001 connected to second unit 1002. Such a sixth command requests transmission of information regarding first unit 1001 to which second unit 1002 is connected.

A sixth command having second field DA03 set to “011” is transmitted by second unit 1002 to first unit 1001 to which second unit 1002 is connected. Such a sixth command requests setting of information regarding second unit 1002 as device information of the destination of connection.

A sixth command having second field DA03 set to “100” is transmitted by first unit 1001 to a device connected to first unit 1001 (for example, second unit 1002). Such a sixth command requests setting of information regarding first unit 1001 as device information of the destination of connection.

A sixth command having third field DA04 set to “000” indicates that it has no information designating a transfer destination of data (such as a file).

A sixth command having third field DA04 set to “001” is transmitted by first unit 1001 to a device that is a data transfer destination. Such a sixth command requests transmission of information on the device that is the data transfer destination.

A sixth command having third field DA04 set to “010” is transmitted by second unit 1002 to first unit 1001 that is a data transfer destination. Such a sixth command requests transmission of information regarding first unit 1001 that is the data transfer destination.

A sixth command having third field DA04 set to “011” is transmitted by second unit 1002 to first unit 1001 that is a data transfer destination. Such a sixth command requests setting of information regarding second unit 1002 as information on a device that will transfer the data.

A sixth command having third field DA04 set to “100” is transmitted by first unit 1001 to a device that is a data transfer destination (for example, second unit 1002). Such a sixth command requests setting of information regarding first unit 1001 as information on the device that will transfer the data.

A sixth command having fourth field DA05 set to “00”, “01”, “10”, or “11” is transmitted by first unit 1001 to second unit 1002.

The sixth command having fourth field DA05 set to “00” does not request second unit 1002 to transmit data indicating strength of a signal. The sixth command having fourth field DA05 set to “01” requests signal strength detecting unit 297 to transmit data indicating the strength of the signal at the moment. The sixth command having fourth field DA05 set to “10” requests transmission of data indicating strength of the signal when there is a change in signal strength. The sixth command having fourth field DA05 set to “11” requests transmission of data indicating strength of the signal every fixed period.

FIG. 14 shows a schematic configuration of the response data. The response data is data that is based on the content of the first command (sensing command).

When the first command is transmitted from main device 101 to second unit 1002, CPU 210 transmits the response data from display device 103 to first unit 1001. On the other hand, when the first command is transmitted from main device 101 to display device 102 of first unit 1001, image processing engine 180 transmits the response data from image processing engine 180 to main device 101. In the description below, the case where the first command is transmitted from main device 101 to second unit 1002 is illustrated by way of example.

Referring to FIG. 14, the response data includes a data region DA11 for its header, a data region DA12 indicating coordinates, a data region DA13 indicating time, and a data region DA14 indicating an image. In data region DA12 indicating coordinates, values of the center coordinates of a partial image are written. In the data region indicating time, time information obtained from timer 282 of image processing engine 280 is written. In the data region indicating an image, image data (i.e., scan data) having been processed by image processing engine 280 is written.

FIG. 15 shows an image (i.e., scan image) obtained by scanning finger 900. Referring to FIG. 15, the entire image corresponds to an image of a region W1 surrounded by a thick solid line, whereas the partial image corresponds to an image of a region P1 surrounded by a dashed line. The center coordinates correspond to a central point C1 of a cross indicated by thick lines.

In the present embodiment, the region of the partial image is a rectangular region including all pixels each having a photosensor circuit and having an output voltage not lower than a predetermined value from sensor signal line SSj (i.e., pixels having not less than a predetermined gradation or a predetermined luminance).

The center coordinates are coordinates determined in consideration of gradation of the pixels in the region of the partial image. Specifically, the center coordinates are determined by weighting the pixels in the partial image based on the gradation of the pixels as well as a distance between each of the pixels and the central point (i.e., centroid) of the rectangle. Namely, the center coordinates do not necessarily coincide with the centroid of the partial image.

However, the position of the center coordinates is not necessarily limited to the above-described position, but the center coordinates may be the coordinates of the centroid or coordinates near the centroid.

When “001” is set in the data region indicating a data type of the first command, image processing engine 280 writes the values of the center coordinates in data region DA12 indicating coordinates. In this case, image processing engine 280 does not write image data in data region DA14 indicating an image. After writing the values of the center coordinates, image processing engine 280 sends the response data including the values of the center coordinates to main device 104. Main device 104 sends the response data including the values of the center coordinates to main device 101 of first unit 1001. As such, when “001” is set in the data region indicating a data type, the first command does not request output of image data but requests output of the values of the center coordinates.

When “010” is set in the data region indicating a data type of the first command, image processing engine 280 writes, in data region DA14 indicating an image, image data of a partial image changed in scan result. In this case, image processing engine 280 does not write the values of the center coordinates in data region DA12 indicating coordinates. After writing the image data of the partial image changed in scan result, image processing engine 280 sends the response data including the image data of the partial image to main device 104. Main device 104 sends the response data including the image data of the partial image to main device 101 of first unit 1001. As such, when “010” is set in the data region indicating a data type, the first command does not request the output of the values of the center coordinates, but requests output of the image data of the partial image changed in scan result.

A reason for requesting transmission only of the partial image changed in scan result as described above is that the scan data of the region of the partial image is data more important than those of other regions in the scan data, and that scan data of a region corresponding to the region of the partial image is likely to be changed depending on a state of contact with a scan target object such as finger 900.

When “011” is set in the data region indicating a data type of the first command, image processing engine 280 writes the values of the center coordinates in data region DA12 indicating coordinates, and writes, in data region DA14 indicating an image, the image data of the partial image changed in scan result. Thereafter, image processing engine 280 sends the response data including the values of the center coordinates and the image data of the partial image to main device 104. Main device 104 sends the response data including the values of the center coordinates and the image data of the partial image to main device 101 of first unit 1001. As such, when “011” is set in the data region indicating a data type, the first command requests output of the values of the center coordinates and output of the image data of the partial image changed in scan result.

When “100” is set in the data region indicating a data type of the first command, image processing engine 280 writes the image data of the entire image in data region DA14 indicating an image of the response data shown in FIG. 14. In this case, image processing engine 280 does not write the values of the center coordinates in data region DA12 indicating coordinates. After writing the image data of the entire image, image processing engine 280 sends the response data including the image data of the entire image to main device 104. Main device 104 sends the response data including the image data of the entire image to main device 101 of first unit 1001. As such, when “100” is set in the data region indicating a data type, the first command does not request output of the values of the center coordinates but requests output of the image data of the entire image.

When “101” is set in the data region indicating a data type of the first command, image processing engine 280 writes the values of the center coordinates in data region DA12 indicating coordinates, and writes the image data of the entire image in data region DA14 indicating an image. Thereafter, image processing engine 280 sends response data including the values of the center coordinates and the image data of the entire image to main device 104. Main device 104 sends the response data including the values of the center coordinates and the image data of the entire image to main device 101 of first unit 1001. As such, when “101” is set in the data region indicating a data type, the first command requests output of the values of the center coordinates and output of the image data of the entire image.

<As to Variation 1 of Configuration>

The configuration of liquid crystal panel 140 is not limited to the one shown in FIG. 3. The following describes a liquid crystal panel different in manner from the one shown in FIG. 3.

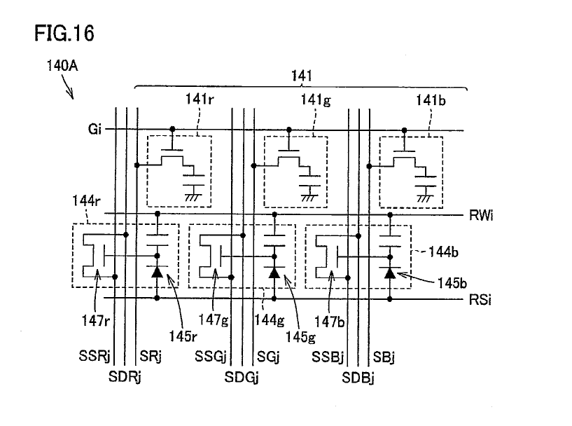

FIG. 16 is a circuit diagram of a photosensor built-in liquid crystal panel 140A different in manner as described above. Referring to FIG. 16, photosensor built-in liquid crystal panel 140A (hereinafter, referred to as liquid crystal panel 140A) includes three photosensor circuits (144r, 144g, 144b) in one pixel. As such, liquid crystal panel 140A including the three photosensor circuits (144r, 144g, 144b) in one pixel is thus different from liquid crystal panel 140 including one photosensor circuit in one pixel. It should be noted that the configuration of photosensor circuit 144 is the same as that of each of the three photosensor circuits (144r, 144g, 144b).

Moreover, the three photodiodes (145r, 145g, 145b) in one pixel are provided at positions opposite to color filter 153r, color filter 153g, and color filter 153b respectively. Hence, photodiode 145r receives red light, photodiode 145g receives green light, and photodiode 145b receives blue light.

Meanwhile, since only one photosensor circuit 144 is provided in one pixel in liquid crystal panel 140, the two data signal lines, i.e., sensor signal line SSj and sensor signal line SDj, are arranged in one pixel for TFT 147. On the other hand, liquid crystal panel 140A includes three photosensor circuits (144r, 144g, 144b) in one pixel, six data signal lines are arranged in one pixel for TFTs (147r, 147g, 147b).

Specifically, for TFT 147r connected to the cathode of photodiode 145r provided at the position opposite to color filter 153r, a sensor signal line SSRj and a sensor signal line SDRj are arranged. For TFT 147g connected to the cathode of photodiode 145g provided at the position opposite to color filter 153g, a sensor signal line SSGj and a sensor signal line SDGj are arranged. For TFT 147b connected to the cathode of photodiode 145b provided at the position opposite to color filter 153b, a sensor signal line SSBj and a sensor signal line SDBj are arranged.

In such a liquid crystal panel 140A, white light emitted from backlight 179 passes through the three color filters (153r, 153g, 153b), and red light, green light, and blue light are mixed at the surface of liquid crystal panel 140A, thus obtaining white light. When the white light is reflected by the scan target object, a portion of the white light is absorbed in a pigment at the surface of the scan target object, and a portion thereof is reflected by the surface thereof. The light thus reflected passes through the three color filters (153r, 153g, 153b) again.

Here, color filter 153r allows light in a wavelength of red to pass therethrough and photodiode 145r receives the light in the wavelength of red. Color filter 153g allows light in a wavelength of green to pass therethrough and photodiode 145g receives the light in the wavelength of green. Color filter 153b allows light in a wavelength of blue to pass therethrough and photodiode 145b receives the light of the wavelength of blue. In other words, the light reflected by the scan target object is separated by the three color filters (153r, 153g, 153b) into light beams of three primary colors (R, G, B), and the photodiodes (145r, 145g, 145b) receive the light beams of corresponding colors respectively.

When a portion of the white light is absorbed in the pigment at the surface of the scan target object, respective amounts of light received by the photodiodes (145r, 145g, 145b) are different among the photodiodes (145r, 145g, 145b). Hence, output voltages of sensor signal line SSRj, sensor signal line SSGj, and sensor signal line SSBj are different from one another.

In accordance with the respective output voltages, image processing engine 180 determines gradation of R, gradation of G, and gradation of B, whereby image processing engine 180 can send a color image of RGB to main device 101.

As described above, in electronic device 100 including liquid crystal panel 140A, the scan target object can be scanned in color.

The following describes a scanning method different from the above-described scanning method (i.e., the method of scanning a reflection image as shown in FIG. 6) with reference to FIG. 17.

FIG. 17 is a cross-sectional view showing how the photodiodes receive external light in scanning. As shown in the figure, the external light is partially blocked by finger 900. Hence, photodiodes arranged below a region of contact with finger 900 in the surface of liquid crystal panel 140 can hardly receive the external light. Photodiodes below a region shaded by finger 900 in the surface thereof can receive a certain amount of the external light, however, the amount of the external light received is smaller than that in regions not shaded in the surface.

Here, by lighting off backlight 179 at least during the sensing period, photosensor circuit 144 can output a voltage from sensor signal line SSj in accordance with the position of finger 900 relative to the surface of liquid crystal panel 140. By controlling backlight 179 to light on and off in this way, in liquid crystal panel 140, a voltage output from each of the sensor signal lines (SS1 to SSn) is changed in accordance with the position of contact with finger 900, a range in contact with finger 900 (determined by pressing force of finger 900), a direction of finger 900 relative to the surface of liquid crystal panel 140, and the like.

In this way, display device 102 can scan an image (hereinafter, also referred to as shadow image) obtained by finger 900 blocking the external light.

Further, display device 102 may be configured to scan with backlight 179 lit on, and then scan again with backlight 179 lit off. Alternatively, display device 102 may be configured to scan with backlight 179 lit off, and then scan again with backlight 179 lit on.

In this case, the two scanning methods are used, and therefore two pieces of scan data can be obtained. Hence, accuracy can be higher as compared with a case where one scanning method alone is employed for scanning.

<As to Display Device>

As in the operation of display device 102, an operation of display device 103 is controlled in accordance with a command from main device 101 (for example, a first command). Display device 103 is configured in the same way as display device 102. Hence, when display device 103 accepts from main device 101 the same command as the command provided to display device 102, display device 103 operates in the same way as display device 102. Hence, explanation is not repeated for the operation and configuration of display device 103.

It should be noted that main device 101 can send commands different in instruction to display device 102 and display device 103. In this case, display device 102 and display device 103 operate in different ways. Further, main device 101 may send a command to either of display device 102 and display device 103. In this case, only one of the display devices operates in accordance with the command. Further, main device 101 may send a command identical in instruction to display device 102 and display device 103. In this case, display device 102 and display device 103 operate in the same way.

It should also be noted that the size of liquid crystal panel 140 of display device 102 may be the same as or different from the size of liquid crystal panel 240 of display device 103. Further, the resolution of liquid crystal panel 140 may be the same as or different from the resolution of liquid crystal panel 240.

<As to Variation 2 of Configuration>

Described in the present embodiment is a configuration in which electronic device 100 includes the liquid crystal panels each having photosensors built therein, such as liquid crystal panel 140 and liquid crystal panel 240. However, only one of the liquid crystal panels may have photosensors built therein.

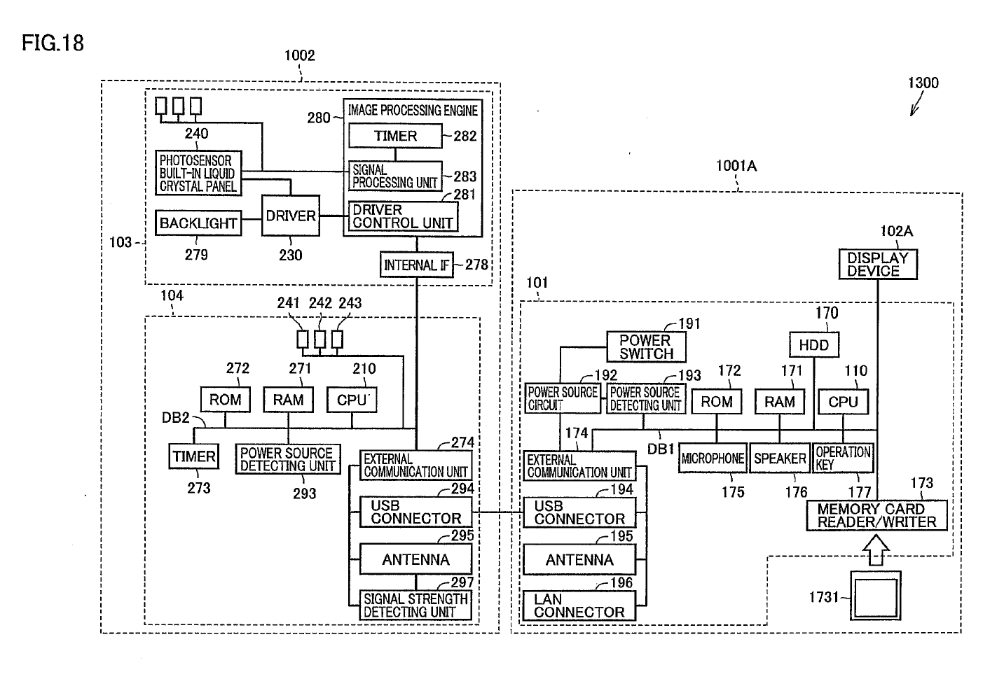

FIG. 18 is a block diagram of a hardware configuration of an electronic device 1300. As in electronic device 100, electronic device 1300 includes first casing 100A and second casing 100B. Referring to FIG. 18, electronic device 1300 includes a first unit 1001A and second unit 1002. First unit 1001A includes main device 101 and a display device 102A. Second unit 1002 includes main device 104 and display device 103.

Display device 102A includes a liquid crystal panel which does not have photosensors built therein (i.e., a liquid crystal panel only having a display function). Electronic device 1300 is different from electronic device 100 in which first unit 1001 includes liquid crystal panel 240 having the built-in photosensors, in that first unit 1001A includes the liquid crystal panel including no photosensor built therein. Such an electronic device 1300 performs the above-described sensing using display device 103 of second unit 1002.

Instead of liquid crystal panel 140 having the built-in photosensors, first unit 1001 may include, for example, a touch panel of a resistive type or a capacitive type.

In the present embodiment, it is assumed that display device 102 includes timer 182 and display device 103 includes timer 282, however, display device 102 and display device 103 may be configured to share one timer.

In the present embodiment, it is assumed that electronic device 100 is a foldable type device, however, electronic device 100 is not necessarily limited to the foldable type. For example, electronic device 100 may be a slidable type device in which first casing 100A is slid relative to second casing 100B.

In electronic device 100 according to the present embodiment and configured as above, second unit 1002 is removably attached to first unit 1001 via USB connectors 194, 294.

Electronic device 100 according to the present embodiment can perform the following function for example when powered on. When a user initially presses down power switch 191 of first unit 1001, first unit 1001 utilizes power from power source circuit 192 to launch BIOS (Basic Input/Output System).

Second unit 1002 obtains power from first unit 1001 via USB connectors 194, 294. Second unit 1002 utilizes the power to transmit data to and receive data from first unit 1001. Here, CPU 210 of second unit 1002 uses power through each of USB connectors 194, 294 so as to display types of OSs (Operating Systems) on liquid crystal panel 240 in a selectable manner. It should be noted that second unit 1002 may directly be supplied with power from power source 192, without going through USB connectors 194, 294.

Through liquid crystal panel 240, the user selects an OS to be launched. In accordance with the user's selection, CPU 210 transmits a command designating the OS to be launched (for example, “first OS” command shown in FIG. 10), to first unit 1001 via USB connectors 194, 294. In accordance with the command, first unit 1001 launches the OS.

Further, second unit 1002 transmits data to and receives data from an external mobile phone or the like via antenna 295, for example. Via antenna 295, CPU 210 of second unit 1002 obtains photograph image data or corresponding thumbnail data from the external mobile phone, and causes RAM 271 or the like to store the photograph image data or corresponding thumbnail data. CPU 210 reads out the thumbnail data from RAM 271, and causes liquid crystal panel 240 to display a thumbnail image of the photograph in a selectable manner.

In accordance with an external selection instruction, CPU 210 causes liquid crystal panel 240 to display the photograph image. Alternatively, CPU 210 causes liquid crystal panel 140 or display device 102A to display the photograph image via USB connector 294.

<Variation 3 of Configuration>

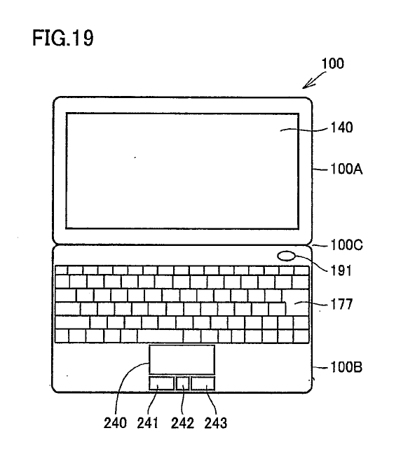

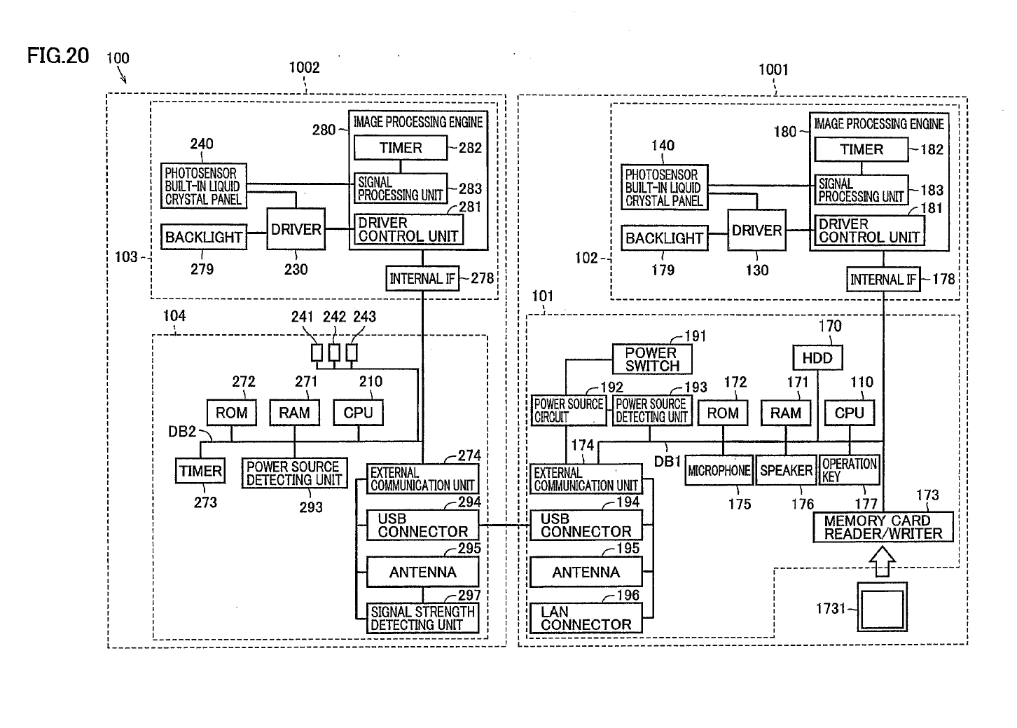

In the present embodiment, as shown in FIG. 19, electronic device 100 may further include a key operation portion in second casing 100B. In addition, in the present embodiment, electronic device 100 is implemented as a notebook type personal computer. It should be noted that electronic device 100 may be implemented as a device having a display function, such as a PDA (Personal Digital Assistant), a mobile phone, or an electronic dictionary. FIG. 20 shows a block diagram showing a hardware configuration of electronic device 100 shown in FIG. 19.

Main device 101 shown in FIG. 20 further includes an HDD (Hard Disc Drive) 170 in main device 101 of electronic device 100 shown in FIG. 2.

In electronic device 100, CPU 110 executes a program. Operation key 177 receives an input of an instruction from the user of electronic device 100. HDD 170 is a storage device in and from data can be written and read. It should be noted that HDD 170 represents one example of such a storage device. In electronic device 100, such a storage device as a flash memory may be employed instead of HDD 170.

In addition, main device 104 shown in FIG. 20 further includes a timer 273 and a key operation portion (a left click key 241, a center key 242, and a right click key 243), as compared with main device 104 shown in FIG. 2. Components (210, 241 to 243, 271, 272, 274, 273, and 293) are connected to one another through data bus DB2.

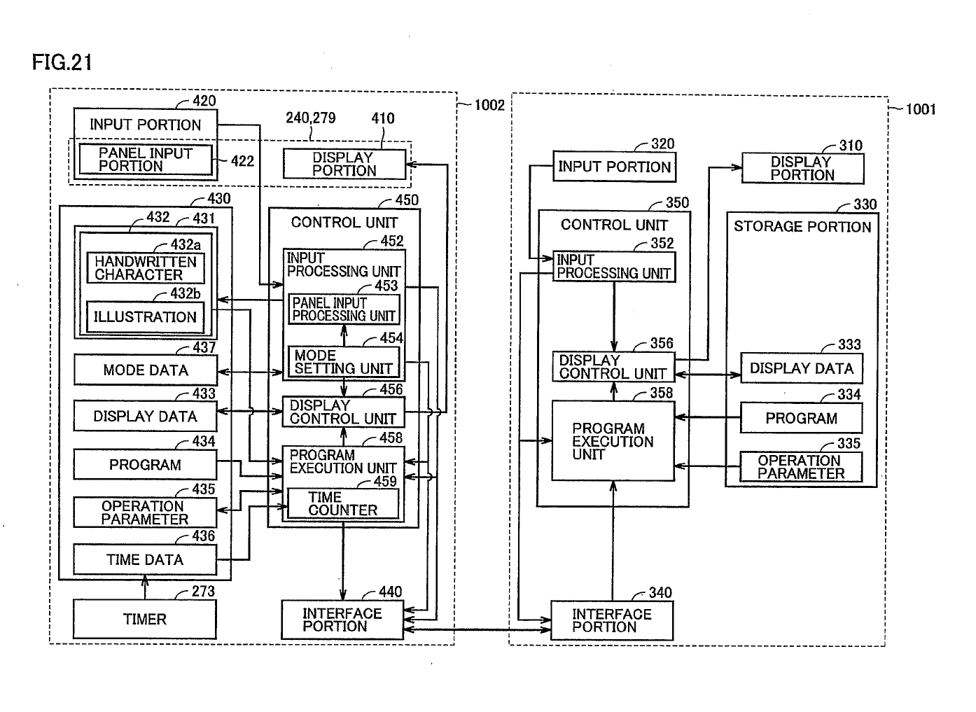

FIG. 21 is a block diagram showing a functional configuration of electronic device 100 in FIG. 19.

As described already, electronic device 100 includes first unit 1001 and second unit 1002. The functional configuration of electronic device 100 will be described hereinafter with reference to FIG. 21.

First unit 1001 includes a display portion 310, an input portion 320, a storage portion 330, an interface portion 340, and a control unit 350. First unit 1001 performs primary operations of electronic device 100.

Display portion 310 displays information in first unit 1001 to the outside. Input portion 320 accepts an external instruction. In the present embodiment, liquid crystal panel 140 performs functions of both of display portion 310 and input portion 320. It should be noted that other display devices, for example, such a display as an LCD (Liquid Crystal Display), may be employed as display portion 310. In addition, operation key 177 also functions as input portion 320.

Storage portion 330 stores information such as display data 333 serving as the basis of a screen to be displayed on display portion 310 of first unit 1001 (liquid crystal panel 140), a program 334, an operation parameter 335, and the like. Generally, storage portion 330 stores a plurality of programs 334. Program 334 herein includes general-purpose application software such as a word processor and a Web browser.

Operation parameter 335 refers to information for providing an operation condition for program 334. Operation parameter 335 includes, for example, data for showing an active window operating in response to pressing or the like of operation key 177 in multi-window program 334.

Interface portion 340 transmits and receives information to and from an interface portion 440 on the second unit 1002 side. In the present embodiment, in a case where first unit 1001 and second unit 1002 are directly connected to each other, USB connector 194 functions as interface portion 340. In a case where first unit 1001 and second unit 1002 are not directly connected to each other, antenna 195 functions as interface portion 340. It should be noted that a method of transmitting and receiving information through interface portion 340 is not limited as such.

Control unit 350 controls an operation of display portion 310, storage portion 330 and interface portion 340 based on an instruction or the like from input portion 320. Control unit 350 includes an input processing unit 352, a display control unit 356, and a program execution unit 358. In the present embodiment, CPU 110 and image processing engine 180 correspond to control unit 350, however, each function of CPU 110 may be implemented by hardware such as a dedicated circuit. In addition, each function of image processing engine 180 may be implemented by CPU 110 executing software. Namely, each function of control unit 350 may be implemented by any of hardware and software.

Input processing unit 352 transmits a signal received from input portion 320 to program execution unit 358. Display control unit 356 controls an operation of display portion 310 based on display data 333 stored in storage portion 330. Program execution unit 358 executes program 334 based on an instruction or the like accepted from input portion 320. Specifically, CPU 110 using RAM 171 as a working memory for executing program 334 corresponds to program execution unit 358.

Second unit 1002 includes a display portion 410, an input portion 420, a storage portion 430, interface portion 440, a control unit 450, and timer 273.

Display portion 410 displays information in second unit 1002 to the outside. Input portion 420 accepts an external instruction. In the present embodiment, photosensor built-in liquid crystal panel 240, left click key 241, center key 242, and right click key 243 correspond to input portion 420. In addition, in the present embodiment, photosensor built-in liquid crystal panel 240 performs functions of both of display portion 410 and input portion 420 (a panel input portion 422). It should be noted that other display devices, for example, such a display as an LCD, may be employed as display portion 410. In addition, input portion 420 is not limited to photosensor built-in liquid crystal panel 240, and a device (a tablet) having a function to recognize a position of input can be employed. For example, a capacitive type touch panel may be employed as input portion 420. A component implementing the functions of display portion 410 and input portion 420 in such a manner is called a “display-integrated touch pad.”

Storage portion 430 stores such information as input data 431, display data 433, a program 434, an operation parameter 435, time data 436, and mode data 437.

Input data 431 is data created based on an input accepted by input portion 420. In particular, in the present embodiment, input data 431 includes input history 432 corresponding to history of inputs. Input history 432 includes handwritten character data 432a and illustration data 432b. Details of handwritten character data 432a and illustration data 432b will be described later.

Display data 433 serves as the basis of a screen to be displayed on display portion 410 of second unit 1002 (liquid crystal panel 240). Display data 433 includes image data stored in storage portion 430 (such as wallpaper) or image data created as program 434 is executed.

In the present embodiment, storage portion 430 stores a plurality of programs 434. Program 434 includes application software for causing liquid crystal panel 240 to display an operation screen (such as handwriting character input software, hand-drawing illustration input software, and a calculator software). Details of program 434 will be described later.

Operation parameter 435 refers to information for providing an operation condition for program 434, similarly to operation parameter 335 in first unit 1001. In particular, in the present embodiment, operation parameter 435 includes a count value of time elapsed since a prescribed event, that is created by program 434.

Time data 436 represents time counted by timer 273. Time data 436 is made use of, for example, when program 434 performing a prescribed operation over time is executed.

Mode data 437 refers to information indicating an operation mode of an input processing unit 452. There are multiple operation modes of input processing unit 452 and mode data 437 indicates a current operation mode. Specifically, for example, a flag stored in a prescribed storage area can be regarded as mode data 437. It should be noted that details of the operation mode of input processing unit 452 will be described later.

Interface portion 440 transmits and receives information to and from interface portion 340 on the first unit 1001 side. In the present embodiment, in a case where first unit 1001 and second unit 1002 are directly connected to each other, USB connector 294 functions as interface portion 440. In a case where first unit 1001 and second unit 1002 are not directly connected to each other, antenna 295 functions as interface portion 440. It should be noted that a method of transmitting and receiving information through interface portion 440 is not limited as such.

Control unit 450 controls an operation of display portion 410, storage portion 430, and interface portion 440 based on an instruction or the like accepted by input portion 420. Control unit 450 includes input processing unit 452, a display control unit 456, and a program execution unit 458.

Input processing unit 452 transmits a signal from input portion 420 to program execution unit 458 or interface portion 440. Input processing unit 452 includes a panel input processing unit 453 and a mode setting unit 454.

Panel input processing unit 453 processes a signal from panel input portion 422. For example, panel input processing unit 453 creates input history 432 (handwritten character data 432a, illustration data 432b or the like) based on history of signals. Details of an operation of panel input processing unit 453 will be described later.

Mode setting unit 454 sets an operation mode of panel input processing unit 453 based on a prescribed signal (such as a signal produced by pressing of center key 242) from input portion 420. Details of an operation of mode setting unit 454 will be described later.

Display control unit 456 controls an operation of display portion 410 based on display data 433. Display control unit 456 causes display portion 410 to display, for example, a screen or the like created as a result of execution of program 434 (an operation screen).

Program execution unit 458 executes program 434 based on an instruction or the like accepted from input portion 420. Specifically, CPU 210 using RAM 271 as a working memory for executing program 434 corresponds to program execution unit 458.

<Overview of Operation>

(Mouse Mode and Tablet Mode)

Electronic device 100 issues an instruction input to liquid crystal panel 240, that is, an instruction for operating an application in response to contact of an object (such as finger 900 or a stylus 950) with liquid crystal panel 240. Electronic device 100 (more specifically, panel input processing unit 453) has two operation modes of a “mouse mode” and a “tablet mode”. Electronic device 100 operates in accordance with these two operation modes.

In the mouse mode, electronic device 100 executes program 334 in response to an input to liquid crystal panel 240 and causes liquid crystal panel 140 to display an image created by executed program 334 (hereinafter referred to as a “program operation screen”).

Specifically, in the mouse mode, electronic device 100 moves a cursor in the operation screen on liquid crystal panel 140 in real time in accordance with change in position of input to liquid crystal panel 240. It should be noted that the “cursor” herein refers to an indicator indicating a position of input of a character, graphics, a display object, or the like.

In addition, in the mouse mode, electronic device 100 creates a command instructing program 334 in first unit 1001 to perform a prescribed operation in response to a prescribed input to liquid crystal panel 240. For example, when electronic device 100 determines that liquid crystal panel 240 has accepted an input corresponding to click, double click, drag, or the like, electronic device 100 executes program 334 in response to the input. The operation performed by electronic device 100 here is determined by program 334.

Namely, when electronic device 100 is in the mouse mode, the user can use liquid crystal panel 240 as a touch pad. For the sake of brevity, an operation of program 334 in accordance with movement of a cursor position and a prescribed input to liquid crystal panel 240 will hereinafter collectively be referred to as a “mouse operation”.

In the tablet mode, electronic device 100 executes program 434 (or program 334) in response to an input to liquid crystal panel 240 and causes liquid crystal panel 240 to display an operation screen of the executed program. In addition, electronic device 100 creates a command for the program, of which operation screen is displayed on liquid crystal panel 240. For example, when an operation button is displayed on liquid crystal panel 240, electronic device 100 executes program 434 and performs an operation in accordance with the operation button on touched liquid crystal panel 240. Namely, while electronic device 100 is in the tablet mode, the user can use liquid crystal panel 240 as a touch screen.

Electronic device 100 switches the operation mode based on a prescribed instruction. In the present embodiment, electronic device 100 switches the operation mode in response to pressing of center key 242

It should be noted that an instruction to switch the operation mode is not limited to pressing of center key 242. Electronic device 100 may switch the operation mode in response to pressing of operation key 177 other than center key 242. Alternatively, electronic device 100 may switch the operation mode in accordance with selection of an operation button displayed on liquid crystal panel 140 or liquid crystal panel 240. Alternatively, electronic device 100 switches the operation mode also depending on an operation state of the electronic device (for example, during processing for launch or during return from sleep or rest state), which will be described later in detail.

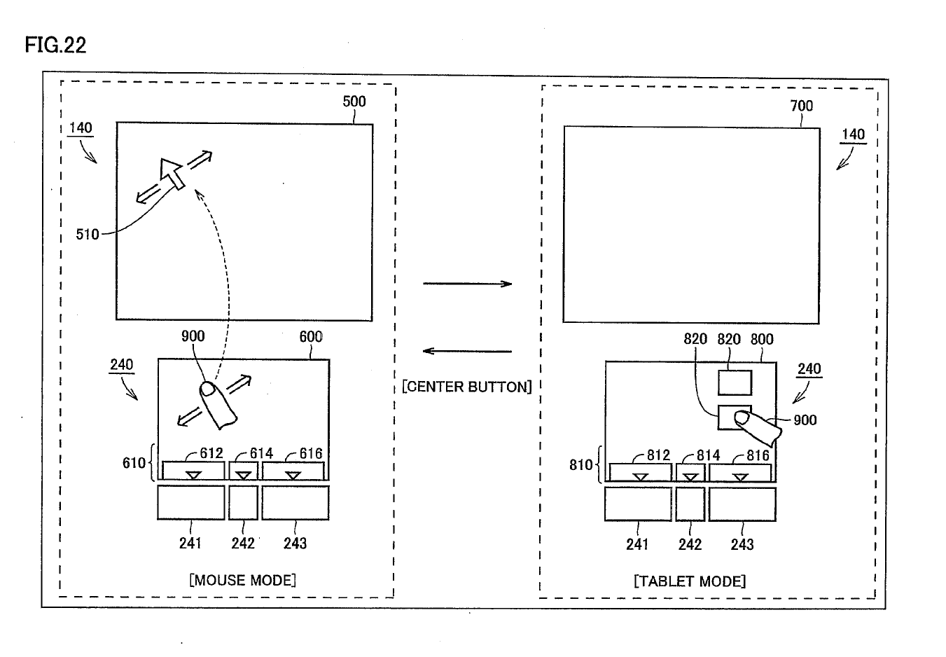

Display on liquid crystal panel 140 and liquid crystal panel 240 in the mouse mode and the tablet mode will be described with reference to FIG. 22. FIG. 22 is a diagram for illustrating a screen displayed on the electronic device in each of the mouse mode and the tablet mode.

In the mouse mode, electronic device 100 displays an operation screen 500 of software such as word processor software or a Web browser on liquid crystal panel 140. Screen 500 is a screen similar to a display screen of a personal computer that has currently widely been used (that is, having one display). It should be noted that, for the sake of brevity, contents on screen 500 are not shown in FIG. 22. In addition, screen 500 is not limited to this specific example.

Screen 500 includes a cursor 510. Here, cursor 510 is assumed as a pointer (a mouse pointer) that can freely move over screen 500. It should be noted that cursor 510 is not limited to a pointer. Cursor 510 may be an indicator indicating a position of input of a character or a display object. In addition, a form of display of cursor 510 is not limited to the form (an arrow) shown in FIG. 22. Moreover, electronic device 100 may vary a form of display of cursor 510 depending on a position indicated thereby.

Further, in the mouse mode, electronic device 100 displays a screen 600 on liquid crystal panel 240. A screen displayed on liquid crystal panel 240 in the mouse mode is hereinafter also referred to as a “mouse screen”. Referring to FIG. 22, screen 600 includes a guidance indication 610.

Guidance indication 610 is an indication for providing explanation of an operation of electronic device 100 when left click key 241, center key 242, and right click key 243 are pressed. Guidance indication 610 includes a left guidance indication 612, a center guidance indication 614, and a right guidance indication 616.

Left guidance indication 612, center guidance indication 614, and right guidance indication 616 include a character and/or a symbol explaining an operation of electronic device 100 when left click key 241, center key 242, and right click key 243 are pressed (it should be noted that such a character and a symbol are not shown in FIG. 22).

The mouse screen does not always have to display left guidance indication 612, center guidance indication 614, and right guidance indication 616. In the present embodiment, when a corresponding key is invalid, electronic device 100 does not provide display of left guidance indication 612, center guidance indication 614, and right guidance indication 616 on liquid crystal panel 240.

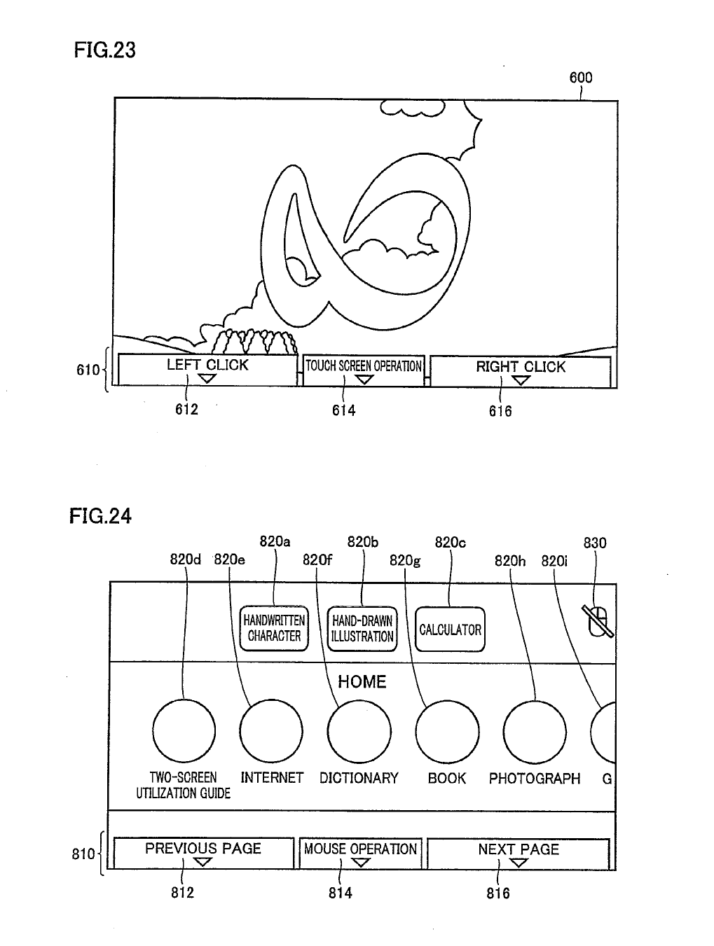

FIG. 23 shows one specific example of the mouse screen. Referring to FIG. 23, screen 600 includes left guidance indication 612, center guidance indication 614, and right guidance indication 616.

In FIG. 23, left guidance indication 612 includes characters “left click”. When this indication is provided, electronic device 100 performs a left click operation (such as an entry processing) in response to pressing of left click key 241. The left click operation is determined by a program that is running.

In FIG. 23, center guidance indication 614 includes characters “touch screen operation.” This indication is provided when electronic device 100 is in the mouse mode. When this indication is provided, electronic device 100 makes transition to the tablet mode in response to pressing of center key 242.

When electronic device 100 is in the tablet mode, characters including characters “mouse operation” are displayed as center guidance indication 614. When this indication is provided, electronic device 100 makes transition to the mouse mode in response to pressing of center key 242.

Right guidance indication 616 includes characters “right click”, which indicates that electronic device 100 performs a right click operation (such as display of a menu) in response to pressing of right click key 243. A detailed operation in right click is determined by a program that is running.

In the present embodiment, it is assumed that the user can set the mouse screen. The user may also be able to set an image such as a photograph stored in electronic device 100 as wallpaper of the mouse screen. In addition, the wallpaper may be an accessory operation screen without requiring a user's operation, such as a clock or a calendar. Moreover, even when the user cannot set the mouse screen, the mouse screen is not limited to that shown in FIG. 23. Further, the wallpaper may also automatically change, depending on a state of electronic device 100.

Specifically, data of an image displayed as the mouse screen is stored in such a storage device as ROM 272 or RAM 271, and CPU 210 reads the image data from the storage device in the mouse mode and causes liquid crystal panel 240 to display the image data.

Referring back to FIG. 22, a screen in the tablet mode will be described. In the tablet mode, liquid crystal panel 140 displays an operation screen 700 of software such as word processor software and a Web browser. Operation screen 700 is identical in contents to operation screen 500.

In addition, in the tablet mode, electronic device 100 causes liquid crystal panel 240 to display a screen 800. A screen displayed on liquid crystal panel 240 in the tablet mode is also hereinafter referred to as a “tablet screen”. Referring to FIG. 22, screen 800 includes a guidance indication 810 and an operation button display 820.

Guidance indication 810 includes a left guidance indication 812, a center guidance indication 814 and a right guidance indication 816 similarly to guidance indication 610 in the mouse mode. Since roles and operations thereof are the same as those of left guidance indication 612, center guidance indication 614 and right guidance indication 616, detailed description will not be repeated.

Operation button display 820 is used for selection of an application. When electronic device 100 senses contact of an external object (such as finger 900 or stylus 950) with a region corresponding to operation button display 820, electronic device 100 starts a prescribed operation corresponding to the region.

(As to Program)

Here, a program executed in electronic device 100 will be described.

A program executed in electronic device 100 according to the present embodiment includes a program of which operation screen is displayed on liquid crystal panel 140 (hereinafter referred to as a “main application”) and a program of which operation screen is displayed on liquid crystal panel 240 (hereinafter referred to as a “sub application”).

An application operating on a current electronic device, such as a browser, a dictionary, a book viewer, and a photo viewer, can be assumed as the main application. For example, an input pad making use of an input to liquid crystal panel 240 (such as a handwriting character input pad, a hand-drawing illustration input pad, and a calculator/number input pad) and an application for operation assistance for the main application are exemplified as the sub application.

In the description of the present embodiment, the sub application is assumed to be independent of the main application. The main application is stored in storage portion 330 of first unit 1001. Meanwhile, the sub application is stored in storage portion 430 of second unit 1002.

Thus, the main application is separate from the sub application. Therefore, a general-purpose application that operates in other electronic devices can be made use of as the main application. In this case, specifications for exchange of data of the sub application with the main application are adapted to specifications of the main application. For example, an instruction for a mouse operation by the sub application is adapted to an operation instruction from a conventional touch pad or mouse.

In addition, in the present embodiment, program execution unit 358 executing the main application and program execution unit 458 executing the sub application are independent of each other. Thus, load imposed on a processor executing the main application (in the present embodiment, CPU 110) can be mitigated. In particular, in a case where a CPU of electronic device 100 is low in performance, it is effective to divide the program execution unit as such.

By providing a control unit and a storage portion in each of first unit 1001 and second unit 1002 as in the present embodiment, exchange of data between first unit 1001 and second unit 1002 can be decreased and processing can be faster.

It should be noted that the sub application does not necessarily have to be independent of the main application. Namely, the same program may function as both of the main application and the sub application. Specifically, a part of the program may create a screen to be displayed on liquid crystal panel 140 and another part of the program may create a screen to be displayed on liquid crystal panel 240.

Further, the main application and the sub application may be executed by the same processor. In this case, the processor executing the applications controls operations of both of liquid crystal panel 140 and liquid crystal panel 240.

(Sub Application)

In the present embodiment, in the tablet mode, electronic device 100 executes any of a plurality of sub applications. In addition, a “home application” for determining an application to be executed is provided as one of the sub applications.

The home application is a launcher for selecting an application. The home application causes liquid crystal panel 240 to display a screen for selecting one sub application (hereinafter a “home menu screen”) from among the plurality of sub applications.

FIG. 24 shows a specific example of a home menu screen. Referring to FIG. 24, the home menu screen includes guidance indication 810, operation button displays 820a to 820i, and a mouse-disabled indication 830. When operation button displays 820a to 820i are touched, the home application calls a sub application corresponding to operation button displays 820a to 820i. Mouse-disabled indication 830 is an indication indicating that electronic device 100 does not perform a mouse operation based on an input to liquid crystal panel 240. This indication helps the user accurately understand an operation of electronic device 100 in the tablet mode, and in addition it also helps the user distinguish between the mouse mode and the tablet mode.

In the present embodiment, electronic device 100 can customize the home menu screen based on a user's instruction. It should be noted that, even though customization of the home menu screen cannot be made, a configuration of the home menu screen is not limited to that shown in FIG. 24. For example, the number of operation button displays 820 or arrangement thereof is not limited to that shown in FIG. 24. In addition, mouse-disabled indication 830 is not limited to that shown in FIG. 24 either. Alternatively, mouse-disabled indication 830 does not have to be included in the home menu screen.

It should be noted that a default sub application in the tablet mode is set to the home application. Namely, when electronic device 100 operates in the tablet mode for the first time after it is launched (after power is turned on), the home application is executed.

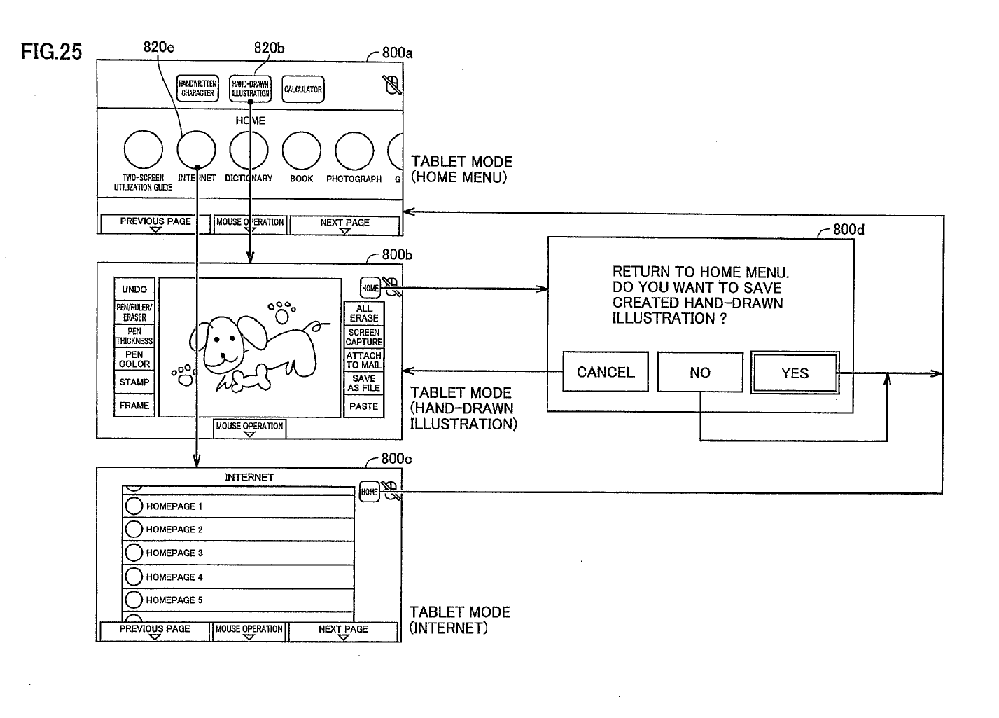

Transition of screen 800 displayed on liquid crystal panel 240 in the tablet mode will be described with reference to FIG. 25. FIG. 25 is a diagram of transition of screen 800 displayed on liquid crystal panel 240 in the tablet mode.

Referring to FIG. 25, when the user selects operation button display 820 (hand-drawn illustration) in a home menu screen 800a, electronic device 100 executes a hand-drawing illustration application and causes liquid crystal panel 240 to display a screen 800b. Screen 800b is an operation screen of the hand-drawing illustration application.

In screen 800b shown in FIG. 25, a picture of a dog input during execution of the hand-drawing illustration application is drawn in a hand-drawing input frame thereof.

When the user selects operation button display 820 (home) in screen 800b, electronic device 100 causes liquid crystal panel 240 to display a window 800d. Here, electronic device 100 may display window 800d and screen 800b mutually exclusively or display window 800d in a manner superimposed on screen 800b. Window 800d includes a sentence asking whether to save the created hand-drawn illustration and operation button display 820 of “YES”, “NO” and “CANCEL”.

When “YES” in window 800d is selected, electronic device 100 causes a storage device in electronic device 100 or an external storage device (such as a hard disc or a flash memory) to store the hand-drawn illustration drawn in the input frame prior to display of window 800d. In addition, electronic device 100 causes liquid crystal panel 240 to display home menu screen 800a.

When “NO” in window 800d is selected, electronic device 100 causes liquid crystal panel 240 to display home menu screen 800a. In this case, electronic device 100 does not cause a storage device to store the hand-drawn illustration drawn in the input frame prior to display of window 800d.

When “CANCEL” in window 800d is selected, electronic device 100 causes liquid crystal panel 240 to display screen 800b prior to display of window 800d. Namely, when the user selects cancel, the user can continue to create a hand-drawn illustration in the hand-drawing input frame.

When the user selects operation button display 820e (the Internet) in home menu screen 800a, electronic device 100 causes liquid crystal panel 140 to display an operation screen 800c for selecting a list of homepages for launching a Web browser.

When the user selects operation button display 820 (home) in screen 800c, electronic device 100 causes liquid crystal panel 240 to display home menu screen 800a. In this case, electronic device 100 does not perform processing for saving input data. Therefore, electronic device 100 does not provide display of such an inquiry screen as window 800d.

<Mode Switching>

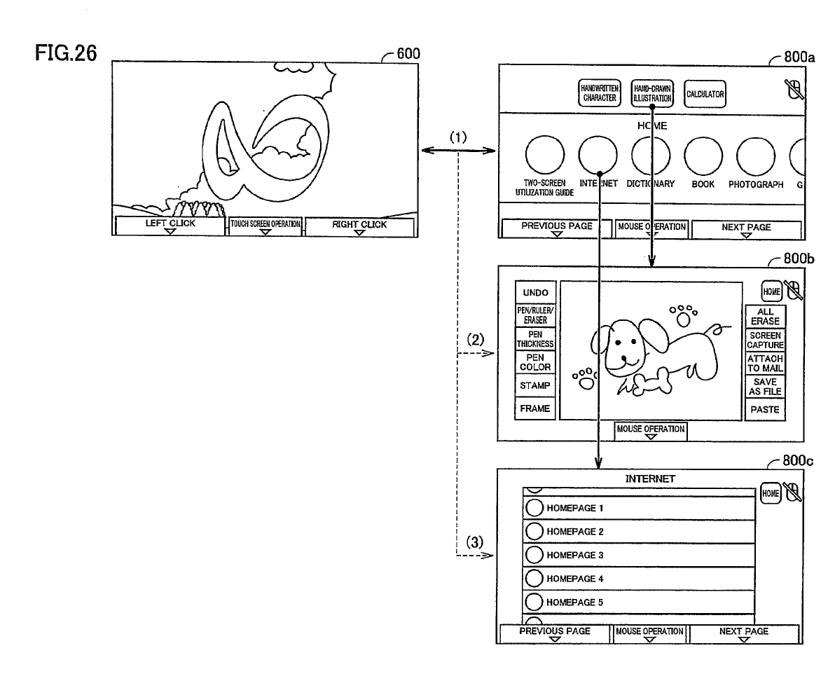

From now on, an operation of electronic device 100 in switching between the mouse mode and the tablet mode will be described in detail with reference to FIG. 26. FIG. 26 is a diagram for illustrating an operation of electronic device 100 in switching between the mouse mode and the tablet mode.

In the present embodiment, as described already, electronic device 100 switches the operation mode basically in response to pressing of center key 242. Electronic device 100 can make transition from the tablet mode to the mouse mode and also transition from the mouse mode to the tablet mode.

In the present embodiment, electronic device 100 changes a method of processing an input to liquid crystal panel 240 in making transition from the tablet mode to the mouse mode. Namely, electronic device 100 now handles an input to liquid crystal panel 240 not as an operation instruction to the sub application but as a mouse operation instruction. In addition, electronic device 100 causes liquid crystal panel 240 to display a mouse screen in making transition to the mouse mode.

It should be noted that electronic device 100 allows the application being executed in the tablet mode to keep operating also after transition to the mouse mode. By doing so, electronic device 100 can smoothly cause liquid crystal panel 240 to display a screen in making transition from the mouse mode to the tablet mode, because a time for starting up the sub application is not required.

In addition, by allowing the application being executed in the tablet mode to keep operating, operability in a case where the user temporarily performs a mouse operation using liquid crystal panel 140 during the tablet mode is improved. For example, it is assumed that electronic device 100 makes transition from the tablet mode to the mouse mode and then again makes transition back to the tablet mode. Since electronic device 100 operates as above, electronic device 100 causes liquid crystal panel 240 to display the operation screen of the same sub application before and after transition to the mouse mode. Therefore, after the user performs the mouse operation, the user can continue to make use of the sub application that has been operating before the mouse operation.

Further, electronic device 100 causes liquid crystal panel 140 to display the operation screen of the main application not only in the mouse mode but also in the tablet mode. Therefore, electronic device 100 can allow the user to operate the sub application without impairing good visibility of the operation screen of the main application.

(Mode at the Time of Start of Operation)

Switching of the operation mode in connection with start of the operation of electronic device 100 will be described in particular. In the present embodiment, it is assumed that start of the operation of electronic device 100 is broadly categorized into two of (i) launch from a power off state (hereinafter referred to as normal launch) and (ii) launch from a power save state (hereinafter referred to as resume).

Here, the “power off state” refers to such a state that an operation of each portion of electronic device 100 (except for a portion necessary for launching electronic device 100) has stopped. The “power save state” refers to such a state that a part of the operation of electronic device 100 has stopped.

The power save state includes a “stand-by state”, a “rest state”, and a “hybrid sleep state” which represents combination of the stand-by state and the rest state.

When an instruction to make transition to the stand-by state is accepted, electronic device 100 causes RAM 171 to save working data. In addition, electronic device 100 stops power supply to a portion except for a portion other than the portion necessary for resuming the operation (such as power source circuit 192, power source detecting unit 193 and RAM 171).

When an instruction to make transition to the rest state is accepted, electronic device 100 causes hard disc 170 to save working data. In addition, electronic device 100 stops power supply to a portion other than the portion necessary for resuming the operation (such as power source circuit 192 and power source detecting unit 193).

When hybrid sleep processing for making transition to the hybrid sleep state is started, electronic device 100 initially causes the memory to store working data. At the same time, electronic device 100 copies the data stored in the memory from the memory to the hard disc after a prescribed period of time elapsed in the sleep state since the instruction was issued.

It should be noted that a type of the power save state is not limited to those described above. In addition, electronic device 100 does not necessarily have to be able to prepare all of these power save processes.

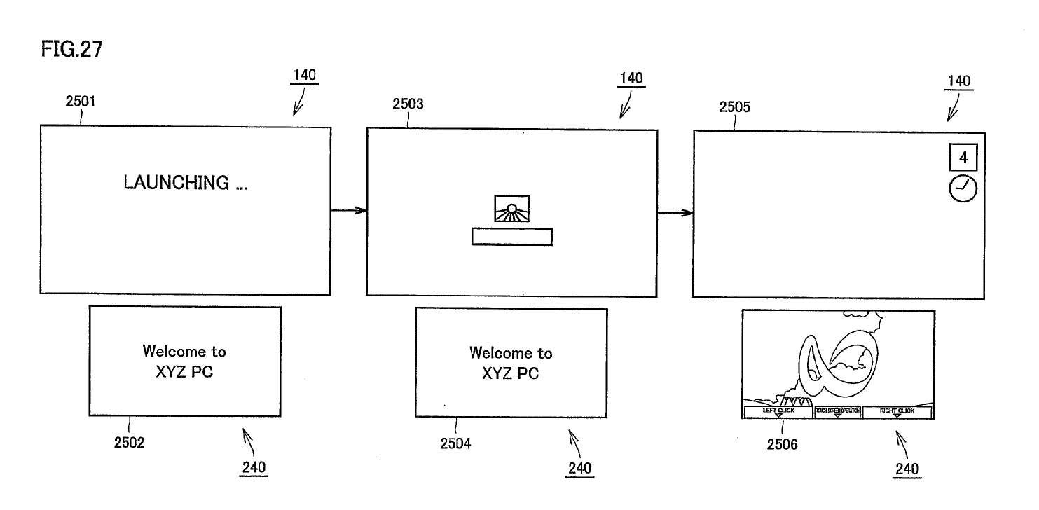

Initially, (i) an operation mode in normal launch will be described with reference to FIG. 27. FIG. 27 is a diagram schematically showing an operation mode in normal launch.

In normal launch, initially, electronic device 100 performs boot processing for launching an OS (Operating System). During the boot processing, electronic device 100 causes liquid crystal panel 140 to display a boot screen 2501. In addition, during the boot processing, the operation mode of electronic device 100 is set to the mouse mode. Electronic device 100 causes liquid crystal panel 240 to display a prescribed mouse screen (hereinafter referred to as a fixed screen) 2502. Fixed screen 2502 does not include a guidance indication, because mode switching cannot be made during the boot processing.

When the boot processing is completed, electronic device 100 causes liquid crystal panel 140 to display a log-in screen 2503. Electronic device 100 here again provides display of a fixed screen 2504.

When log-in is completed, electronic device 100 causes liquid crystal panel 140 to display a desktop screen 2505. In addition, electronic device 100 causes liquid crystal panel 240 to display a mouse screen 2506. At this stage, in electronic device 100, switching from the mouse mode to the tablet mode is allowed. Accordingly, mouse screen 2506 includes a guidance indication as in mouse screen 600 shown in FIG. 23.

It should be noted that a default sub application in the tablet mode is set to the home application. Namely, when electronic device 100 operates for the first time in the tablet mode after launch (after power is turned on), the home application is executed. This operation is also the same in rebooting electronic device 100, without limited to launch from power off.

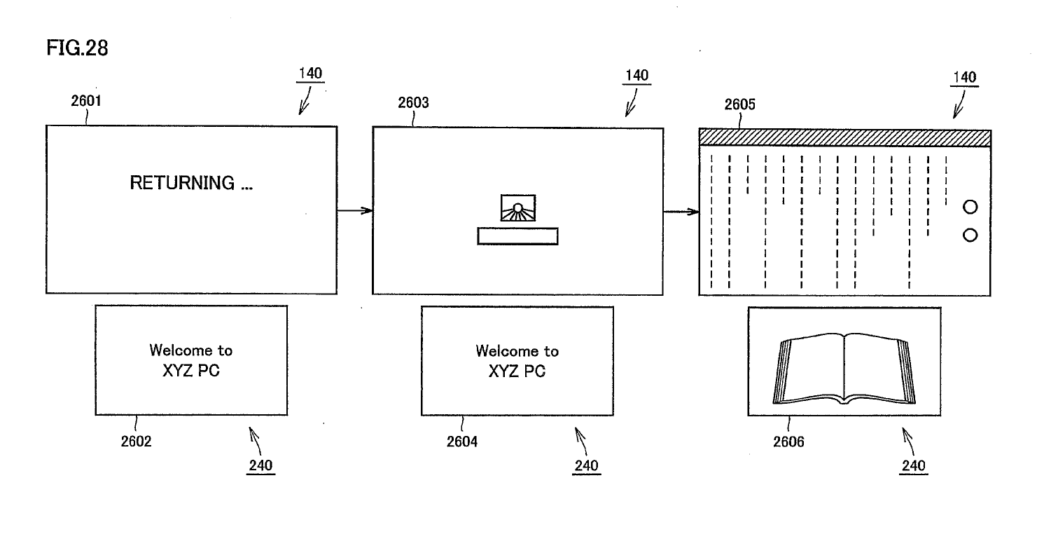

Then, (ii) an operation mode in returning will be described with reference to FIG. 28. FIG. 28 is a diagram schematically showing an operation mode in returning.

In resume from the power save state, electronic device 100 initially reads data on a working state stored in such a storage device as a memory or a hard disc. During this period, electronic device 100 causes liquid crystal panel 140 to display a resuming screen 2601. It should be noted that display of resuming screen 2601 may be omitted. In addition, during this period, the operation mode of electronic device 100 is set to the mouse mode. Electronic device 100 causes liquid crystal panel 240 to display a fixed screen 2602.

When reading of the working state is completed, electronic device 100 causes liquid crystal panel 140 to display a log-in screen 2603. Electronic device 100 here again displays a fixed screen 2604. Depending on setting in electronic device 100, this log-in screen may not be displayed, and in that case, the screen automatically makes transition to a next log-in completion screen.

When log-in is completed, electronic device 100 causes liquid crystal panel 140 to again display a display screen 2605 that has been displayed on liquid crystal panel 140 immediately before transition to the power save state, based on the read working state. In addition, electronic device 100 causes liquid crystal panel 240 to display a display screen 2606 based on the sub application that has been operating immediately before transition to the power save state.

It should be noted that electronic device 100 may cause liquid crystal panel 140 to unexceptionally display a mouse screen after completion of log-in. In a case where an operation first performed by the user after resumption is expected to be a mouse operation or the like, this processing can improve operability.

In addition, in electronic device 100, in such a case that electronic device 100 is highly likely to be operated with a mouse, such as during launch of an OS, during return from the sleep state, in a stand-by state in switching a log-in user (for example, in a stand-by state including a period during which a screen prompting input of new user's log-in information is displayed on liquid crystal panel 140), or during a period in which a screen saver is displayed on liquid crystal panel 140, liquid crystal panel 240 may display a mouse screen for switching to the mouse mode.

As electronic device 100 thus operates in the mouse mode during launch of an OS, during return from the sleep state or the like, electronic device 100 operates in the first mode in launching or in returning from a specific power supply state. In addition, as electronic device 100 operates in the mouse mode in the stand-by state for switching a log-in user, during a period in which a screen saver is displayed or the like, electronic device 100 operates in the first mode while it is in a specific operation state.

<Operation in Tablet Mode>

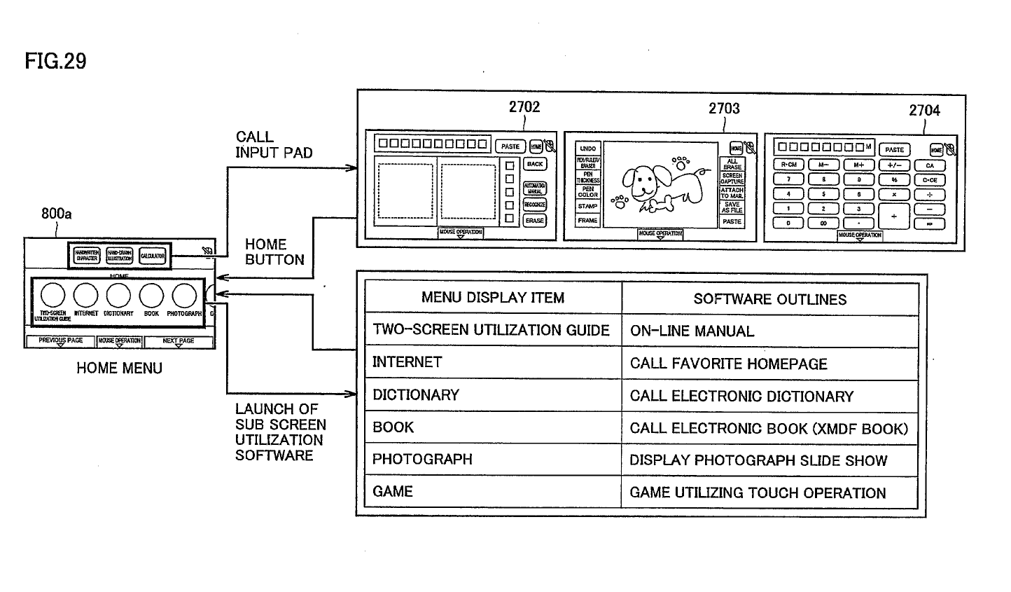

From now on, an operation of electronic device 100 in the tablet mode will be described in further detail with reference to FIG. 29. FIG. 29 is a diagram for illustrating an operation of electronic device 100 in the tablet mode.

In the tablet mode, broadly speaking, electronic device 100 performs any of execution of the home application, execution of the input pad application, and execution of sub screen utilization software.

During execution of the home application, electronic device 100 causes liquid crystal panel 240 to display home menu screen 800a. When electronic device 100 accepts touch onto a prescribed position (indicated by an operation button display) on liquid crystal panel 240 during execution of the home application, electronic device 100 calls the input pad. Alternatively, when electronic device 100 accepts touch onto a prescribed position on liquid crystal panel 240 during execution of the home application, electronic device 100 starts execution of the sub screen utilization software.

When electronic device 100 calls the input pad, it causes liquid crystal panel 240 to display a screen for input. Referring to FIG. 29, in the present embodiment, three types of input pads, that is, a handwriting character input pad, a hand-drawing illustration input pad, and a calculator/number input pad are available. Screens 2702 to 2704 displayed on liquid crystal panel 240 represent operation screens of the handwriting character input pad, the hand-drawing illustration input pad, and the calculator/number input pad, respectively. Details of each input pad will be described later.

In addition, when electronic device 100 accepts a prescribed instruction during execution of the input pad, it launches the home application. In the present embodiment, the operation screen of the input pad includes a home button, and electronic device 100 ends the input pad and launches the home application in response to touch onto the home button.

Referring to FIG. 29, the sub screen utilization software in the present embodiment includes two-screen utilization guide, the Internet, dictionary, book, photograph, and game.

The “two-screen utilization guide” is an on-line manual. When electronic device 100 executes the two-screen utilization guide, it obtains manual data from HDD 170 or an external server and causes liquid crystal panel 240 (or liquid crystal panel 140 or both of liquid crystal panel 140 and liquid crystal panel 240) to display the manual.

The “Internet” is software for launching a Web browser and calling various homepage screens, and it is hereinafter referred to as Web page calling software. Details of an operation of this software will be described later.

The “dictionary” is software for calling an electronic dictionary and hereinafter referred to as dictionary calling software. In the present embodiment, this software calls one electronic dictionary from a plurality of electronic dictionaries. Details of an operation of this software will be described later.

The “book” is software for selecting an electronic book to be viewed on a book viewer (for example, a book in an XMDF (Mobile Document Format) format). The “photograph” is software for displaying slide show of photographs.

The “game” is game software for displaying a game screen on liquid crystal panel 240. In the present embodiment, the “game” is assumed as a game utilizing a touch operation onto liquid crystal panel 240.

When electronic device 100 accepts a prescribed instruction during execution of the sub screen utilization software, it ends the sub screen utilization software and launches the home application. In the present embodiment, the operation screen of the sub screen utilization software includes the home button and electronic device 100 launches the home application in response to touch onto the home button.

(Handwriting Character Input Pad)

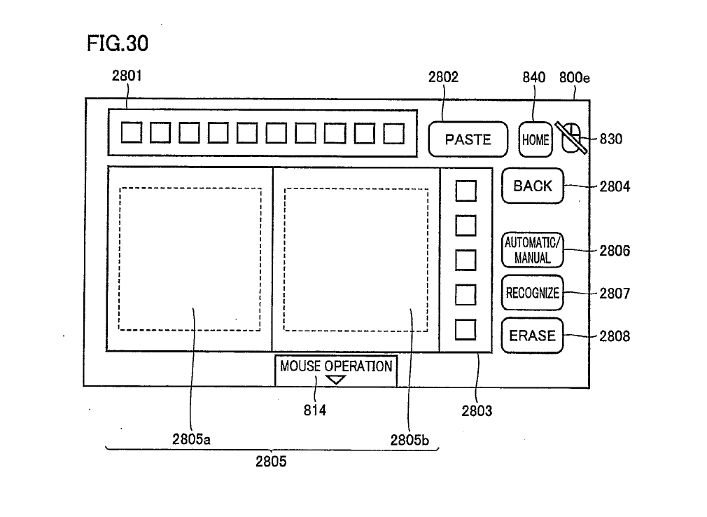

An operation of electronic device 100 executing the handwriting character input pad (specifically, CPU 210 executing the application) will be described with reference to FIG. 30. FIG. 30 is a diagram showing one example of a screen (a character input screen) displayed on liquid crystal panel 240 by electronic device 100 while the handwriting character input pad is launched.

Referring to FIG. 30, the character input screen includes center guidance indication 814, mouse-disabled indication 830, a home button 840, a text box 2801, a paste button 2802, a candidate area 2803, a back button 2804, a handwriting area 2805, a recognition mode switch button 2806, a recognize button 2807, and an erase button 2808.

Text box 2801 displays a character confirmed as a result of handwritten character recognition. Text box 2801 can display ten confirmed characters at the maximum. It should be noted that the maximum number of characters displayed in text box 2801 is not limited as such.

When paste button 2802 is pressed while a character string (one character or a plurality of characters) is present in text box 2801, electronic device 100 transmits the character string to an active application displayed on liquid crystal panel 140. When the character string is transmitted, contents in text box 2801 are cleared automatically (without a user's special operation).

In addition, when there is no character string in text box 2801, paste button 2802 functions as an Enter key. For example, the user presses paste button 2802 to transmit a character string to a search box and thereafter the user can again press paste button 2802 for causing the application to conduct search. When text box 2801 includes no character string (or when paste button 2802 functions as the Enter key), electronic device 100 changes characters displayed in paste button 2802 to “Enter”.

Candidate area 2803 displays candidates for recognition of an input. In the present embodiment, candidate area 2803 displays top five recognition candidates at the maximum, in the descending order from the first candidate. It should be noted that the maximum number of candidates displayed in candidate areas 2803 is not limited as such.

In the present embodiment, electronic device 100 automatically adds the first candidate (the top character in candidate area 2803) to text box 2801. In addition, electronic device 100 can change the added character in response to selection of a candidate within candidate area 2803. Since it is highly likely that the first candidate is a character the user is trying to input, the number of times of user's operations performed can be decreased by automatically adding the first candidate to text box 2801.

When back button 2804 is pressed, electronic device 100 erases the last character in the character string within text box 2801. When text box 2801 includes no character string, electronic device 100 does not perform an operation involved with pressing of back button 2804.

Handwriting area 2805 accepts an external input. Electronic device 100 creates handwritten character data 432a corresponding to history of inputs to handwriting area 2805 and causes storage portion 430 to store the same. For example, electronic device 100 creates as handwritten character data 432a, all coordinates input within a prescribed period of time or coordinates at the start and the end of temporally continuous inputs within a prescribed period of time. In addition, electronic device 100 provides display of graphics corresponding to coordinates of which input has been accepted (or handwritten character data 432a) in handwriting area 2805.

In the present embodiment, handwriting area 2805 includes two regions (an area 2805a and an area 2805b). Electronic device 100 creates handwritten character data 432a for each of area 2805a and area 2805b.

Recognition mode switch button 2806 switches a mode of recognition of a handwritten input. In the present embodiment, two recognition modes of an “automatic mode” and a “manual mode” are available. It is assumed that the recognition mode at the time when the handwriting input pad is first launched is set to the automatic mode.

In the “automatic mode”, electronic device 100 automatically starts recognition of a character input into handwriting area 2805 after a prescribed period of time has elapsed since pen-up (end of input to handwriting area 2805). The automatic mode is advantageous in its ability to decrease the number of times of user's operations performed. It should be noted that, instead of pen-up, electronic device 100 may automatically start character recognition after other events, for example, after a prescribed period of time has elapsed since start of input to handwriting area 2805.

In the “manual mode”, electronic device 100 does not start character recognition until recognize button 2807 is pressed. The manual mode is advantageous in that the user can calmly input a character.

When recognize button 2807 is pressed, electronic device 100 starts character recognition of handwritten character data 432a based on inputs to input area 2805. In the automatic mode as well, if recognize button 2807 is pressed earlier than the time to start recognition, electronic device 100 starts character recognition of handwritten character data 432a.

When erase button 2808 is pressed, electronic device 100 erases graphics and handwritten character data 432a displayed in input area 2805. Erase button 2805 is used when the user rewrites the character handwritten before character recognition.

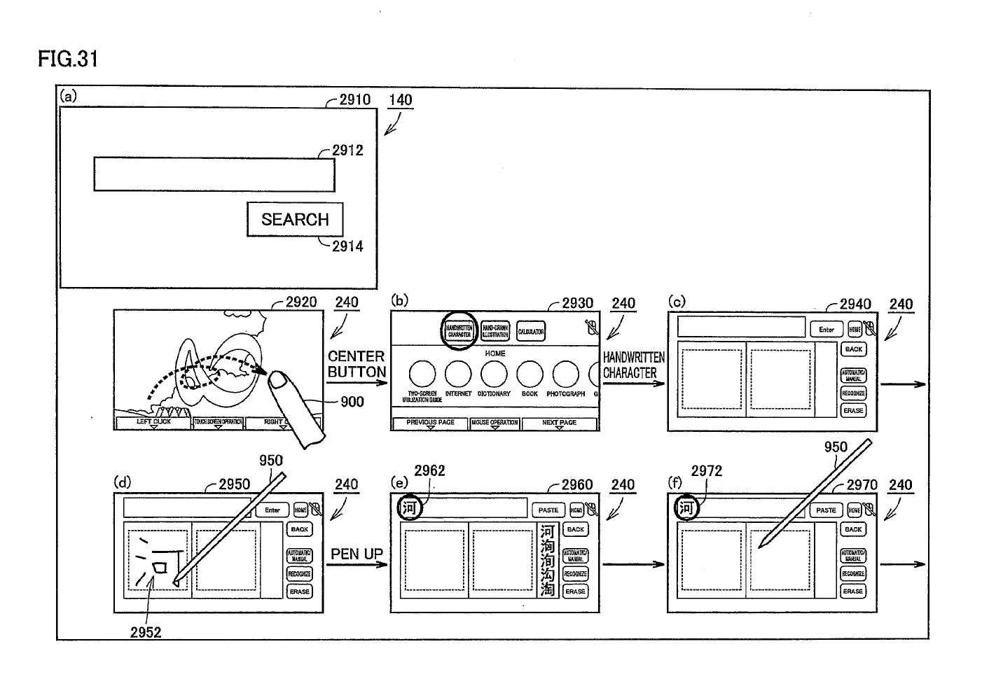

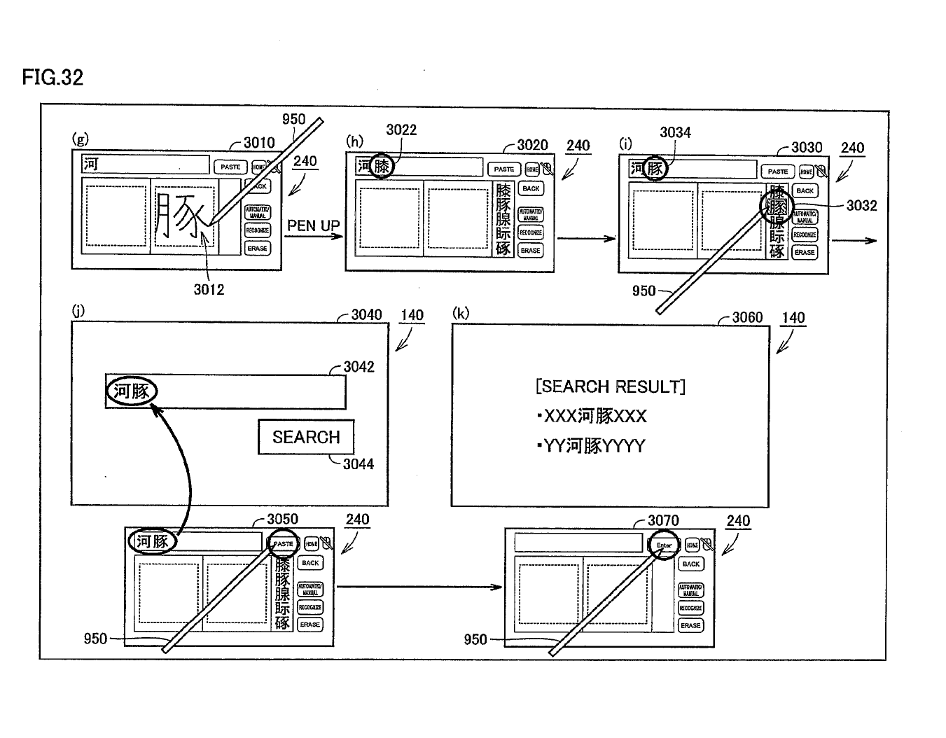

A method of making use of the handwriting character input pad will be described with reference to FIGS. 31 and 32. FIGS. 31 and 32 are diagrams for illustrating an operation of electronic device 100 in making use of the handwriting character input pad. Here, an operation example where the user inputs a character string (strings or phrase) constituted of two Chinese characters using liquid crystal panel 240 during use of an application for displaying a screen including a search box (such as a Web browser) and conducts search relating to the input character string will be described.

A screen 2910 is a screen displayed on liquid crystal panel 140 in the mouse mode. Here, liquid crystal panel 240 displays a mouse screen 2920. Screen 2910 displayed on liquid crystal panel 140 is an operation screen of the main application. Screen 2910 includes a search box 2912 and a search start button 2914. It is assumed that search box 2912 is activated by the mouse operation involved with movement of finger 900 over liquid crystal panel 240.

A screen 2930 is a screen displayed on liquid crystal panel 240 after a mode switching instruction (specifically, pressing of center key 242) is issued while screen 2910 is displayed on liquid crystal panel 140.

Here, screen 2930 is the home menu screen.

A screen 2940 is a screen displayed on liquid crystal panel 240 after a button for calling the handwriting character input pad (surrounded by a circle in screen 2930) is pressed in screen 2930. Screen 2940 is the character input screen.

A screen 2950 is a screen displayed on liquid crystal panel 240 when stylus 950 is used to provide handwriting inputs to screen 2940. In an input area of screen 2950, graphics 2952 corresponding to the handwritten inputs is displayed.

A screen 2960 is a screen displayed on liquid crystal panel 240 when stylus 950 moved away from liquid crystal panel 240. In a candidate area of screen 2950, candidate characters (five Chinese characters) corresponding to the handwritten inputs are displayed. In addition, in the text box, a first candidate character 2962 among candidates displayed in the candidate area is displayed.

A screen 2970 represents one example of a screen displayed on liquid crystal panel 240 when first candidate character 2962 is confirmed. A character 2972 is a confirmed character. In screen 2970, a candidate character is no longer displayed in the candidate area.

Referring to FIG. 32, a screen 3010 is a screen displayed on liquid crystal panel 240 when the user uses stylus 950 to provide handwriting inputs after screen 2970 is displayed. Screen 3010 includes graphics 3012 corresponding to handwritten inputs.

A screen 3020 is a screen displayed on liquid crystal panel 240 when stylus 950 that has touched screen 3010 moved away from screen 3010 (liquid crystal panel 240). In a candidate area of a screen 3030, candidate characters corresponding to handwritten inputs are displayed. In addition, in the text box, a first candidate character 3022 among the candidate characters is added on the right of the already-confirmed character (see screen 2970 in FIG. 31).

Screen 3030 is a screen displayed on liquid crystal panel 240 when a character 3032 in the candidate area was pressed with stylus 950 in screen 3020. As character 3032 is pressed, the character that has been displayed in the text box changes to a character displayed as character 3032 (a character 3034).

Screens 3040 and 3050 are screens displayed on liquid crystal panels 140 and 240 respectively after character 3034 is confirmed. Screen 3040 includes a search box 3042 and a search start button 3044. When the paste button in display screen 3050 is pressed with stylus 950 after character 3034 is confirmed, the character string in the text box is input to active search box 3042.

Screens 3060 and 3070 are screens displayed on liquid crystal panels 140 and 240 respectively after the Enter button (paste button) is pressed in screen 3050 and search button 3044 is pressed in screen 3040. Pressing of the Enter button in display screen 3070 achieves an effect the same as that of pressing of search start key 3044. Namely, the main application conducts search relating to the character string in search box 3042 in response to pressing of the Enter button and causes screen 3060 to display a search result.

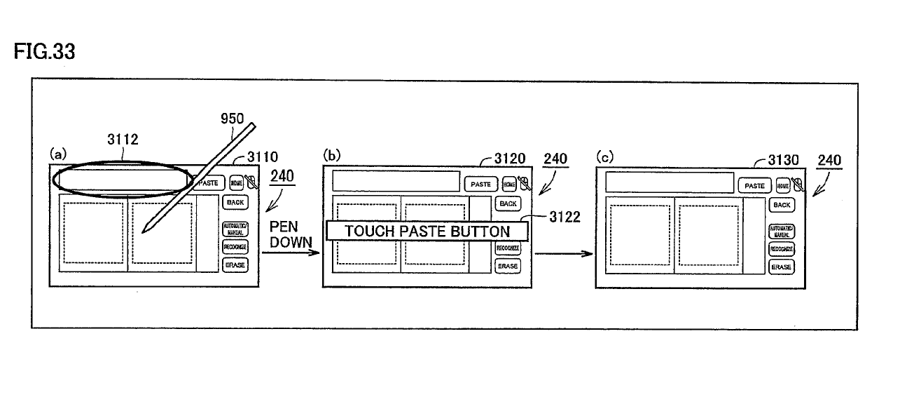

In the present embodiment, when the text box is full (a maximum number of acceptable characters has been input in the text box), electronic device 100 does not accept any more handwriting. An operation of electronic device 100 at the time when the text box is full will be described with reference to FIG. 33.

A screen 3110 shows a screen displayed on liquid crystal panel 240 while the user uses stylus 950 to attempt to provide inputs into an input area with the text box being already full (ten characters have been input in the text box). A character string 3112 (a character string including ten characters) is displayed in the text box in screen 3110.

When stylus 950 touches liquid crystal panel 240, electronic device 100 causes liquid crystal panel 240 to display a screen 3120 including a warning indication 3122. Warning indication 3122 includes a character string prompting confirmation of a character, that is, pressing of the paste button. Though the character string included in warning indication 3122 is herein set to “touch paste button,” the character string is not limited thereto.

After warning indication 3122 is provided, liquid crystal panel 240 displays a screen 3130. Screen 3130 displays contents the same as contents displayed in screen 3110. The user can continue character input by pressing the paste button to confirm the character string displayed in the text box or by pressing the back button to erase the character already input in the text box while this screen 3130 is displayed. It should be noted that, for example, electronic device 100 changes a screen to be displayed on liquid crystal panel 240 from screen 3120 to screen 3130 automatically after a prescribed period of time has passed since display of warning indication 3122 or in response to some kind of instruction given to liquid crystal panel 240.

It is assumed in the present embodiment that handwritten character data 432a (see FIG. 19) is temporarily stored in RAM 271 or the like and electronic device 100 discards handwritten character data 432a when the handwriting character input pad ends. Therefore, when the handwriting character input pad is again called, the user can newly input a character.

It should be noted that electronic device 100 may hold handwritten character data 432a so that the user can resume handwriting input from the previous state when he/she uses the handwriting input pad again. In this case, when the handwriting character input pad is resumed, electronic device 100 causes liquid crystal panel 240 to display graphics corresponding to handwritten character data 432a based on handwritten character data 432a.

It should be noted that the user may be able to select which of the two operations above should be performed by the handwriting character input pad (whether to hold handwritten character data 432 or not). In this case, the user can determine as appropriate which of the two operations above should be performed by the handwriting character input pad, in accordance with a manner of use of the handwriting character input.

(Hand-Drawing Illustration Input Pad)

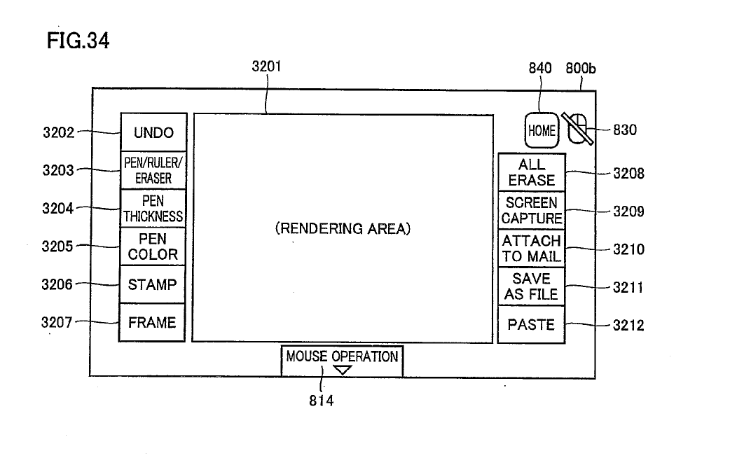

An operation of electronic device 100 executing the hand-drawing illustration input pad (specifically, CPU 210 executing the application) will be described with reference to FIG. 34. FIG. 34 is a diagram showing one example of a screen displayed on liquid crystal panel 240 by electronic device 100 (an illustration input screen) while the hand-drawing illustration input pad is launched.

Referring to FIG. 34, the illustration input screen includes center guidance indication 814, mouse-disabled indication 830, home button 840, a rendering area 3201, an undo button 3202, a pen/ruler/eraser button 3203, a pen thickness button 3204, a pen color button 3205, a stamp button 3206, a frame button 3207, an all erase button 3208, a screen capture button 3209, an attach-to-mail button 3210, a save-as-file button 3211, and a paste button 3212.

Rendering area 3201 accepts an external input. Electronic device 100 creates illustration data 432b based on an input to rendering area 3201 and rendering setting (such as an input tool, a pen thickness or a pen color) and causes storage portion 430 to store the same. Illustration data 432b includes all coordinates input within a prescribed period of time or coordinates at the start and the end of temporally continuous inputs within a prescribed period of time, similarly to handwritten character data 432a. Illustration data 432b further includes data on the rendering setting (such as an input tool, a pen thickness or a pen color).

In the present embodiment, a ratio between a horizontal length and a vertical length of rendering area 3201 is set to 4:3, because the hand-drawing illustration input pad is used also for processing photographs. It should be noted that an aspect ratio of rendering area 3201 is not limited as such.

Undo button 3202 is a button for canceling an immediately preceding input operation onto rendering area 3201. Electronic device 100 manages inputs recorded in input history 432 in time sequence and hence it erases the immediately preceding input from input history 432 when undo button 3202 is pressed. At the same time, a corresponding rendered portion is erased from rendering area 3201.

Pen/Ruler/Eraser button 3203 is a button for selecting a tool for rendering in rendering area 3201. In response to pressing of Pen/Ruler/Eraser button 3203, electronic device 100 switches the rendering tool in the order of pen, ruler, eraser, pen, and so on.

Pen thickness button 3204 is a button for setting a pen thickness. In response to pressing of pen thickness button 3204, electronic device 100 changes setting of a thickness of a line drawn in accordance with input into rendering area 3201 while the pen tool is selected. Alternatively, when pen thickness button 3204 is pressed, electronic device 100 may cause liquid crystal panel 240 to display a screen for having the user set a pen thickness.

Pen color button 3205 is a button for setting a pen color. In response to pressing of pen color button 3205, setting of a color of a line drawn in accordance with input into rendering area 3201 while the pen tool is selected is changed. Alternatively, when pen color button 3205 is pressed, electronic device 100 may cause liquid crystal panel 240 to display a screen for having the user set a color of a line.

Stamp button 3206 is a button for attaching a stamp in rendering area 3201 in response to an input to rendering area 3201.

Frame button 3207 is a button for adding a frame such as a decorative frame to an illustration drawn in rendering area 3201.

All erase button 3208 is a button for erasing entire illustration data 432b. By pressing this button, the user can set rendering area 3201 to a state at the time of launch of the hand-drawing illustration input pad (blank).

Screen capture button 3209 is a button for displaying a part of the screen displayed on liquid crystal panel 140 in rendering area 3201. Attach-to-mail button 3210 is a button for attaching illustration data 432b to an e-mail. Save-as-file button 3211 is a button for saving illustration data 432b in a designated storage area. An area for storing illustration data 432b may be fixed or may be designated by the user.

Paste button 3212 is a button for sending illustration data 432b to an active main application. When paste button 3212 is pressed, electronic device 100 provides an active main application with illustration data 432b created by the hand-drawing illustration input pad. The user can use the hand-drawing illustration input pad, for example, to insert an illustration in a document being created with the main application.

In the present embodiment, as described with reference to FIG. 25, when an instruction to end the hand-drawing illustration input pad is accepted, the hand-drawing illustration input pad inquires whether to save created hand-drawn illustration data 432b or not. This inquiry, however, is not essential. The hand-drawing illustration input pad may automatically discard hand-drawn illustration data 432b created so far when it ends.

(Calculator/Number Input Pad)

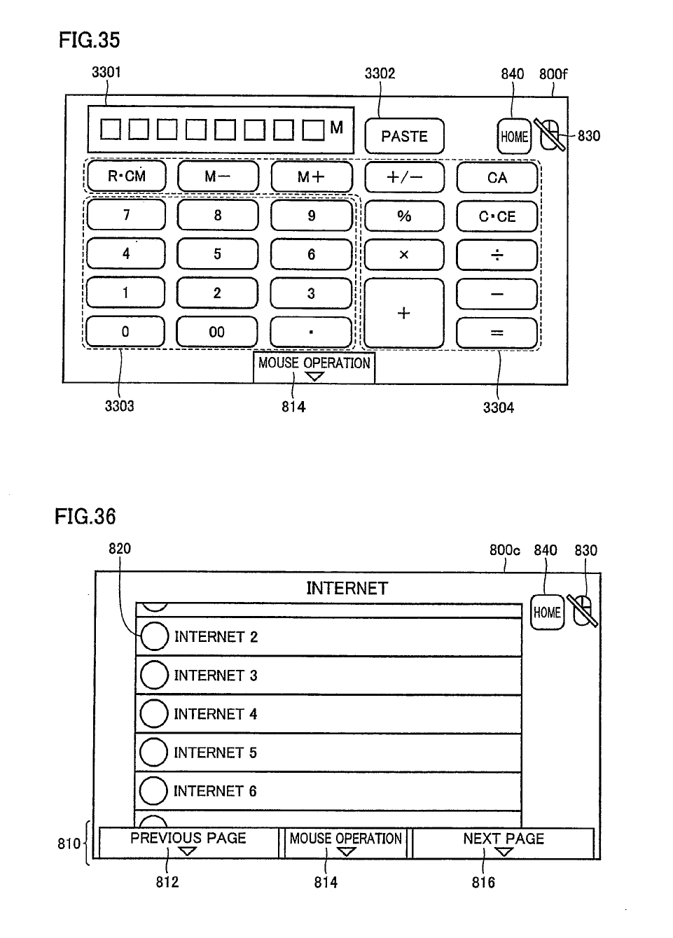

An operation of electronic device 100 executing a calculator/number input pad (specifically, CPU 210 executing the application) will be described with reference to FIG. 35. FIG. 35 is a diagram showing one example of a screen displayed on liquid crystal panel 240 by electronic device 100 while the calculator/number input pad is launched (a calculator screen).

Referring to FIG. 35, the calculator screen includes center guidance indication 814, mouse-disabled indication 830, home button 840, a number box 3301, a paste button 3302, number buttons 3303, and function buttons 3304.

Number box 3301 displays an input number or a number indicating a result of calculation. It is assumed that the maximum number of numbers that can be displayed in number box 3301 is set to eight. It should be noted that the maximum number is not limited to eight.

When paste button 3302 is pressed, electronic device 100 transmits a number displayed in number box 3301 to an active application displayed on liquid crystal panel 140.

Number button 3303 is a button for inputting a number into number box 3301. Function button 3304 is a button for indicating a prescribed arithmetic operation such as four arithmetic operations. Since an operation of electronic device 100 at the time when number button 3303 and function button 3304 are pressed is the same as the operation of a common calculator or a calculator application, detailed description thereof will not be repeated here.

(Internet)

An operation of electronic device 100 executing Web page calling software representing one piece of the sub screen utilization software (specifically, CPU 210 executing the application) will be described with reference to FIG. 36. FIG. 36 is a diagram showing one example of a screen displayed on liquid crystal panel 240 by electronic device 100 while the Web page calling software is launched (an Internet screen).

Referring to FIG. 36, the Internet screen includes guidance indication 810 (left guidance indication 812, center guidance indication 814 and right guidance indication 816), a plurality of operation button displays 820, mouse-disabled indication 830, and home button 840.

Operation button displays 820 correspond to Web pages to be called, respectively. Each operation button display 820 includes a character representing a name of a corresponding Web page (in the drawing, “Internet 2” or the like). When electronic device 100 detects touch onto a region corresponding to operation button display 820, it launches a Web browser and causes liquid crystal panel 140 (or liquid crystal panel 240) to display the selected Web page.

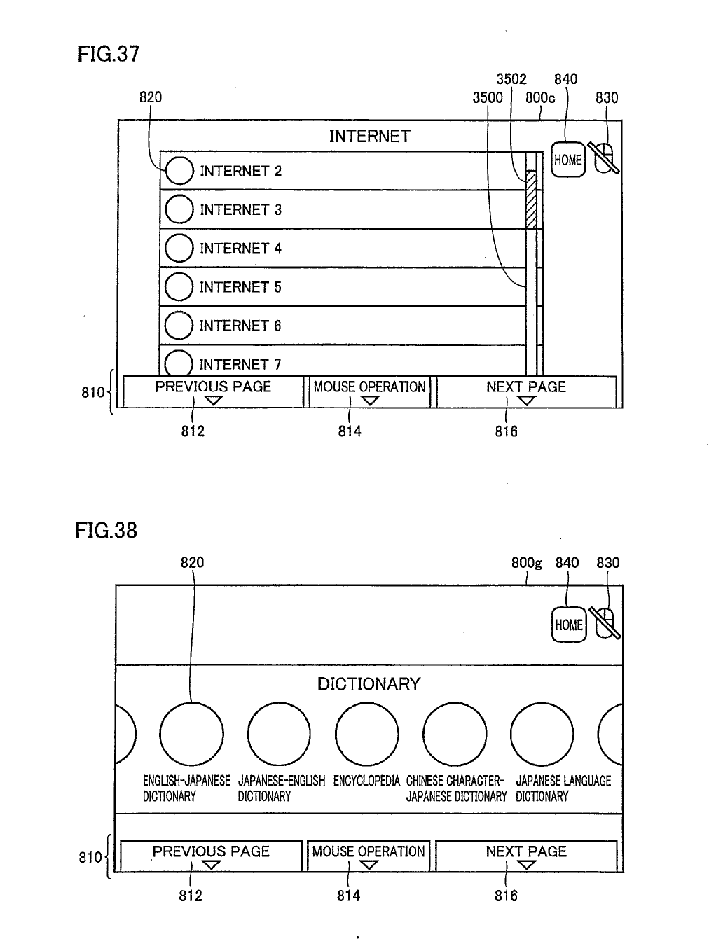

It should be noted that the Web page calling software may cause liquid crystal panel 240 to display a scroll bar. FIG. 37 shows one example of an Internet screen including a scroll bar. Referring to FIG. 37, the Internet screen includes a scroll bar 3500. When the user drags a slider 3502 in scroll bar 3500, the Web page calling software causes the Internet screen to scroll.

(Dictionary)

An operation of electronic device 100 executing dictionary calling software representing one piece of the sub screen utilization software (specifically, CPU 210 calling the application) will be described with reference to FIG. 38. FIG. 38 is a diagram showing one example of a screen displayed on liquid crystal panel 240 by electronic device 100 while the dictionary calling software is launched (a dictionary selection screen).

Referring to FIG. 38, the dictionary selection screen includes guidance indication 810 (left guidance indication 812, center guidance indication 814 and right guidance indication 816), a plurality of operation button displays 820, mouse-disabled indication 830, and home button 840.

Operation button displays 820 correspond to electronic dictionaries to be called, respectively. Each operation button display 820 includes characters representing a name of a corresponding electronic dictionary (in the drawing, “English-Japanese Dictionary” or the like). When electronic device 100 detects touch onto a region corresponding to operation button display 820, it launches the electronic dictionary and causes liquid crystal panel 140 (or liquid crystal panel 240) to display a screen of the launched electronic dictionary.

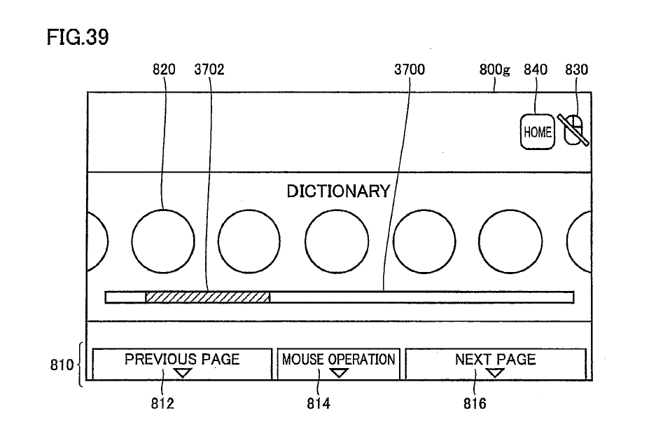

It should be noted that the dictionary calling software may cause liquid crystal panel 240 to display a scroll bar. FIG. 39 shows one example of a dictionary selection screen including a scroll bar. Referring to FIG. 39, the dictionary selection screen includes a scroll bar 3700. When the user drags a slider 3702 in scroll bar 3700, the dictionary calling software causes the dictionary selection screen to scroll.

<Process Flow>

(Basic Flow)

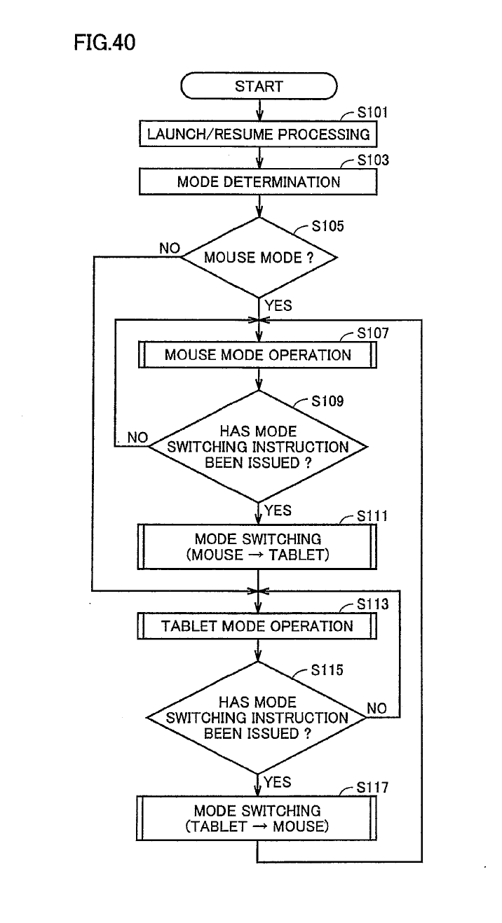

A flow of processing performed by electronic device 100 according to the present embodiment will be described with reference to FIG. 40. FIG. 40 shows in a flowchart form, a flow of the processing performed by electronic device 100. It should be noted that FIG. 40 collectively shows processing performed by control unit 350 in first unit 1001 and processing performed by control unit 450 in second unit 1002.

In step S101, when an instruction for normal launch of electronic device 100 or a resume instruction is accepted, control unit 350 and control unit 450 perform normal launch processing or resume processing.

As described already, normal launch refers to launch from the power off state. The normal launch processing performed by control unit 350 includes, for example, boot processing and display of a boot screen on liquid crystal panel 140. Normal launch processing performed by control unit 450 includes display of a boot screen on liquid crystal panel 240.

Control unit 350 and control unit 450 regard pressing or the like of a prescribed button (power switch 191 or the like) in the power off state as an instruction for normal launch. It should be noted that the configuration may be such that one control unit (control unit 450 or 350) accepts a normal launch instruction, then performs its own normal launch processing and provides the other control unit (control unit 350 or 450) with an instruction for normal launch processing.

As described already, resume refers to launch from the power save state. The resume processing performed by control unit 350 includes reading of a working state stored in RAM 171, HDD 170 or the like and display of a resuming screen on liquid crystal panel 140. The resume processing performed by control unit 450 includes reading of a working state stored in RAM 271, HDD 170 or the like and display of a resuming screen on liquid crystal panel 240.

Control unit 350 and control unit 450 regard pressing of a prescribed button (power switch 191 or the like) in the power save state, touch onto liquid crystal panel 240 or the like as a normal launch instruction. It should be noted that one control unit (450 or 350) may perform the resume processing in response to an instruction from the other control unit (350 or 450) that accepted the resume instruction.

In step S103, mode setting unit 454 included in control unit 450 sets the operation mode to any of the mouse mode and the tablet mode.

In the present embodiment, the operation mode in the case of normal launch has been set to the mouse mode. In the case of normal launch, mode setting unit 454 sets mode data 437 in storage portion 430 to data representing the mouse mode.

In addition, in resuming, mode setting unit 454 sets mode data 437 based on the operation mode of mode data 437 before the power save state. In this case, it is assumed that control unit 450 causes RAM 271 or the like to store mode data 437 before the power save state, in making transition to the power save state or in resume. Alternatively, in resume, mode setting unit 454 may always set mode data 437 to data indicating the mouse mode. In this case, control unit 450 does not have to perform processing for storing mode data 437 before the power save mode.

In step S105, input processing unit 452 determines whether the operation mode is set to the mouse mode or not. Namely, input processing unit 452 determines based on mode data 437, whether the operation mode is set to the mouse mode or not.

When the operation mode is set to the mouse mode (YES in step S105), control unit 350 and control unit 450 proceed to a mouse mode operation in step S107. When the operation mode is not set to the mouse mode (NO in step S105), control unit 350 and control unit 450 proceed to a tablet mode operation in step S113.

In step S107, control unit 350 and control unit 450 perform the mouse mode operation. Namely, control unit 350 and control unit 450 control each portion of electronic device 100 such that an input to liquid crystal panel 240 causes a mouse operation of the main application. Details of the mouse mode operation will be described later.

Mode setting unit 454 determines in step S109 whether a mode switching instruction has been accepted or not. Specifically, mode setting unit 454 determines whether a signal in response to pressing of center key 242 has been accepted or not. It should be noted that the mode switching instruction is not limited to pressing of center key 242.

When the mode switching instruction has been issued during the mouse mode (YES in step S109), control unit 450 performs processing for switching from the mouse mode to the tablet mode in step S111. When a mode switching instruction has not been issued (NO in step S109), control unit 350 and control unit 450 repeat the processing from step S107 (the mouse mode operation).

In step S111, control unit 450 performs the processing for switching from the mouse mode to the tablet mode. For example, in step S111, control unit 450 causes liquid crystal panel 240 to display a sub application operation screen and switches an operation of panel input processing unit 453. Details of the processing for switching from the mouse mode to the tablet mode will be described later. After step S111 ends, control unit 350 and control unit 450 proceed to the tablet mode operation in step S113.

In step S113, control unit 350 and control unit 450 perform the tablet mode operation. Namely, control unit 350 and control unit 450 control each portion of electronic device 100 such that the sub application operates in response to an input to liquid crystal panel 240. Details of the tablet mode operation will be described later.

In step S115, mode setting unit 454 determines whether a mode switching instruction has been accepted or not. Specifically, mode setting unit 454 determines whether a signal in response to pressing of center key 242 has been accepted or not. It should be noted that the mode switching instruction is not limited to pressing of center key 242.

When a mode switching instruction is issued during the tablet mode (YES in step S115), control unit 450 performs processing for switching from the tablet mode to the mouse mode in step S117. When a mode switching instruction is not issued (NO in step S115), control unit 350 and control unit 450 repeat the processing from step S113 (the tablet mode operation).

In step S117, control unit 450 performs processing for switching from the tablet mode to the mouse mode. For example, in step S117, control unit 450 causes liquid crystal panel 240 to display the mouse screen and switches an operation of panel input processing unit 453. Details of the processing for switching from the tablet mode to the mouse mode will be described later. After step S117 ends, control unit 350 and control unit 450 proceed to the mouse mode operation in step S107.

It should be noted that control unit 350 and control unit 450 perform processing for cutting off power or processing for making transition to the power save state at the time point when an instruction to cut off power or an instruction to make transition to the power save state is accepted. Such processing is interrupt processing and it is performed after any step in FIG. 40. It should be noted that such processing is not shown in FIG. 40.

(Mouse Mode Operation)

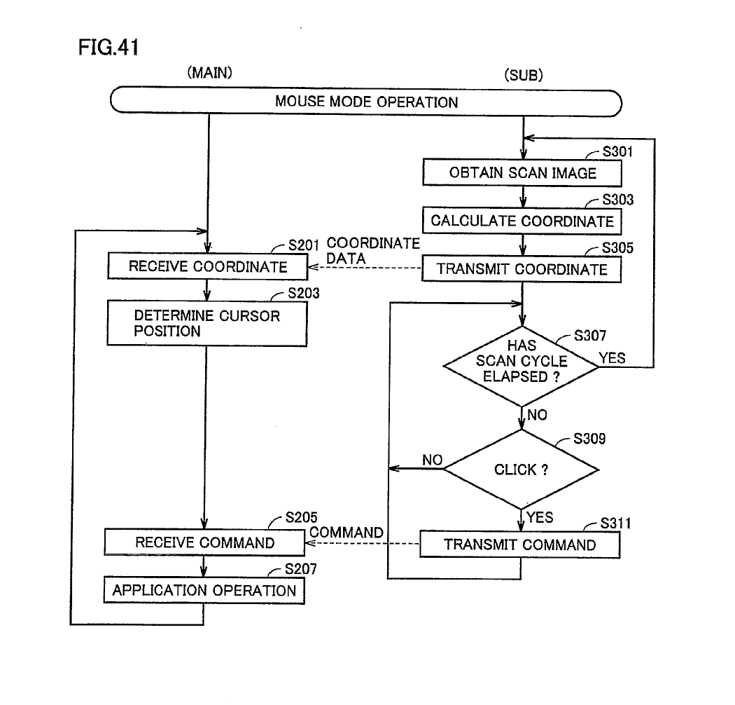

The mouse mode operation in step S107 in FIG. 40 will be described in detail with reference to FIG. 41. FIG. 41 is a diagram showing in a flowchart form, a flow of processing in the mouse mode operation.

Initially, an operation of control unit 350 on the first unit 1001 side will be described. A flow of the operation of control unit 350 is shown on the left in FIG. 41.

In step S201, control unit 350 obtains coordinate data through interface portion 340. Transmission of this coordinate data to interface portion 440 through interface portion 440 has been caused by control unit 450 on the second unit 1002 side.

In step S203, control unit 350 determines a cursor position based on the coordinate data. More specifically, it is program execution unit 358 included in control unit 350 that performs the processing in step S203. Program execution unit 358 executes program 334 so as to determine a cursor position.

In step S205, control unit 350 obtains a command through interface portion 340. Transmission of this command to interface portion 340 through interface portion 440 has been caused by control unit 450 on the second unit 1002 side.

In step S207, control unit 350 performs an application operation in accordance with the command. Specifically, program execution unit 358 executes program 334 so as to perform the application operation. Program execution unit 358 determines the application operation based on a type of the application, the cursor position and a type of the command.

The application operation is similar to an operation involved with mouse click in a currently widely used application. For example, the application operation includes selection or launch of a file or a folder located at the cursor position, execution of processing in accordance with a button located at the cursor position (a minimize (maximize) button, a close button or the like), or the like.

In succession, an operation of control unit 450 on the second unit 1002 side will be described. A flow of the operation of control unit 450 is shown on the right in FIG. 41.

In step S301, panel input processing unit 453 included in input processing unit 452 of control unit 450 obtains a scan image from liquid crystal panel 240 (panel input portion 422).

In step S303, panel input processing unit 453 calculates coordinate data specifying a position of input on liquid crystal panel 240 based on the scan image obtained in step S301.

In step S305, panel input processing unit 453 controls interface portion 440 so as to transmit the coordinate data to interface portion 340 on the first unit 101 side.

In step S307, panel input processing unit 453 determines whether or not a prescribed scan cycle time has elapsed since step S301 was performed. When the scan cycle time has elapsed (YES in step S307), panel input processing unit 453 repeats the processing from step S301 (obtaining of a scan image). When the scan cycle time has not elapsed (NO in step S307), control unit 450 proceeds to processing in step S309.

In step S309, input processing unit 452 determines whether a click operation has been performed or not. Specifically, input processing unit 452 determines whether pressing of left click key 241 or right click key 243 has been pressed or not. It should be noted that input processing unit 452 may determine an operation to tap liquid crystal panel 240 as the click operation. Specifically, input processing unit 452 determines that the tap operation has been performed when detection of an external object in a specific region on liquid crystal panel 240 was started and ended within a prescribed short period of time.

When a click operation has not been performed (NO in step S309), control unit 450 repeats the processing from step S307. When a click operation has been performed (YES in step S309), control unit 450 proceeds to processing in step S311.

In step S311, input processing unit 452 controls interface portion 440 so as to transmit a command to interface portion 340 on the first unit 1001 side in response to the click operation in step S309.

Here, it is assumed that input processing unit 452 determines a type of a command based on a type of the click operation. For example, input processing unit 452 transmits commands different between a case where left click key 241 is pressed and a case where right click key 243 is pressed.

Transmission of a command based on a click operation has been described above, however, an operation triggering a command transmission is not limited to the click operation. For example, input processing unit 452 may transmit a command in response to double click, drag, multiple-touch, a gesture operation, or the like.

(Tablet Mode Operation)

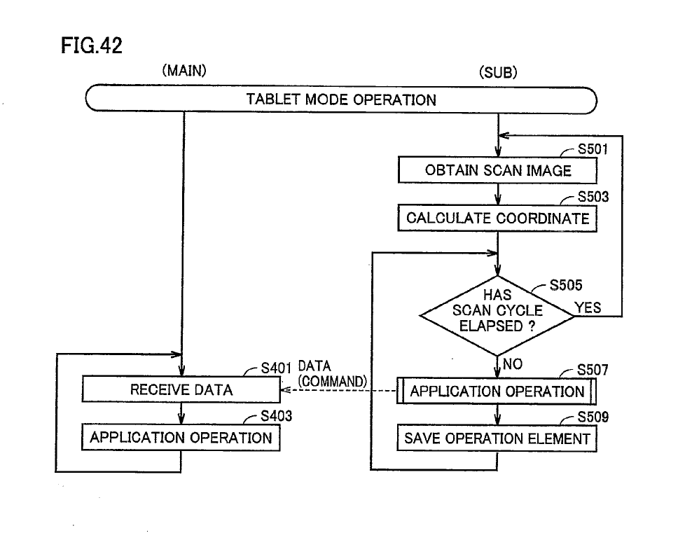

The tablet mode operation in step S109 in FIG. 40 will be described in detail with reference to FIG. 42. FIG. 42 is a diagram showing in a flowchart form, a flow of processing in the tablet mode operation.

Initially, an operation of control unit 350 on the first unit 1001 side will be described. A flow of the operation of control unit 350 is shown on the left in FIG. 42.

In step S401, control unit 350 obtains data through interface portion 340. The “data” herein was created by execution of a sub application by control unit 450 on the second unit 1002 side.

Specifically, the “data” refers, for example, to character (or numeric) data or illustration data. Alternatively, the data may be a command. For example, when “Enter” in the operation screen of the handwriting character input pad is touched, control unit 450 creates a command.

In step S403, control unit 350 performs the application operation in accordance with the data. Specifically, program execution unit 358 executes program 334 so as to perform the application operation. Program execution unit 358 processes the data obtained in step S401 with the main application being executed. When step S403 ends, control unit 350 returns to the processing in step S401.

In succession, an operation of control unit 450 on the second unit 1002 side will be described. A flow of the operation of control unit 450 is shown on the right in FIG. 42.

In step S501, panel input processing unit 453 included in input processing unit 452 of control unit 450 obtains a scan image from liquid crystal panel 240 (panel input portion 422).

In step S503, panel input processing unit 453 calculates coordinate data specifying a position of input on liquid crystal panel 240 based on the scan image obtained in step S501.

In step S505, panel input processing unit 453 determines whether or not a prescribed scan cycle time has elapsed since step S501 was performed. When the scan cycle time has elapsed (YES in step S505), panel input processing unit 453 repeats the processing from step S501 (obtaining of a scan image). When the scan cycle time has not elapsed (NO in step S505), control unit 450 proceeds to processing in step S507.

In step S507, control unit 450 performs the sub application operation. The sub application operation includes performing an operation based on time count. In step S507, control unit 450 may control interface portion 440 so as to transmit data to the first unit 1001 side.

In step S509, control unit 450 causes storage portion 430 to store data determining an operation of the application being executed (referred to as an “operation element”). In the present embodiment, operation parameter 435 including lapse of time since an event or the like and input history 432 fall under the operation element. It is assumed, however, that control unit 450 performs the processing in step S509 at prescribed time intervals, at the time of change in operation element, at the time of saving of the operation element (such as saving of an illustration), or the like. After step S509 is performed, control unit 450 repeats the processing from step S505.

(Mode Switching: from Mouse Mode to Tablet Mode)

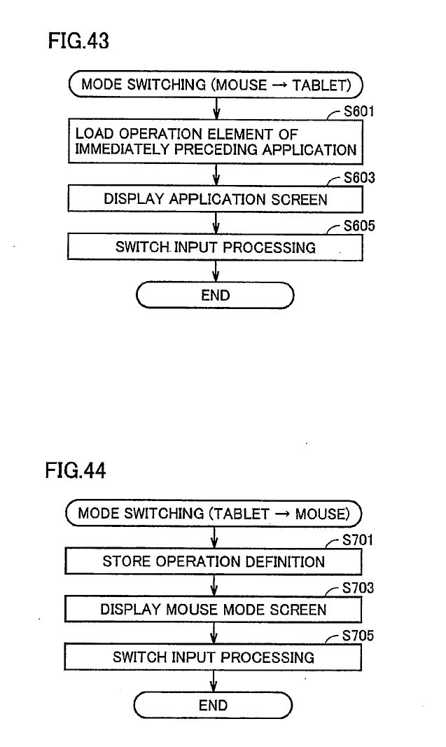

Mode switching (from the mouse mode to the tablet mode) in step S107 in FIG. 40 will be described in detail with reference to FIG. 43. FIG. 43 is a diagram showing in a flowchart form, a flow of processing in the mode switching (from the mouse mode to the tablet mode) operation.

In step S601, mode setting unit 454 included in control unit 450 loads operation definition of the immediately preceding application stored in storage portion 430.

Here, the “immediately preceding application” refers to a sub application that last operated in the tablet mode before mode setting unit 454 accepts an instruction to switch the mode to the tablet mode. In the present embodiment, since the sub application continues to operate also in the mouse mode, the immediately preceding application is the same as the sub application that was operating at the time when an instruction to switch the mode was issued.

In step S603, program execution unit 458 included in control unit 450 resumes the operation of the sub application that has been executed until immediately before, based on the operation definition loaded in step S601. Then, program execution unit 458 controls display control unit 456 to cause display portion 410 to display the operation screen of the sub application.

It should be noted that program execution unit 458 may perform the processing in step S601 at any time during the processing in step S603. Namely, during execution of the immediately preceding application, the operation definition stored in storage portion 430 may be read and the sub application may be executed based on the read data, as necessary.

In step S605, panel input processing unit 453 included in control unit 450 switches a method of processing a signal from panel input portion 422. Namely, panel input processing unit 453 converts a signal from panel input portion 422 to a sub application operation instruction.

(Mode Switching: from Tablet Mode to Mouse Mode)

From now on, mode switching (from the tablet mode to the mouse mode) in step S113 in FIG. 40 will be described in detail.

FIG. 44 is a diagram showing in a flowchart form, a flow of first processing in the mode switching (from the tablet mode to the mouse mode) operation.

Electronic device 100 is configured such that the operation definition of the immediately preceding application is loaded when the operation mode is switched from the mouse mode to the tablet mode. In this case, on liquid crystal panel 240 immediately after switching to the tablet mode, a screen that has been displayed during execution of the previous tablet mode and immediately before switching to the mouse mode is displayed.

When the operation mode is switched from the tablet mode to the mouse mode as a result of pressing or the like of center key 242, this operation definition is stored in storage portion 430 constituted of RAM 271 or the like.

Specifically, in such mode switching, in step S701, program execution unit 458 causes RAM 271 to store as the operation definition, information specifying an application being executed (immediately preceding application) and operation contents of the application at that time point.

Then, when a signal indicating that an instruction to switch the mode has been issued from mode setting unit 454 is received, in step S703, display control unit 456 included in control unit 450 causes liquid crystal panel 240 to display the mouse mode screen based on display data 433.

Then, in step S705, panel input processing unit 453 included in control unit 450 switches a method of processing a signal from panel input portion 422. Namely, panel input processing unit 453 converts a signal from panel input portion 422 to a sub application operation instruction.

When the operation mode is switched from the mouse mode to the tablet mode, the operation definition stored as above is read and loaded (step S601 in FIG. 43). When the operation definition is not stored (an initialized state), the home application is launched in step S601.

When power of electronic device 100 is turned off or when electronic device 100 is rebooted, the stored operation definition is preferably initialized. Thus, when the tablet mode is executed for the first time after normal launch or reboot, resume, or the like of electronic device 100, the home menu is initially displayed on liquid crystal panel 240.

In addition, in electronic device 100, the operation definition is preferably initialized after the sub application is executed and the home application is launched as a result of touch of the home button or the like. In that case, when the operation mode is switched to the mouse mode at this time point, the home application display screen is displayed at the time point of return to the tablet mode. This is because, when the operation definition has been initialized, the home application is launched in step S601. Therefore, when the home application is launched, it is not necessary to store the operation definition of the current tablet mode in switching to the mouse mode.

<As to Processing in Connection with Sub Application “Book”>

In the present embodiment, when the operation mode is switched from the mouse mode to the tablet mode in electronic device 100, information in accordance with operation contents in the tablet mode so far is displayed on liquid crystal panel 240.

For example, in a sub application “Book”, information on history of electronic books selected so far for viewing on a book viewer in that sub application is stored and display based on the history information is provided on liquid crystal panel 240. An operation in accordance with the sub application “Book” will be described hereinafter.

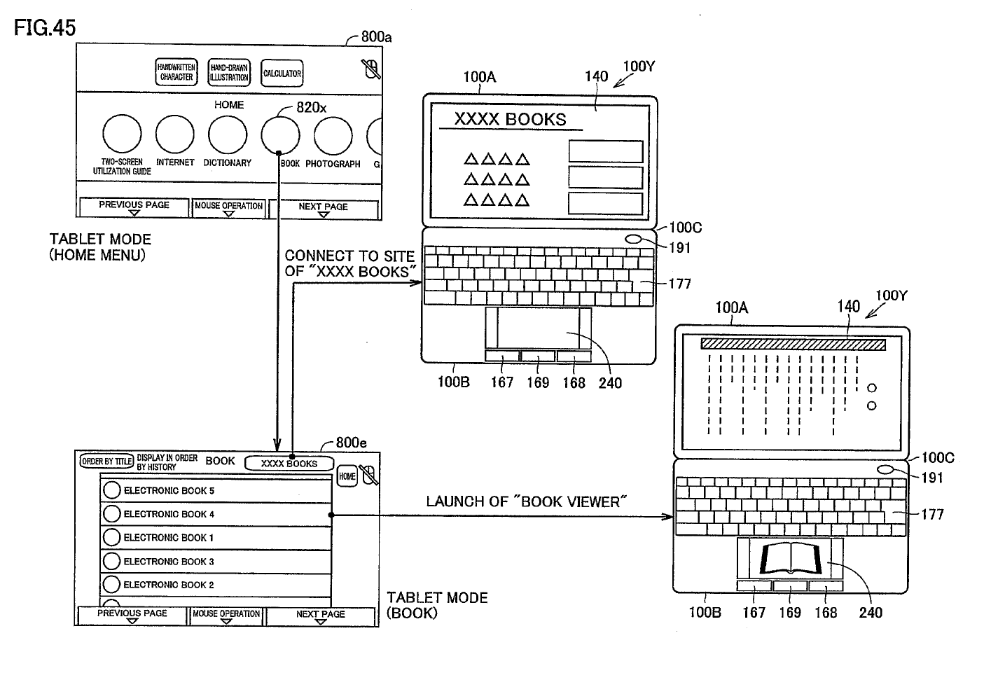

Referring to FIG. 45, when the user selects an operation button display 820x in home menu screen 800a (“book” of the sub screen utilization software), electronic device 100 executes the sub application “Book” and causes liquid crystal panel 240 to display a screen 800e. Screen 800e is an operation screen of the present application.

Screen 800e includes a left guidance indication, a center guidance indication, and a right guidance indication (left guidance indication 812, center guidance indication 814, and right guidance indication 816 in FIG. 37 or the like).

In addition, in screen 800e, characters “Book” indicating the sub application being executed are displayed in the upper center thereof and a character string “order by title” and “display in order by history” is displayed on the left thereof.

In addition, in the center of screen 800e, a soft key displaying a character string of a name for each electronic book, such as “Electronic Book 5,” “Electronic Book 4,” or “Electronic Book 1” indicating the name of the electronic book to be viewed on the book viewer is displayed. In screen 800e, the soft keys representing the respective electronic books are sequenced in the descending order of selection history in the “Book” application.

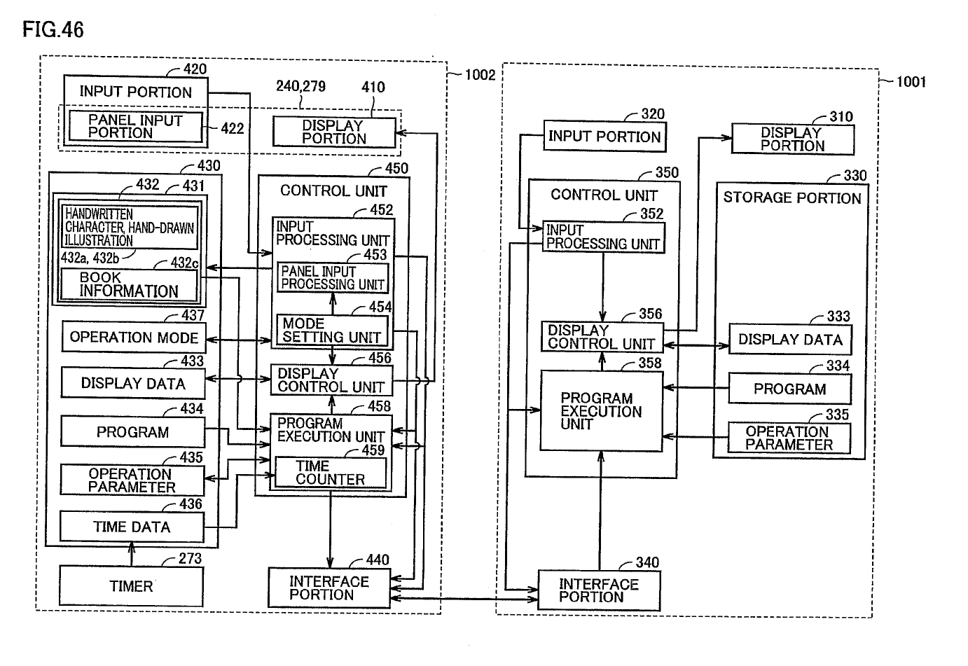

In this case, in electronic device 100, book information 432c is stored as input data 431 in storage portion 430, as shown in FIG. 46.

Book information 432c includes “Book Name Information” shown in Table 1 and “Book History Information” shown in Table 2.

TABLE 1
Book Name Information

| Book No. | Electronic Book Name |
|---|---|
| 1 | Electronic Book 1 |
| 2 | Electronic Book 2 |
| 3 | Electronic Book 3 |
| 4 | Electronic Book 4 |
| 5 | Electronic Book 5 |
| 6 | Electronic Book 6 |
| . | . |
| . | . |
| . | . |

TABLE 2
Book History Information

| History | |
|---|---|
| Rank | Electronic Book Name |
| 1 | Electronic Book 5 |
| 2 | Electronic Book 4 |
| 3 | Electronic Book 1 |
| 4 | Electronic Book 3 |
| 5 | Electronic Book 2 |
| . | . |
| . | . |
| . | . |

Book name information is such information that information specifying an electronic book that can be selected as an electronic book to be viewed on the book viewer is sequenced, for example, in the order by name.

Book history information is such information that information specifying an electronic book selected as the electronic book to be viewed on the book viewer in the “Book” application is sequenced in the order of latest selection.

In the default “Book” application operation screen, information on each electronic book is displayed as a soft key in the order in accordance with the book history information described above.

It should be noted that the information displayed in each soft key may be a name of an electronic book as shown in screen 800e or an image corresponding to an electronic book.

In the “Book” application operation screen, a sequence of display of the soft keys of the respective electronic books can be changed between a sequence in accordance with the book name information and a sequence in accordance with the book history information.

Namely, though the character string of “order by title” and “display in order by history” is displayed in the operation screen, in a case where the soft keys are displayed in a sequence in accordance with the book name information, “order by title” is displayed simply as a character string whereas “display in order by history” is displayed as a soft key. When a selection operation of the soft key “display in order by history” is performed, the sequence of display of the soft keys of the respective electronic books is changed to a sequence in accordance with the book history information. Alternatively, when the soft keys are displayed in a sequence in accordance with the book history information, “order by title” is displayed as the soft key whereas “display in order by history” is displayed simply as a character string. Then, when a selection operation of the soft key “order by title” is performed, the sequence of display of the soft keys of the respective electronic books is changed to a sequence in accordance with the book name information.

In the upper portion of screen 800e, a soft key “XXXX books” is displayed. The soft key is operated for connecting electronic device 100 to a site from which an electronic book can be downloaded. When the soft key “XXXX books” is operated, data for connection to that site is transmitted from control unit 450 to first unit 1001 (step S507). Thus, electronic device 100 is connected to the site and a homepage screen of the site is displayed on liquid crystal panel 140.

Meanwhile, when a soft key for selecting an electronic book in screen 800e is operated, data for viewing an electronic book corresponding to the selected soft key after the book viewer is launched is transmitted from control unit 450 to first unit 1001 (step S507). Thus, in electronic device 100, liquid crystal panel 140 displays a book viewer screen for viewing the selected electronic book. In this case, for example, control unit 450 switches the operation to the mouse mode and accepts such an operation onto liquid crystal panel 240 as page turning in connection with the book viewer.

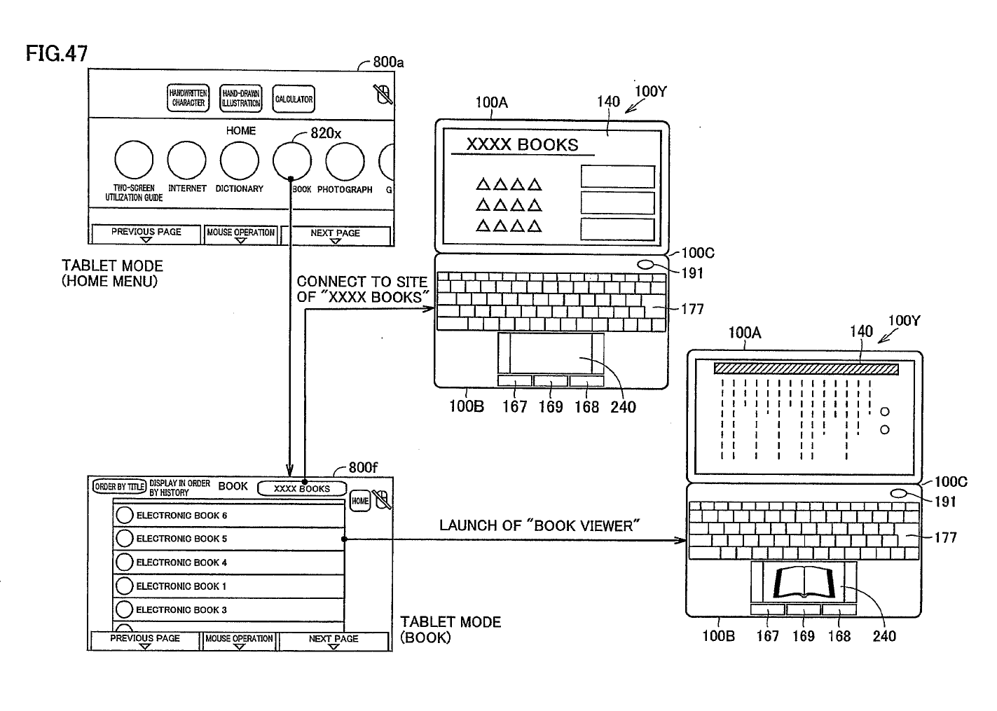

The book history information is updated each time an electronic book is selected in the “Book” application. For example, when an electronic book “Electronic Book 6” is selected in the state shown in Table 2, the book history information is updated to the information shown in Table 3. In response, a sequence of the soft keys corresponding to the electronic books is changed in the operation screen of the “Book” application, as displayed in a screen 800f in FIG. 47.

TABLE 3
Book History Information

| History | |
|---|---|
| Rank | Electronic Book Name |
| 1 | Electronic Book 6 |
| 2 | Electronic Book 5 |
| 3 | Electronic Book 4 |
| 4 | Electronic Book 1 |
| 5 | Electronic Book 3 |
| 6 | Electronic Book 2 |
| . | . |
| . | . |
| . | . |

[Variation 4]

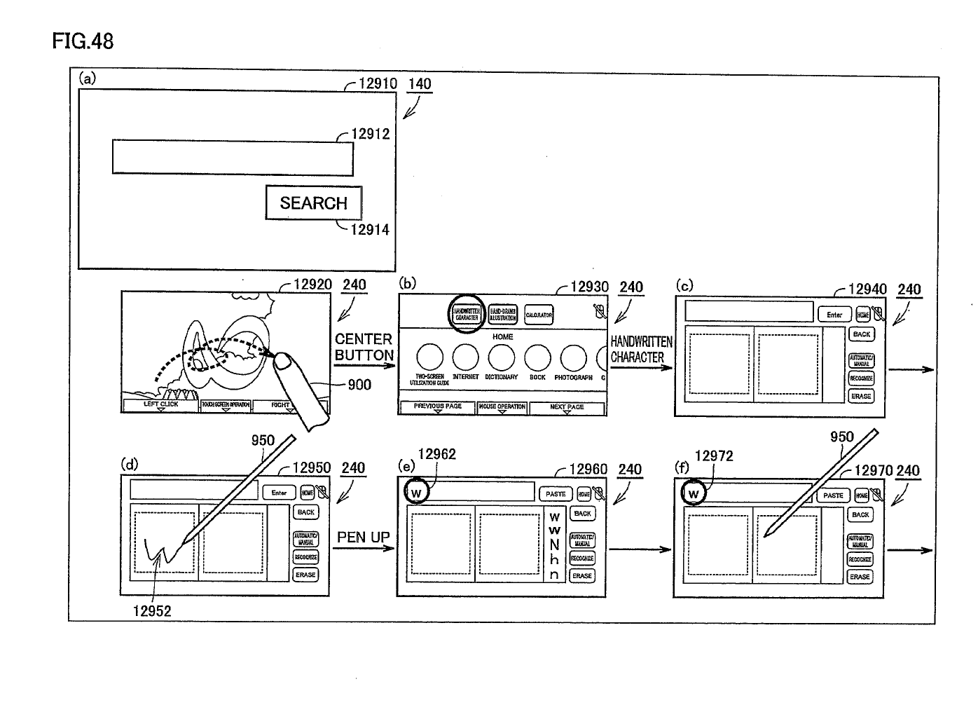

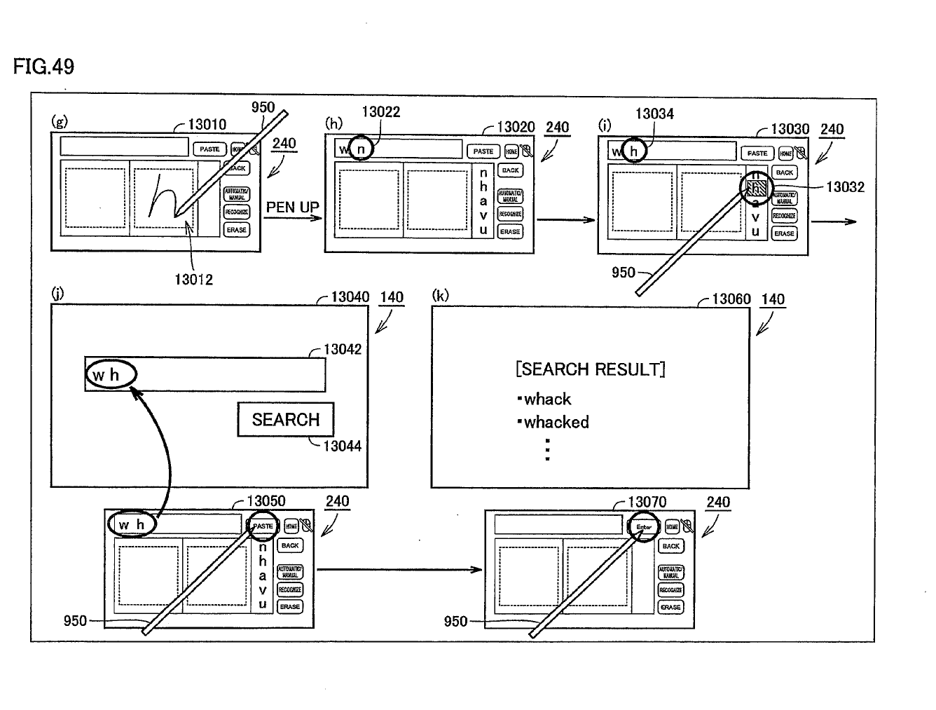

A method of making use of a handwriting character input pad will be described as Variation 4 of the present embodiment with reference to FIGS. 48 and 49. Here, an operation example where the user inputs a character string (strings or phrase) consisting of two Chinese characters by using liquid crystal panel 240 during use of an application for displaying a screen including a search box (such as a Web browser) and conducts search relating to the input character string will be described.

A screen 12910 is a screen displayed on liquid crystal panel 140 in the mouse mode. Here, liquid crystal panel 240 displays a mouse screen 12920. Screen 12910 displayed on liquid crystal panel 140 is a main application operation screen. Screen 12910 includes a search box 12912 and a search start button 12914. It is assumed that search box 12912 is activated as a result of a mouse operation as finger 900 is moved over liquid crystal panel 240.

A screen 12930 is a screen displayed on liquid crystal panel 240 when an instruction to switch the mode (specifically, pressing of center key 242) is issued while screen 12910 is displayed on liquid crystal panel 140.

Here, screen 12930 is the home menu screen.

A screen 12940 is a screen displayed on liquid crystal panel 240 after a button (surrounded by a circle in screen 12930) for calling the handwriting character input pad is pressed in screen 12930. Screen 12940 is the character input screen.

A screen 12950 is a screen displayed on liquid crystal panel 240 when a handwritten input is provided to screen 12940 with the use of stylus 950. Graphics 12952 corresponding to the handwritten input is displayed in an input area in screen 12950.

A screen 12960 is a screen displayed on liquid crystal panel 240 when stylus 950 moved away from liquid crystal panel 240. Candidate characters (five characters) corresponding to the handwritten inputs are displayed in a candidate area in screen 12950. In addition, a first candidate character 12962 among the candidates displayed in the candidate area is displayed in a text box.

A screen 12970 represents one example of a screen displayed on liquid crystal panel 240 when first candidate character 12962 is confirmed. A character 12972 is a confirmed character. In screen 12970, a candidate character is no longer displayed in the candidate area.

Referring to FIG. 49, a screen 13010 is a screen displayed on liquid crystal panel 240 while the user provides a handwritten input with the use of stylus 950 after screen 12970 is displayed. Screen 13010 includes graphics 13012 corresponding to the handwritten input.

A screen 13020 is a screen displayed on liquid crystal panel 240 when stylus 950 that has touched screen 13010 moved away from screen 13010 (liquid crystal panel 240). In a candidate area in a screen 13030, candidate characters corresponding to the handwriting input are displayed. In addition, in a text box, a first candidate character 13022 among the candidate characters is added on the right of the already-confirmed character (see screen 12970 in FIG. 48).

Screen 13030 is a screen displayed on liquid crystal panel 240 when a character 13032 in the candidate area is pressed with stylus 950 in screen 13020. As character 13032 is pressed, the character displayed in the text box changes to the character that has been displayed as character 13032 (a character 13034).

Screens 13040 and 13050 are screens displayed on liquid crystal panels 140 and 240 respectively, after character 13034 is confirmed. Screen 13040 includes a search box 13042 and a search start button 13044. When a paste button in display screen 13050 is pressed with stylus 950 after character 13034 is confirmed, a character string in the text box is input into active search box 13042.

Screens 13060 and 13070 are screens displayed on liquid crystal panels 140 and 240 respectively, after the Enter button (paste button) is pressed in screen 13050 and search button 13044 is pressed in screen 13040. Pressing of the Enter button in display screen 13070 achieves an effect the same as that of pressing of search start key 13044. Namely, the main application conducts search relating to a character string in search box 13042 in response to pressing of the Enter button and causes screen 13060 to display a search result.

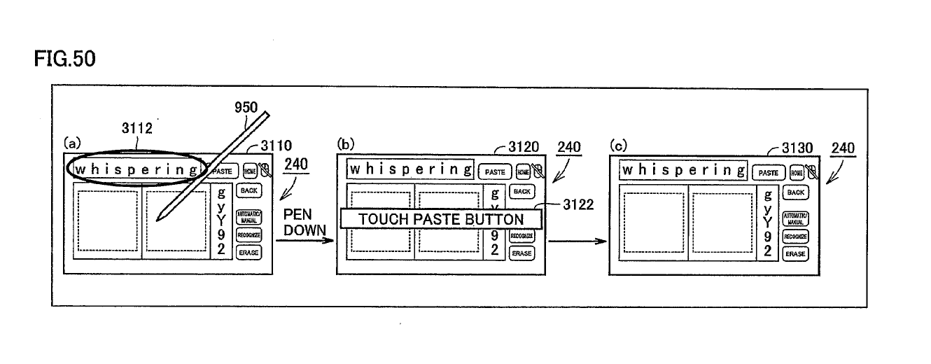

In the present embodiment, when the text box is full (a maximum number of acceptable characters has been input in the text box), electronic device 100 does not accept any more handwriting. An operation of electronic device 100 at the time when the text box is full will be described with reference to FIG. 50.

A screen 13110 shows a screen displayed on liquid crystal panel 240 while the user uses stylus 950 to provide inputs into an input area with the text box being already full (ten characters have been input in the text box). A character string 13112 (a character string including ten characters) is displayed in the text box in screen 13110.

When stylus 950 comes in contact with liquid crystal panel 240, electronic device 100 causes liquid crystal panel 240 to display a screen 13120 including a warning indication 13122. Warning indication 13122 includes a character string prompting confirmation of characters, that is, pressing of the paste button. Though the character string included in warning indication 13122 is herein set to “touch paste button,” the character string is not limited thereto.

After warning indication 13122 is displayed, liquid crystal panel 240 displays a screen 13130. Screen 13130 displays contents the same as contents displayed in screen 13110. The user can continue character input by pressing the paste button to confirm the character string displayed in the text box or by pressing the back button to erase the character already input in the text box while this screen 13130 is displayed. It should be noted that, for example, electronic device 100 changes a screen to be displayed on liquid crystal panel 240 from screen 13120 to screen 13130 automatically after a prescribed period of time has passed since display of warning indication 13122 or in response to some kind of instruction to liquid crystal panel 240.

It is assumed in the present embodiment that handwritten character data 432a (see FIG. 19) is temporarily stored in RAM 271 or the like and electronic device 100 discards handwritten character data 432a when the handwriting character input pad ends. Therefore, when the handwriting character input pad is again called, the user can newly input a character.

It should be noted that electronic device 100 may hold handwritten character data 432a so that the user can resume handwriting input from the previous state when he/she uses the handwriting input pad again. In this case, when the handwriting character input pad is resumed, electronic device 100 causes liquid crystal panel 240 to display graphics corresponding to handwritten character data 432a, based on handwritten character data 432a.

It should be noted that the user may be able to select which of the two operations above should be performed by the handwriting character input pad (whether to hold handwritten character data 432a or not). In this case, the user can determine as appropriate which of the two operations above should be performed by the handwriting character input pad, in accordance with a manner of use of the handwriting character input.

[Variation 5]

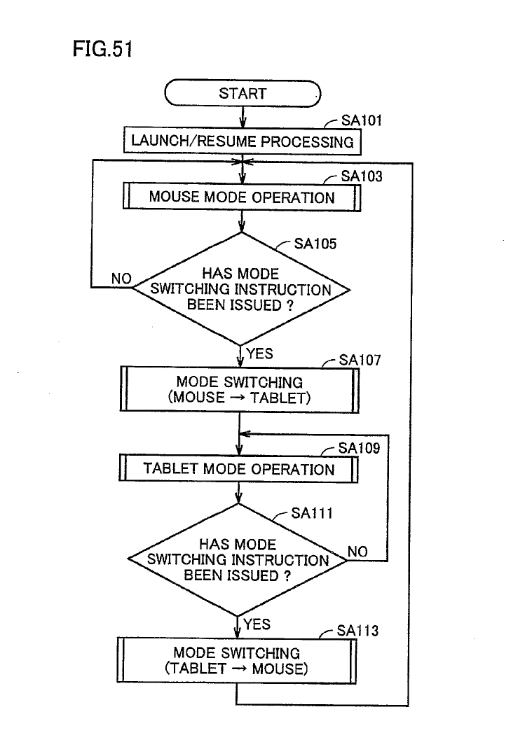

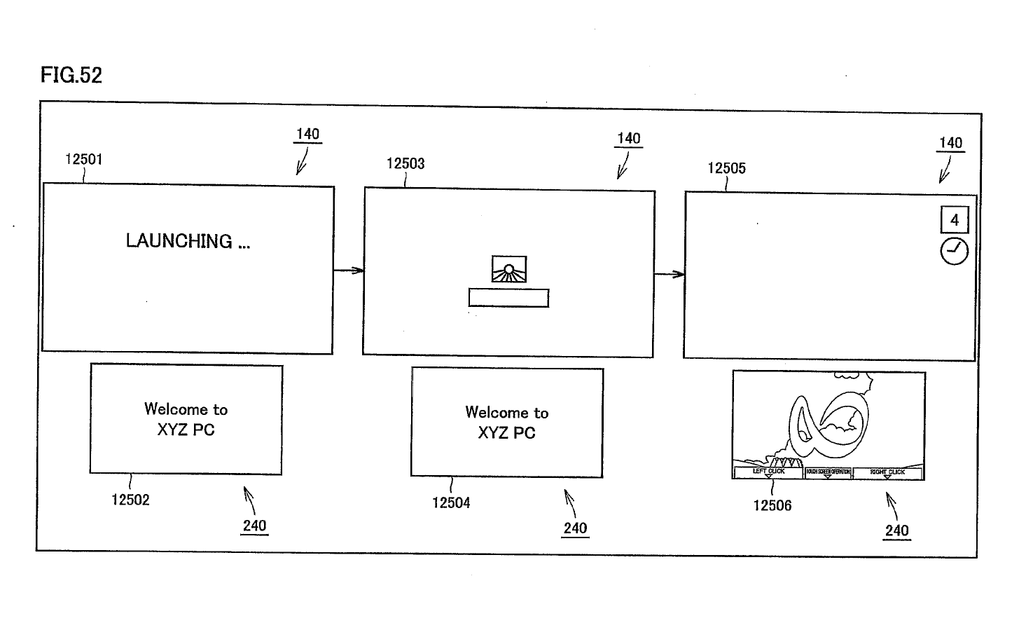

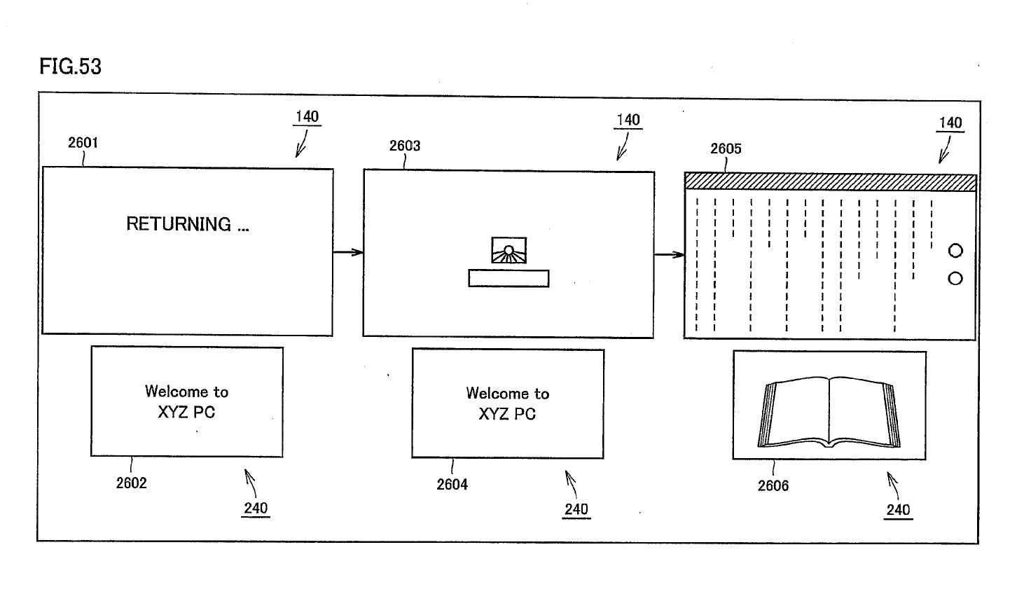

FIG. 51 is a flowchart of a variation of the processing in electronic device 100 shown in FIG. 38.

A flow of processing performed by electronic device 100 according to the present embodiment will be described with reference to FIG. 51. It should be noted that FIG. 51 collectively shows processing performed by control unit 350 in first unit 1001 and processing performed by control unit 450 in second unit 1002.

In SA101, when an instruction for normal launch (including reboot) of electronic device 100 or a resume instruction is accepted, control unit 350 and control unit 450 perform normal launch processing or resume processing.

As described already, normal launch refers to launch from the power off state. The normal launch processing performed by control unit 350 includes, for example, boot processing and display of a boot screen on liquid crystal panel 140. Normal launch processing performed by control unit 450 includes display of a boot screen on liquid crystal panel 240.

Control unit 350 and control unit 450 regard pressing of a prescribed button (power switch 191 or the like) in the power off state as an instruction for normal launch. It should be noted that the configuration may be such that one control unit (control unit 450 or 350) accepts a normal launch instruction, then performs its own normal launch processing, and provides the other control unit (control unit 350 or 450) with an instruction for normal launch processing.

As described already, resume refers to launch from the power save state. The resume processing performed by control unit 350 includes reading of a working state stored in RAM 171, HDD 170 or the like and display of a resuming screen on liquid crystal panel 140. The resume processing performed by control unit 450 includes reading of a working state stored in RAM 271, HDD 170 or the like and display of a resuming screen on liquid crystal panel 240.

Control unit 350 and control unit 450 regard pressing of a prescribed button (power switch 191 or the like) in the power save state or touch or the like onto liquid crystal panel 240 as a resume instruction. It should be noted that one control unit (450 or 350) may perform the resume processing in response to an instruction from the other control unit (350 or 450) that accepted the resume instruction.

Then, in step SA103, control unit 350 and control unit 450 proceed to the mouse mode operation.

When a mode switching instruction has been issued during the mouse mode (YES in step SA105), control unit 450 performs processing for switching from the mouse mode to the tablet mode in step SA107. When a mode switching instruction has not been issued (NO in step SA105), control unit 350 and control unit 450 repeat the processing from step SA103 (the mouse mode operation).

In step SA107, control unit 450 performs the processing for switching from the mouse mode to the tablet mode. For example, control unit 450 causes liquid crystal panel 240 to display a sub application operation screen and switches an operation of panel input processing unit 453 in step SA107. Details of the processing for switching from the mouse mode to the tablet mode will be described later. After step SA107 ends, control unit 350 and control unit 450 proceed to the tablet mode operation in step SA109.

In step SA109, control unit 350 and control unit 450 perform the tablet mode operation. Namely, control unit 350 and control unit 450 control each portion of electronic device 100 such that the sub application operates in response to an input to liquid crystal panel 240. Details of the tablet mode operation will be described later.

In step SA111, mode setting unit 454 determines whether a mode switching instruction has been accepted or not. Specifically, mode setting unit 454 determines whether a signal in response to pressing of center key 242 has been accepted or not. It should be noted that the mode switching instruction is not limited to pressing of center key 242.

When a mode switching instruction is issued during the tablet mode (YES in step SA111), control unit 450 performs processing for switching from the tablet mode to the mouse mode in step SA113. When a mode switching instruction is not issued (NO in step SA111), control unit 350 and control unit 450 repeat the processing from step SA109 (the tablet mode operation).

In step SA113, control unit 450 performs processing for switching from the tablet mode to the mouse mode. For example, control unit 450 causes liquid crystal panel 240 to display the mouse screen and switches an operation of panel input processing unit 453 in step SA113. Details of the processing for switching from the tablet mode to the mouse mode will be described later. After step SA113 ends, control unit 350 and control unit 450 proceed to the mouse mode operation in step SA103.

It should be noted that control unit 350 and control unit 450 perform processing for cutting off power or processing for making transition to the power save state at the time point when an instruction to cut off power or reboot or an instruction to make transition to the power save state is accepted. Such processing is interrupt processing, and it is performed after any step in FIG. 51. It should be noted that such processing is not shown in FIG. 51.

In addition, as described with reference to FIG. 28, in electronic device 100, in resuming from the power save state, resuming screen 2601 is displayed on liquid crystal panel 140 and the operation mode is fixed to the mouse mode. Therefore, even when an operation corresponding to the mode switching instruction is performed during the resume operation, control unit 350 and control unit 450 do not accept the operation. Therefore, during the resume operation, the process does not proceed from step SA105 to step SA107.

Moreover, as described with reference to FIG. 28, after the power save state is completed, electronic device 100 causes liquid crystal panel 240 to display display screen 2606 based on the sub application that has been operating immediately before transition to the power save state.

Such control contents are implemented as follows. Namely, electronic device 100 is configured such that a signal corresponding to an instruction to switch from the mouse mode to the tablet mode is generated at the time of completion of the power save state. Then, generation of the signal advances the processing from step SA105 to step SA107. Thus, during the resuming operation from the power save state, the operation mode of electronic device 100 is fixed to the mouse mode (step SA103 to step SA105), and when the resuming operation from the power save state is completed, the operation mode of electronic device 100 is switched to the tablet mode (step SA107).

[As to Essential Effect of the Present Embodiment]

In the present embodiment, the first display portion is implemented by liquid crystal panel 140 and the second display portion is implemented by liquid crystal panel 240.

In addition, the first mode is implemented in electronic device 1 by the mouse mode in which a program operation screen created as a result of execution of program 334 in response to an input to liquid crystal panel 240 is displayed on liquid crystal panel 140.

Moreover, the second mode is implemented in electronic device 1 by the tablet mode in which a program operation screen generated as a result of execution of program 434 (or program 334) in response to an input to liquid crystal panel 240 is displayed on liquid crystal panel 240.

Then, in electronic device 1, as center key 242 or the like is pressed, the mode above is switched.

As described above, electronic device 1 may be configured such that the operation definition of the immediately preceding application is loaded when the operation mode is switched from the mouse mode to the tablet mode. In this case, on liquid crystal panel 240 immediately after switching to the tablet mode, a screen that has been displayed during execution of the previous tablet mode and immediately before switching to the mouse mode is displayed.

In the present embodiment described above, the operation of the sub application has ended by the time of switching of the operation mode to the mouse mode, however, electronic device 100 may be configured such that the sub application continues to operate also in the mouse mode.

In addition, in the embodiment of the present invention described above, liquid crystal panel 140 may not have a function as an input portion but may be a display providing display alone of a screen (a single-function display). In particular, in a case where liquid crystal panel 140 has a large size and it is difficult to use this as a touch panel, such a configuration is useful.

Moreover, first unit 1001 and second unit 1002 operate independently of each other, except for exchange of data. Therefore, second unit 1002 may be removable from first unit 1001.

Further, in electronic device 100, second unit 1002 may be configured to be replaceable with other units (such as a mobile information terminal) having a function equivalent to that of second unit 1002. Therefore, a system including an electronic device including first unit 1001 and a unit connected or connectable to the electronic device may be considered as one embodiment of the present invention.

According to the present embodiment, in the electronic device including the first display portion and the second display portion, operations in two types of modes of the first mode causing the first display portion to display a screen created by the processing performed in accordance with an input to a tablet including the second display portion and the second mode mainly causing the second display portion to display a screen crated by the processing performed in accordance with an input to the tablet can be performed, and the operation mode is switched between the first mode and the second mode in accordance with an operation onto operation means.

Therefore, the user can use the electronic device including two display devices (first and second display portions) in both of the first mode and the second mode and the user can seamlessly use the electronic device by switching between these modes with a simplified operation.

In particular, the present invention is effective in a case where the electronic device can execute a plurality of sub applications in the second mode and an operation to switch between each sub application and the first mode is frequently performed.

[Variation 7]

In Variation 7 of electronic device 100 according to the present embodiment, cursor display control is carried out.

<Cursor Display Control>

In electronic device 100, in the mouse mode, a cursor displayed on liquid crystal panel 140 can be moved by changing a position of input on liquid crystal panel 240 (such as sliding an object over liquid crystal panel 240).

Meanwhile, in electronic device 100, in the tablet mode, a cursor is not moved by changing a position of input on liquid crystal panel 240 (such as sliding an object over liquid crystal panel 240). Namely, in the tablet mode, cursor display does not directly relate to an operation of the main application. Therefore, in order not to impair visibility of an image displayed on liquid crystal panel 140, in the tablet mode, cursor display is preferably less conspicuous.

In the present embodiment, electronic device 100 causes a cursor to be displayed in the tablet mode in a form of display less conspicuous than a form of display in the mouse mode. Specifically, electronic device 100 causes a cursor to be displayed in the tablet mode in a less intense manner than in the mouse mode. More specifically, for example, electronic device 100 lowers luminance of a cursor. Alternatively, electronic device 100 increases transmittance of a display color of a cursor.

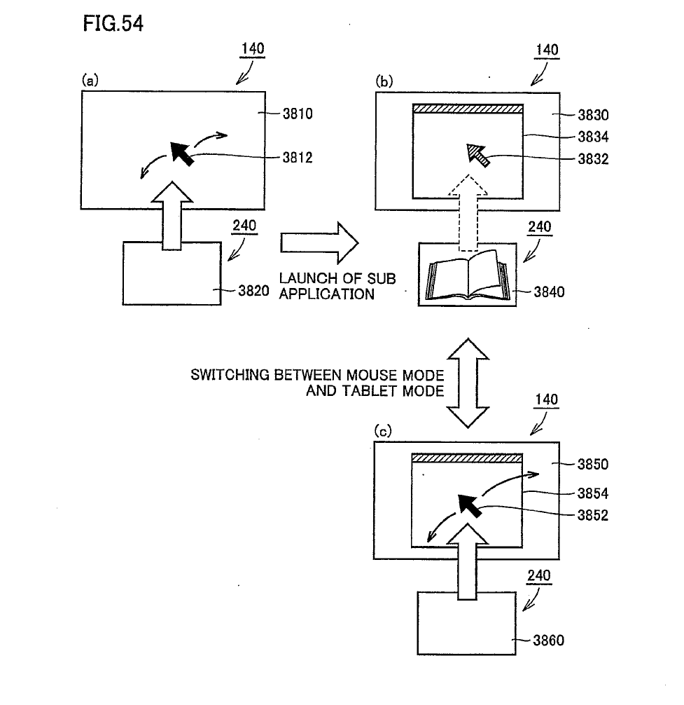

Change in cursor display control according to the present embodiment will be described with reference to FIG. 54. FIG. 54 is a diagram for illustrating change in cursor display control according to the first embodiment.

FIG. 54 shows a display screen 3810 on liquid crystal panel 140 and a display screen 3820 on liquid crystal panel 240 in the mouse mode.

Display screen 3810 includes a cursor 3812. An operation screen of the main application is displayed in a portion in display screen 3810 other than cursor 3812.

Display screen 3820 displays a mouse screen such as wallpaper. For the sake of brevity, however, FIG. 54 does not illustrate the operation screen of the main application and the mouse screen in detail, which is also similarly applicable to the drawings below.

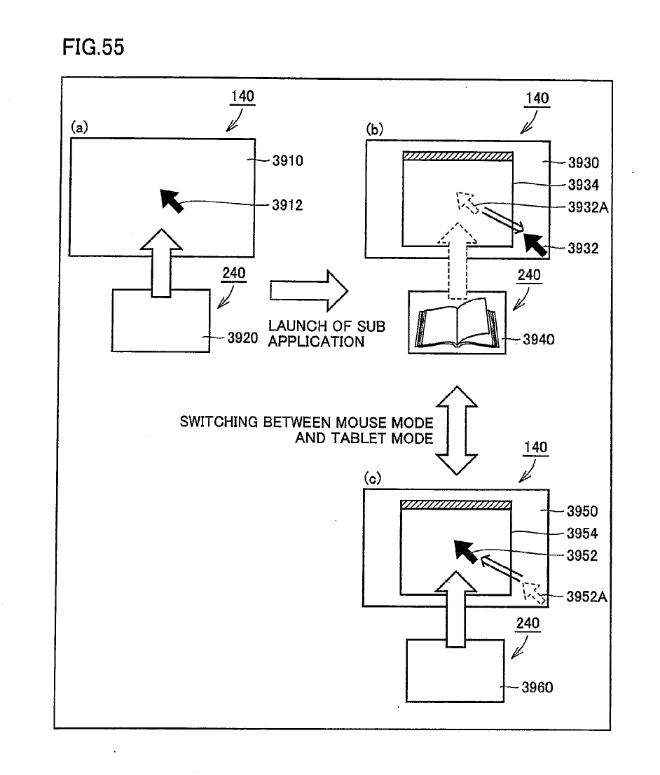

In the mouse mode, electronic device 100 causes cursor 3812 to move in real time in accordance with change in position of input on liquid crystal panel 240, which is shown in FIG. 55 with a solid arrow extending from liquid crystal panel 240 toward liquid crystal panel 140.

In addition, FIG. 54 shows a display screen 3830 on liquid crystal panel 140 and a display screen 3840 on liquid crystal panel 240 in the tablet mode. Here, a case where electronic device 100 launched a book viewer application from the home application in the tablet mode is shown by way of example. It should be noted that description of an operation of electronic device 100 here is also applicable to a case where electronic device 100 launched a sub application other than the book viewer.

Display screen 3830 includes a cursor 3832 and a window 3834. Window 3834 is created by the executed book viewer application. Window 3834 displays an operation screen of the book viewer application.

Cursor 3832 is lower in display density than cursor 3812 in the mouse mode. It should be noted that, in display screen 3830 in FIG. 54, in order to express less intense cursor 3832, cursor 3832 is shown as being hatched inside. Actually, cursor 3832 does not have to be displayed with a hatched line.

Display screen 3840 displays an operation assistance screen of the book viewer application. The user can turn a page or the like by operating the operation assistance screen. The user, however, is not able to move cursor 3832 by changing a position of input on liquid crystal panel 240. Namely, in the tablet mode, electronic device 100 does not allow change in position of input on liquid crystal panel 240 to be reflected on movement of cursor 3832. In display screen 3830 in FIG. 54, this fact is shown with a dashed arrow extending from liquid crystal panel 240 toward liquid crystal panel 140.

If it is assumed that electronic device 100 changes a position of cursor 3832 based on a position of input on liquid crystal panel 240, cursor 3832 is moved each time the user performs such an operation as page turning, and hence visibility of liquid crystal panel 140 may become poor. Electronic device 100 controls a cursor position on liquid crystal panel 140 independently of a position of input on the tablet in the tablet mode as in the present embodiment, so that the display screen on liquid crystal panel 140 can be prevented from becoming difficult to view.

In addition, as a form of display of a cursor is varied between the mouse mode and the tablet mode, the user can more readily grasp whether or not the cursor is movable based on an input to liquid crystal panel 240.

Display screens 3850 and 3860 in FIG. 54 are display screen 3850 on liquid crystal panel 140 and display screen 3860 on liquid crystal panel 240 after transition from the states shown in display screens 3830 and 3840 in FIG. 54 (the tablet mode) to the mouse mode, respectively.

Display screen 3850 includes a cursor 3852 and a window 3854. Window 3854 is the same as window 3834 in the tablet mode. Namely, electronic device 100 successively causes liquid crystal panel 140 to display the operation screen of the application that has been displayed on liquid crystal panel 140 in the tablet mode also after transition from the tablet mode to the mouse mode.

In contrast, electronic device 100 successively causes liquid crystal panel 140 to display the operation screen of the application that has been displayed on liquid crystal panel 140 in the mouse mode also after transition from the mouse mode to the tablet mode.

Thus, electronic device 100 causes liquid crystal panel 140 to display the same operation screen before and after switching between the mouse mode and the tablet mode. Therefore, operability of electronic device 100 is improved. The user can selectively perform a mouse operation or an operation of an application assisting an operation of an application of which operation screen is displayed on liquid crystal panel 140, as necessary, while the user visually recognizes the operation screen of the application displayed on liquid crystal panel 140.

Cursor 3852 is displayed in a form of display the same as that of cursor 3812 on display screen 3810. Namely, in the mouse mode, electronic device 100 causes liquid crystal panel 140 to display a cursor in the same form.

Display screen 3860 is a mouse screen, similarly to display screen 3820. In addition, electronic device 100 causes cursor 3852 to move in accordance with change in position of input on liquid crystal panel 240.

An example where electronic device 100 causes the cursor to be displayed in the tablet mode in a manner less intense than in the mouse mode has been described so far with reference to FIG. 54, however, a method of making a cursor less conspicuous in the tablet mode is not limited thereto.

For example, electronic device 100 may stop cursor display in the tablet mode. Namely, electronic device 100 may make a cursor invisible in the tablet mode, which can be regarded also as one form of change in form of display. Namely, electronic device 100 can make a cursor invisible by setting the cursor to completely transparent.

Alternatively, electronic device 100 may make a cursor invisible in the tablet mode by creating display data not including a cursor. In this case, electronic device 100 causes a cursor to be displayed at a prescribed position (for example, at a corner of a screen on liquid crystal panel 140) after transition from the tablet mode to the mouse mode. Alternatively, electronic device 100 may cause such a storage device as RAM 271 to store a cursor position at the time of transition to the tablet mode, read the cursor position from the storage device at the time of transition to the mouse mode, and then cause the cursor to be displayed at the read cursor position.

Further, in the tablet mode, electronic device 100 may move a position of display of the cursor in order to make the cursor less conspicuous. This operation example will be described with reference to FIG. 55. FIG. 55 is a diagram for illustrating change in cursor display control according to a variation of the first embodiment.

FIG. 55 shows a display screen 3910 on liquid crystal panel 140 and a display screen 3920 on liquid crystal panel 240 in the mouse mode. Display screen 3910 includes a cursor 3912. Display screen 3920 is a mouse screen. While display screens 3910 and 3920 are displayed on liquid crystal panels 140 and 240 respectively, electronic device 100 operates as in the state where display screens 3810 and 3820 are displayed. Namely, electronic device 100 causes cursor 3912 to move in accordance with a position of input on liquid crystal panel 240.

FIG. 55 further shows a display screen 3930 on liquid crystal panel 140 and a display screen 3940 on liquid crystal panel 240 in the tablet mode. Here, a case where electronic device 100 executes the book viewer is shown by way of example, similarly to display screens 3830 and 3840. It should be noted that description of the operation of electronic device 100 here is again applicable also to a case where electronic device 100 executes an application other than the book viewer.

Display screen 3930 includes a cursor 3932 and a window 3934. Window 3934 is created by the application, similarly to window 3834 in display screen 3830.

Cursor 3932 is located at the lower right corner of the screen. Namely, in the tablet mode, electronic device 100 moves the cursor in the mouse mode to a prescribed position. By thus changing a position of display of the cursor, window 3934 can be prevented from becoming difficult to view due to the cursor. For facilitated understanding, FIG. 55(b) shows with a dashed line, a virtual cursor 3932A corresponding to a position of cursor 3912 in the mouse mode.

In the present embodiment, electronic device 100 causes the cursor to move to the lower right corner of the screen of the display. By thus moving the cursor to an end portion of the screen of the display, visibility of the screen can more reliably be improved. It should be noted that the “end portion” herein is not limited to four corners of the screen but it may be a side of the screen or a region within a prescribed distance from each side. In addition, the entire cursor does not have to be displayed, and the cursor may be hidden at the end of the screen in part or substantially in its entirety.

In addition, in the present embodiment, as shown in FIG. 55, a form of display of cursor 3932 is assumed as being the same as the form of display in the mouse mode. It should be noted that electronic device 100 may change a form of display of the cursor after movement, for example, by displaying the cursor in a manner less intense than in the mouse mode.

FIG. 55 shows a display screen 3950 on liquid crystal panel 140 and a display screen 3960 on liquid crystal panel 240 when transition to the mouse mode is made from the state where display screens 3930 and 3940 are displayed (the tablet mode).

Display screen 3950 includes a cursor 3952 and a window 3954. Relation between window 3934 and window 3954 in FIG. 55 is the same as relation between window 3834 and window 3854 in FIG. 54.

Cursor 3952 is displayed at a position the same as that of cursor 3812 shown in display screen 3910. Namely, electronic device 100 causes a cursor to be displayed at the same position in the screen on liquid crystal panel 140 before transition from the mouse mode to the tablet mode and after returning from the tablet mode to the mouse mode. For facilitated understanding, a virtual cursor 3952A corresponding to a position of cursor 3932 in the tablet mode is shown with a dashed line in display screen 3950 in FIG. 55.

For this movement of the cursor, electronic device 100 causes such a storage device as RAM 271 to store a cursor position in transition from the mouse mode to the tablet mode. Then, in returning from the tablet mode to the mouse mode, electronic device 100 reads the stored cursor position and causes the cursor to be displayed at the read cursor position.

By thus displaying the cursor at the same position in the mouse mode before and after the tablet mode, the user can perform the mouse operation from the same position even when transition from the mouse mode to the tablet mode is once made and thereafter the mode returns to the mouse mode again.

It should be noted that, when transition from the tablet mode to the mouse mode is made, electronic device 100 does not necessarily have to move the cursor to the position before transition to the tablet mode. Not moving the cursor here may facilitate the user's mouse operation.

Display screen 3960 is a mouse screen, similarly to display screen 3920. In addition, electronic device 100 causes cursor 3952 to move in accordance with change in position of input on liquid crystal panel 240.

[Variation 8]

(Mode Switching: from Mouse Mode to Tablet Mode)

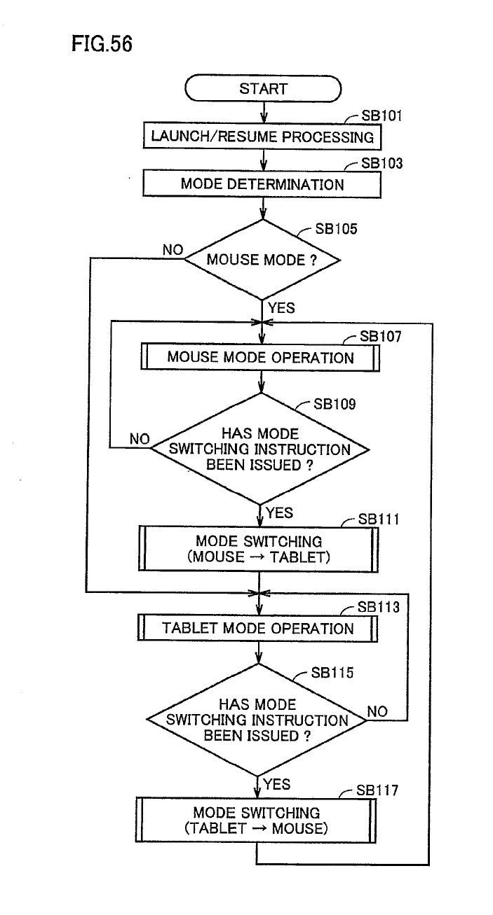

Mode switching (from the mouse mode to the tablet mode) in step SB 111 in FIG. 56 will be described in detail with reference to FIG. 59. FIG. 59 is a diagram showing in a flowchart form, a flow of processing in the mode switching (from the mouse mode to the tablet mode) operation.

In step SB601, mode setting unit 454 included in control unit 450 loads the operation element of the immediately preceding application stored in storage portion 430.

Here, the “immediately preceding application” refers to a sub application that last operated in the tablet mode before mode setting unit 454 accepts an instruction to switch the mode to the tablet mode. In the present embodiment, since the sub application continues to operate also in the mouse mode, the immediately preceding application is the same as the sub application that was operating at the time when an instruction to switch the mode was issued.

In step SB603, program execution unit 458 included in control unit 450 executes the immediately preceding application based on the operation element loaded in step SB601. Then, program execution unit 458 controls display control unit 456 to cause display portion 410 to display the operation screen of the sub application.

It should be noted that program execution unit 458 may perform the processing in step SB601 at any time during the processing in step SB603. Namely, during execution of the immediately preceding application, the operation element stored in storage portion 430 may be read and the sub application may be executed based on the read data, as necessary.

In step SB605, panel input processing unit 453 included in control unit 450 switches a method of processing a signal from panel input portion 422. Namely, panel input processing unit 453 converts a signal from panel input portion 422 to a sub application operation instruction.

In step SB607, program execution unit 358 and display control unit 356 change cursor display on liquid crystal panel 140. Details of processing for changing cursor display will be described later.

(Mode Switching: from Tablet Mode to Mouse Mode)

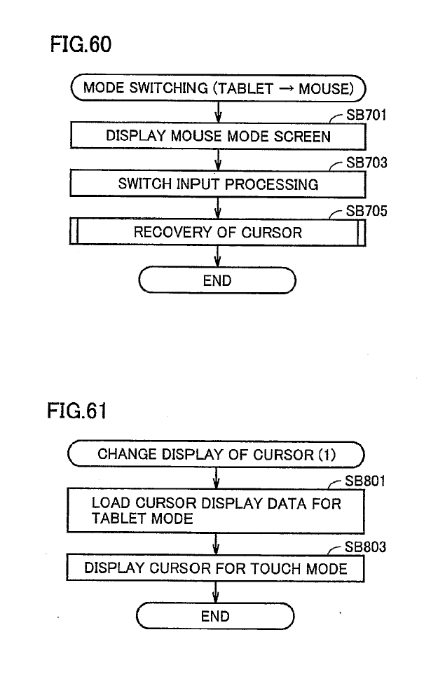

From now on, mode switching (from the tablet mode to the mouse mode) in step SB117 in FIG. 56 will be described in detail with reference to FIG. 60. FIG. 60 is a diagram showing in a flowchart form, a flow of processing in the mode switching (from the tablet mode to the mouse mode) operation.

In step SB701, when display control unit 456 included in control unit 450 receives a signal indicating that an instruction to switch the mode has been issued from mode setting unit 454, display control unit 456 causes liquid crystal panel 240 to display the mouse mode screen based on display data 433.

In step SB703, panel input processing unit 453 included in control unit 450 switches a method of processing a signal from panel input portion 422. Namely, panel input processing unit 453 converts a signal from panel input portion 422 to a signal for a mouse operation on liquid crystal panel 140.

In step SB705, program execution unit 358 and display control unit 356 included in control unit 350 perform processing for recovering cursor display changed at the time of transition from the mouse mode to the tablet mode. Details of cursor recovery processing will be described later.

(Cursor Display Change and Recovery [No. 1]. Change in Form of Display)

From now on, details of processing in step SB607 in FIG. 59 (change in cursor display) and processing in step SB705 in FIG. 60 (recovery of cursor) will be described.

Initially, processing performed by control unit 350 in a case where a form of display of a cursor is changed between the mouse mode and the tablet mode, such as less intense display of a cursor in the tablet mode, will be described with reference to FIG. 61. FIG. 61 is a diagram showing in a flowchart form, a flow of processing for changing a form of display of a cursor.

In step SB801, display control unit 356 included in control unit 350 loads cursor display data for the tablet mode from storage portion 330. The cursor display data for the tablet mode is assumed to be stored in advance in storage portion 330. The cursor display data for the tablet mode is different from the cursor display data for the mouse mode (which is also assumed to be stored in storage portion 330). Specifically, the cursor display data for the tablet mode is set to have lower luminance or higher transmittance than that of the cursor display data for the mouse mode.

In step SB803, display control unit 356 causes liquid crystal panel 140 to display a cursor for a touch mode based on the cursor display data for the tablet mode loaded in step SB801.

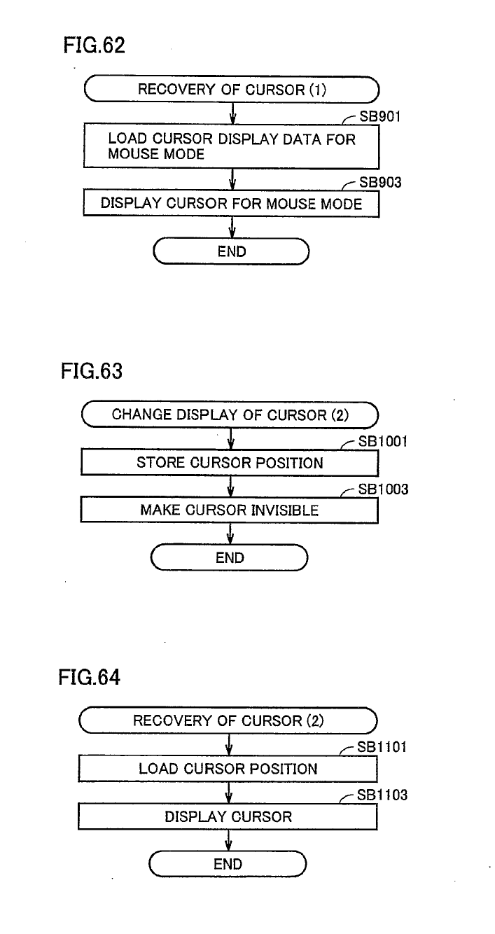

Processing for recovering a cursor corresponding to change in the form of display of the cursor described with reference to FIG. 61 will be described with reference to FIG. 62. FIG. 62 is a diagram showing in a flowchart form, a flow of processing for recovering a form of display of a cursor.

In step SB901, display control unit 356 included in control unit 350 loads cursor display data for the mouse mode from storage portion 330.

In step SB903, display control unit 356 causes liquid crystal panel 140 to display a cursor for the mouse mode based on the cursor display data for the mouse mode loaded in step SB901.

It is assumed here that display control unit 356 causes the cursor display data for the tablet mode and the mouse mode to be stored in advance, however, display control unit 356 may create one cursor display data based on the other cursor display data. For example, display control unit 356 may create cursor display data by subjecting the cursor display data for the mouse mode stored in advance to prescribed change processing relating to luminance or transmittance.

(Cursor Display Change and Recovery [No. 2]: Display/Display in Invisible Manner of Cursor)

In succession, processing performed by control unit 350 for making a cursor invisible in the tablet mode will be described with reference to FIG. 63. FIG. 63 is a diagram showing in a flowchart form, a flow of processing in making a cursor invisible.

In step SB1001, control unit 350 causes storage portion 330 to store a current cursor position. Here, the term “current” refers to the time point when control unit 350 accepted an instruction to switch the mode from the mouse mode to the tablet mode.

In step SB1003, control unit 350 makes the cursor on liquid crystal panel 140 invisible. Specifically, program execution unit 358 included in control unit 350 creates display data based on a result of execution of the program except for a portion relating to cursor display. Display control unit 356 causes liquid crystal panel 140 to display a screen based on the created display data.

It should be noted that control unit 350 may make a cursor invisible by making cursor display completely transparent. In this case, control unit 350 makes the cursor invisible by calling cursor display data corresponding to colorlessness through the processing the same as the processing shown in FIG. 61. Alternatively, control unit 350 may make the cursor invisible by changing display data of the cursor being displayed (that is, the cursor in the mouse mode).

Processing for recovering the cursor corresponding to making the cursor invisible described with reference to FIG. 63 will be described with reference to FIG. 64. FIG. 64 is a diagram showing in a flowchart form, a flow of processing for again displaying a cursor.

In step SB1101, display control unit 356 included in control unit 350 loads from storage portion 330, the “current cursor position” stored in storage portion 330 in step SB1001 in FIG. 63.

In step SB1103, display control unit 356 causes the cursor to be displayed at the cursor position loaded in step SB1101. Here, display control unit 350 provides display of the cursor for the mouse mode based on the cursor display data for the mouse mode.

(Cursor Display Change and Recovery [No. 3]: Movement of Cursor)

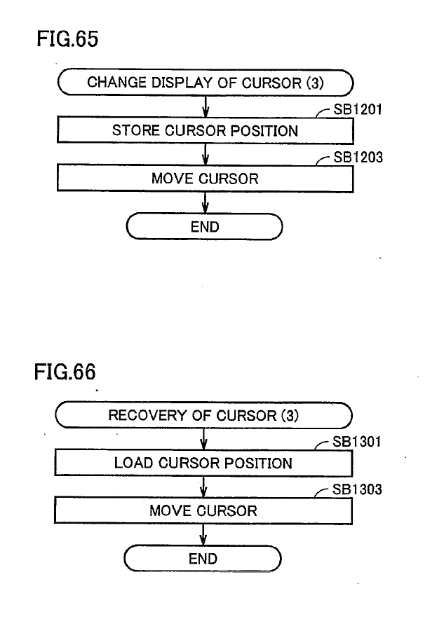

In succession, processing performed by control unit 350 in moving the cursor when transition from the mouse mode to the tablet mode is made will be described with reference to FIG. 65. FIG. 65 is a diagram showing in a flowchart form, a flow of processing in moving a cursor in transition from the mouse mode to the tablet mode.

In step SB1201, control unit 350 causes storage portion 330 to store the current cursor position. Here, the term “current” refers to the time point when control unit 350 accepted an instruction to switch the mode from the mouse mode to the tablet mode, similarly to the previous description.

In step SB1203, control unit 350 moves the cursor on liquid crystal panel 140. Specifically, program execution unit 358 included in control unit 350 reads a designated position of the cursor in the tablet mode stored in advance in storage portion 330. Then, program execution unit 358 creates display data for displaying the cursor at the read designated position. Display control unit 356 causes liquid crystal panel 140 to display an image based on the created display data.

Processing for recovering the cursor corresponding to movement of the cursor described with reference to FIG. 65 will be described with reference to FIG. 66. FIG. 66 is a diagram showing in a flowchart form, a flow of processing in moving a cursor in transition from the tablet mode to the mouse mode.

In step SB1301, display control unit 356 included in control unit 350 loads from storage portion 330, the “current cursor position” stored in storage portion 330 in step SB1201 in FIG. 65.

In step SB1303, display control unit 356 causes the cursor to be displayed at the cursor position loaded in step SB1301. Here, display control unit 350 causes the cursor for the mouse mode to be displayed based on the cursor display data for the mouse mode.

In a case where the cursor position is not returned to the previous cursor position in the mouse mode in returning to the mouse mode, the processing in step SB1201 and step SB1301 is not necessary. In this case, storage portion 330 stores in advance a cursor display position at the time when the cursor will again be displayed. Display control unit 356 loads a prescribed display position from storage portion 330 when the cursor is again displayed. Then, display control unit 356 causes the cursor to be displayed at the loaded prescribed display position.

[Variation 9]

Electronic device 100 according to Variation 8 described above unexceptionally changes cursor display when transition from the mouse mode to the tablet mode is made. In contrast, electronic device 100 according to Variation 9 changes cursor display only when the cursor overlaps with an active window within the display screen on liquid crystal panel 140.

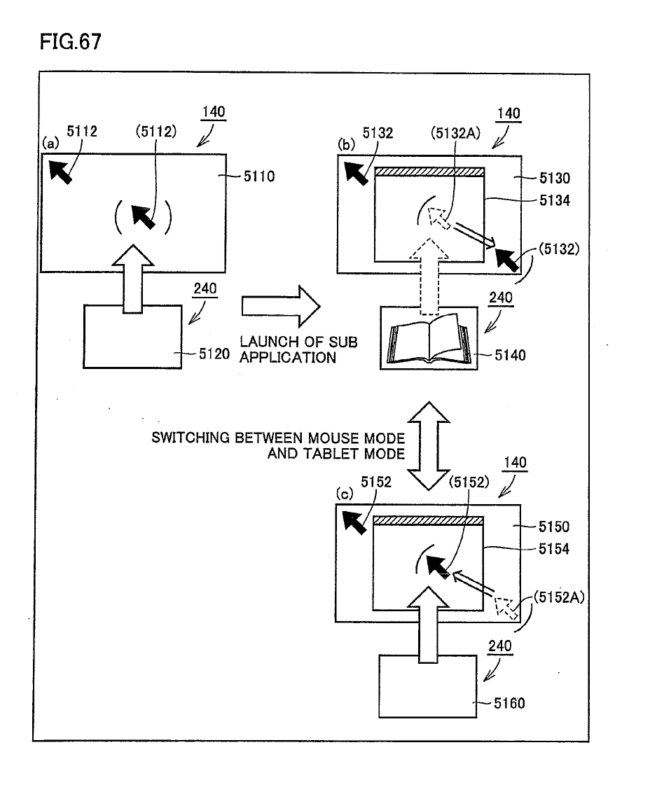

Change in cursor display control according to Variation 9 will be described with reference to FIG. 67. FIG. 67 is a diagram for illustrating change in cursor display control according to the present variation.

FIG. 67 shows a display screen 5110 on liquid crystal panel 140 and a display screen 5120 on liquid crystal panel 240 in the mouse mode. Display screen 5110 includes a cursor 5112.

For the sake of illustration, display screen 5110 in FIG. 67 shows cursor 5112 at two different positions. Actually, however, only one cursor 5112 is displayed on liquid crystal panel 140 and two cursors 5112 will never be displayed on liquid crystal panel 140 simultaneously, which is expressed by parentheses around one cursor 5112 in display screen 5110. It should be noted that this display method is also applicable to display screens 5130 and 5150.

In addition, FIG. 67 shows display screen 5130 on liquid crystal panel 140 and a display screen 5140 on liquid crystal panel 240 in the tablet mode. Here, a case where electronic device 100 executes the book viewer is shown by way of example, as in the case of display screens 3830 and 3840 in FIG. 54.

Display screen 5130 includes a cursor 5132 and a window 5134. Window 5134 is an active window created by the executed book viewer application.

Here, an operation in a case where electronic device 100 causes the cursor to move will be described. In a variation of the subject matter 9, electronic device 100 determines a position of display of cursor 5132 based on the position of display in the mouse mode before switching to the tablet mode and positional relation with window 5134.

When the cursor position in the mouse mode does not overlap with the display region of window 5134, in the tablet mode, electronic device 100 causes the cursor to be displayed at the position the same as in the mouse mode. Namely, when the cursor was displayed at the position of cursor 5112 not inside parentheses on display screen 5110 in the mouse mode, electronic device 100 causes the cursor to be displayed at the position of cursor 5132 not inside parentheses in the tablet mode.

Meanwhile, when the cursor position in the mouse mode overlaps with the display region of window 5134, electronic device 100 moves the cursor at the time of transition from the mouse mode to the tablet mode, and causes the cursor to be displayed outside the display region of window 5134 in the tablet mode. Namely, when the cursor was displayed at the position of cursor 5112 inside parentheses in display screen 5110 in FIG. 67 in the mouse mode, electronic device 100 causes the cursor to be displayed at the position of cursor 5132 inside the parentheses in the tablet mode. For facilitated understanding, in display screen 5130, a virtual cursor 5132A corresponding to the position of cursor 5112 in the mouse mode is shown with a dashed line.

In addition, FIG. 67 shows display screen 5150 on liquid crystal panel 140 and a display screen 5160 on liquid crystal panel 240 after transition to the mouse mode from the state shown in display screens 5130 and 5140 (the tablet mode).

Display screen 5150 includes a cursor 5152 and a window 5154. Relation between window 5134 and window 5154 is similar to relation between window 3834 and window 3854 (see FIG. 54).

When the cursor display position is not moved at the time of transition from the mouse mode to the tablet mode, electronic device 100 causes the cursor to be displayed at the position the same as before returning to the mouse mode (in display screen 5150, cursor 5152 not inside the parentheses).

Meanwhile, when the cursor display position was moved at the time of transition from the mouse mode to the tablet mode, electronic device 100 moves the cursor to the position the same as in the mouse mode before transition to the tablet mode (in display screen 5150, cursor 5152 inside the parentheses). For facilitated understanding, in display screen 5150, a virtual cursor 5152A corresponding to the position of cursor 5132 inside the parentheses in the tablet mode is shown with a dashed line.

Movement of the cursor in a case where the cursor overlaps with the active window has been described above, however, when the cursor overlaps with the window, electronic device 100 may change a form of display, for example, by displaying the cursor in a less intense manner.

Since a hardware configuration and a functional configuration of electronic device 100 according to Variation 9 are substantially the same as in Variation 8, detailed description thereof will not be repeated. It should be noted that Variation 8 and Variation 9 are different from each other in processing performed by control unit 350 and control unit 450 as will be described below.

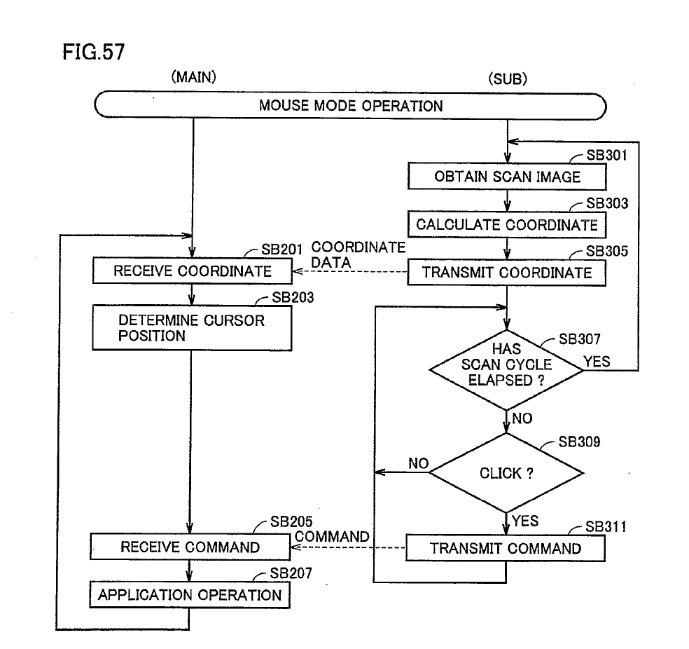

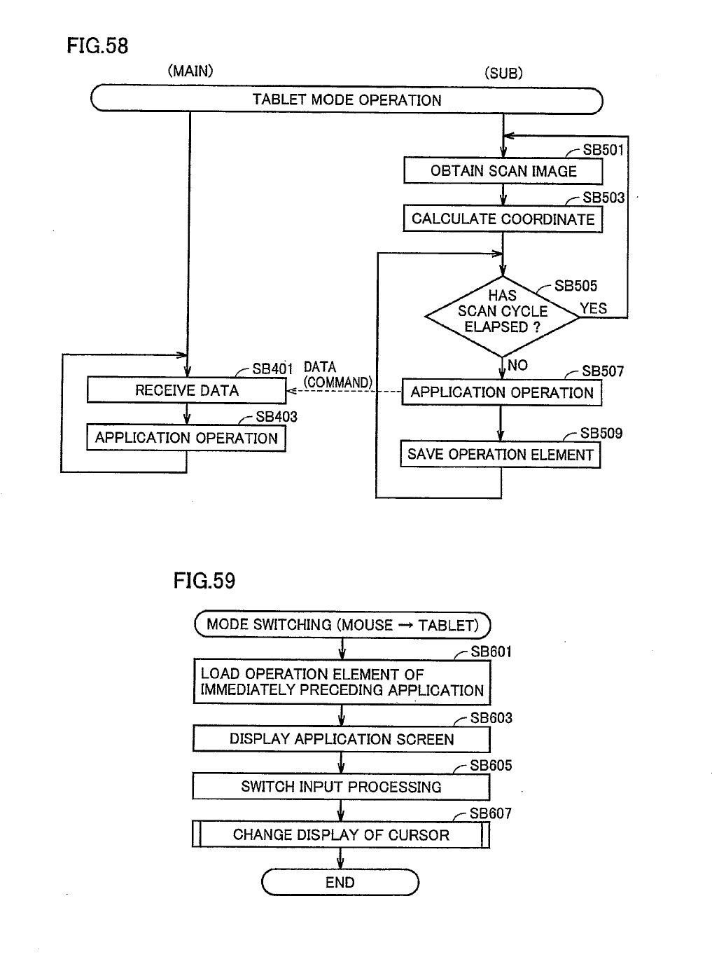

In addition, since a basic flow of the processing in electronic device 100 according to Variation 9 is the same as in Variation 8 (FIG. 56), it will not be repeated. Moreover, the mouse mode operation and the tablet mode operation are also the same as in Variation 8 (FIGS. 57 and 58), and hence they will not be repeated. It should be noted that the mode switching processing is different from that in Variation 8, as will be described below.

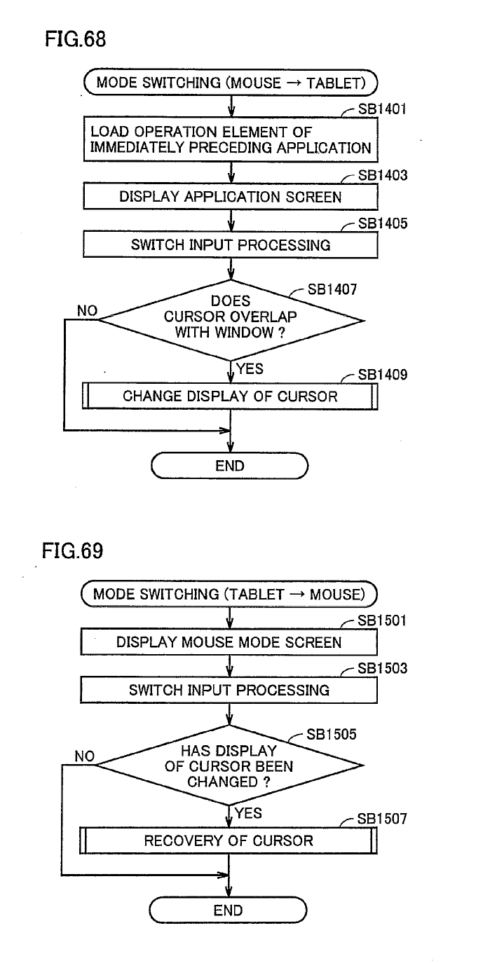

Mode switching (from the mouse mode to the tablet mode) according to Variation 9 will be described in detail with reference to FIG. 68. FIG. 68 is a diagram showing in a flowchart form, a flow of processing in the mode switching (from the mouse mode to the tablet mode) operation according to Variation 9.

In step SB 1401, mode setting unit 454 included in control unit 450 loads an operation element of an immediately preceding application stored in storage portion 430. Here, the “immediately preceding application” refers to a sub application that last operated in the tablet mode before mode setting unit 454 accepts an instruction to switch the mode to the tablet mode, as described already.

In step SB1403, program execution unit 458 included in control unit 450 executes the immediately preceding application based on the operation element loaded in step SB1401. Then, program execution unit 458 controls display control unit 456 to cause display portion 140 to display the operation screen of the sub application.

It should be noted that program execution unit 458 may perform the processing in step SB1401 at any time during the processing in step SB 1403. Namely, during execution of the immediately preceding application, the operation element stored in storage portion 430 may be read and the sub application may be executed based on the read data, as necessary.

In step SB1405, panel input processing unit 453 included in control unit 450 switches a method of processing a signal from panel input portion 422. Namely, panel input processing unit 453 converts a signal from panel input portion 422 to a sub application operation instruction.

In step SB1407, program execution unit 358 determines whether the cursor overlaps with the display region of the window or not. Specifically, program execution unit 358 reads from storage portion 330, data showing the display region of the active window and the data specifying the cursor display position. Then, when positions specified by respective pieces of data are common at least in part, program execution unit 358 determines that the cursor overlaps with the display region of the window.

It should be noted that program execution unit 358 may determine overlapping between the cursor and the window by using a display region of the window larger than actual or the cursor display position. By doing so, electronic device 100 can move a cursor which is located in the vicinity of the window in spite of being located outside the window and which may impair visual recognition of the window.

When control unit 350 determines that the cursor overlaps with the window (YES in step SB 1407), the process proceeds to step SB 1409. In step SB 1409, control unit 350 performs processing for changing cursor display provided on liquid crystal panel 140. Specifically, control unit 350 performs processing the same as the processing described with reference to FIG. 61, 63 or 65.

Though an example where electronic device 100 moves the cursor to the corner of the screen has been shown above, electronic device 100 should only move the cursor to a region that does not impair visual recognition of the window. For example, as in Variation 8, electronic device 100 may move the cursor to an end portion of the screen, such as on each side of the screen. In addition, electronic device 100 should only move the cursor at least to such a region that the cursor is not visually obstructive to the active window. For example, electronic device 100 may move the cursor to the end portion of the window or just outside the window.

On the other hand, when control unit 350 determines that the cursor does not overlap with the window (NO in step SB 1407), it does not perform the processing for changing display of the cursor (does not perform step SB 1409) and ends the processing for switching the mode from the mouse mode to the tablet mode.

(Mode Switching: from Tablet Mode to Mouse Mode)

From now on, mode switching (from the tablet mode to the mouse mode) according to Variation 9 will be described in detail with reference to FIG. 69. FIG. 69 is a diagram showing in a flowchart form, a flow of processing in the mode switching (from the tablet mode to the mouse mode) operation according to Variation 9.

In step SB 1501, when display control unit 456 included in control unit 450 receives a signal indicating that an instruction to switch the mode has been issued from mode setting unit 454, display control unit 456 causes liquid crystal panel 240 to display the mouse mode screen based on display data 434.

In step SB 1503, panel input processing unit 453 included in control unit 450 switches a method of processing a signal from panel input portion 422. Namely, panel input processing unit 453 converts a signal from panel input portion 422 to a signal for a mouse operation on liquid crystal panel 140.

In step SB1505, program execution unit 358 included in control unit 350 determines whether or not cursor display has been changed in transition from the mouse mode to the tablet mode.

For example, when transition from the mouse mode to the tablet mode is made, program execution unit 358 causes storage portion 330 to store a form of display (or a display position) of the cursor in the mouse mode before transition. Then, program execution unit 358 compares the stored form of display (or the display position) with the form of display (or the display position) of the cursor in the tablet mode in step SB 1505 and determines whether cursor display has been changed or not.

Alternatively, program execution unit 358 causes storage portion 330 to store data representing a result of determination made at the time of determination in step SB1407 in FIG. 68. Then, in step SB1505, whether cursor display has been changed or not is determined based on the data representing the stored determination result.

When cursor display has been changed (YES in step SB1505), in step SB1507, program execution unit 356 and display control unit 356 included in control unit 350 perform processing for recovering display of the cursor that has been changed in transition from the mouse mode to the tablet mode. Specifically, control unit 350 performs processing the same as the processing described with reference to FIG. 62, 64 or 66. When cursor display has not been changed (NO in step SB1505), control unit 350 ends the mode switching processing without performing the processing for recovering display of the cursor.

[Variation 10]

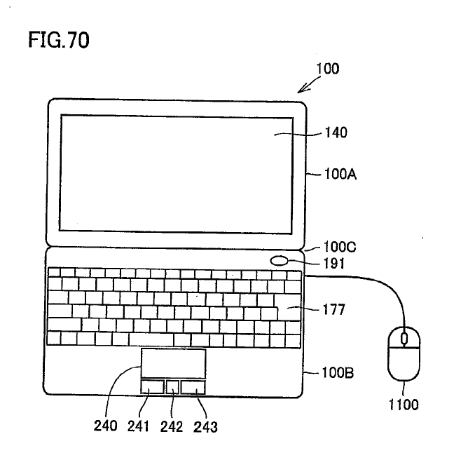

Electronic device 100 to which an external pointing device can be connected will be described in Variation 10. FIG. 70 shows appearance of electronic device 100 according to Variation 10. FIG. 70 is a diagram showing appearance of electronic device 100 according to Variation 10.

Referring to FIG. 70, the configuration of electronic device 100 is the same as that in Variation 8 except for connection of a mouse 1100. It should be noted that mouse 1100 represents one example of the pointing device. The description below is also applicable to electronic device 100 to which other pointing devices can be connected.

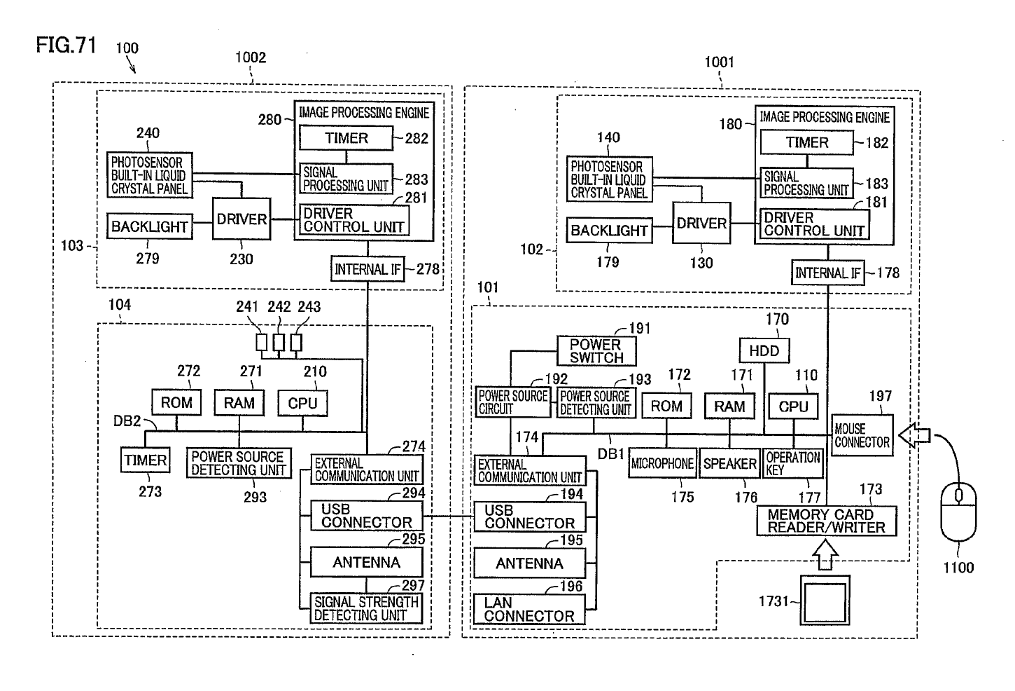

A position and a manner of a hardware configuration of electronic device 100 according to Variation 10 will be described with reference to FIG. 71. FIG. 71 is a block diagram showing the hardware configuration of electronic device 100.

The hardware configuration of electronic device 100 shown in FIG. 71 is the same as in FIG. 2 in connection with Variation 8, with a mouse connector 197 being added. Mouse 1100 is removably attached to mouse connector 197. Mouse connector 197 senses connection of mouse 1100 and removal of mouse 1100 and sends a signal indicating a state of connection of mouse 1100 to CPU 110 or the like.

A connector such as a USB connector physically connecting a terminal on the mouse side can be employed as mouse connector 197. It should be noted that mouse connector 197 represents one example of an interface between electronic device 100 and an external pointing device and it is not limited to those described above. For example, electronic device 100 may include an interface establishing wireless connection to a pointing device.

In addition, the hardware configuration of electronic device 100 is not limited to that shown in FIG. 71. For example, as in Variation 8, such a configuration that mouse connector 197 is added to first unit 1001A instead of first unit 1001 may be employed.

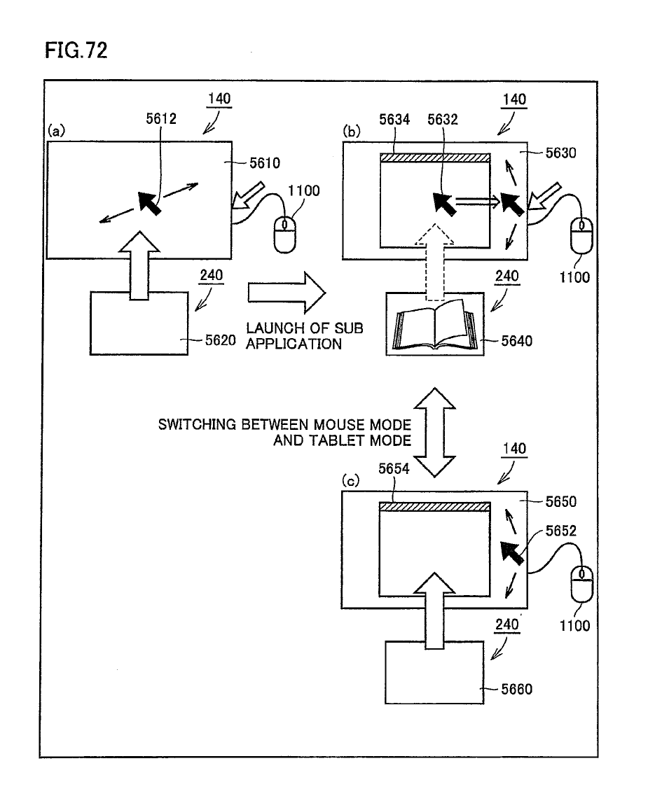

Change in cursor display control according to Variation 10 will be described with reference to FIG. 72. FIG. 72 is a diagram for illustrating change in cursor display control according to Variation 10.

FIG. 72 shows a display screen 5610 on liquid crystal panel 140 and a display screen 5620 on liquid crystal panel 240 in the mouse mode. Display screen 5610 includes a cursor 5612.

As in Variation 8 and Variation 9, electronic device 100 changes a position of cursor 5612 in accordance with change in position of input on liquid crystal panel 240. In addition, in the present variation, electronic device 100 moves cursor 5612 in accordance with movement of mouse 1100. FIG. 72 shows this movement with an arrow extending from mouse 1100 toward liquid crystal panel 140.

Moreover, FIG. 72 shows a display screen 5630 on liquid crystal panel 140 and a display screen 5640 on liquid crystal panel 240 in the tablet mode. Here, a case where electronic device 100 executes the book viewer is shown by way of example, as in FIG. 54 or the like. Display screen 5630 includes a cursor 5632 and a window 5634. Window 5634 is created by the executed book viewer application.

While mouse 1100 is connected to electronic device 100, electronic device 100 according to Variation 10 does not change display of the cursor when transition from the mouse mode to the tablet mode is made. Namely, electronic device 100 displays the same cursor before and after switching between the modes. More specifically, in the tablet mode, electronic device 100 causes cursor 5632 to be displayed in a form of display the same as that of cursor 5612, at the position the same as that of cursor 5612 in the mouse mode before mode switching.

In the present variation, also in the tablet mode, electronic device 100 can move cursor 5632 in accordance with movement of mouse 1100.

A display screen 5650 in FIG. 72 shows a manner in which the user moved cursor 5632 to the right. Thus, the user can move the cursor also in the tablet mode.

Then, electronic device 100 according to the present variation does not move the cursor when transition to the tablet mode is made. If the cursor that can be moved by the user becomes inconspicuous or if it is moved without the user's operation, it impairs user's operability of the cursor on the contrary. Even if the cursor overlaps with the window, the user can move the cursor to such a position as facilitating viewing of a window by moving mouse 1100 and hence visibility is not impaired.

Electronic device 100 does not change mouse display even when transition from the tablet mode to the mouse mode is made.

Further, FIG. 72 shows a display screen 5650 on liquid crystal panel 140 and a display screen 5660 on liquid crystal panel 240 when transition to the mouse mode from the state shown in display screens 5030 and 5040 (the tablet mode) is made. Display screen 5650 includes a cursor 5652 and a window 5654 similarly to display screen 5630.

Since a basic flow of processing in electronic device 100 according to Variation 10 is the same as in Variation 8 (FIG. 56), it will not be repeated. An operation by manipulated mouse 1100, however, is also performed, and therefore the mouse mode operation and the tablet mode operation are different from those in Variation 8 or Variation 9. In addition, as described below, the mode switching processing is also different from that in the first embodiment and the second embodiment. A flow of processing different from that in other embodiments will be described below.

(Mouse Mode Operation)

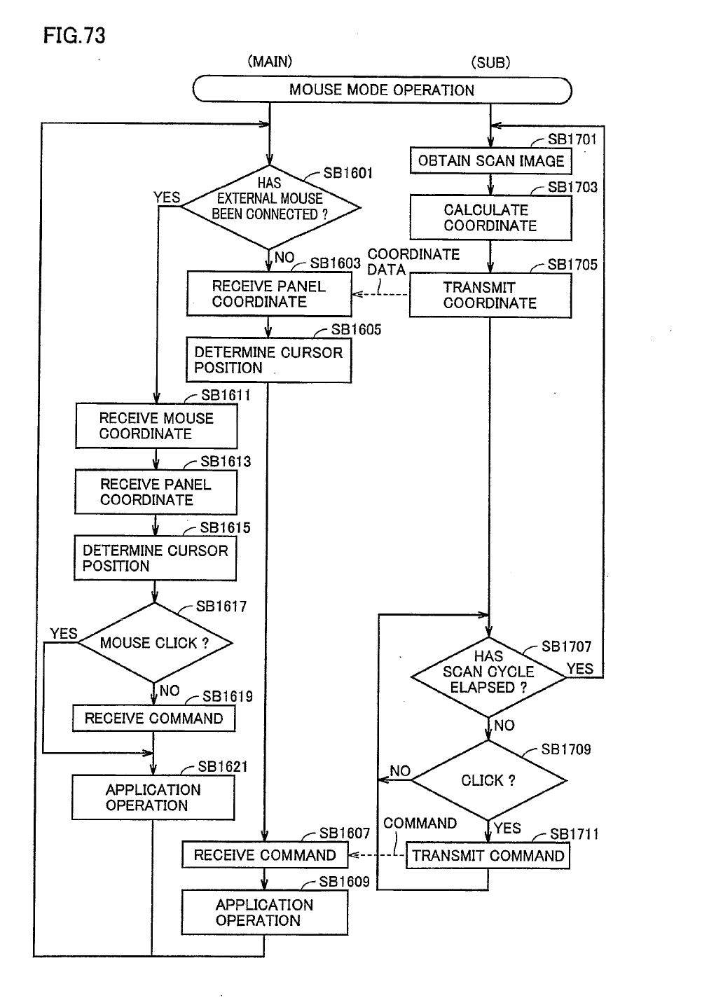

The mouse mode operation according to Variation 10 will be described in detail with reference to FIG. 73. FIG. 73 is a diagram showing in a flowchart form, a flow of processing in the mouse mode operation according to the present variation.

Initially, an operation of control unit 350 on the first unit 1001 side will be described. A flow of the operation of control unit 350 is shown on the left in FIG. 73.

In step SB1601, control unit 350 determines whether mouse 1100 has been connected to mouse connector 197 or not.

When control unit 350 determines that mouse 1100 has not been connected (NO in step SB1601), the process proceeds to the processing from step SB 1603 to step SB1609. Since the processing from step SB1603 to step SB1609 is the same as the processing from step SB201 to step SB207 in FIG. 57, description thereof will not be repeated.

When control unit 350 determines that mouse 1100 has been connected (YES in step SB1601), control unit 350 calculates in step SB1611 a position coordinate (a mouse coordinate) designated by mouse 1100. Specifically, control unit 350 calculates a mouse coordinate based on an amount of movement of mouse 1100 determined by movement of a mouse ball or the like and definition of an amount of variation in coordinate corresponding to the amount of movement or the like.

In step SB1613, control unit 350 obtains a panel coordinate. Since this is the same as the processing in step SB 1603, description thereof will not be repeated.

In step SB1615, control unit 350 determines a cursor position based on the mouse coordinate and the panel coordinate.

In step SB1617, control unit 350 determines whether clicking with mouse 1100 has been performed or not. Specifically, control unit 350 determines whether or not a signal corresponding to clicking with mouse 1100 has been accepted from mouse connector 197.

When clicking with mouse 1100 has been performed (YES in step SB 1617), control unit 350 performs in step SB1621 an application operation based on a command corresponding to clicking with mouse 1100. It should be noted that the command is not limited to a command corresponding to a click operation but it may be a command corresponding to double click, drag or the like.

On the other hand, when clicking with mouse 1100 has not been performed (NO in step SB 1617), control unit 350 receives a command from second unit 1002 in step SB1619. Thereafter, control unit 350 performs in step SB1621 an application operation in accordance with the command. Since the operation in step SB 1621 here is the same as in step SB 1609, description thereof will not be repeated.

After step SB1621, control unit 350 repeats the processing from step SB1601.

An operation of control unit 450 on the second unit 1002 side is shown on the right in FIG. 73. Since the processing from step SB 1701 to step SB 1711 is the same as the processing from step SB301 to step SB311 in FIG. 57, detailed description thereof will not be repeated.

(Tablet Mode Operation)

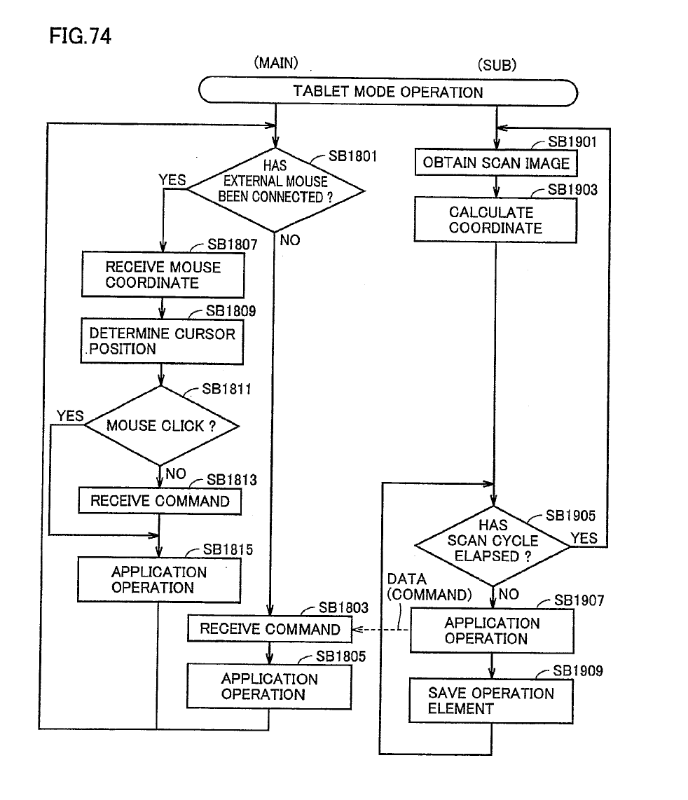

The tablet mode operation according to the present variation will be described with reference to FIG. 74. FIG. 74 is a diagram showing in a flowchart form, a flow of processing in the tablet mode operation according to the present variation.

Initially, an operation of control unit 350 on the first unit 1001 side will be described. A flow of the operation of control unit 350 is shown on the left in FIG. 74.

In step SB1701, control unit 350 determines whether mouse 1100 has been connected to mouse connector 197 or not.

When control unit 350 determines that mouse 1100 has not been connected (NO in step SB 1701), the process proceeds to the processing in step SB 1803 and step SB1805. Since the processing in step SB1803 and step SB1805 is the same as the processing in step SB401 and step SB403 in FIG. 58, description thereof will not be repeated.

When control unit 350 determines that mouse 1100 has been connected (YES in step SB 1701), the process proceeds to the processing from step SB 1807 to step SB1815. Since the processing from step SB1807 to step SB 1815 is the same as the processing in step SB1611 and from step SB1615 to step SB1621 in FIG. 73, description thereof will not be repeated.

An operation of control unit 450 on the second unit 1002 side is shown on the right in FIG. 74. Since the processing from step SB 1901 to step SB 1909 is the same as the processing from step SB501 to step SB509 in FIG. 58, detailed description thereof will not be repeated.

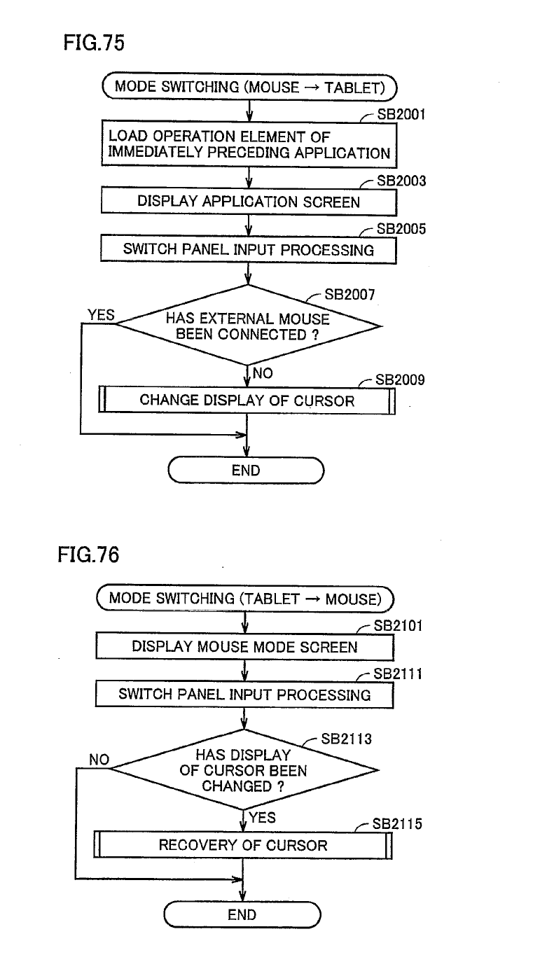

Mode switching (from the mouse mode to the tablet mode) according to the present variation will be described in detail with reference to FIG. 75. FIG. 75 is a diagram showing in a flowchart form, a flow of processing in the mode switching (from the mouse mode to the tablet mode) operation according to the third embodiment.

Since the processing from step SB2001 to step SB2005 is the same as the processing from step SB 1401 to step SB 1405 in FIG. 68, description thereof will not be repeated.

In step SB2007, control unit 350 determines whether mouse 1100 has been connected to mouse connector 197 or not.

When control unit 350 determines that mouse 1100 has not been connected (NO in step SB2007), the process proceeds to processing in step SB2009 (change in cursor display). Since the processing in step SB2009 is the same as the processing in step SB 1409 in FIG. 68, detailed description thereof will not be repeated.

On the other hand, when control unit 350 determines that mouse 1100 has been connected (YES in step SB2007), control unit 350 ends the processing for switching the mode from the mouse mode to the tablet mode without performing the processing for changing display of the cursor (without performing step SB2009).

(Mode Switching: from Tablet Mode to Mouse Mode)

FIG. 76 shows mode switching (from the tablet mode to the mouse mode) according to the present variation. FIG. 76 is a diagram showing in a flowchart form, a flow of processing in the mode switching (from the tablet mode to the mouse mode) operation according to the present variation. Since each processing in FIG. 76 (from step SB2101 to step SB2115) is the same as the processing from step SB 1501 to step SB1507 in FIG. 69 described in Variation 9, detailed description thereof will not be repeated.

[Others]

In the embodiment (each variation) described herein, liquid crystal panel 140 may be a display not having a function as an input portion but providing display alone of a screen (a single-function display). In a case where liquid crystal panel 140 has a large size and it is difficult to use this as a touch panel, such a configuration is useful.

On the other hand, second liquid crystal panel 240 of electronic device 100 may be a normal touch panel having a tablet function and a display function.

In addition, a configuration based on combination as appropriate of the embodiments (variations) is also naturally encompassed in the present invention. For example, an electronic device based on combination of Variation 9 and Variation 10 can also be considered as one form of the present invention. Namely, an electronic device to which an external pointing device is not connected and which changes display of a cursor when the cursor overlaps with a window in the tablet mode also represents one embodiment of the present invention.

Moreover, first unit 1001 and second unit 1002 operate independently of each other, except for exchange of data. Therefore, second unit 1002 may be removable. Further, second unit 1002 may be replaceable with other units (such as a mobile information terminal) having a function equivalent to that of second unit 1002. Therefore, a system including an electronic device including first unit 1001 and a unit connected or connectable to the electronic device may be considered as one manner of the present invention.

[Variation 11]

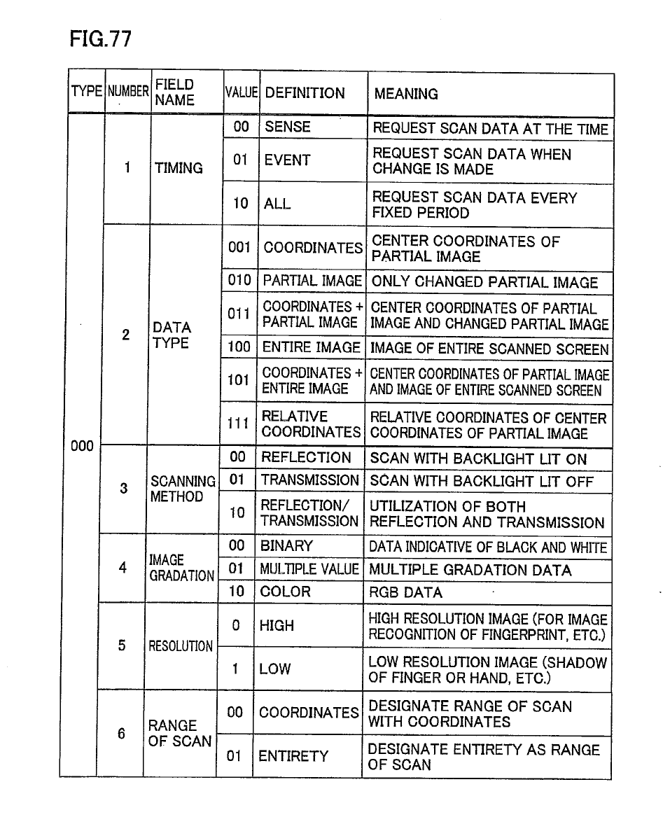

In electronic device 100, a first command as described with reference to FIG. 8 is transmitted from main device 101 to second unit 1002 or display device 102. It should be noted that the first command may include a field designating a range of scan data of which transmission is requested to second unit 1002 or display device 102, in addition to the fields shown in FIG. 8. FIG. 77 shows a diagram for illustrating such a variation of the command of type “000”.

Referring to FIG. 77, the first command in this variation has “111” added as a value set in second field DA03, as compared with the command shown in FIG. 8. The first command having “111” set in second field DA03 requests transmission of a coordinate value of a relative coordinate.

Here, the relative coordinate refers to a coordinate value indicating difference between a coordinate value of the center coordinate found in the present scan result and a coordinate value of the center coordinate found in the previous scan result. Namely, the relative coordinate is a coordinate representing how much an operation position on liquid crystal panel 240 or the like has varied between previous scanning and present scanning.

In the first command shown in FIG. 77, CPU 110 writes a value of a range of scan corresponding to a number “6” in reserve data region DA07 (see FIG. 7).

The first command having “00” set in reserve data region DA07 requests to image processing engine 280 to designate a range of scan on liquid crystal panel 240 with coordinates, when it is transmitted to second unit 1002. In addition, the first command having “01” set in reserve data region DA07 requests to image processing engine 280 to set a range of scan on liquid crystal panel 240 to an entire scannable region on liquid crystal panel 240.

The first command described with reference to FIG. 77 and having “001” set in second field DA03 requests transmission of a coordinate value of the center coordinate in the partial image, when it is transmitted to second unit 1002. Namely, when a touch operation onto liquid crystal panel 240 is performed, the first command requests transmission of an absolute coordinate value of the operation position.

On the other hand, the first command having “111” set in second field DA03 requests transmission of a coordinate value of the relative coordinate of the center coordinate in the partial image. Thus, when the operation position on liquid crystal panel 240 is moved while touch onto liquid crystal panel 240 is maintained, transmission of data indicating difference of the present coordinate value of the center coordinate from the coordinate value of the center coordinate based on the previous scan result, that is calculated each time the scan result is derived, is requested.

In addition, the first command described with reference to FIG. 77 and having reserve data region DA07 written with a value indicating a range of scan corresponding to number “6” can designate a range of liquid crystal panel 240 for the scan data of which transmission is requested.

Namely, the first command described with reference to FIG. 77 can request transmission of the scan data of entire liquid crystal panel 240 and also can request transmission of scan data by designating a range of scan in accordance with a type of data.

By thus designating a certain region on liquid crystal panel 240 as a coordinate indicating a range of scan and setting “001” in second field DA03, the first command in FIG. 77 can request transmission of a coordinate value of the center coordinate indicating the position of the operation performed on the certain region above. In addition, as a certain specific region is designated as a range of scan and the first command has “111” set in second field DA03, the first command can request transmission of an amount of variation in relative operation position resulting from a touch operation performed within the region above.

Regarding the response data of the first command having “111” set in second field DA03, a coordinate value indicating difference in the coordinate value of the center coordinate between the present scan result and the previous scan result is written in data region DA14 (see FIG. 14) representing an image, as image data that has been subjected to processing by image processing engine 280.

<As to Sub Screen Control Processing>

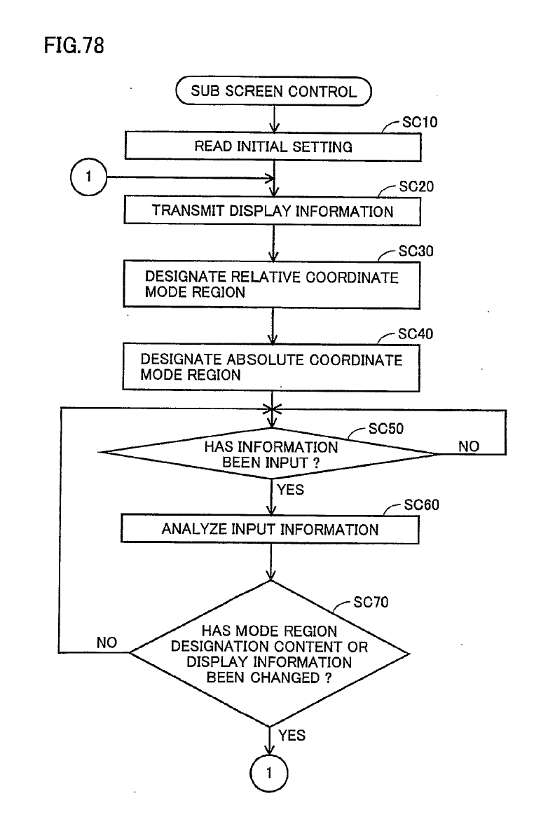

Processing performed by CPU 110 for controlling liquid crystal panel 240 in accordance with a state of an application executed in electronic device 100 (sub screen control processing) will now be described with reference to FIG. 78 showing a flowchart of the processing.

Referring to FIG. 78, in the sub screen control processing, initially in step SC10, CPU 110 reads contents of initial setting of liquid crystal panel 240 in the application program being executed and the process proceeds to step SC20. The contents of the initial setting include display information, relative coordinate mode region information, and absolute coordinate mode region information which will be described later.

In step SC20, CPU 110 transmits to second unit 1002, display information of liquid crystal panel 240 determined based on the initial setting above or on a result of analysis of input information in step SC60 which will be described later, and the process proceeds to step SC30. The information transmitted here includes the second command in FIG. 9.

In step SC30, CPU 110 transmits to second unit 1002, the relative coordinate mode region information and the absolute coordinate mode region information determined based on the initial setting described above and on the result of analysis of the input information in step SC60 which will be described later, and the process proceeds to step SC50.

The relative coordinate mode region information refers to information specifying a region in a display surface of liquid crystal panel 240, designated to output a relative coordinate in connection with an operation when the operation is performed, and it includes the first command in FIG. 77.

The absolute coordinate mode region information refers to information for specifying a region in a display surface of liquid crystal panel 240, designated to output a center coordinate in a partial image when an operation is performed, and it includes the first command in FIG. 77.

In step SC50, CPU 110 determines whether information has been input to electronic device 100 or not. Input of information to be determined here includes not only input of information to input means provided in first unit 1001 such as operation key 177 but also input of information to input means included in second unit 1002 such as liquid crystal panel 240.

Then, when CPU 110 determines that the information has been input, the process proceeds to step SC60.

In step SC60, CPU 110 analyzes contents of the information determined in step SC50 to have been input, analyzes the information input in accordance with the program of the application being executed, and performs appropriate processing based on the result of analysis, and the process proceeds to step SC70.

In step SC70, CPU 110 determines whether or not change in at least one of the display information transmitted to second unit 1002 in step SC20 and the relative coordinate mode region information and the absolute coordinate mode region information transmitted to second unit 1002 in steps SC30 and SA40 has been necessitated as a result of analysis and the processing performed in step SC60. When it is determined that such change has not been necessitated, the process returns to step SC50. On the other hand, when it is determined that such change has been necessitated, the process returns to step SC20, changed information is transmitted to second unit 1002 through step SC20 to step SC40, and an input of information is awaited in step SC50.

<Sub Side Control Processing>

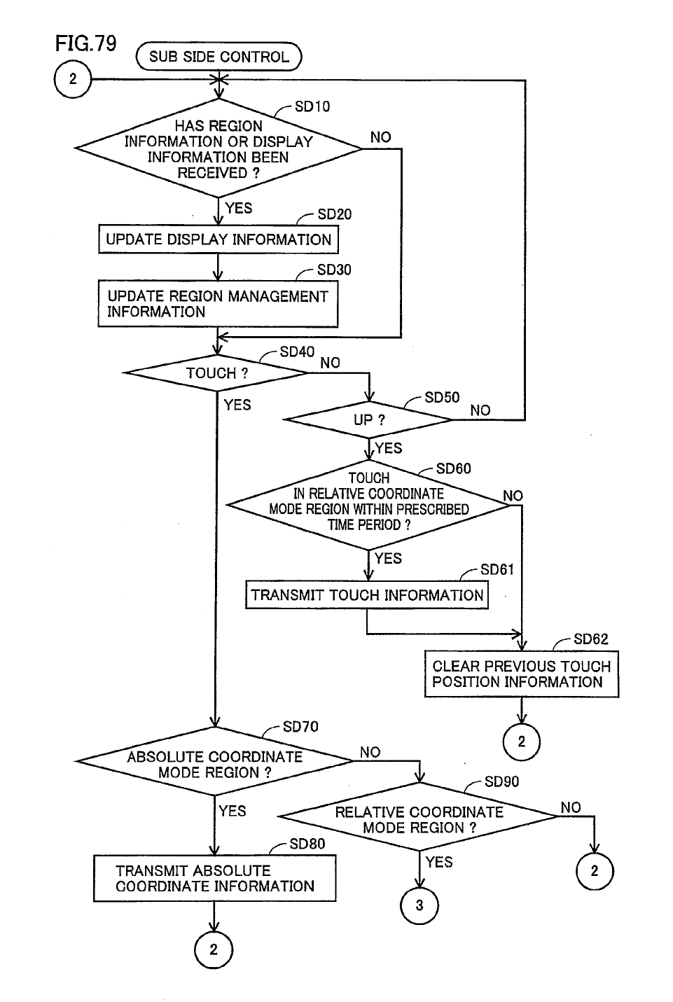

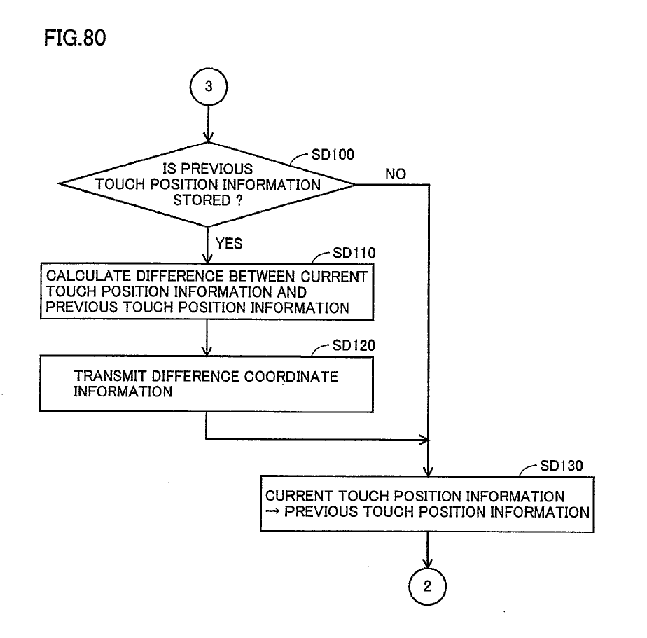

Then, processing for signal processing unit 283 to control liquid crystal panel 240 (sub side control processing) in response to transmission of information to second unit 1002 as a result of the sub screen control processing above performed by CPU 110 will now be described with reference to FIGS. 79 and 80 showing a flowchart of the processing.

Referring initially to FIG. 79, in the sub side control processing, initially in step SD10, signal processing unit 283 waits until at least one of the display information and the region information above is received. When CPU 110 determines that the information has been received, the process proceeds to step SD20.

In step SD20, signal processing unit 283 updates display contents on liquid crystal panel 240 in accordance with the display information transmitted from CPU 110, and the process proceeds to step SD30.

In step SD30, signal processing unit 283 updates region management information stored in a storage device within signal processing unit 283 based on the region information transmitted from CPU 110, and the process proceeds to step SD40.

Here, the region management information refers to information specifying a region designated as the relative coordinate mode region by the relative coordinate mode region information and a region designated as the absolute coordinate mode region by the absolute coordinate mode region information, in a region of liquid crystal panel 240 where sensing can be carried out.

In step SD40, signal processing unit 283 determines whether or not a touch operation has been performed anywhere in the region of liquid crystal panel 240 where sensing can be carried out. When it is determined that the touch operation has been performed, the process proceeds to step SD70, and when it is determined that the touch operation has not been performed, the process proceeds to step SD50.

Here, the phrase that the touch operation has been performed means that touch onto liquid crystal panel 240 has been made.

In step SD50, signal processing unit 283 determines whether or not an up-operation has been performed anywhere in the region of liquid crystal panel 240 where sensing can be carried out. When it is determined that the up-operation has been performed, the process proceeds to step SD60, and when it is determined that the up-operation has not been performed, the process returns to step SD10.

Here, the up-operation refers to change from a state where touch onto liquid crystal panel 240 is made to a state where there is no touch.

Then, when signal processing unit 283 determines in step SD250 that the up-operation has been performed, the process proceeds to step SD60.

In step SD60, signal processing unit 283 determines whether or not the touch operation that has been terminated by the up-operation detected in step SD50 is a touch operation of which duration is not longer than a prescribed period of time in the relative coordinate mode region. Namely, in step SD60, signal processing unit 283 determines whether or not the touch operation has been stopped before it continued for a prescribed period of time in the relative coordinate mode region. When it is determined that it is the case, the process proceeds to step SD61. On the other hand, when it is determined that it is not the case, that is, when it is determined that the preceding touch operation has been performed in the absolute coordinate mode region or when the touch operation has been performed for a period exceeding the prescribed period of time above in the relative coordinate mode region, the process proceeds to step SD62.

In step SD61, signal processing unit 283 transmits to first unit 1001 information indicating that a click operation has been performed in the relative coordinate mode region (hereinafter also referred to as “touch information”) and the process proceeds to step SD62.

In step SD62, signal processing unit 283 clears previous touch position information stored in the storage device within signal processing unit 283, and the process returns to step SD10. The previous touch position information refers to information updated in step SD130 which will be described later, and it refers to a center coordinate in a partial image at that time point.

In step SD70, whether or not the center coordinate determined in step SD40 that the touch operation thereon has been made is within a range of the absolute coordinate mode region updated in step SD30 is determined. When it is determined that it is the case, the process proceeds to step SD80. When it is determined that it is not the case, the process proceeds to step SD90.

In step SD80, signal processing unit 283 transmits to first unit 1001, response data including the center coordinate in the partial image determined in step SD40 that the touch operation has been performed thereon (absolute coordinate information) (see FIG. 14), and the process returns to step SD10.

In step SD90, whether or not the coordinate determined in step SD40 that the touch operation has been made thereon is included in the relative coordinate mode region updated in step SD30 is determined. When it is determined that it is the case, the process proceeds to step SD100 (see FIG. 80). When it is determined that it is not the case, the process returns to step SD10.

Referring to FIG. 80, in step SD100, signal processing unit 283 determines whether or not information is stored as the previous touch position information at this time point. When it is determined that the information is stored, the process proceeds to step SD110. When there is no storage of information after the information was cleared in step SD62, the process proceeds to step SD130.

In step SD110, a coordinate value indicating difference between the center coordinate in the partial image in connection with the touch operation determined in step SD40 that the touch operation has been performed thereon (current touch position information) and the previous touch position information stored in the storage device is calculated, and the process proceeds to step SD120.

In step SD120, signal processing unit 283 transmits to first unit 1001, the coordinate value indicating difference calculated in step SD110 (difference coordinate information), and the process proceeds to step SD130.

In step SD130, signal processing unit 283 updates the previous touch position information already stored in the storage device with the current touch position information, and the process returns to step SD10.

In the sub side control processing described above, signal processing unit 283 receives in step SD10 at least one of the display information and the region information above from CPU 110. Thereafter, when touch onto the relative coordinate mode region continues without such information being updated, the process proceeds from step SD10 to step SD20. Thereafter, whether the touch operation has been performed or not is determined in step SD40 after step SD20 and step SD30. The process thus proceeds to step SD70. Then, since the touch operation has been performed onto the relative coordinate mode region, the process proceeds from step SD90 to step SD100. Since the previous touch position information is not stored in the first processing in step SD100, the process returns to step SD10 through step SD130. Then, when neither of the display information and the region information is updated, the process proceeds from step SD10 to step SD40. When the touch operation in the relative coordinate mode region continues, the process proceeds to step SD100 through step SD40 to step SD70 and step SD90. Here, since the previous touch position information has already been stored, the processing in step SD110 is performed, the difference coordinate information is transmitted to first unit 1001 in step SD120, and thereafter the process returns to step SD10. Thereafter, while the touch operation onto the relative coordinate mode region continues, the processing in step SD10 to step SD40, step SD70, step SD90, step SD100 to step SD130, step SD10, and so on is repeated.

<As to Display Screen>

One example of contents displayed on liquid crystal panel 140 and liquid crystal panel 240 as the sub screen control processing and the sub side control processing above are performed will now be described.

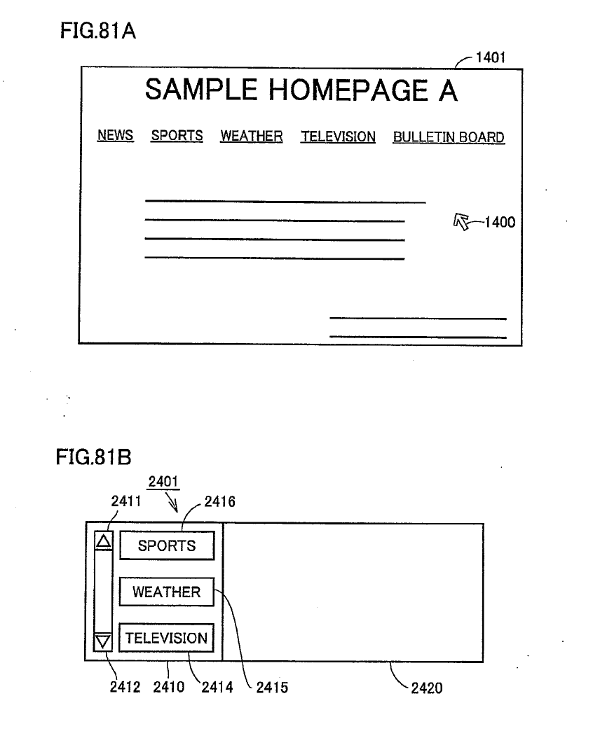

FIG. 81A shows one example of a screen displayed on liquid crystal panel 140 as a result of execution of a web page viewing application representing one example of an application executed in electronic device 100.

In FIG. 81A, in a screen 1401, a screen of a homepage entitled “Sample Homepage A” representing one example of a homepage is displayed. In addition, a pointer 1400 is displayed in screen 1401. A position of display of pointer 1400 is changed as operation key 177 or a relative coordinate mode region 2420 which will be described later is operated.

FIG. 81B is a diagram schematically showing one example of a screen displayed on liquid crystal panel 240.

Referring to FIG. 81B, a screen 2401 mainly includes an absolute coordinate mode region 2410 and relative coordinate mode region 2420.

Absolute coordinate mode region 2410 includes an up button 2411, a down button 2412, a television button 2414, a weather button 2415, and a sports button 2416.

In liquid crystal panel 240, a position, a shape and a size set as relative coordinate mode region 2420 are specified by the relative coordinate mode region information, and a position, a shape and a size set as absolute coordinate mode region 2410 are specified by the absolute coordinate mode region information. In addition, positions or types of images of various buttons 2411 to 2416 displayed in absolute coordinate mode region 2410 are specified by the absolute coordinate mode region information transmitted from CPU 110. Specifically, the absolute coordinate mode region information includes the second command (see FIG. 9) for displaying an image of each button.

The application being executed in electronic device 100 can transmit to second unit 1002, such absolute coordinate mode region information (the second command) as causing display of a button in coordination with display contents in screen 1401 displayed on liquid crystal panel 140, as a button to be displayed in absolute coordinate mode region 2410. Thus, in absolute coordinate mode region 2410, buttons 2414 to 2416 corresponding to “television”, “weather” and “sports” respectively, representing some of menus displayed on screen 1401, are displayed. When any of buttons 2414 to 2416 is operated and information indicating that the operation has been performed is transmitted from signal processing unit 283 as the response data (see FIG. 14), CPU 110 performs the processing equivalent to selection of a menu on screen 1401 corresponding to the operated button, in the application being executed.

In screen 1401, other than three menus of “television”, “weather” and “sports” above, such menus as “news” and “bulletin board” are also displayed. The application can allow display of buttons corresponding to some of these menus in absolute coordinate mode region 2410, and as up button 2411 or down button 2412 is operated, it can change a type of button corresponding to a menu among the plurality of menus above displayed in absolute coordinate mode region 2410.

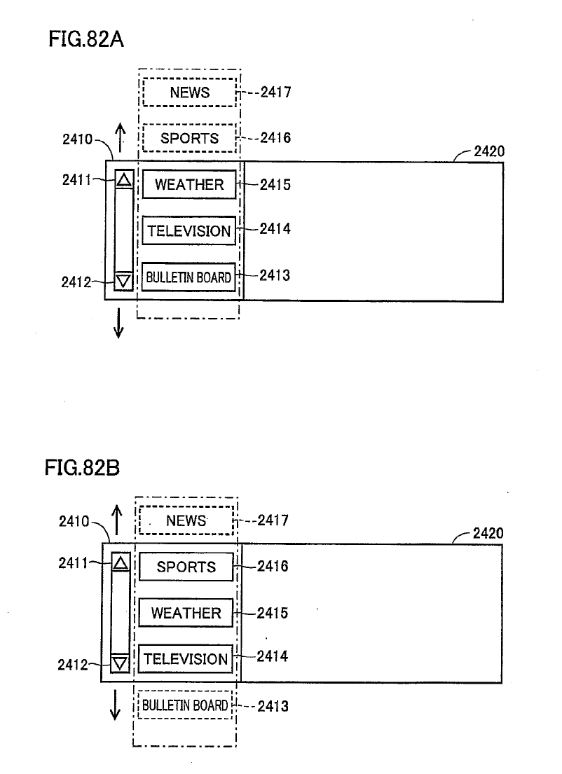

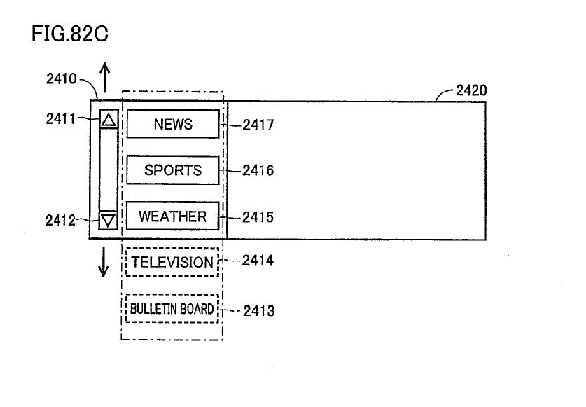

Specifically, when a touch operation onto down button 2412 is performed from the state shown in FIG. 81B, display contents on liquid crystal panel 240 change as shown in FIG. 82C.

Referring to FIG. 82A, in absolute coordinate mode region 2410, other than up button 2411 and down button 2412, buttons 2413 to 2415 corresponding to respective menus of “bulletin board”, “television” and “weather” are displayed. It should be noted that buttons 2416 and 2417 that are buttons corresponding to respective menus of “sports” and “news” in FIG. 82A are shown for reference purpose and they are not displayed in absolute coordinate mode region 2410.

Regarding buttons displayed in absolute coordinate mode region 2410, in response to an operation of up button 2411 or down button 2412, three buttons are selected from among buttons 2413 to 2417 sequenced as shown in FIG. 82A and displayed in absolute coordinate mode region 2410.

For example, when a touch operation of down button 2412 is performed once from the state displayed in FIG. 82A, buttons displayed in absolute coordinate mode region 2410 are changed to 2414 to 2416.

When down button 2412 is further operated once from the state shown in FIG. 82B, buttons displayed in absolute coordinate mode region 2410 are changed to buttons 2415 to 2417 as shown in FIG. 82C.

Thus, a manner of control of liquid crystal panel 240 such that types of buttons displayed in absolute coordinate mode region 2410 are selected in response to an operation of up button 2411 or down button 2412 is implemented by such a series of information transmission and reception that CPU 110 initially transmits to second unit 1002 information for displaying three predetermined buttons among five buttons in absolute coordinate mode region 2410 (the second command), thereafter a position of display of up button 2411 or down button 2412 representing one type of the response data transmitted in response to the first command from main device 101 is transmitted to first unit 1001 as the center coordinate (the center coordinate in the partial image in FIG. 8), and CPU 110 transmits to second unit 1002 as a result of analysis of the response data, display information for changing types of buttons to be displayed in absolute coordinate mode region 2410 (the second command) as shown in FIG. 82B or 82C.

It should be noted that CPU 110 may transmit information for displaying all buttons of buttons 2413 to 2417 (image data to be displayed or the like) to second unit 1002 as display information to be transmitted to second unit 1002 as display information at the time of launch of the application, and signal processing unit 283 may carry out control for selecting three buttons to be displayed in absolute coordinate mode region 2410 among five buttons 2413 to 2417 in response to an operation of up button 2411 and down button 2412.

Relative coordinate mode region 2420 is a region for detecting a tracing operation with the use of a finger, a stylus or the like for moving a position of display of pointer 1400 displayed on liquid crystal panel 140, like a conventional touch pad. As described as the processing from step SD60 to step SD61 in FIG. 79, in electronic device 100, a click operation onto relative coordinate mode region 2420 is detected and the fact that such an operation has been performed is transmitted from display device 103 to first unit 1001 as the response data. Thus, as CPU 110 determines the click operation as having been performed at a position of display of pointer 1400 at that time point, CPU 110 executes the application.

[Variation 12]

<As to Variation of Display Contents>

As described above, in electronic device 100, screen 2401 including absolute coordinate mode region 2410 and relative coordinate mode region 2420 corresponding to contents of the application executed in electronic device 100 is displayed on liquid crystal panel 240.

It should be noted that a size or a range of the absolute coordinate mode region or the relative coordinate mode region displayed on liquid crystal panel 240 may be changed depending of a type of an application executed in electronic device 100.

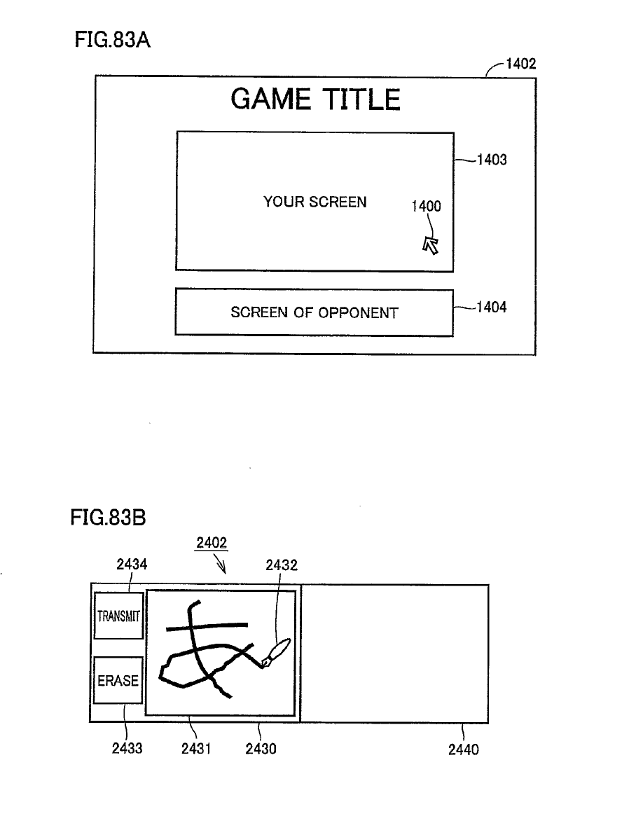

FIGS. 83A and 83B show display contents on liquid crystal panel 140 and liquid crystal panel 240 in a case where an application different from the application described with reference to FIGS. 81A and 81B is executed in electronic device 100.

FIG. 83A shows a screen 1402 representing one example of a screen displayed on liquid crystal panel 140.

Screen 1402 is a display screen for a game application, and a game title is displayed in the upper portion thereof, or a screen 1403 showing a state of a game of an operator of electronic device 100 and a screen 1404 showing a state of a game of an opponent are included therein. In addition, screen 1402 displays pointer 1400.

FIG. 83B shows a screen 2402 representing one example of a screen displayed on liquid crystal panel 240.

Screen 2402 includes an absolute coordinate mode region 2430 and a relative coordinate mode region 2440. A ratio of a size between the absolute coordinate mode region and the relative coordinate mode region in the screen displayed on liquid crystal panel 240 can be changed for each application. Thus, a ratio between absolute coordinate mode region 2430 and relative coordinate mode region 2440 is changed from a ratio of a size between absolute coordinate mode region 2410 and relative coordinate mode region 2420 shown in FIG. 81B.

A function of relative coordinate mode region 2440 in screen 2402 displayed in FIG. 83B is similar to that of relative coordinate mode region 2420 in FIG. 81B.

In absolute coordinate mode region 2430, a handwriting pad region 2431 for inputting a handwritten character or hand-drawn graphics, a button 2433 for clearing information input to handwriting pad region 2431, and a button 2434 operated to cause signal processing unit 283 to transmit image information displayed on handwriting pad region 2431 to first unit 1001 as absolute coordinate information are displayed. In handwriting pad region 2431, a trace of operation positions from start of an operation onto the region until an operation of button 2433 or button 2434 is displayed and a pen-shaped image 2432 showing a current operation position as a pen-point position is further displayed. Image 2432 does not necessarily have to be displayed.

While the application described with reference to FIGS. 83A and 83B is executed, the sub screen control processing described with reference to FIG. 78 or the sub side control processing described with reference to FIGS. 79 and 80 is basically performed. It should be noted that, in executing this application, the sub side control processing is varied with regard to transmission of absolute coordinate information.

Specifically, in the server side control processing described with reference to FIG. 79, absolute coordinate information has successively been transmitted through the processing in step SD80. On the other hand, in the application described with reference to FIGS. 83A and 83B, a trace of positions of operation onto handwriting pad region 2431 from start of the operation onto handwriting pad region 2431 (in a case where button 2433 is operated, from subsequent start of an operation onto handwriting pad region 2431) until the operation of button 2434 is stored, and on condition that button 2434 is operated, accumulated information on the trace of the positions of operation onto handwriting pad region 2431 is transmitted to first unit 1001 as the absolute coordinate information.

[Variation 13]

<As to Variation of Processing Contents>

In the sub screen control processing described with reference to FIG. 78, the relative coordinate mode region information and the absolute coordinate mode region information have been transmitted together with the display information to the other display device 103.

The storage device in signal processing unit 283 can store the display information, the relative coordinate mode region information, and the absolute coordinate mode region information for each application. Thus, simply by the first unit transmitting information specifying a type of an application to be executed, signal processing unit 283 can cause liquid crystal panel 240 to display a screen in accordance with a type of an application, such as screen 2410 in FIG. 81B or screen 2402 in FIG. 83B.

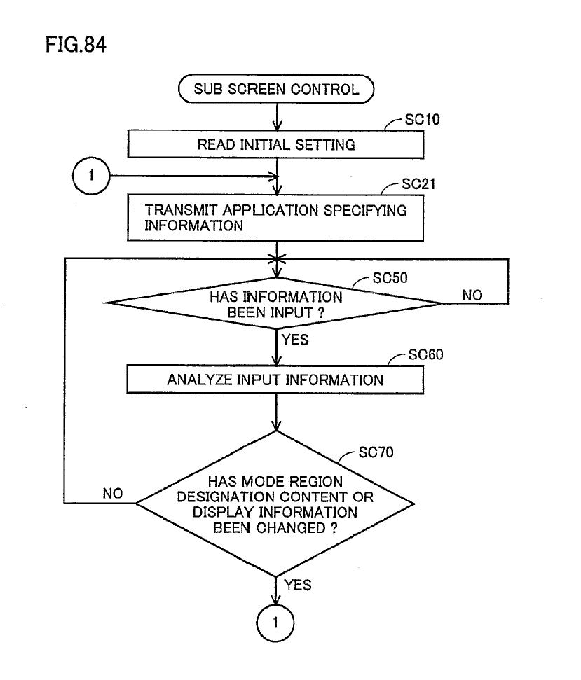

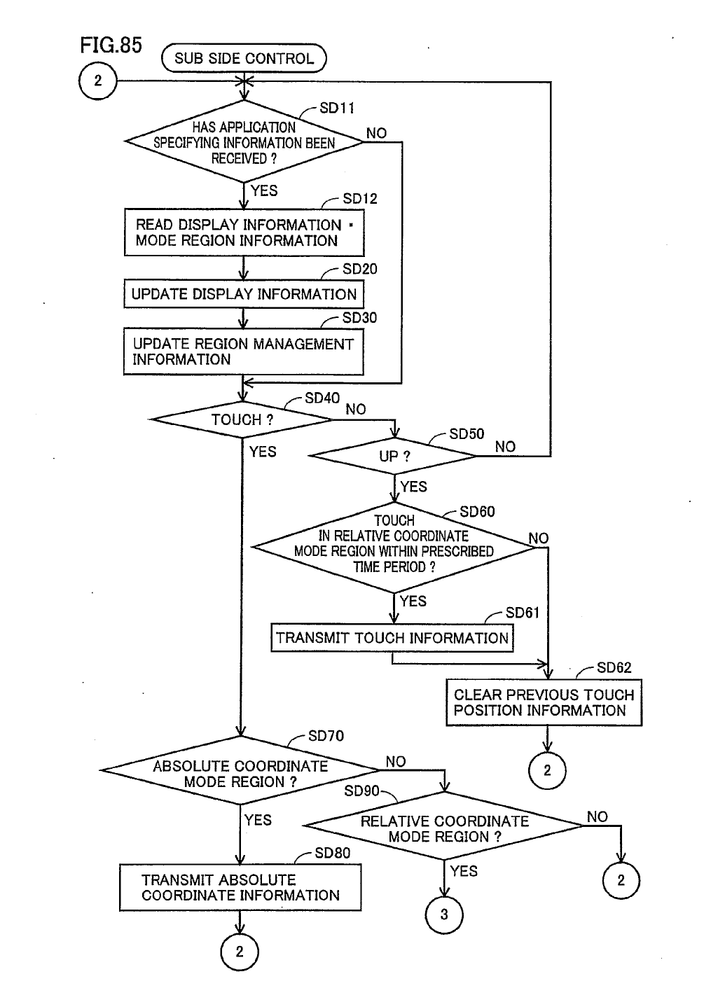

In such a case, the flowchart of the sub screen control processing shown in FIG. 78 is varied, for example, as shown in FIG. 84, while the flowchart of the sub side control processing shown in FIG. 79 is varied, for example, as shown in FIG. 85.

Referring to FIG. 84, in this variation of the sub screen control processing, CPU 110 reads initial setting in step SC10 and thereafter transmits in step SC21 information specifying an application to be executed (application specifying information) (instead of the processing from step SC20 to step SC40 in FIG. 78).

In addition, in a variation of the sub side control processing shown in FIG. 85, signal processing unit 283 waits in step SD11 until it receives the application specifying information instead of the processing in step SD10 in FIG. 84, and when signal processing unit 283 determines that it received the information, the process proceeds to step SD12.

Then, in step SD12, signal processing unit 283 reads the display information as well as the relative coordinate mode region information and the absolute coordinate mode region information stored in the storage device in signal processing unit 283 in association with the received application specifying information.

Then, signal processing unit 283 updates in step SD20 and step SD30 display contents on liquid crystal panel 240 based on the display information as well as the relative coordinate mode region information and the absolute coordinate mode region information read in step SD12.

[Variation 14]

<Variation of Configuration of Electronic Device>

Display device 103 including liquid crystal panel 240 may be mounted on electronic device 100 or it may be configured to removably be attached to the electronic device.

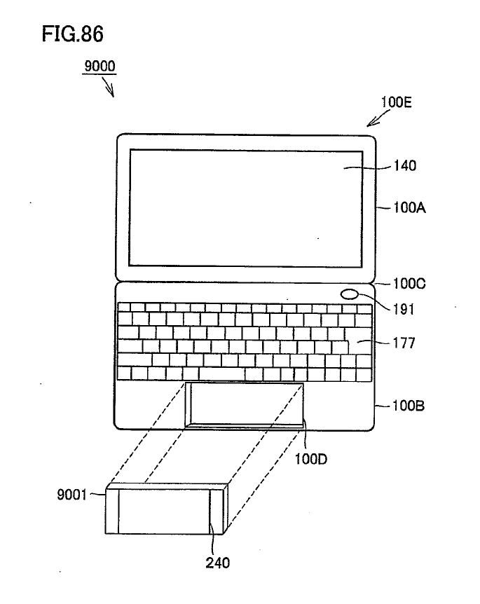

FIG. 86 shows an information processing system 9000 constituted of an information processing terminal 9001 including at least components of second unit 1002 among the components of electronic device 100 shown in FIG. 2 and an electronic device 100E including the components of display device 102.

Information processing terminal 9001 is configured, for example, in such a manner as fitted into a recess 100D provided in electronic device 100E.

The configuration may be such that USB connector 194 is provided in recess 100D and information processing terminal 9001 is fitted into recess 100D so that USB connector 294 is connected to USB connector 194 and thus power is supplied from electronic device 100E.

In addition, information processing terminal 9001 may include a power source such as a power storage battery for supplying power to each internal component.

[Variation 15]

<Overall Configuration of Electronic Device 100>

An overall configuration of electronic device 100 according to Variation 15 of a content display device will be described.

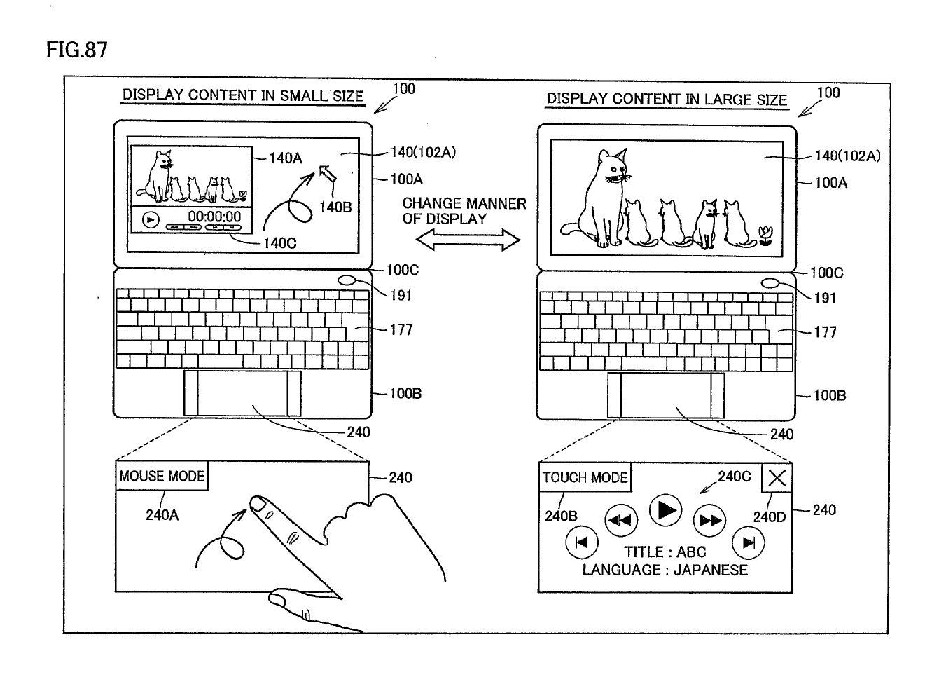

FIG. 87 is a schematic diagram showing appearance of electronic device 100 according to the present variation. A state that a content is displayed in a small size on a first display panel 140 (or display device 102A) is shown on the left and a state that a content is displayed in a large size on first display panel 140 is shown on the right.

Referring to FIG. 87, electronic device 100 includes first casing 100A and second casing 100B. First casing 100A and second casing 100B are foldably connected to each other via hinge 100C. First casing 100A includes first photosensor built-in liquid crystal panel 140 (hereinafter also referred to as first display panel 140). Second casing 100B includes an operation key and a second photosensor built-in liquid crystal panel 240 (hereinafter also referred to as second display panel 240 or a sub screen). As such, electronic device 100 according to the present embodiment includes two photosensor built-in liquid crystal panels. It should be noted that electronic device 100 is configured as a mobile device having a display function, such as a PDA, a notebook type personal computer, a mobile phone, or an electronic dictionary.

Electronic device 100 according to the present embodiment causes first display panel 140 to display a content such as a motion picture 140A and accepts a user's instruction through operation key 177 and second display panel 240. Second display panel 240 accepts an instruction to move a pointer displayed on first display panel 140 or an operation instruction to control reproduction of motion picture 140A or the like displayed on first display panel 140.

It should be noted that first display panel 140 does not have to be a photosensor built-in liquid crystal panel, and it should only be capable of displaying a content. On the other hand, second display panel 240 should detect a user's touch operation and therefore a touch panel having a tablet function and a display function or a photosensor built-in liquid crystal panel is preferably employed.

<Overview of Operation of Electronic Device 100>

An overview of an operation of electronic device 100 according to the present embodiment will now be described with reference to FIG. 87.

As shown on the left in FIG. 87, electronic device 100 causes first display panel 140 to display motion picture 140A in a small window. When motion picture 140A is displayed in a small window, electronic device 100 is set to a normal mode. In the normal mode, electronic device 100 causes first display panel 140 to display a pointer 140B and accepts an instruction to move pointer 140B through second display panel 240 (a first movement instruction). Thus, as the user performs a touch operation on second display panel 240, pointer 140B displayed on first display panel 140 can be moved.

Here, electronic device 100 causes first display panel 140 to display a main operation image 140C (a second image) for controlling reproduction of a content. At the same time, electronic device 100 causes second display panel 240 to display an image 240A showing that the normal mode is currently set.

Meanwhile, as shown on the right in FIG. 87, the user can cause full-screen display of a content by operating operation key 177 or second display panel 240. Namely, by operating operation key 177 or second display panel 240, the user can change a manner of display of a content on first display panel 140. When full-screen display of a content is provided, electronic device 100 is set to a full-screen mode.

In the full-screen mode, electronic device 100 causes second display panel 240 to display a sub operation image 240C (a first image) for controlling reproduction of a content. Here, electronic device 100 causes second display panel 240 to display an image 240B indicating that the full-screen mode is currently set.

As the user thus touches sub operation image 240C on second display panel 240, the user can readily control reproduction of a content. In other words, by providing an operation screen readily operable by the user depending on a situation, electronic device 100 according to the present embodiment can solve such a problem that an operation image (an operation screen) satisfactorily operable by the user is different if a purpose or a target of an input instruction is different.

More specifically, in accordance with a manner of display of a content displayed on first display panel 140, an operation instruction that the user desires to input through second display panel 240 (an operation panel) varies.

In a case where a window for an application is displayed in a large size on first display panel 140, the user is highly likely to input an operation instruction for controlling an operation of the application through second display panel 240, however, the user is less likely to input an instruction for controlling other applications. For example, when a window for an application for reproducing a motion picture is displayed in a large size on first display panel 140, the user is highly likely to input an operation instruction for controlling reproduction of a motion picture, however, the user is less likely to input an instruction to move the pointer.

In contrast, in a case where a window for an application is displayed in a small size on first display panel 140, the user is highly likely to input an instruction for controlling other applications. For example, in a case where a window for reproducing a motion picture is displayed in a small size on first display panel 140, the user is highly likely to input an instruction to move the pointer.

Electronic device 100 according to the present embodiment provides an operation screen readily operable by the user depending on a situation, based on the above-described viewpoint.

[Variation 16]

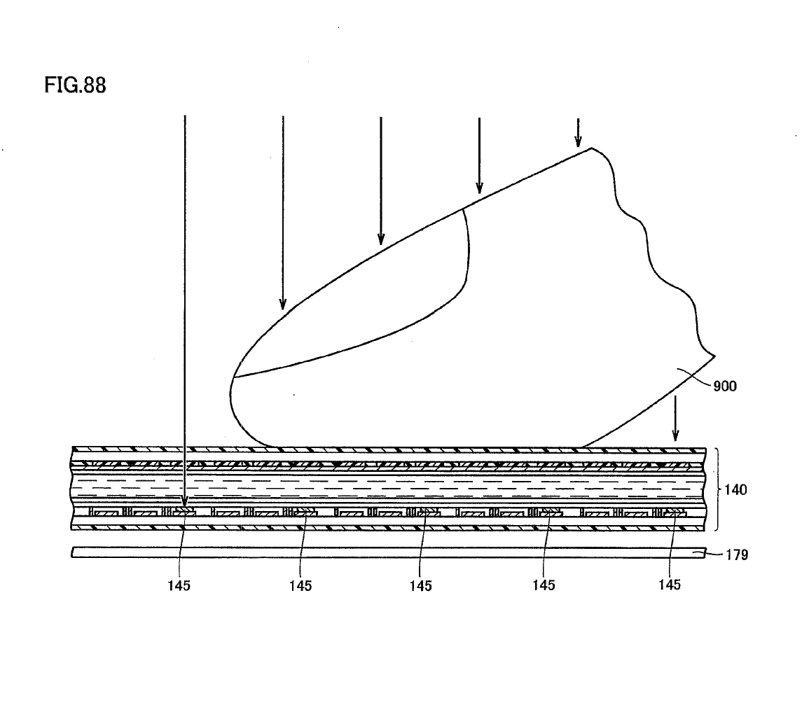

A scanning method different from the scanning method described previously (that is, a method of scanning a reflected image in FIG. 6) will now be described with reference to FIG. 88.

FIG. 88 is a cross-sectional view showing a configuration in which a photodiode receives external light in scanning. As shown in the figure, the external light is partially blocked by finger 900. Hence, photodiodes arranged below a region in contact with finger 900 in the surface of display panel 140 can hardly receive the external light. Photodiodes below a region shaded by finger 900 in the surface thereof can receive a certain amount of the external light, however, the amount of the external light received is smaller than that in regions not shaded in the surface.

Here, by lighting off backlight 179 at least during the sensing period, photosensor circuit 144 can output a voltage from sensor signal line SSj in accordance with the position of finger 900 relative to the surface of display panel 140. By controlling backlight 179 to light on and off in this way, in display panel 140, a voltage output from each of the sensor signal lines (SS1 to SSn) is changed in accordance with the position in contact with finger 900, a range in contact with finger 900 (determined by pressing force of finger 900), a direction of finger 900 relative to the surface of display panel 140, and the like.

In this way, display device 102 can scan an image (hereinafter, also referred to as shadow image) obtained by finger 900 blocking the external light.

Further, display device 102 may be configured to scan with backlight 179 lit on, and then scan again with backlight 179 lit off. Alternatively, display device 102 may be configured to scan with backlight 179 lit off, and then scan again with backlight 179 lit on.

In this case, the two scanning methods are used, and therefore two pieces of scan data can be obtained. Hence, accuracy can be higher as compared with a case where one scanning method alone is employed for scanning.

<As to Display Device>

As in the operation of display device 102, an operation of display device 103 is controlled in accordance with a command from main device 101 (for example, the first command). Display device 103 is configured in the same way as display device 102. Hence, when display device 103 accepts from main device 101 the same command as the command provided to display device 102, display device 103 operates in the same way as display device 102. Hence, explanation is not repeated for the operation and configuration of display device 103.

It should be noted that main device 101 can send commands different in instruction to display device 102 and display device 103. In this case, display device 102 and display device 103 operate in different ways. Further, main device 101 may send a command to either of display device 102 and display device 103. In this case, only one of the display devices operates in accordance with the command. Further, main device 101 may send a command identical in instruction to display device 102 and display device 103. In this case, display device 102 and display device 103 operate in the same way.

It should also be noted that the size of display panel 140 of display device 102 may be the same as or different from the size of display panel 240 of display device 103. Further, the resolution of display panel 140 may be the same as or different from the resolution of display panel 240.

[Variation 17]

In the present embodiment, electronic device 100 includes first display panel 140 containing a photosensor and second display panel 240 containing a photosensor, however, only second display panel 240 may be configured to contain a tablet or a photosensor as described previously.

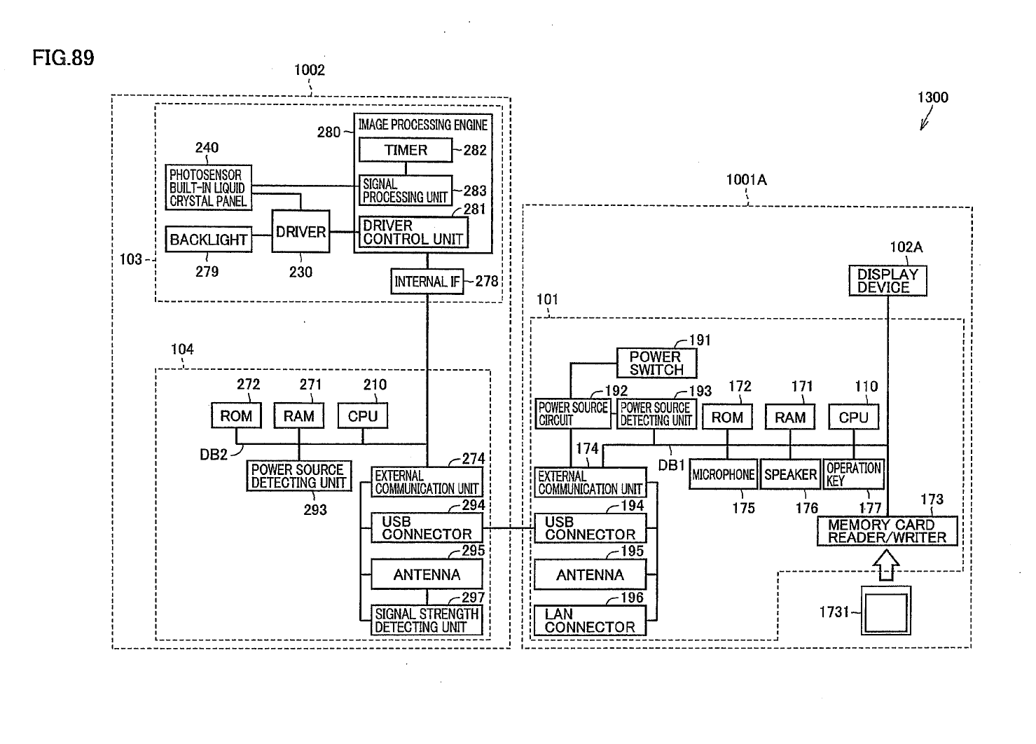

FIG. 89 is a block diagram showing a hardware configuration of electronic device 1300. As in electronic device 100, electronic device 1300 includes first casing 100A and second casing 100B. Referring to FIG. 89, electronic device 1300 includes first unit 1001A and second unit 1002. First unit 1001A includes main device 101 and display device 102A. Second unit 1002 includes main device 104 and display device 103.

Display device 102A is a display panel which does not have photosensors built therein (i.e., a display panel only having a display function). Electronic device 1300 is different from electronic device 100 in which first unit 1001 includes display panel 240 having the built-in photosensors, in that first unit 1001A includes the display panel having no photosensor built therein. Such an electronic device 1300 performs the above-described sensing using display device 103 of second unit 1002.

Instead of display panel 140 having the built-in photosensors, first unit 1001 may include, for example, a touch panel of a resistive type or a capacitive type.

In the present embodiment, it is assumed that display device 102 includes timer 182 and display device 103 includes timer 282, however, display device 102 and display device 103 may be configured to share one timer.

In the present embodiment, it is assumed that electronic device 100 is a foldable type device, however, electronic device 100 is not necessarily limited to the foldable type. For example, electronic device 100 may be a slidable type device in which first casing 100A is slid relative to second casing 100B.

In electronic device 100 according to the present embodiment and configured as above, second unit 1002 is removably attached to first unit 1001 via USB connectors 194, 294.

Electronic device 100 according to the present embodiment can perform the following function for example when powered on. When a user initially presses down power switch 191 of first unit 1001, first unit 1001 utilizes power from power source circuit 192 to launch BIOS (Basic Input/Output System).

Second unit 1002 obtains power from first unit 1001 via USB connectors 194, 294. Second unit 1002 can utilize the power to transmit data to and receive data from first unit 1001. Here, CPU 210 of second unit 1002 uses power through each of USB connectors 194, 294 so as to display types of OSs (Operating Systems) on display panel 240 in a selectable manner.

Through display panel 240, the user selects an OS to be launched. In accordance with the user's selection, CPU 210 transmits a command designating the OS to be launched (for example, “first OS” command shown in FIG. 10), to first unit 1001 via USB connectors 194, 294. In accordance with the command, first unit 1001 launches the OS.

Further, second unit 1002 transmits data to and receives data from an external mobile phone or the like via antenna 295, for example. Via antenna 295, CPU 210 of second unit 1002 obtains photograph image data or corresponding thumbnail data from the external mobile phone, and causes RAM 271 or the like to store the photograph image data or corresponding thumbnail data. CPU 210 reads out the thumbnail data from RAM 271, and causes display panel 240 to display a thumbnail image of the photograph in a selectable manner.

In accordance with an external selection instruction, CPU 210 causes display panel 240 to display the photograph image. Alternatively, CPU 210 causes display panel 140 or display device 102A to display the photograph image via USB connector 294.

As described above, second display panel 240 of electronic device 100 may be a normal touch panel having a tablet function and a display function.

[Variation 18]

<Functional Configuration of Electronic Device 100 According to the Present Embodiment>

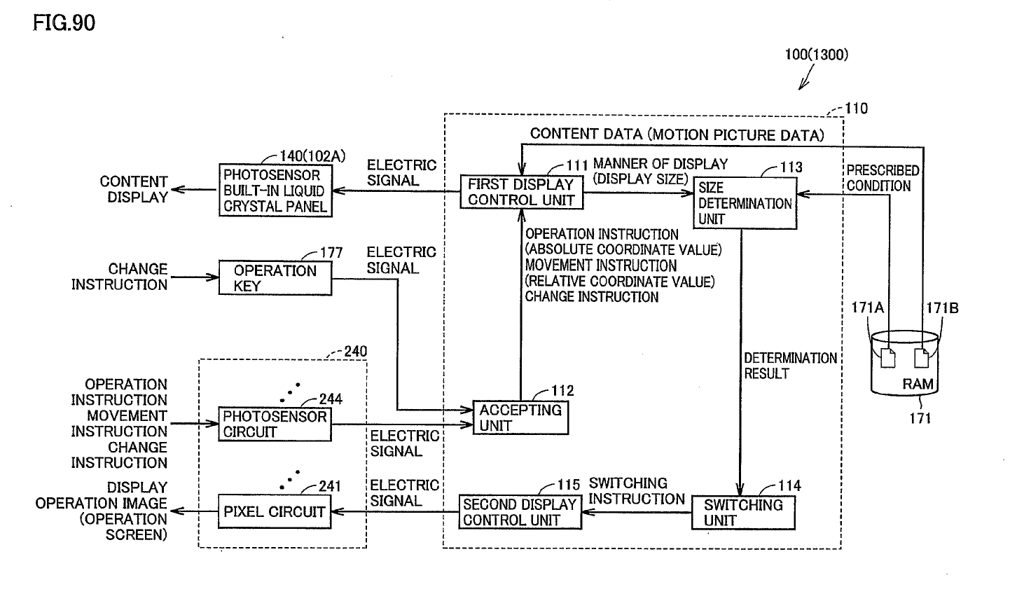

A functional configuration of electronic device 100 (1300) according to the present embodiment will be described hereinafter with reference to FIGS. 2, 87 and 90. It should be noted that FIG. 90 is a block diagram showing a functional configuration of electronic device 100 (1300) according to the present embodiment.

Electronic device 100 according to the present embodiment includes a first display control unit 111, an accepting unit 112, a size determination unit 113, a switching unit 114, and a second display control unit 115. In addition, as shown also in FIG. 2, electronic device 100 includes RAM 171, first display panel 140 (or display device 102A), and second display panel 240 including a plurality of photosensor circuits 244 and a plurality of pixel circuits 241.

Initially, RAM 171 stores condition data 171A storing prescribed conditions used in determining whether to switch a display mode or not and content data 171B such as motion picture data representing a motion picture, still image data representing a still image or a photograph image or the like.

First display panel 140 emits visible light to the outside based on the image data or text data from first display control unit 111, that is, based on an output signal from CPU 110. More specifically, first display panel 140 displays a content, a text or the like with the use of light from backlight 179, based on the image data or the text data from first display control unit 111, through image processing engine 180 (FIG. 2) or the like.

Each of the plurality of photosensor circuits 244 of second display panel 240 receives incident light and generates an electric signal in accordance with the incident light. The plurality of photosensor circuits 244 as a whole input an electric signal corresponding to the incident light to accepting unit 112 through image processing engine 280 (FIG. 2) or the like. It should be noted that the plurality of photosensor circuits 244 may read a position of contact with finger 900, a stylus pen or the like while backlight 179 is turned off as shown in FIG. 88.

The plurality of photosensor circuits 244 and image processing engine 280 according to the present embodiment as a whole thus implement an operation portion. Then, the operation portion accepts an operation instruction for controlling reproduction of a content displayed on first display panel 140, accepts a movement instruction to move the pointer displayed on first display panel 140 (a first movement instruction), or accepts a change instruction to change a size of a content displayed on first display panel 140, through second display panel 240.

Each of the plurality of pixel circuits 241 of second display panel 240 emits visible light to the outside based on the image data or the text data from second display control unit 115, that is, based on an output signal from CPU 110. More specifically, the plurality of pixel circuits 241 as a whole display a content, a text or the like with the use of light from backlight 179, based on the image data or the text data from second display control unit 115, through image processing engine 280 (FIG. 2) or the like.

The plurality of pixel circuits 241 and image processing engine 280 according to the present embodiment as a whole thus implement a display portion. Namely, the display portion causes second display panel 240 to display an operation image, other images, a text, or the like.

First display control unit 111, accepting unit 112, size determination unit 113, switching unit 114, and second display control unit 115 are functions implemented by CPU 110 or the like. More specifically, each function of CPU 110 is a function implemented by execution of a control program stored in RAM 171 or the like by CPU 110 and control thereby of each piece of hardware shown in FIG. 2.

Initially, first display control unit 111 reads content data 171B from RAM 171 and causes first display panel 140 to display a content. For example, first display control unit 111 causes first display panel 140 to reproduce a motion picture.

First display control unit 111 according to the present embodiment changes also a displayed object in accordance with a set display mode. For example, in the normal mode, first display control unit 111 causes first display panel 140 to display a content in a normal size. In the normal mode, first display control unit 111 provides display of the pointer. In the normal mode, first display control unit 111 provides display of main operation image 140C for operating display of a content. In the full-screen mode, first display control unit 111 provides full-screen display of a content on first display panel 140.

First display control unit 111 changes a manner of display of a content based on the change instruction from accepting unit 112. For example, in response to the change instruction to change a window size from accepting unit 112, first display control unit 111 changes a display size of a content. The user uses pointer 140B to pick up an end portion of the window displaying motion picture 140A (content), changes the size of the window, and releases the end portion, to thereby change the display size of motion picture 140A (content).

In addition, first display control unit 111 operates display of a content based on the operation instruction from accepting unit 112. For example, first display control unit 111 causes reproduction of a motion picture, fast-forwarding of the motion picture, or slide show of still images.

In addition, in the normal mode, first display control unit 111 moves the pointer based on the movement instruction from accepting unit 112.

Accepting unit 112 accepts an operation instruction, a movement instruction, a change instruction, or the like input to second display panel 240, based on an electric signal from operation key 177 or an electric signal input from the plurality of photosensor circuits 244 through image processing engine 280. More specifically, accepting unit 112 obtains the image data output from image processing engine 280 of second display panel 240 every sensing time and generates an operation instruction, a movement instruction, a change instruction, or the like based on the image data.

Then, accepting unit 112 may cause RAM 171 to store the image data output from image processing engine 180. Namely, first accepting unit 112 may constantly update the image data in RAM 171 to most recent image data. It should be noted that first accepting unit 112 may be a function implemented by CPU 110 and a plurality of photosensor circuits 144 of first display panel 140. Namely, first accepting unit 112 may be a concept representing a functional block including a partial function of CPU 110 and a light reception function of first display panel 140.

Thus, accepting unit 112 generates a change instruction to change a manner of display of a displayed content, for example, based on an electric signal from operation key 177 or second display panel 240. Accepting unit 112 passes the change instruction to first display control unit 111. For example, the change instruction is an instruction to change a display size of a content (or a size of a window in which a content is to be displayed).

Alternatively, in the normal mode, accepting unit 112 accepts an instruction to make transition to the full-screen mode input through operation key 177 or second display panel 240 as the change instruction, and passes the transition instruction to first display control unit 111. In the full-screen mode, accepting unit 112 accepts an instruction to make transition to the normal mode input through operation key 177 or second display panel 240 as the change instruction, and passes the transition instruction to first display control unit 111. It should be noted that accepting unit 112 accepts an instruction to make transition to the normal mode by sensing pressing of a back button 240D (see the right side in FIG. 87) through second display panel 240.

In addition, in the full-screen mode, accepting unit 112 generates an operation instruction for controlling display of a content based on an absolute coordinate input through second display panel 240. Accepting unit 112 passes the operation instruction to first display control unit 111. For example, accepting unit 112 generates (accepts) an operation instruction to reproduce a motion picture, an operation instruction for fast-forwarding, an operation instruction for skip to a specific position, or the like. Accepting unit 112 passes the operation instruction to first display control unit 111.

In the normal mode, accepting unit 112 generates (accepts) a movement instruction for moving the pointer based on a relative coordinate input through second display panel 240. Accepting unit 112 passes the movement instruction to first display control unit 111.

Size determination unit 113 reads condition data 171A from RAM 171, determines whether or not a manner of display of a content provided by first display control unit 111 on first display panel 140 satisfies a prescribed condition, and outputs a result of determination to switching unit 114. Size determination unit 113 determines that the manner of display of the content satisfies the prescribed condition, for example, when a ratio occupied by an area where the content is displayed to the entire first display panel 140 is not smaller than a prescribed value. Alternatively, when first display control unit 111 provides full-screen display of a content on first display panel 140, size determination unit 113 determines that the manner of display satisfies the prescribed condition, and when first display control unit 111 does not provide full-screen display of the content on first display panel 140, it determines that the manner of display does not satisfy the prescribed condition.

Switching unit 114 switches the display mode based on the result of determination made by size determination unit 113. Switching unit 114 makes switching to the full-screen mode when size determination unit 113 determines that the manner of display satisfies the prescribed condition, and it makes switching to the normal mode when size determination unit 113 determines that the manner of display does not satisfy the prescribed condition.

When size determination unit 113 determines that the manner of display satisfies the prescribed condition, second display control unit 115 causes second display panel 240 to display sub operation image 240C accepting an operation instruction for operating display of a content. Namely, second display control unit 115 causes second display panel 240 to display sub operation image 240C in the full-screen mode. Thus, for example, second display panel 240 plays a role as an operation screen for controlling reproduction of a motion picture and hence user's operability is improved.

On the other hand, when size determination unit 113 determines that the manner of display of the content does not satisfy the prescribed condition, second display control unit 115 causes second display panel 240 to display a wallpaper image. Namely, in the normal mode, second display control unit 115 causes second display panel 240 to display a wallpaper image. Alternatively, in the normal mode, second display control unit 115 provides no display.

In the normal mode, second display control unit 115 causes second display panel 240 to display image 240A indicating that the normal mode is set, that is, second display panel 240 performs a mouse function. In the full-screen mode, second display control unit 115 causes second display panel 240 to display image 240B indicating that the full-screen mode is set, that is, second display panel 240 performs a function as an operation screen dedicated for a content.

<Content Display Processing According to the Present Embodiment>

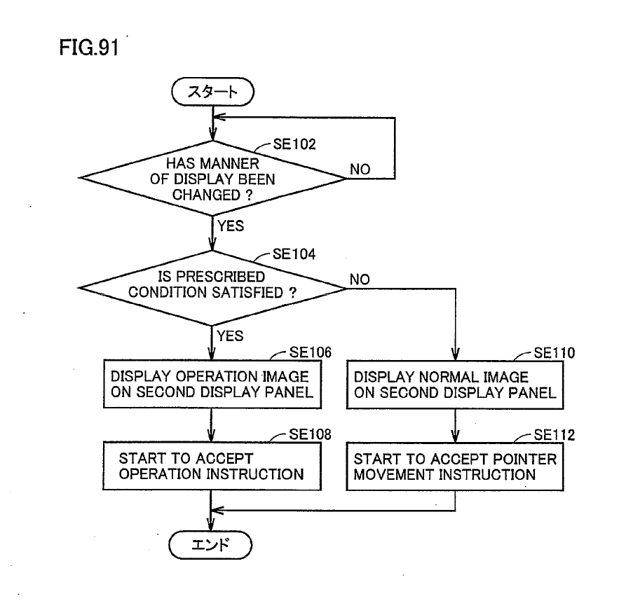

Content display processing in electronic device 100 according to the present embodiment will now be described with reference to FIGS. 2, 87, 90, and 91. It should be noted that FIG. 91 is a conceptual diagram showing a processing procedure in content display processing in electronic device 100 according to the present embodiment. A case where a motion picture is displayed on first display panel 140 in advance will be described below.

Initially, CPU 110 functioning as first display control unit 111 reads content data 171B from RAM 171 and causes first display panel 140 to display a motion picture. When CPU 110 functioning as accepting unit 112 accepts change in display size of a content (determination as YES is made in step SE102), CPU 110 functioning as size determination unit 113 determines whether a manner of display of the changed content satisfies a prescribed condition or not (step SE 104).

Here, CPU 110 determines whether full-screen display of a content is provided on first display panel 140 or not (step SE 104). As shown on the right in FIG. 87, when full-screen display of a content is provided on first display panel 140 (determination as YES is made in step SE104), CPU 110 functioning as switching unit 114 makes switching to the full-screen mode. Namely, CPU 110 functioning as second display control unit 115 causes second display panel 240 to display sub operation image 240C (step SE106). For example, second display control unit 115 causes second display panel 240 to display a play button, a fast-forward button, a rewind button, a skip button, or the like for an operation in a selectable manner (in a manner allowing pressing). CPU 110 functioning as accepting unit 112 accepts an operation instruction for controlling reproduction of a content through second display panel 240 (step SE108).

Meanwhile, as shown on the left in FIG. 87, when a content is displayed in a part of first display panel 140 (determination as NO is made in step SE104), CPU 110 functioning as switching unit 114 makes switching to the normal mode. Namely, CPU 110 functioning as second display control unit 115 causes second display panel 240 to display a normal image (such as a wallpaper image) (step SE110). Alternatively, second display control unit 115 causes second display panel 240 to display nothing, that is, second display panel 240 functions only as a photosensor. CPU 110 functioning as accepting unit 112 accepts an instruction to move pointer 140B through second display panel 240 (step SE112). Namely, second display panel 240 performs a function like a mouse.

<First Additional Function of Electronic Device 100>

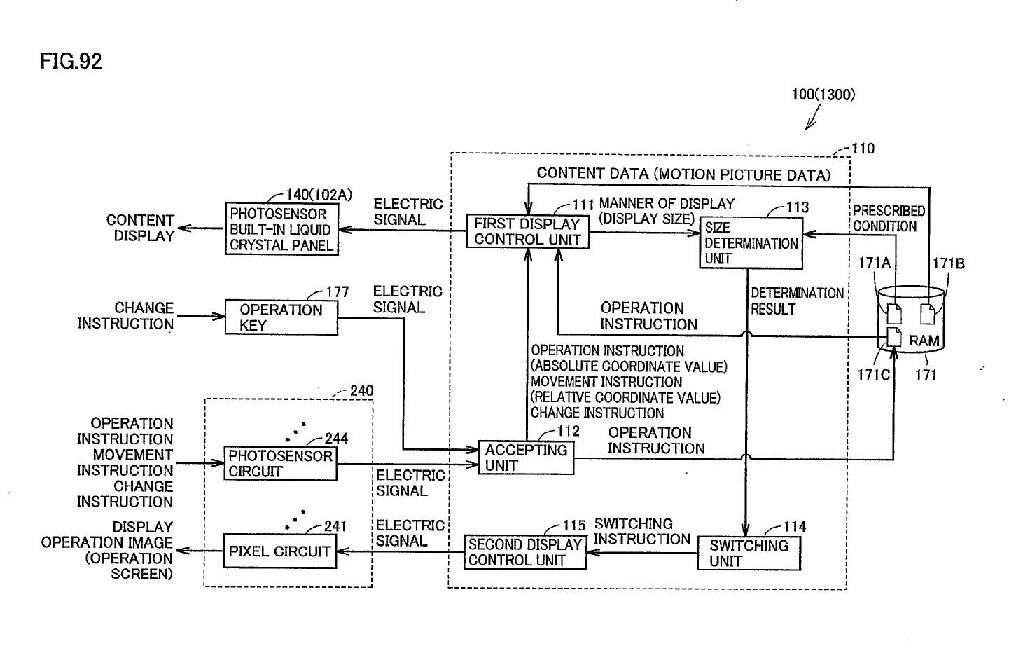

A first additional function of electronic device 100 (1300) according to the present embodiment will now be described with reference to FIGS. 2, 87 and 92. FIG. 92 is a block diagram showing a functional configuration of electronic device 100 (1300) having the first additional function.

As described above, electronic device 100 according to the present embodiment has a function that is convenient when transition to a state in which second display panel 240 displays sub operation image 240C (first image) is made. Meanwhile, the first additional function described here is a function that is convenient when transition to a state in which first display panel 140 displays main operation image 140C (second image) is made.

Since functions of first display panel 140, second display panel 240, size determination unit 113, switching unit 114, and second display control unit 115 are similar to those as described above, description will not be repeated here. A function added to accepting unit 112 and first display control unit 111 will mainly be described below.

In addition to the function described above, accepting unit 112 causes RAM 171 to store instruction data 171C based on an operation instruction input through operation key 177, sub operation image 240C on second display panel 240, or the like. More specifically, accepting unit 112 updates instruction data 171C stored in RAM 171 in response to a newly accepted operation instruction. Thus, RAM 171 always stores instruction data 171C corresponding to the last (most recent) operation instruction.

In addition to the function described above, first display control unit 111 reads the most recent instruction data from RAM 171 in switching from the full-screen mode to the normal mode and causes first display panel 140 to display the pointer at a position corresponding to the most recent operation instruction. First display control unit 111 causes the pointer to be displayed in a manner superimposed on an operation button corresponding to the operation instruction among the operation buttons included in main operation image 140C, based on the instruction data.

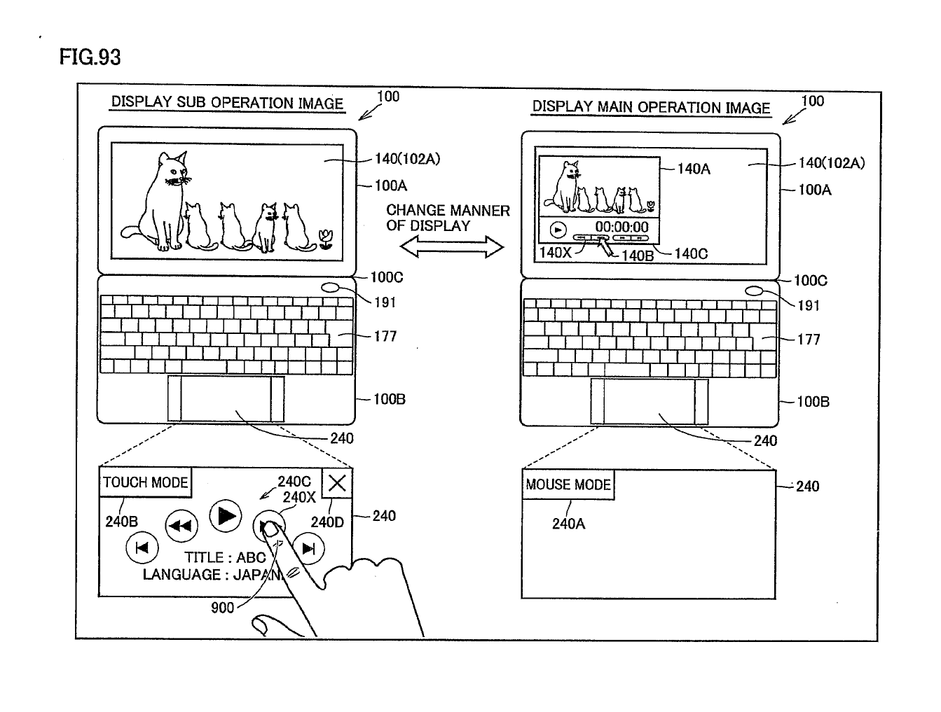

FIG. 93 is a conceptual diagram showing transition of a screen on electronic device 100 having the first additional function. In FIG. 93, a state in which second display control unit 115 causes second display panel 240 to display sub operation image 240C in the full-screen mode is shown on the left. When the user presses a fast-forward button 240X on second display panel 240, that is, when accepting unit 112 accepts an instruction to fast-forward a motion picture through second display panel 240, accepting unit 112 causes RAM 171 to store instruction data 171C indicating the fast-forward instruction.

Thereafter, when accepting unit 112 accepts an instruction to make transition to the normal mode, as shown on the right in FIG. 93, a state where first display control unit 111 causes first display panel 140 to display main operation image 140C is shown. Here, first display control unit 111 causes first display panel 140 to display pointer 140B at a position in main operation image 140C where a fast-forward button 140X is displayed.

Thus, when the user desires to fast-forward the motion picture again, the user does not have to move pointer 140B to fast-forward button 140X. In other words, it is not necessary to perform a precise touch operation onto second display panel 240 in order to move pointer 140B. Namely, electronic device 100 according to the present embodiment can provide an operation screen readily operable by the user depending on a situation.

<Content Display Processing in Electronic Device 100 Having First Additional Function>

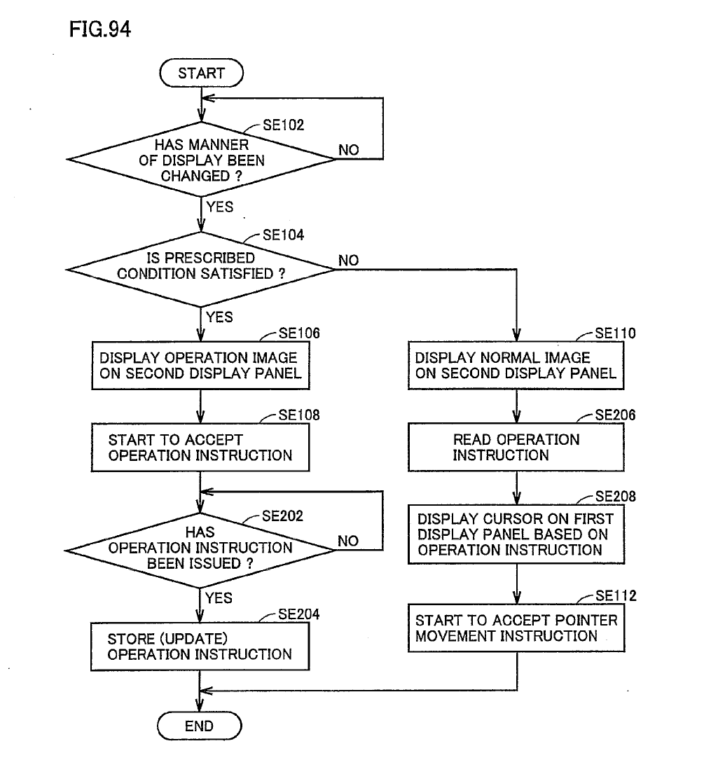

Content display processing in electronic device 100 according to the present embodiment will now be described with reference to FIGS. 2, 87, 92, 93, and 94. It should be noted that FIG. 94 is a conceptual diagram showing a processing procedure in content display processing in electronic device 100 having the first additional function. A case where a motion picture is displayed on first display panel 140 in advance will be described below.

Initially, CPU 110 functioning as first display control unit 111 reads content data 171B from RAM 171 and causes first display panel 140 to display a motion picture. When CPU 110 functioning as accepting unit 112 accepts change in display size of a content (determination as YES is made in step SE102), CPU 110 functioning as size determination unit 113 determines whether a manner of display of the changed content satisfies a prescribed condition or not (step SE104).

Here, CPU 110 determines whether full-screen display of a content is provided on first display panel 140 or not (step SE104). As shown on the right in FIG. 87, when full-screen display of a content is provided on first display panel 140 (determination as YES is made in step SE104), CPU 110 functioning as switching unit 114 makes switching to the full-screen mode. Namely, CPU 110 functioning as second display control unit 115 causes second display panel 240 to display sub operation image 240C (step SE106). For example, second display control unit 115 causes second display panel 240 to display a play button, fast-forward button 240X, a rewind button, a skip button, or the like for an operation in a selectable manner (in a manner allowing pressing). CPU 110 functioning as accepting unit 112 accepts an operation instruction for controlling reproduction of a content through second display panel 240 (step SE108).

CPU 110 functioning as accepting unit 112 accepts a user's operation instruction through sub operation image 240C on second display panel 240 (step SE202). CPU 110 causes RAM 171 to store (update) instruction data 171C corresponding to the operation instruction (step SE204).

Meanwhile, as shown on the left in FIG. 87, when a content is displayed in a part of first display panel 140 (determination as NO is made in step SE 104), CPU 110 functioning as switching unit 114 makes switching to the normal mode. Namely, CPU 110 functioning as second display control unit 115 causes second display panel 240 to display a normal image (such as a wallpaper image) (step SE110). Alternatively, second display control unit 115 causes second display panel 240 to display nothing, that is, second display panel 240 functions only as a photosensor.

CPU 110 functioning as first display control unit 111 reads most recent instruction data 171C from RAM 171 (step SE206). CPU 110 causes first display panel 140 to display pointer 140B at a position in main operation image 140C, corresponding to the most recent operation instruction accepted from the user (over fast-forward button 140X) (step SE208). CPU 110 functioning as accepting unit 112 accepts an instruction to move pointer 140B through second display panel 240 (step SE112). Namely, second display panel 240 performs a function like a mouse.

<Second Additional Function of Electronic Device 100>

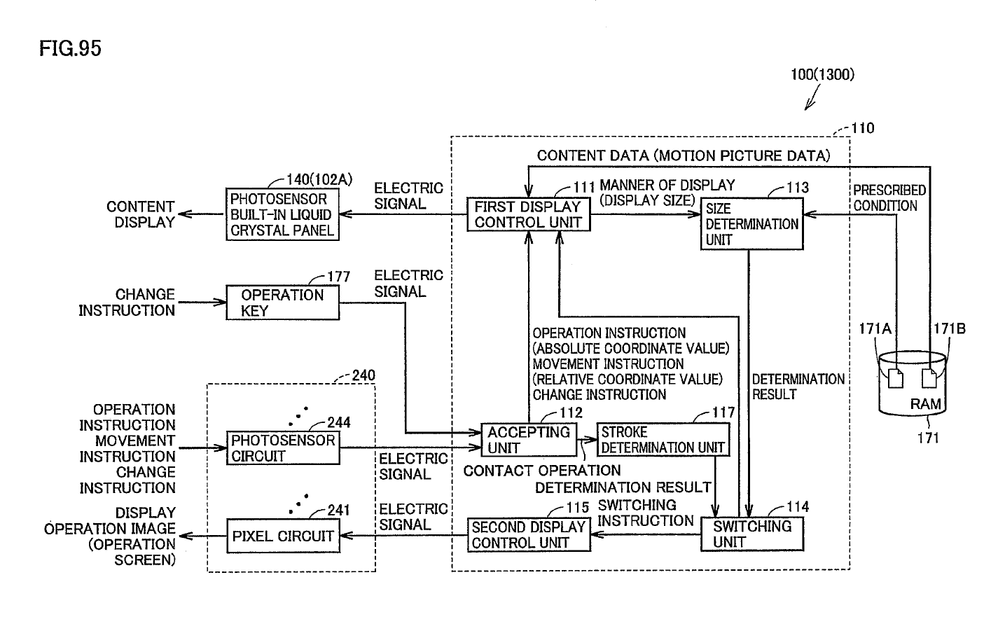

A second additional function of electronic device 100 (1300) according to the present embodiment will now be described with reference to FIGS. 2, 87 and 95. FIG. 95 is a block diagram showing a functional configuration of electronic device 100 (1300) having the second additional function.

As described above, the first additional function is a function that is convenient when transition to a state in which first display panel 140 displays main operation image 140C (second image) is made. Meanwhile, the second additional function described here is a function for first display panel 140 to display pointer 140B while full-screen display of a content is provided. It should be noted that a stroke determination unit 117 or the like implementing the second additional function is also additionally applicable to electronic device 100 having the first additional function.

Since functions of first display panel 140, second display panel 240, size determination unit 113, and second display control unit 115 are similar to those described above, description will not be repeated here. Electronic device 100 includes stroke determination unit 117 as the second additional function. A function added to accepting unit 112 and first display control unit 111 and a function of stroke determination unit 117 will be described below.

In addition to the function described above, accepting unit 112 accepts various contact operations from the user through second display panel 240. The contact operation includes, for example, a stroke operation to slide finger 900 over second display panel 240 while it is in contact with second display panel 240 and a tap operation that finger 900 touches second display panel 240 (an operation hardly sliding over second display panel 240).

In the full-screen mode, accepting unit 112 senses a user's operation to contact second display panel 240 based on image data obtained from second display panel 240. For example, accepting unit 112 obtains a position of contact of finger 900 with second display panel 240 for each piece of image data (a center coordinate in a portion of contact of finger 900 with second display panel 240) based on image data sent at any time from second display panel 240 and passes chronological data of positions of contact to stroke determination unit 117 as contact operation data.

In the full-screen mode, stroke determination unit 117 determines whether an instruction to operate a content such as a motion picture (a tap operation) or a display instruction for displaying the pointer on second display panel 240 (a stroke operation) has been accepted. Namely, in the full-screen mode, stroke determination unit 117 determines whether or not a display instruction has been accepted, based on the contact operation data from accepting unit 112.

Stroke determination unit 117 determines whether or not a length of a stroke of the user's operation to contact second display panel 240 is equal to or longer than a prescribed distance set in advance. Specifically, stroke determination unit 117 calculates a length of a stroke of the contact operation by calculating a distance between a position of start of the contact operation and a position of end of the contact operation based on the contact operation data. Then, when the length of the stroke of the contact operation is equal to or longer than the prescribed distance set in advance, stroke determination unit 117 determines that the user has input a display instruction for displaying the pointer. On the other hand, when the length of the stroke of the contact operation is shorter than the prescribed distance set in advance, stroke determination unit 117 determines that the user has pressed the operation button, that is, the user has input the instruction to operate the content.

When stroke determination unit 117 determines that the display instruction has been input, switching unit 114 makes switching to the normal mode. At the same time, when stroke determination unit 117 determines that the display instruction has been input, first display panel 140 is caused to display pointer 140B. Thus, accepting unit 112 starts to accept a pointer movement instruction to move pointer 140B from the user through second display panel 240.

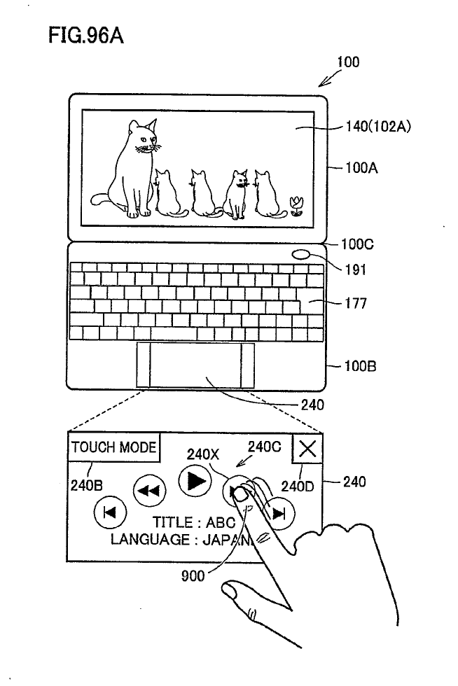

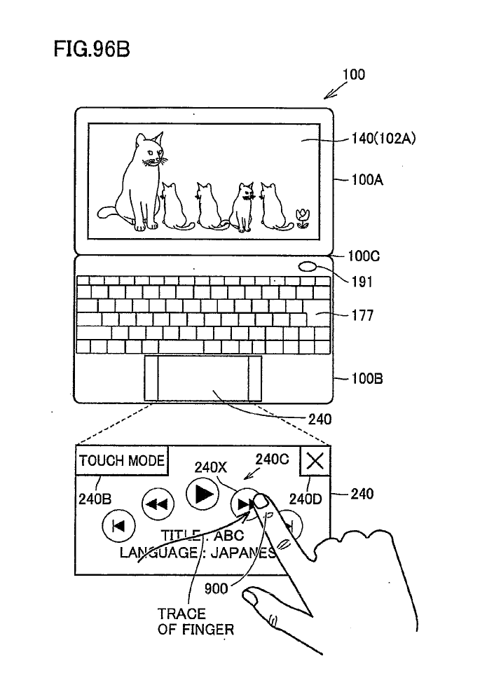

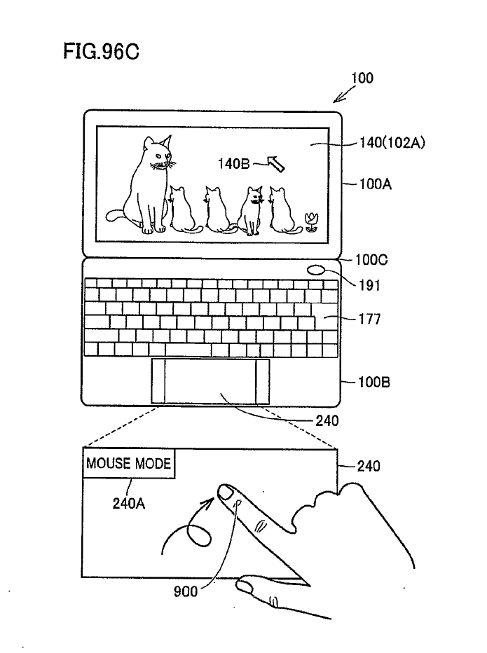

FIG. 96 is a conceptual diagram showing transition of a screen on electronic device 100 having the second additional function. As shown in FIG. 96A, in the full-screen mode, second display control unit 115 causes second display panel 240 to display sub operation image 240C. Then, when the user's finger 900 came in contact with fast-forward button 240X on second display panel 240 and moved away from second display panel 240 without sliding, stroke determination unit 117 accepts an instruction to operate a content, for example, a content fast-forward instruction. Here, no transition is made with the full-screen mode being maintained, and neither of the screen on first display panel 140 and the screen on second display panel 240 changes. Namely, when the user performs a tap operation on second display panel 240, second display panel 240 does not make transition from the full-screen mode.

On the other hand, when the user's finger 900 came in contact with second display panel 240, slid by a prescribed distance or more, and moved away from second display panel 240, that is, when stroke determination unit 117 determines that a distance of slide of the user's finger 900 (a length of the stroke of the contact operation) is equal to or longer than the prescribed distance, switching unit 114 makes switching from the full-screen mode to the normal mode as shown in FIG. 96C. Namely, switching unit 114 sends a switching instruction to first display control unit 111 and second display control unit 115. Thus, first display control unit 111 causes first display panel 140 to display pointer 140B while full-screen display of the content is maintained. Then, accepting unit 112 starts to accept an instruction to move pointer 140B through second display panel 240. Namely, when the user performs a stroke operation onto second display panel 240, second display panel 240 makes transition from the full-screen mode to the normal mode.

It should be noted that first display control unit 111 may cause a part of first display panel 140 to display a content when the user performs a stroke operation onto second display panel 240. In addition, as shown on the right in FIG. 93, first display control unit 111 may cause first display panel 140 to display pointer 140B and main operation image 140C. Then, size determination unit 113 determines whether or not a manner of display of a content provided by first display control unit 111 on first display panel 140 satisfies a prescribed condition (whether full-screen display of a content is provided or not).

Here, since full-screen display of the content is not provided, switching unit 114 makes switching to the normal mode. Namely, in the normal mode, second display control unit 115 causes second display panel 240 to display a wallpaper image. Alternatively, in the normal mode, second display control unit 115 provides no display.

Thus, for example, the user can move pointer 140B over a desired object so as to cause first display panel 140 or second display panel 240 of electronic device 100 to display description of the object even in the full-screen mode. Namely, electronic device 100 according to the present embodiment can provide an operation screen readily operable by the user depending on a state of display and can also change an operation screen based only on user's intention.

<Content Display Processing in Electronic Device 100 Having Second Additional Function>

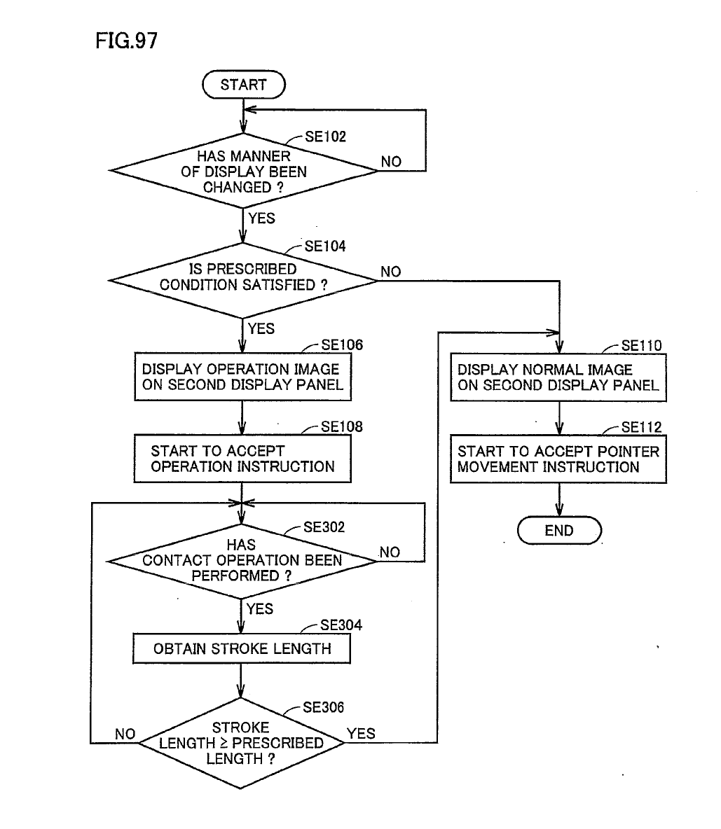

Content display processing in electronic device 100 according to the present embodiment will now be described with reference to FIGS. 2, 87, 95, 96A to 96C, and 97. It should be noted that FIG. 97 is a conceptual diagram showing a processing procedure in content display processing in electronic device 100 having the second additional function. A case where a motion picture is displayed on first display panel 140 in advance will be described below.

Initially, CPU 110 functioning as first display control unit 111 reads content data 171B from RAM 171 and causes first display panel 140 to display a motion picture. When CPU 110 functioning as accepting unit 112 accepts change in display size of a content (determination as YES is made in step SE102), CPU 110 functioning as size determination unit 113 determines whether a manner of display of the changed content satisfies a prescribed condition or not (step SE104).

Here, CPU 110 determines whether full-screen display of a content is provided on first display panel 140 or not (step SE104). As shown on the right in FIG. 87, when full-screen display of a content is provided on first display panel 140 (determination as YES is made in step SE104), CPU 110 functioning as switching unit 114 makes switching to the full-screen mode. Namely, CPU 110 functioning as second display control unit 115 causes second display panel 240 to display sub operation image 240C (step SE106). For example, second display control unit 115 causes second display panel 240 to display a play button, a fast-forward button, a rewind button, a skip button, or the like for an operation in a selectable manner (in a manner allowing pressing). CPU 110 functioning as accepting unit 112 accepts an operation instruction for controlling reproduction of a content through second display panel 240 (step SE108).

CPU 110 functioning as accepting unit 112 waits for a user's contact operation through second display panel 240 (step SE302). When the user's contact operation has been accepted (determination as YES is made in step SE302), CPU 110 functioning as stroke determination unit 117 calculates a length of a stroke of the contact operation based on the contact operation data (step SE304). CPU 110 determines whether the length of the stroke is equal to or longer than a prescribed distance or not (step SE306).

When the length of the stroke is equal to or longer than the prescribed distance (determination as YES is made in step SE306), CPU 110 causes first display panel 140 to display pointer 140B on the content and then repeats the processing from step SE110. In contrast, when the length of the stroke is not longer than the prescribed distance (determination as NO is made in step SE306), CPU 110 repeats the processing from step SE302.

Meanwhile, as shown on the left in FIG. 87, when a content is displayed in a part of first display panel 140 (determination as NO is made in step SE 104), CPU 110 functioning as switching unit 114 makes switching to the normal mode. Namely, CPU 110 functioning as second display control unit 115 causes second display panel 240 to display a normal image (such as a wallpaper image) (step SE110). Alternatively, second display control unit 115 causes second display panel 240 to display nothing, that is, second display panel 240 functions only as a photosensor.

CPU 110 functioning as accepting unit 112 accepts an instruction to move the pointer through second display panel 240 (step SE112). Namely, second display panel 240 performs a function like a mouse.

<Third Additional Function of Electronic Device 100>

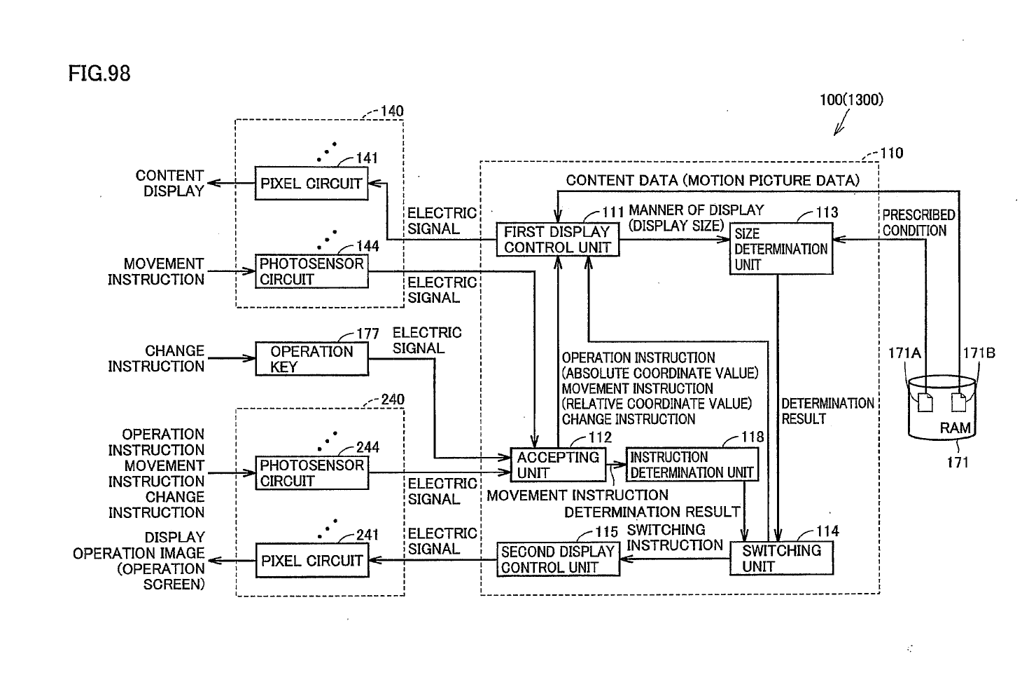

A third additional function of electronic device 100 (1300) according to the present embodiment will now be described with reference to FIGS. 2, 87 and 98. FIG. 98 is a block diagram showing a functional configuration of electronic device 100 (1300) having the third additional function.

As described above, electronic device 100 according to the present embodiment changes contents to be displayed on second display panel 240 or an instruction to be accepted through second display panel 240 in accordance with a state of display on first display panel 140, that is, the mode thereof is switched between the full-screen mode and the normal mode in accordance with a state of display on first display panel 140. The third additional function described here changes a state of display on first display panel 140, contents to be displayed on second display panel 240, or an instruction to be accepted through second display panel 240, in response to a user's operation. Namely, the user actively makes such changes.

It should be noted that an instruction determination unit 118 or the like implementing the third additional function is also applicable to electronic device 100 having the first additional function, it is also additionally applicable to electronic device 100 having the second additional function, or it is also additionally applicable to electronic device 100 having the first additional function and the second additional function.

Since functions of first display panel 140, second display panel 240, size determination unit 113, and second display control unit 115 are similar to those described above, description will not be repeated here. Electronic device 100 includes instruction determination unit 118 as the third additional function. A function added to accepting unit 112 and first display control unit 111 and a function of instruction determination unit 118 will be described below.

In addition to the function described above, accepting unit 112 accepts various contact operations from the user through second display panel 240. The contact operation includes, for example, a stroke operation to slide finger 900 over second display panel 240 while it is in contact with second display panel 240 and a tap operation that finger 900 touches second display panel 240 (an operation hardly sliding over second display panel 240).

In a case where first display panel 140 is a photosensor built-in liquid crystal panel or a touch panel, in the normal mode, accepting unit 112 senses a user's operation to contact first display panel 140 based on the image data obtained from first display panel 140. For example, accepting unit 112 obtains a position of contact of finger 900 with first display panel 240 for each piece of image data (a center coordinate in a portion of contact of finger 900 with first display panel 140) based on the image data sent at any time from first display panel 240.

In addition, accepting unit 112 senses a user's operation of contact with second display panel 240 based on the image data obtained from second display panel 240. For example, accepting unit 112 obtains a position of contact of finger 900 with second display panel 240 for each piece of image data (a center coordinate in a portion of contact of finger 900 with second display panel 240) based on the image data sent at any time from second display panel 240.

Thus, the user inputs a movement instruction for moving main operation image 140C (a second movement instruction) to electronic device 100 through second display panel 240. Then, in a case where first display panel 140 is a photosensor built-in liquid crystal panel or a touch panel, the user can input to electronic device 100 also through first display panel 140, a movement instruction (second movement instruction) for moving (dragging) main operation image 140C.

Accepting unit 112 sets main operation image 140C in a selected (held) state based on the contact position and the display position of main operation image 140C. Accepting unit 112 passes chronological data of positions of contact in the held state to stroke determination unit 117 as movement instruction data.

In the normal mode, instruction determination unit 118 determines whether held main operation image 140C was moved to the lower end of first display panel 140 (an end portion of first display panel 140 on the second display panel 240 side) or not, based on the movement instruction data. More specifically, instruction determination unit 118 determines whether or not the contact position has reached a prescribed area while main operation image 140C is held. Alternatively, instruction determination unit 118 obtains a coordinate value indicating a contact position, a direction of movement of the contact position, or a moving speed of the contact position based on the movement instruction data, and determines whether or not main operation image 140C has disappeared off to the lower end of first display panel 140 based on the coordinate value, the direction of movement, or the moving speed.

When instruction determination unit 118 determines that the contact position reached the prescribed area set at the lower end of first display panel 140 while it moved downward, switching unit 114 determines that the mode switching instruction has been input from the user. Namely, in the normal mode, switching unit 114 makes switching to the full-screen mode when instruction determination unit 118 determines that the contact position reached the prescribed area set at the lower end of first display panel 140 while it moved downward.

More specifically, when instruction determination unit 118 determines that the contact position reached the prescribed area set at the lower end of first display panel 140 while it moved downward, first display panel 140 provides full-screen display of a content. Then, size determination unit 113 determines whether or not the manner of display of the content provided by first display control unit 111 on first display panel 140 satisfies the prescribed condition (whether full-screen display of the content is provided or not).

Since full-screen display of the content is provided here, switching unit 114 makes switching to the full-screen mode. Namely, in the full-screen mode, second display control unit 115 causes second display panel 240 to display sub operation image 240C. Accepting unit 112 starts to accept an instruction to operate a content from the user through second display panel 240.

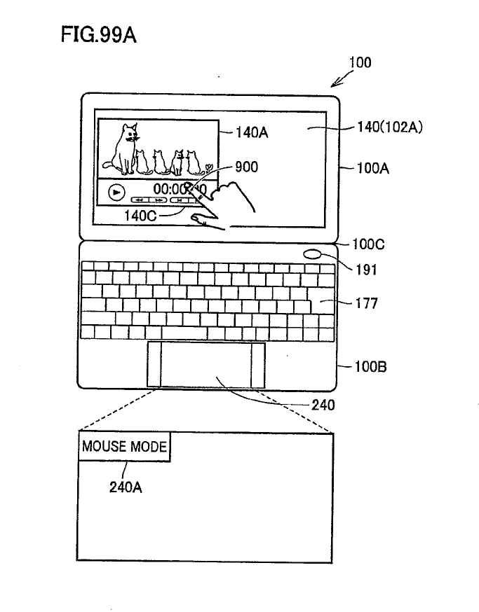

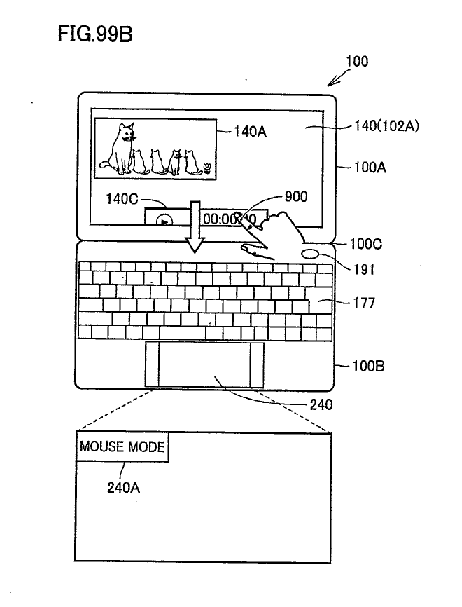

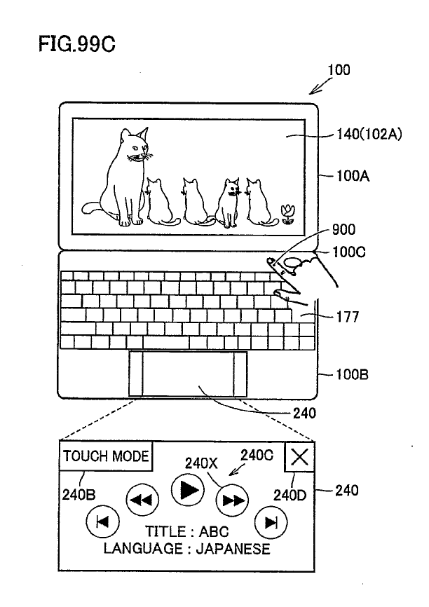

FIGS. 99A to 99C are conceptual diagrams showing transition of a screen on electronic device 100 having the third additional function. A case where first display panel 140 is a photosensor built-in liquid crystal panel or a touch panel will be described here. As shown in FIG. 99A, in the normal mode, when the user's finger 900 comes in contact with a position in first display panel 140 where main operation image 140C is displayed, accepting unit 112 sets main operation image 140C to the held state. When the user's finger 900 slides over the surface of first display panel 140 while main operation image 140C is in the held state, main operation image 140C moves over first display panel 140 in accordance with the position of contact between first display panel 140 and finger 900.

As shown in FIG. 99B, when the user's finger 900 holds main operation image 140C to move the same to the lower end of first display panel 140 (a prescribed area provided in the lower portion of first display panel 140), instruction determination unit 118 determines that main operation image 140C has reached the prescribed area and switching unit 114 makes switching to the full-screen mode.

As shown in FIG. 99C, when transition to the full-screen mode is made, first display panel 140 provides full-screen display of a content. In other words, when first display panel 140 provides full-screen display of the content, switching unit 114 makes switching to the full-screen mode. In the full-screen mode, second display panel 240 displays sub operation image 240C. Accepting unit 112 accepts an instruction to operate the content through the operation screen on second display panel 240.

<Content Display Processing in Electronic Device 100 Having Third Additional Function>

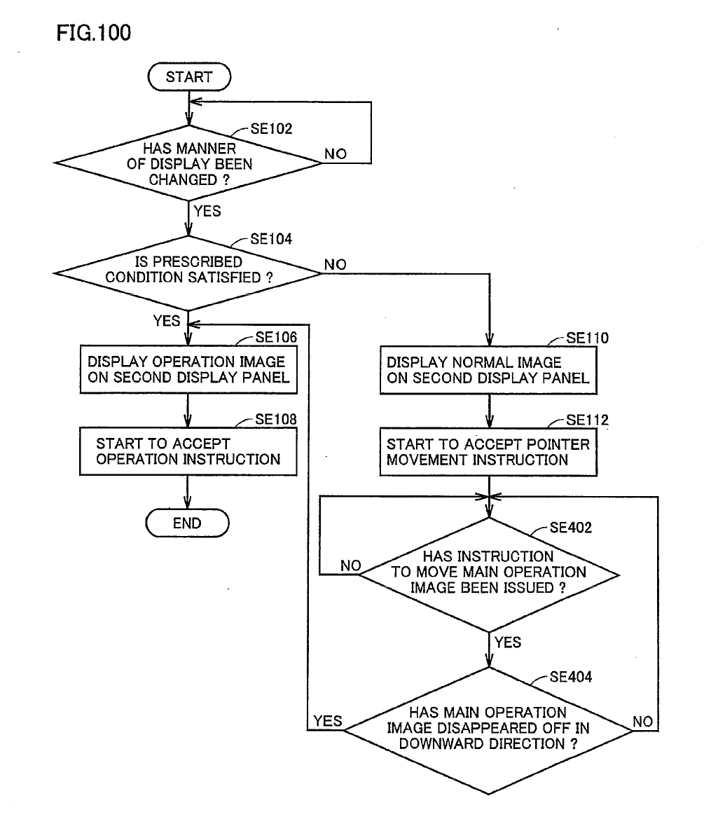

Content display processing in electronic device 100 according to the present embodiment will now be described with reference to FIGS. 2, 87, 98, 99A to 99C, and 100. It should be noted that FIG. 100 is a conceptual diagram showing a processing procedure in content display processing in electronic device 100 having the third additional function. A case where a motion picture is displayed on first display panel 140 in advance will be described below.

Initially, CPU 110 functioning as first display control unit 111 reads content data 171B from RAM 171 and causes first display panel 140 to display a motion picture. When CPU 110 functioning as accepting unit 112 accepts change in display size of a content (determination as YES is made in step SE102), CPU 110 functioning as size determination unit 113 determines whether a manner of display of the changed content satisfies a prescribed condition or not (step SE 104).

Here, CPU 110 determines whether full-screen display of a content is provided on first display panel 140 or not (step SE104). As shown on the right in FIG. 87, when full-screen display of a content is provided on first display panel 140 (determination as YES is made in step SE104), CPU 110 functioning as switching unit 114 makes switching to the full-screen mode. Namely, CPU 110 functioning as second display control unit 115 causes second display panel 240 to display sub operation image 240C (step SE106). For example, second display control unit 115 causes second display panel 240 to display a play button, a fast-forward button, a rewind button, a skip button, or the like for an operation in a selectable manner (in a manner allowing pressing). CPU 110 functioning as accepting unit 112 accepts an operation instruction for controlling reproduction of a content through second display panel 240 (step SE108).

Meanwhile, as shown on the left in FIG. 87, when a content is displayed in a part of first display panel 140 (determination as NO is made in step SE104), CPU 110 functioning as switching unit 114 makes switching to the normal mode. Namely, CPU 110 functioning as second display control unit 115 causes second display panel 240 to display a normal image (such as a wallpaper image) (step SE110). Alternatively, second display control unit 115 causes second display panel 240 to display nothing, that is, second display panel 240 functions only as a photosensor.

CPU 110 functioning as accepting unit 112 accepts an instruction to move pointer 140B through second display panel 240 (step SE112). Namely, second display panel 240 performs a function like a mouse.

CPU 110 functioning as accepting unit 112 waits for an instruction to move main operation image 140C from the user through first display panel 140 or second display panel 240 (step SE402). When CPU 110 functioning as instruction determination unit 118 has accepted the user's movement instruction (determination as YES is made in step SE402), it determines whether main operation image 140C has reached the prescribed area or not, based on the movement instruction data (step SE404). For example, CPU 110 determines whether or not the lower portion of main operation image 140C has disappeared off in a downward direction of first display panel 140.

When main operation image 140C has reached the prescribed area (determination as YES is made in step SE404), CPU 110 provides full-screen display of the content on first display panel 140 and repeats the processing from step SE106. In contrast, when main operation image 140C has not reached the prescribed area (determination as NO is made in step SE404), CPU 110 repeats the processing from step SE402.

### OTHER EMBODIMENTS

The present invention is naturally applicable also to a case where the present invention is achieved by supplying a program to a system or an apparatus. In addition, the effects of the present invention can be achieved also by supply of a storage medium storing a program implemented by software for achieving the present invention to a system or an apparatus and reading and execution of program codes stored in the storage medium by the system or a computer (or a CPU or an MPU) of the apparatus.

In this case, the program codes themselves read from the storage medium implement the functions of the embodiments described previously and the storage medium storing the program codes implements the present invention.

As a storage medium for supplying program codes, for example, a hard disc, an optical disc, a magneto-optical disc, a CD-ROM, a CD-R, a magnetic tape, a non-volatile memory card (an IC memory card), a ROM (a mask ROM, a flash EEPROM and the like), and the like can be employed.

In addition, such a case that not only the functions of the embodiments described previously are implemented by executing the program codes read by the computer but also the functions of the embodiments described previously are implemented by actual processing partially or entirely performed by an OS (operating system) operating on the computer based on an instruction from the program codes is naturally encompassed.

Further, such a case that the program codes read from the storage medium are written in a memory included in a function expansion board inserted in the computer or a function expansion unit connected to the computer and thereafter the functions of the embodiments described previously are implemented by actual processing partially or entirely performed by a CPU or the like included in the function expansion board or the function expansion unit based on an instruction from the program codes is naturally encompassed.

### SUMMARY

An electronic device according to the present invention includes a first display portion, a second display portion, an operation portion, and a control unit for controlling a manner of display on the first and second display portions, the second display portion is a display-integrated tablet capable of accepting an external input, the control unit is capable of operating in a first mode causing the first display portion to display a screen created in processing performed in accordance with the input to the tablet and in a second mode causing the second display portion to display a screen created in processing performed in accordance with the input to the tablet, and the control unit switches the operation mode between the first mode and the second mode in response to an operation onto the operation portion.

In addition, the electronic device according to the present invention further includes a storage portion. When the operation mode is switched from the second mode to the first mode, the control unit causes the storage portion to store operation information which is information specifying contents of the operation in the second mode, and when the operation mode is switched from the first mode to the second mode, the control unit causes the second display portion to display information in accordance with the operation information stored in the storage portion.

In addition, in the electronic device according to the present invention, when the operation mode is switched from the first mode to the second mode, the control unit launches a specific application if the operation information stored in the storage portion is in an initial state, and the control unit causes the second display portion to display a screen generated as a result of execution of the specific application.

In addition, in the electronic device according to the present invention, the control unit initializes the operation information stored in the storage portion in accordance with variation in a power supply state of the electronic device or reboot of the electronic device.

In addition, in the electronic device according to the present invention, the control unit can execute a plurality of applications, the plurality of applications include a specific application for launching other applications among the plurality of applications, and when the specific application is launched, the control unit initializes the operation information stored in the storage portion.

In addition, in the electronic device according to the present invention, when the electronic device is launched or returns from the specific power supply state, the control unit operates in the first mode.

In addition, in the electronic device according to the present invention, the control unit operates in the first mode while the electronic device is in a specific operation state.

In addition, in the electronic device according to the present invention, the control unit causes the second display portion to show that the operation portion can be operated for making switching between the modes only during a period in which mode switching between the first mode and the second mode can be made as the operation portion is operated.

A method of controlling an electronic device according to the present invention is a method of controlling an electronic device including a first display portion, a second display portion implemented by a display-integrated tablet capable of accepting an external input, an operation portion, and a control unit for controlling a manner of display on first and second display devices, and an operation is performed in a first mode causing the first display portion to display a screen created in processing performed in accordance with the input to the tablet and in a second mode causing the second display portion to display a screen created in processing performed in accordance with the input to the tablet, and the operation mode is switched between the first mode and the second mode in response to an operation onto the operation portion.

A program for controlling an electronic device according to the present invention is a computer-readable control program for controlling an electronic device including a first display portion, a second display portion implemented by a display-integrated tablet capable of accepting an external input, an operation portion, and a control unit for controlling a manner of display on first and second display devices, and the control program causes the electronic device to operate in a first mode causing the first display portion to display a screen created in processing performed in accordance with the input to the tablet and in a second mode causing the second display portion to display a screen created in processing performed in accordance with the input to the tablet, and causes the operation mode to switch between the first mode and the second mode in response to an operation onto the operation portion.

According to the present invention, in the electronic device including the first display portion and the second display portion, an operation can be performed in two types of modes of the first mode causing the first display portion to display the screen created in the processing performed in accordance with the input to the tablet including the second display portion and the second mode causing the second display portion to mainly display the screen created in the processing performed in accordance with the input to the tablet, and the operation mode is switched between the first mode and the second mode in response to an operation onto the operation portion.

Thus, the user can use the electronic device including two display devices (first and second display portions) in both of the first mode and the second mode, and the user can seamlessly use the electronic device by switching between these modes with a simplified operation.

In particular, the present invention is effective when the electronic device can execute a plurality of sub applications in the second mode and an operation to switch between each sub application and the first mode is frequently performed.

According to one aspect of the present invention, an electronic device includes a display for displaying a first screen, a display-integrated tablet capable of accepting an external input, and a control unit for controlling an operation of the display and the tablet, the control unit includes a mode switching unit for switching between a first operation mode and a second operation mode of the control unit and an execution unit for executing a program, and the execution unit executes the program in response to an input to the tablet, causes the display to display an image created by the executed program, and changes an image displayed on the display in accordance with change in position of input to the tablet in the first operation mode, and executes the program in response to an input to the tablet, causes the tablet to display an image created by the executed program, and controls display on the display independently of change in position of the input to the tablet in the second operation mode.

Preferably, the execution unit causes a cursor to be displayed at a position within the display in accordance with the position of input to the tablet in the first operation mode and controls the position of the cursor independently of the position of input to the tablet in the second operation mode.

Further preferably, the execution unit changes display of the cursor in response to switching from the first operation mode to the second operation mode.

Further preferably, in the second operation mode, the execution unit causes the cursor to be displayed in a form of display different from that in the first operation mode.

Further preferably, in the second operation mode, the execution unit causes the cursor to be displayed in a less intense manner than the cursor in the first operation mode.

Further preferably, in the second operation mode, the execution unit stops display of the cursor on the display.

Further preferably, in the second operation mode, the execution unit changes display of the cursor when it determines that the cursor overlaps with an active window within the display.

Further preferably, the execution unit moves the cursor to a prescribed display position in response to switching from the first operation mode to the second operation mode.

Further preferably, in the second operation mode, the execution unit causes the cursor to be displayed at an end portion of the display.

Further preferably, in the second operation mode, the execution unit moves the cursor to a prescribed display position when it determines that the cursor overlaps with an active window within the display.

Further preferably, in the second operation mode, the execution unit moves the cursor to a region outside the window when it determines that the cursor overlaps with an active window within the display.

Further preferably, in the second operation mode, the execution unit causes the cursor to be displayed at an end portion of the display when it determines that the cursor overlaps with an active window within the display.

Further preferably, the electronic device further includes a storage device, and the execution unit causes the storage device to store the position of the cursor in the first operation mode and causes the cursor to be displayed at the position of the cursor stored in the storage device in response to switching from the second operation mode to the first operation mode.

Further preferably, the electronic device further includes an interface to which an external pointing device can be connected, and when it is determined that the pointing device is connected to the interface, the execution unit causes the same cursor to be displayed before and after switching from the first operation mode to the second operation mode.

Further preferably, a program includes a first program and a second program, and the execution unit executes the first program in response to an input to the tablet in the first operation mode and executes the second program in response to an input to the tablet in the second operation mode.

Further preferably, the execution unit includes a first execution unit and a second execution unit, the first execution unit executes the first program in response to the input to the tablet in the first operation mode, and the second execution unit executes the second program in response to the input to the tablet in the second operation mode.

According to another aspect of the present invention, an information processing system includes a first information processing unit and a second information processing unit, the first information processing unit includes a display for displaying a first screen, a first interface portion for transmitting and receiving data to and from the second information processing unit, and a first control unit for controlling the display and the first interface portion, the first control unit includes a first execution unit for executing a first program and causing the display to display an image created by the executed first program, the second information processing unit includes a display-integrated tablet for displaying a second screen, capable of accepting an external input, a second interface portion for transmitting and receiving data to and from the first information processing unit, and a second control unit for controlling the tablet and the second interface portion, the second control unit includes a mode switching unit for switching between a first operation mode and a second operation mode of the second control unit and a second execution unit for executing a second program, and the second execution unit creates a first command for changing display of the first program in accordance with change in position of an input to the tablet, controls the second interface portion, and transmits the first command to the first information processing unit in the first operation mode, and executes the second program in response to an input to the tablet, causes the tablet to display an image created by the executed second program, creates a second command for the first program independently of change in position of the input to the tablet, controls the second interface portion, and transmits the second command to the first information processing unit in the second operation mode.

According to yet another aspect of the present invention, a method of controlling an electronic device including a display for displaying a first screen, a display-integrated tablet for displaying a second screen, capable of accepting an external input, and an execution unit for executing a program, includes the steps of: switching between a first operation mode and a second operation mode of the electronic device; executing the program in response to an input to the tablet and causing the display to display an image created by the executed program in the first operation mode, the step of causing the display to display an image in the first operation mode including the step of changing the image displayed on the display in accordance with change in position of the input to the tablet; and executing the program in response to an input to the tablet, causing the tablet to display an image created by the executed program, and controlling display on the display independently of change in position of the input to the tablet in the second operation mode.

According to yet another aspect of the present invention, a program for controlling an electronic device including a display for displaying a first screen, a display-integrated tablet for displaying a second screen, capable of accepting an external input, and an execution unit for executing a program, includes the steps of: switching between a first operation mode and a second operation mode of the electronic device; executing the program in response to an input to the tablet and causing the display to display an image created by the executed program in the first operation mode, the step of causing the display to display an image in the first operation mode including the step of changing the image displayed on the display in accordance with change in position of the input to the tablet; and executing the program in response to an input to the tablet, causing the tablet to display an image created by the executed program, and controlling display on the display independently of change in position of the input to the tablet in the second operation mode.

An electronic device (or an information processing system) according to the present invention includes a display for displaying a first screen and a display-integrated tablet for displaying a second screen, capable of accepting an external input. In addition, the electronic device includes the first operation mode and the second operation mode between which switching can be made.

In the first operation mode, the electronic device changes the image displayed on the display based on change in position of input to the tablet. On the other hand, in the second operation mode, the electronic device controls display of an image on the display independently of change in position of input to the tablet.

More specifically, in the first operation mode, the electronic device directly operates the display based on the position of input to the tablet. In addition, in the second operation mode, the electronic device operates the display through an operation based on the position of input to the tablet in a UI (user interface) screen displayed on a second screen tablet. The electronic device carries out such control as suppression of appearance of an unnecessary indication on the display as a result of input to the tablet in response to switching from the first operation mode to the second operation mode.

Consequently, according to the present invention, the electronic device or the information processing system having two display screens and two types of operation modes and achieving high operability can be provided. Alternatively, according to the present invention, a method of controlling an electronic device and a control program achieving improved operability of an electronic device having two display screens and two types of operation modes can be provided.

An electronic device according to one aspect of the present invention includes a first display portion for displaying an image, a second display portion for displaying an image, which contains a touch sensor, a first storage portion, and a control unit for causing the first display portion to display, by executing a program of an application stored in the first storage portion, at least a part of an output screen showing a result of execution of processing in accordance with the application, the control unit executes the program of the application based on information on a first operation position which is an absolute operation position in a first region in the second display portion determined based on the application and on information on a second operation position which is a relative operation position in a second region in the second display portion determined based on the application, and the second display portion transmits information on the first and second operation positions to the control unit based on a detection output from a touch sensor.

In addition, preferably, in the electronic device according to the present invention, the touch sensor is implemented by a photosensor.

In addition, preferably, in the electronic device according to the present invention, the control unit causes an image to be displayed at a prescribed position in the first region based on the application and performs prescribed processing of the application in response to an operation onto the prescribed position.

In addition, preferably, in the electronic device according to the present invention, the control unit transmits information designating the first region and the second region to the second display portion, and the second display portion determines in which of the first region and the second region the operation position detected by the touch sensor is included, transmits the information on the first operation position to the control unit based on the detection output from the touch sensor when it is determined that the operation position is included in the first region, and transmits the information on the second operation position to the control unit based on the detection output from the touch sensor when it is determined that the operation position is included in the second region.

In addition, preferably, in the electronic device according to the present invention, the control unit transmits to the second display portion, specifying information which is information for specifying an application being executed, the second display portion includes a second storage portion storing a type of the application and information determining the first region and the second region in association with each other, in which of the first region and the second region the operation position detected by the touch sensor is included is determined based on the specifying information and storage contents in the second storage portion, when it is determined that the operation position is included in the first region, the information on the first operation position is transmitted to the control unit based on the detection output from the touch sensor, and when it is determined that the operation position is included in the second region, the information on the second operation position is transmitted to the control unit based on the detection output from the touch sensor.

An electronic device according to another aspect of the present invention includes a first display portion for displaying an image, a first storage portion, a control unit for causing the first display portion to display, by executing a program of an application stored in the first storage portion, at least a part of an output screen showing a result of execution of processing in accordance with the application, and a communication unit for transmitting and receiving information to and from an information processing terminal including a second display portion for displaying an image, which contains a touch sensor, the control unit executes the program of the application based on a first operation position which is an absolute operation position in a first region in the second display portion and on a second operation position which is a relative operation position in a second region in the second display portion determined based on the application, and the communication unit receives from the information processing terminal, information on the first and second operation positions generated based on a detection output from the touch sensor.

An information processing terminal according to the present invention is an information processing terminal capable of transmitting and receiving information to and from an electronic device including a first display portion for displaying an image, a first storage portion, and a control unit for causing the first display portion to display, by executing a program of an application stored in the first storage portion, at least a part of an output screen showing a result of execution of processing in accordance with the application, and the information processing terminal includes a second display portion for displaying an image, which contains a touch sensor, a reception unit for receiving from the electronic device, information specifying a first region and a second region in the second display portion determined based on the application executed in the electronic device, an information generation unit for generating information on a first operation position which is an absolute operation position in the first region and information on a second operation position which is a relative operation position in the second region based on a detection output from the touch sensor for execution of the program of the application by the control unit, and a transmission unit for transmitting the information on the first and second operation positions to the electronic device.

An application program according to one aspect of the present invention is an application program executed in an electronic device including a first display portion for displaying an image and a second display portion for displaying an image, which contains a touch sensor, and the application program causes the electronic device to perform the steps of causing the first display portion to display at least a part of an output screen showing a result of execution of processing in accordance with the application, obtaining information on a first operation position which is an absolute operation position in a first region in the second display portion and information on a second operation position which is a relative operation position in a second region in the second display portion determined based on the application based on a detection output from the touch sensor, and executing the program of the application based on the information on the first and second operation positions.

An application program according to another aspect of the present invention is an application program executed in an electronic device including a first display portion for displaying an image, and the application program causes the electronic device to perform the steps of causing the first display portion to display at least a part of an output screen showing a result of execution of processing in accordance with the application, receiving from an information processing terminal including a second display portion for displaying an image, which contains a touch sensor, information on a first operation position which is an absolute operation position in a first region in the second display portion and information on a second operation position which is a relative operation position in a second region in the second display portion, that are determined based on the application and generated based on a detection output from the touch sensor, and executing the program of the application based on the information on the first and second operation positions.

A control program according to the present invention is a control program for an information processing terminal capable of transmitting and receiving information to and from an electronic device, which includes a display portion for displaying an image, which contains a touch sensor, and the control program causes the information processing terminal to perform the steps of receiving from the electronic device, information specifying a first region and a second region in the display portion determined based on an application executed in the electronic device, generating information on a first operation position which is an absolute operation position in the first region and information on a second operation position which is a relative operation position in the second region based on a detection output from the touch sensor for execution of the program of the application in the electronic device, and transmitting the information on the first and second operation positions to the electronic device.

According to the present invention, the first region in which an absolute operation position is detected and the second region in which a relative operation position is detected can be provided in the display portion containing a touch sensor, and an outline of each region within the display portion can be changed for each application.

Therefore, the user can input information in the display portion, simultaneously making use of the first region and the second region.

In addition, according to the present invention, not only simultaneous use of the first region and the second region, each of which has conventionally been used only mutually exclusively, can be achieved, but also setting in connection with the first region and the second region in the display portion containing the touch sensor in the main device is made depending on a type of an application, and thus it is not necessary to use a setting tool or the like. Thus, the user can input information for executing the application into the electronic device by making use of the first region and the second region, without taking the trouble for making such setting.

According to one aspect of the present invention, a content display device is provided. The content display device includes first and second display panels, a first display control unit for causing the first display panel to display a content, an accepting unit for accepting a change instruction to change a manner of display of the displayed content, a first determination unit for determining whether the manner of display satisfies a prescribed condition or not, and a second display control unit for causing the second display panel to display a first image for accepting an operation instruction for operating display of the content when the first determination unit determines that the manner of display satisfies the prescribed condition.

Preferably, the content display device further includes a switching unit for switching to a first mode when the first determination unit determines that the manner of display satisfies the prescribed condition and switching to a second mode when the first determination unit determines that the manner of display does not satisfy the prescribed condition. In the second mode, the first display control unit causes the first display panel to display a pointer. In the second mode, the accepting unit accepts a first movement instruction for moving the pointer through the second display panel.

Preferably, in the second mode, the first display control unit causes the first display panel to display a content and a second image for accepting an operation instruction for operating display of the content.

Preferably, in the first mode, the first display control unit causes the first display panel to display the content without causing the first display panel to display a second image.

Preferably, when switching to the second mode is made, the first display control unit causes the first display panel to display the pointer at a location in the second image corresponding to the last accepted operation instruction.

Preferably, the content display device further includes a second determination unit for determining whether or not the accepting unit has accepted a second movement instruction for moving the second image to a prescribed area in the second mode. When the second determination unit determines that the accepting unit has accepted the second movement instruction, the switching unit makes switching to the first mode and the first display control unit causes the first display panel to provide full-screen display of the content.

Preferably, the content display device further includes a third determination unit for determining whether or not the accepting unit has accepted a second prescribed instruction in the first mode. When the third determination unit determines that the accepting unit has accepted the second prescribed instruction, the switching unit makes switching to the second mode and the first display control unit causes the first display panel to display the pointer.

Preferably, the accepting unit generates an operation instruction based on an absolute coordinate input through the second display panel in the first mode, and generates a first movement instruction based on a relative coordinate input through the second display panel in the second mode.

Preferably, the manner of display of the content is a display size of the content. The first display control unit changes the display size of the content based on the change instruction.

Preferably, the first determination unit determines that the manner of display satisfies the prescribed condition when the first display control unit causes the first display panel to provide full-screen display of the content, and it determines that the manner of display does not satisfy the prescribed condition when the first display control unit does not cause the first display panel to provide full-screen display of the content.

Preferably, the second display panel includes a plurality of photosensor circuits for generating an input signal in accordance with incident light and a plurality of pixel circuits emitting light in accordance with an output signal. The accepting unit accepts an operation instruction based on the input signal from the plurality of photosensor circuits. The second display control unit causes the second display panel to display the first image by outputting an output signal to the pixel circuit.

According to another aspect of the present invention, a content display method in a content display device including first and second display panels and an operation processing unit is provided. The content display method includes the steps of: the operation processing unit causing the first display panel to display a content; the operation processing unit accepting a change instruction to change a manner of display of the displayed content; the operation processing unit determining whether the manner of display satisfies a prescribed condition or not; and causing the second display panel to display a first image for accepting an operation instruction for operating display of the content when the operation processing unit determines that the manner of display satisfies the prescribed condition.

According to another aspect of the present invention, a content display program for causing a content display device including first and second display panels and an operation processing unit to display a content is provided. The content display program causes the operation processing unit to perform the steps of causing the first display panel to display a content, accepting a change instruction to change a manner of display of the displayed content, determining whether the manner of display satisfies a prescribed condition or not, and causing the second display panel to display a first image for accepting an operation instruction for operating display of the content when it is determined that the manner of display satisfies the prescribed condition.

As described above, according to the present invention, a content display device, a content display method and a content display program capable of providing an operation screen readily operable by a user depending on a situation can be provided.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### DESCRIPTION OF THE REFERENCE SIGNS

100 electronic device; 100A, 100B casing; 100C hinge; 100D recess; 101, 104 main device; 102, 102A, 103 display device; 130, 230 driver; 131 operation signal line driving circuit; 132 data signal line driving circuit; 133 photosensor driving circuit; 134 switch; 135 amplifier; 140, 140A, 240 liquid crystal panel; 141 pixel circuit; 141b, 141g, 141r sub pixel circuit; 143 electrode pair; 143a pixel electrode; 143b counter electrode; 144 photosensor circuit; 145, 145b, 145g, 145r photodiode; 146 capacitor; 151A active matrix substrate; 151B counter substrate; 152 liquid crystal layer; 153b, 153g, 153r color filter; 157 data signal line; 161 polarizing filter; 162 glass substrate; 163 light shielding film; 164 alignment film; 173 memory card reader/writer; 174, 274 external communication unit; 175 microphone; 176 speaker; 177 operation key; 179, 279 backlight; 180, 280 image processing engine; 181, 281 driver control unit; 182, 282 timer; 183, 283 signal processing unit; 191 power switch; 192 power source circuit; 193, 293 power source detecting unit; 194, 294 connector; 195, 295 antenna; 196 connector; 297 signal strength detecting unit; 310, 410 display portion; 320, 420 input portion; 330, 430 storage portion; 340, 440 interface portion; 350, 450 control unit; 432c book history; 900 finger; 1001, 1001A first unit; and 1002 second unit.

1. An electronic device, comprising:
a first display portion;
a second display portion;
a storage portion; and
a control unit for controlling a manner of display on said first and second display portions,
said second display portion being a display-integrated tablet capable of accepting an external input,
said control unit
being capable of operating in a first mode causing said first display portion to display a screen created in processing performed in accordance with the input to said tablet and in a second mode causing said second display portion to display a screen created in processing performed in accordance with the input to said tablet,
causing said storage portion to store operation information which is information specifying a content of an operation in said second mode when an operation mode is switched from said second mode to said first mode, and
causing said second display portion to display information in accordance with said operation information stored in said storage portion when the operation mode is switched from said first mode to said second mode.

2. The electronic device according to claim 1, wherein
said control unit causes said second display portion to display a screen including a sequence of soft keys as information in accordance with said operation information stored in said storage portion in switching the operation mode from said first mode to said second mode.

3. The electronic device according to claim 2, wherein
contents can be selected in said second mode,
said storage portion stores as said operation information, information on history of selection of the contents in said second mode, and
said soft key is a soft key for selecting the contents sequenced in correspondence with the information on said history of selection of the contents stored in said storage portion.

4. The electronic device according to claim 3, wherein
said storage portion stores information specifying contents selectable in said second mode in an order by name, and
said control unit accepts input of information as to whether to sequence said soft keys in correspondence with said information on said history of selection of the contents or to sequence said soft keys in said order by name.

5. A method of controlling an electronic device including a first display portion, a second display portion implemented by a display-integrated tablet capable of accepting an external input, a storage portion, and a control unit for controlling a manner of display on the first and second display portions, comprising the steps of:
operating in a first mode causing said first display portion to display a screen created in processing performed in accordance with the input to said tablet;
operating in a second mode causing said second display portion to display a screen created in processing performed in accordance with the input to said tablet;
storing in said storage portion, operation information which is information specifying a content of an operation in said second mode when an operation mode is switched from said second mode to said first mode; and
displaying on said second display portion, information in accordance with said operation information stored in said storage portion when the operation mode is switched from said first mode to said second mode.

6. A recording medium recording a control program executed in an electronic device including a first display portion, a second display portion implemented by a display-integrated tablet capable of accepting an external input, a storage portion, and a control unit for controlling a manner of display on the first and second display portions, said control program causing said electronic device to perform the steps of:
operating in a first mode causing said first display portion to display a screen created in processing performed in accordance with the input to said tablet;
operating in a second mode causing said second display portion to display a screen created in processing performed in accordance with the input to said tablet;
storing in said storage portion, operation information which is information specifying a content of an operation in said second mode when an operation mode is switched from said second mode to said first mode; and
displaying on said second display portion, information in accordance with said operation information stored in said storage portion when the operation mode is switched from said first mode to said second mode.
